(19) United States
(12) Patent Application Publication
(10) Pub. No.: US 2004/0233461 A1
(43) Pub. Date: Nov. 25, 2004

(54) Methods and apparatus for measuring orientation and distance

(76) Inventors: Brian S. Armstrong, Shorewood, WI (US); Karl B. Schmidt, Wauwatosa, WI (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/865,733

(22) Filed: Jun. 9, 2004

Related U.S. Application Data
(63) Continuation of application No. 09/711,857, filed on Nov. 13, 2000, now abandoned.
(60) Provisional application No. 60/164,754, filed on Nov. 12, 1999.
(60) Provisional application No. 60/212,434, filed on Jun. 16, 2000.

(51) Int. Cl. G01B 11/14

(52) U.S. Cl. 356/620

(57) ABSTRACT

Methods and apparatus for measuring orientation and distance. In one example, an orientation dependent radiation source emanates radiation having at least one detectable property that varies as a function of a rotation of the orientation dependent radiation source and/or an observation distance from the orientation dependent radiation source (e.g., a distance between the source and a radiation detection device). In one particular example, the rotation of the source is determined from a position or phase of the orientation dependent radiation on an observation surface of the source, and the observation distance between the source and the detection device is determined from a spatial frequency of the orientation dependent radiation. In another example, an image metrology reference target is provided that when placed in a scene of interest facilitates image analysis for various measurement purposes. Such a reference target may include automatic detection means for facilitating an automatic detection of the reference target in an image of the reference target obtained by a camera, and bearing determination means for facilitating a determination of position and/or orientation of the reference target with respect to the camera. In one example, the bearing determination means of the reference target includes one or more orientation dependent radiation sources.

CROSS REFERENCE TO RELATED APPLICATIONS

The present application is a continuation of prior application Ser. No. 09/711,857, filed Nov. 13, 2000 entitled METHODS AND APPARATUS FOR MEASURING ORIENTATION AND DISTANCE, which application claims the benefit, under 35 U.S.C. §119(e), of U.S. Provisional Application Serial No. 60/164,754, entitled “Image Metrology System,” and of U.S. Provisional Application Serial No. 60/212,434, entitled “Method for Locating Landmarks by Machine Vision,” which applications are hereby incorporated herein by reference.

### FIELD OF THE INVENTION

The present invention relates to various methods and apparatus for facilitating measurements of orientation and distance, and more particularly, to orientation and distance measurements for image metrology applications.

### DESCRIPTION OF THE RELATED ART

A. Introduction

Photogrammetry is a technique for obtaining information about the position, size, and shape of an object by measuring images of the object, instead of by measuring the object directly. In particular, conventional photogrammetry techniques primarily involve determining relative physical locations and sizes of objects in a three-dimensional scene of interest from two-dimensional images of the scene (e.g., multiple photographs of the scene).

In some conventional photogrammetry applications, one or more recording devices (e.g., cameras) are positioned at different locations relative to the scene of interest to obtain multiple images of the scene from different viewing angles. In these applications, multiple images of the scene need not be taken simultaneously, nor by the same recording device; images of the scene need not be taken simultaneously, nor by the same recording device, however, generally it is necessary to have a number of features in the scene of interest appear in each of the multiple images obtained from different viewing angles.

In conventional photogrammetry, knowledge of the spatial relationship between the scene of interest and a given recording device at a particular location is required to determine information about objects in a scene from multiple images of the scene. Accordingly, conventional photogrammetry techniques typically involve a determination of a position and an orientation of a recording device relative to the scene at the time an image is obtained by the recording device. Generally, the position and the orientation of a given recording device relative to the scene is referred to in photogrammetry as the “exterior orientation” of the recording device. Additionally, some information typically must be known (or at least reasonably estimated) about the recording device itself (e.g., focussing and/or other calibration parameters); this information generally is referred to as the “interior orientation” of the recording device. One of the aims of conventional photogrammetry is to transform two-dimensional measurements of particular features that appear in multiple images of the scene into actual three-dimensional information (i.e., position and size) about the features in the scene, based on the interior orientation and the exterior orientation of the recording device used to obtain each respective image of the scene.

In view of the foregoing, it should be appreciated that conventional photogrammetry techniques typically involve a number of mathematical transformations that are applied to features of interest identified in images of a scene to obtain actual position and size information in the scene. Fundamental concepts related to the science of photogrammetry are described in several texts, including the text entitled Close Range Photogrammetry and Machine Vision, edited by K. B. Atkinson, and published in 1996 by Whittles Publishing, ISBN 1-870325-46-X, which text is hereby incorporated herein by reference (and hereinafter referred to as the “Atkinson text”). In particular, Chapter 2 of the Atkinson text presents a theoretical basis and some exemplary fundamental mathematics for photogrammetry. A summary of some of the concepts presented in Chapter 2 of the Atkinson text that are germane to the present disclosure is given below. The reader is encouraged to consult the Atkinson text and/or other suitable texts for a more detailed treatment of this subject matter. Additionally, some of the mathematical transformations discussed below are presented in greater detail in Section L of the Detailed Description, as they pertain more specifically to various concepts relating to the present invention.

B. The Central Perspective Projection Model

FIG. 1 is a diagram which illustrates the concept of a “central perspective projection,” which is the starting point for building an exemplary functional model for photogrammetry. In the central perspective projection model, a recording device used to obtain an image of a scene of interest is idealized as a “pinhole” camera (i.e., a simple aperture). For purposes of this disclosure, the term “camera” is used generally to describe a generic recording device for acquiring an image of a scene, whether the recording device be an idealized pinhole camera or various types of actual recording devices suitable for use in photogrammetry applications, as discussed further below.

In FIG. 1, a three-dimensional scene of interest is represented by a reference coordinate system 74 having a reference origin 56 (Oᵣ) and three orthogonal axes 50, 52, and 54 (xᵣ, yᵣ, and zᵣ, respectively). The origin, scale, and orientation of the reference coordinate system 74 can be arbitrarily defined, and may be related to one or more features of interest in the scene, as discussed further below. Similarly, a camera used to obtain an image of the scene is represented by a camera coordinate system 76 having a camera origin 66 (O_{c}) and three orthogonal axes 60, 62, and 64 (x_{c}, y_{c}, and z_{c}, respectively).

In the central perspective projection model of FIG. 1, the camera origin 66 represents a pinhole through which all rays intersect, passing into the camera and onto an image (projection) plane 24. For example, as shown in FIG. 1, an object point 51 (A) in the scene of interest is projected onto the image plane 24 of the camera as an image point 51′ (a) by a straight line 80 which passes through the camera origin 66. Again, it is to be appreciated that the pinhole camera is an idealized representation of an image recording device, and that in practice the camera origin 66 may represent a “nodal point” of a lens or lens system of an actual camera or other recording device, as discussed further below.

In the model of FIG. 1, the camera coordinate system 76 is oriented such that the z_{c} axis 64 defines an optical axis 82 of the camera. Ideally, the optical axis 82 is orthogonal to the image plane 24 of the camera and intersects the image plane at an image plane origin 67 (Oᵢ). Accordingly, the image plane 24 generally is defined by two orthogonal axis xᵢ and yᵢ, which respectively are parallel to the x_{c} axis 60 and the y_{c} axis 62 of the camera coordinate system 76 (wherein the z_{c} axis 64 of the camera coordinate system 76 is directed away from the image plane 24). A distance 84 (d) between the camera origin 66 and the image plane origin 67 typically is referred to as a “principal distance” of the camera. Hence, in terms of the camera coordinate system 76, the image plane 24 is located at z_{c}=−d.

In FIG. 1, the object point A and image point a each may be described in terms of their three-dimensional coordinates in the camera coordinate system 76. For purposes of the present disclosure, the notation

^{S}P_{B}

is introduced generally to indicate a set of coordinates for a point B in a coordinate system S. Likewise, it should be appreciated that this notation can be used to express a vector from the origin of the coordinate system S to the point B. Using the above notation. individual coordinates of the set are identified by ^{S}P_{B}(x), ^{S}P_{B}(y), and ^{S}P_{B}(z), for example. Additionally, it should be understood that the above notation may be used to describe a coordinate system S having any number of (e.g., two or three) dimensions.

With the foregoing notation in mind, the set of three x-, y-, and z-coordinates for the object point A in the camera coordinate system 76 (as well as the vector O_{c}A from the camera origin 66 to the object point A) can be expressed as ^{c}P_{A}. Similarly, the set of three coordinates for the image point a in the camera coordinate system (as well as the vector O_{c}a from the camera origin 66 to the image point a) can be expressed as ^{c}Pₐ, wherein the z-coordinate of ^{c}Pₐ is given by the principal distance 84 (i.e., ^{c}Pₐ(z)=−d).

From the projective model of FIG. 1, it may be appreciated that the vectors ^{c}P_{A} and ^{c}Pₐ are opposite in direction and proportional in length. In particular, the following ratios may be written for the coordinates of the object point A and the image point a in the camera coordinate system:

$$\begin{matrix} \frac{ {}_{}^{c}{P}{}_{a}^{} ( x )}{{}_{}^{c}{P}{}_{a}^{} ( z )} = \frac{{}_{}^{c}{P}{}_{A}^{} ( x )}{{}_{}^{c}{P}{}_{A}^{} ( z )} \\ and \\ \frac{{}_{}^{c}{P}{}_{a}^{} ( y )}{{}_{}^{c}{P}{}_{a}^{} ( z )} = \frac{{}_{}^{c}{P}{}_{A}^{} ( y )}{{}_{}^{c}{P}{}_{A}^{} ( z )} .\end{matrix}$$

By rearranging the above equations and making the substitutions, ^{c}Pₐ(z)=−d for the principal distance 84, the x- and y-coordinates of the image point a in the camera coordinate system may be expressed as:

$$\begin{matrix}{}_{}^{c}{P}{}_{a}^{} ( x ) = ( - d ) ( \frac{{}_{}^{c}{P}{}_{A}^{} ( x )}{{}_{}^{c}{P}{}_{A}^{} ( z )} ) & ( 1 ) \\ and & \\ {}_{}^{c}{P}{}_{a}^{} ( y ) = ( - d ) ( \frac{{}_{}^{c}{P}{}_{A}^{} ( y )}{{}_{}^{c}{P}{}_{A}^{} ( z )} ) . & ( 2 )\end{matrix}$$

It should be appreciated that since the respective x and y axes of the camera coordinate system 76 and the image plane 24 are parallel, Eqs. (1) and (2) also represent the image coordinates (sometimes referred to as “photo-coordinates”) of the image point a in the image plane 24. Accordingly, the x- and y-coordinates of the image point a given by Eqs. (1) and (2) also may be expressed respectively as ⁱPₐ(x) and ⁱPₐ(y), where the left superscript i represents the two-dimensional image coordinate system given by the xᵢ axis and the yᵢ axis in the image plane 24.

From Eqs. (1) and (2) above, it can be seen that by knowing the principal distance d and the coordinates of the object point A in the camera coordinate system, the image coordinates ⁱPₐ(x) and ⁱPₐ(y) of the image point a may be uniquely determined. However, it should also be appreciated that if the principal distance d and the image coordinates ⁱPₐ(x) and ⁱPₐ(y) of the image point a are known, the three-dimensional coordinates of the object point A may not be uniquely determined using only Eqs. (1) and (2), as there are three unknowns in two equations. For this reason, conventional photogrammetry techniques typically require multiple images of a scene in which an object point of interest is present to determine the three-dimensional coordinates of the object point in the scene. This multiple image requirement is discussed further below in the Section G of the Description of the Related Art, entitled “Intersection.”

C. Coordinate System Transformations

While Eqs. (1) and (2) relate the image point a to the object point A in FIG. 1 in terms of the camera coordinate system 76, one of the aims of conventional photogrammetry techniques is to relate points in an image of a scene to points in the actual scene in terms of their three-dimensional coordinates in a reference coordinate system for the scene (e.g., the reference coordinate system 74 shown in FIG. 1). Accordingly, one important aspect of conventional photogrammetry techniques often involves determining the relative spatial relationship (i.e., relative position and orientation) of the camera coordinate system 76 for a camera at a particular location and the reference coordinate system 74, as shown in FIG. 1. This relationship commonly is referred to in photogrammetry as the “exterior orientation” of a camera, and is referred to as such throughout this disclosure.

FIG. 2 is a diagram illustrating some fundamental concepts related to coordinate transformations between the reference coordinate system 74 of the scene (shown on the right side of FIG. 2) to the camera coordinate system 76 (shown on the left side of FIG. 2). The various concepts outlined below relating to coordinate system transformations are treated in greater detail in the Atkinson text and other suitable texts, as well as in Section L of the Detailed Description.

In FIG. 2, object point 51 (A) may be described in terms of its three-demensional coordinates in either the reference coordinate system 74 or the camera coordinate system 76. In particular, using the notation introduced above, the coordinates of the point A in the reference coordinate system 74 (as well as a first vector 77 from the origin 56 of the reference coordinate system 74 to the point A) can be expressed as ^{r}P_{A}. Similarly, as discussed above, the coordinates of the point A in the camera coordinate system 76 (as well as a second vector 79 from the origin 66 of the camera coordinate system 76 to the object point A) can be expressed as ^{c}P_{A}, wherein the left superscripts r and c represent the reference and camera coordinate systems, respectively.

Also indicated in FIG. 2 is a third “translation” vector 78 from the origin 56 of the reference coordinate system 74 to the origin 66 of the camera coordinate system 76. The translation vector 78 may be expressed in the above notation as ^{r}P_{O}_{_{c}}. In particular, the vector ^{r}P_{O}_{_{c}} designates the location (i.e., position) of the camera coordinate system 76 with respect to the reference coordinate system 74. Stated alternatively, the notation ^{r}P_{O}_{_{c}} represents an x-coordinate, a y-coordinate, and a z-coordinate of the origin 66 of the camera coordinate system 76 with respect to the reference coordinate system 74.

In addition to a translation of one coordinate system to another (as indicated by the vector 78), FIG. 2 illustrates that one of the reference and camera coordinate systems may be rotated in three-dimensional space with respect to the other. For example, an orientation of the camera coordinate system 76 with respect to the reference coordinate system 74 may be defined by a rotation about any one or more of the x, y, and z axes of one of the coordinate systems. For purposes of the present disclosure, a rotation of γ degrees about an x axis is referred to as a “pitch” rotation, a rotation of α degrees about a y axis is referred to as a “yaw” rotation, and a rotation of β degrees about a z axis is referred to as a “roll” rotation.

With this terminology in mind, as shown in FIG. 2, a pitch rotation 68 of the reference coordinate system 74 about the xᵣ axis 50 alters the position of the yᵣ axis 52 and the zᵣ axis 54 so that they respectively may be parallel aligned with the y_{c} axis 62 and the z_{c} axis 64 of the camera coordinate system 76. Similarly, a yaw rotation 70 of the reference coordinate system about the yᵣ axis 52 alters the position of the xᵣ axis 50 and the zᵣ axis 54 so that they respectively may be parallel aligned with the x_{c} axis 60 and the z_{c} axis 64 of the camera coordinate system. Likewise, a roll rotation 72 of the reference coordinate system about the zᵣ axis 54 alters the position of the xᵣ axis 50 and the yᵣ axis 52 so that they respectively may be parallel aligned with the x_{c} axis 60 and the y_{c} axis 62 of the camera coordinate system. It should be appreciated that, conversely, the camera coordinate system 76 may be rotated about one or more of its axes so that its axes are parallel aligned with the axes of the reference coordinate system 74.

In sum, an orientation of the camera coordinate system 76 with respect to the reference coordinate system 74 may be given in terms of three rotation angles; namely, a pitch rotation angle (γ), a yaw rotation angle (α), and a roll rotation angle (β). This orientation may be expressed by a three-by-three rotation matrix, wherein each of the nine rotation matrix elements represents a trigonometric function of one or more of the yaw, roll, and pitch angles α, β, and γ, respectively. For purposes of the present disclosure, the notation

_{S1}^{S2}R

is used to represent one or more rotation matrices that implement a rotation from the coordinate system S1 to the coordinate system S2. Using this notation, ᵣ^{c}R denotes a rotation from the reference coordinate system to the camera coordinate system, and _{c}^{r}R denotes the inverse rotation (i.e., a rotation from the camera coordinate system to the reference coordinate system). It should be appreciated that since these rotation matrices are orthogonal, the inverse of a given rotation matrix is equivalent to its transpose; accordingly, _{c}^{r}R=ᵣ^{c}R^{T}. It should also be appreciated that rotations between the camera and reference coordinate systems shown in FIG. 2 implicitly include a 180 degree yaw rotation of one of the coordinate systems about its y axis, so that the respective z axes of the coordinate systems are opposite in sense (see Section L of the Detailed Description).

By combining the concepts of translation and rotation discussed above, the coordinates of the object point A in the camera coordinate system 76 shown in FIG. 2, based on the coordinates of the point A in the reference coordinate system 74 and a transformation (i.e., translation and rotation) from the reference coordinate system to the camera coordinate system, are given by the vector expression:

^{c}P_{A}=ᵣ^{c}R ^{r}P_{A}+^{c}P_{O}_{ᵣ}. (3)

Likewise, the coordinates of the point A in the reference coordinate system 74, based on the coordinates of the point A in the camera coordinate system and a transformation (i.e., translation and rotation) from the camera coordinate system to the reference coordinate system, are given by the vector expression:

^{r}P_{A}=_{c}^{r}R ^{c}P_{A}+^{r}P_{O}_{_{c}}, (4)

where _{c}^{r}R=ᵣ^{c}R^{T}, and where for the translation vector 78, ^{r}P_{O}_{_{c}}=−_{c}^{r}R^{c}P_{O}_{ᵣ}. Each of Eqs. (3) and (4) includes six parameters which constitute the exterior orientation of the camera; namely, three position parameters in the respective translation vectors ^{c}P_{O}_{ᵣ} and ^{r}P_{O}_{_{c}} (i.e., the respective x-, y-, and z-coordinates of one coordinate system origin in terms of the other coordinate system), and three orientation parameters in the respective rotation matrices ᵣ^{c}R and _{c}^{r}R (i.e., the yaw, roll, and pitch rotation angles α, β, and γ).

Eqs. (3) and (4) alternatively may be written using the notation

_{S1}^{S2}T(•), (5)

which is introduced to generically represent a coordinate transformation function of the argument in parentheses. The argument in parentheses is a set of coordinates in the coordinate system S1, and the transformation function T transforms these coordinates to coordinates in the coordinate system S2. In general, it should be appreciated that the transformation function T may be a linear or a nonlinear function; in particular, the coordinate systems S1 and S2 may or may not have the same dimensions. In the following discussion, the notation T⁻¹ is used herein to indicate an inverse coordinate transformation (e.g., _{S1}^{S2}T⁻¹(•)=_{S2}^{S1}T(•), where the argument in parenthesis is a set of coordinates in the coordinate system S2).

Using the notation of Eq. (5), Eqs. (3) and (4) respectively may be rewritten as

^{c}P_{A}=ᵣ^{c}T(^{r}P_{A}), (6)

and

^{r}P_{A}=_{c}^{r}T(^{c}P_{A}), (7)

wherein the transformation functions ᵣ^{c}T and _{c}^{r}T represent mappings between the three-dimensional reference and camera coordinate systems, and wherein ᵣ^{c}T=_{c}^{r}T⁻¹ (the transformations are inverses of each other). Each of the transformation functions ᵣ^{c}T and _{c}^{r}T includes a rotation and a translation and, hence, the six parameters of the camera exterior orientation.

With reference again to FIG. 1, it should be appreciated that the concepts of coordinate system transformation illustrated in FIG. 2 and the concepts of the idealized central perspective projection model illustrated in FIG. 1 may be combined to derive spatial transformations between the object point 51 (A) in the reference coordinate system 74 for the scene and the image point 51′ (a) in the image plane 24 of the camera. For example, known coordinates of the object point A in the reference coordinate system may be first transformed using Eq. (6) (or Eq. (3)) into coordinates of the point A in the camera coordinate system. The transformed coordinates may be then substituted into Eqs. (1) and (2) to obtain coordinates of the image point a in the image plane 24. In particular, Eq. (6) may be rewritten in terms of each of the coordinates of ^{c}P_{A}, and the resulting equations for the respective coordinates ^{c}P_{A}(x), ^{c}P_{A}(y), and ^{c}P_{A}(z) may be substituted into Eqs. (1) and (2) to give two “collinearity equations” (see, for example, the Atkinson text, Ch. 2.2), which respectively relate the x- and y-image coordinates of the image point a directly to the three-dimensional coordinates of the object point A in the reference coordinate system 74. It should be appreciated that one object point A in the scene generates two such collinearity equations (i.e., one equation for each x- and y-image coordinate of the corresponding image point a), and that each of the collinearity equations includes the principal distance d of the camera, as well as terms related to the six exterior orientation parameters (i.e., three position and three orientation parameters) of the camera.

D. Determining Exterior Orientation Parameters: “Resection”

If the exterior orientation of a given camera is not known a priori (which is often the case in many photogrammetry applications), one important aspect of conventional photogrammetry techniques involves determining the parameters of the camera exterior orientation for each different image of the scene. The evaluation of the six parameters of the camera exterior orientation from a single image of the scene commonly is referred to in photogrammetry as “resection.” Various conventional resection methods are known, with different degrees of complexity in the methods and accuracy in the determination of the exterior orientation parameters.

In conventional resection methods, generally the principal distance d of the camera is known or reasonably estimated a priori (see Eqs. (1) and (2)). Additionally, at least three non-collinear “control points” are selected in the scene of interest that each appear in an image of the scene. Control points refer to features in the scene for which actual relative position and/or size information in the scene is known. Specifically, the spatial relationship between the control points in the scene must be known or determined (e.g., measured) a priori such that the three-dimensional coordinates of each control point are known in the reference coordinate system. In some instances, at least three non-collinear control points are particularly chosen to actually define the reference coordinate system for the scene.

As discussed above in Section B of the Description of the Related Art, conventional photogrammetry techniques typically require multiple images of a scene to determine unknown three-dimensional position and size information of objects of interest in the scene. Accordingly, in many instances, the control points for resection need to be carefully selected such that they are visible in multiple images which are respectively obtained by cameras at different locations, so that the exterior orientation of each camera may be determined with respect to the same control points (i.e., a common reference coordinate system). Often, selecting such control points is not a trivial task; for example, it may be necessary to plan a photo-survey of the scene of interest to insure that not only are a sufficient number of control points available in the scene, but that candidate control points are not obscured at different camera locations by other features in the scene. Additionally, in some instances, it may be incumbent on a photogrammetry analyst to identify the same control points in multiple images accurately (i.e., “matching” of corresponding images of control points) to avoid errors in the determination of the exterior orientation of cameras at different locations with respect to a common reference coordinate system. These and other issues related to corresponding point identification in multiple images are discussed further below in the Sections G and H of the Description of the Related Art, entitled “Intersection” and “Multi-image Photogrammetry and Bundle Adjustments,” respectively.

In conventional resection methods, each control point corresponds to two collinearity equations which respectively relate the x- and y-image coordinates of a control point as it appears in an image to the three-dimensional coordinates of the control point in the reference coordinate system 74 (as discussed above in Section C of the Description of the Related Art). For each control point, the respective image coordinates in the two collinearity equations are obtained from the image. Additionally, as discussed above, the principal distance of the camera generally is known or reasonably estimated a priori, and the reference system coordinates of each control point are known a priori (by definition). Accordingly, each collinearity equation based on the idealized pinhole camera model of FIG. 1 (i.e., using Eqs. (1) and (2)) has only six unknown parameters (i.e., three position and three orientation parameters) corresponding to the exterior orientation of the camera.

In view of the foregoing, using at least three control points, a system of at least six collinearity equations (two for each control point) in six unknowns is generated. In some conventional resection methods, only three non-collinear control points are used to directly solve (i.e., without using any approximate initial values for the unknown parameters) such a system of six equations in six unknowns to give an estimation of the exterior orientation parameters. In other conventional resection methods, a more rigorous iterative least squares estimation process is used to solve a system of at least six collinearity equations.

In an iterative estimation process for resection, often more than three control points are used to generate more than six equations to improve the accuracy of the estimation. Additionally, in such iterative processes, approximate values for the exterior orientation parameters that are sufficiently close to the final values typically must be known a priori (e.g., using direct evaluation) for the iterative process to converge; hence, iterative resection methods typically involve two steps, namely, initial estimation followed by an iterative least squares process. The accuracy of the exterior orientation parameters obtained by such iterative processes may depend, in part, on the number of control points used and the spatial distribution of the control points in the scene of interest; generally, a greater number of well-distributed control points in the scene improves accuracy. Of course, it should be appreciated that the accuracy with which the exterior orientation parameters are determined in turn affects the accuracy with which position and size information about objects in the scene may be determined from images of the scene.

E. Camera Modeling: Interior Orientation and Distortion Effects

The accuracy of the exterior orientation parameters obtained by a given resection method also may depend, at least in part, on how accurately the camera itself is modeled. For example, while FIG. 1 illustrates an idealized projection model (using a pinhole camera) that is described by Eqs. (1) and (2), in practice an actual camera that includes various focussing elements (e.g., a lens or a lens system) may affect the projection of an object point onto an image plane of the recording device in a manner that deviates from the idealized model of FIG. 1. In particular, Eqs. (1) and (2) may in some cases need to be modified to include other terms that take into consideration the effects of various structural elements of the camera, depending on the degree of accuracy desired in a particular photogrammetry application.

Suitable recording devices for photogrammetry applications generally may be separated into three categories; namely, film cameras, video cameras, and digital devices (e.g., digital cameras and scanners). As discussed above, for purposes of the present disclosure, the term “camera” is used herein generically to describe any one of various recording devices for acquiring an image of a scene that is suitable for use in a given photogrammetry application. Some cameras are designed specifically for photogrammetry applications (e.g., “metric” cameras), while others may be adapted and/or calibrated for particular photogrammetry uses.

A camera may employ one or more focussing elements that may be essentially fixed to implement a particular focus setting, or that may be adjustable to implement a number of different focus settings. A camera with a lens or lens system may differ from the idealized pinhole camera of the central perspective projection model of FIG. 1 in that the principal distance 84 between the camera origin 66 (i.e., the nodal point of the lens or lens system) may change with lens focus setting. Additionally, unlike the idealized model shown in FIG. 1, the optical axis 82 of a camera with a lens or lens system may not intersect the image plane 24 precisely at the image plane origin Oᵢ, but rather at some point in the image plane that is offset from the origin Oᵢ. For purposes of this disclosure, the point at which the optical axis 82 actually intersects the image plane 24 is referred to as the “principal point” in the image plane. The respective x- and y-coordinates in the image plane 24 of the principal point, together with the principal distance for a particular focus setting, commonly are referred to in photogrammetry as “interior orientation” parameters of the camera, and are referred to as such throughout this disclosure.

Traditionally, metric cameras manufactured specifically for photogrammetry applications are designed to include certair features that ensure close conformance to the central perspective projection model of FIG. 1. Manufacturers of metric cameras typically provide calibration information for each camera, including coordinates for the principal point in the image plane 24 and calibrated principal distances 84 corresponding to specific focal settings (i.e., the interior orientation parameters of the camera for different focal settings). These three interior orientation parameters may be used to modify Eqs. (1) and (2) so as to more accurately represent a model of the camera.

Film cameras record images on photographic film. Film cameras may be manufactured specifically for photogrammetry applications (i.e., a metric film camera), for example, by including “fiducial marks” (e.g., the points f₁, f₂, f₃, and f₄ shown in FIG. 1) that are fixed to the camera body to define the xi and yi axes of the image plane 24. Alternatively, for example, some conventional (i.e., non-metric) film cameras may be adapted to include film-type inserts that attach to the film rails of the device, or a glass plate that is fixed in the camera body at the image plane, on which fiducial marks are printed so as to provide for an image coordinate system for photogrammetry applications. In some cases, film format edges may be used to define a reference for the image coordinate system. Various degrees of accuracy may be achieved with the foregoing examples of film cameras for photogrammetry applications. With non-metric film cameras adapted for photogrammetry applications, typically the interior orientation parameters must be determined through calibration, as discussed further below.

Digital cameras generally employ a two-dimensional array of light sensitive elements, or “pixels” (e.g., CCD image sensors) disposed in the image plane of the camera. The rows and columns of pixels typically are used as a reference for the xᵢ and yᵢ axes of the image plane 24 shown in FIG. 1, thereby obviating fiducial marks as often used with metric film cameras. Generally, both digital cameras and video cameras employ CCD arrays. However, images obtained using digital cameras are stored in digital format (e.g., in memory or on disks), whereas images obtained using video cameras typically are stored in analog format (e.g., on tapes or video disks).

Images stored in digital format are particularly useful for photogrammetry applications implemented using computer processing techniques. Accordingly, images obtained using a video camera may be placed into digital format using a variety of commercially available converters (e.g., a “frame grabber” and/or digitizer board). Similarly, images taken using a film camera may be placed into digital format using a digital scanner which, like a digital camera, generally employs a CCD pixel array.

Digital image recording devices such as digital cameras and scanners introduce another parameter of interior orientation; namely, an aspect ratio (i.e., a digitizing scale, or ratio of pixel density along the xᵢ axis to pixel density along the yᵢ axis) of the CCD array in the image plane. Accordingly, a total of four parameters; namely, principal distance, aspect ratio, and respective x- and y-coordinates in the image plane of the principal point, typically constitute the interior orientation of a digital recording device. If an image is taken using a film camera and converted to digital format using a scanner, these four parameters of interior orientation may apply to the combination of the film camera and the scanner viewed hypothetically as a single image recording device. As with metric film cameras, manufacturers of some digital image recording devices may provide calibration information for each device, including the four interior orientation parameters. With other digital devices, however, these parameters may have to be determined through calibration. As discussed above, the four interior orientation parameters for digital devices may be used to modify Eqs. (1) and (2) so as to more accurately represent a camera model.

In film cameras, video cameras, and digital image recording devices such as digital cameras and scanners, other characteristics of focussing elements may contribute to a deviation from the idealized central perspective projection model of FIG. 1. For example, “radial distortion” of a lens or lens system refers to nonlinear variations in angular magnification as a function of angle of incidence of an optical ray to the lens or lens system. Radial distortion can introduce differential errors to the coordinates of an image point as a function of a radial distance of the image point from the principal point in the image plane, according to the expression

δR=K₁R³+K₂R⁵+K₃R⁷, (8)

where R is the radial distance of the image point from the principal point, and the coefficients K₁, K₂, and K₃ are parameters that depend on a particular focal setting of the lens or lens system (see, for example, the Atkinson text, Ch. 2.2.2). Other models for radial distortion are sometimes used based on different numbers of nonlinear terms and orders of power of the terms (e.g., R²,R⁴). In any case, various mathematical models for radial distortion typically include two to three parameters, each corresponding to a respective nonlinear term, that depend on a particular focal setting for a lens or lens system.

Regardless of the particular radial distortion model used, the distortion δR (as given by Eq. (8), for example) may be resolved into x- and y-components so that radial distortion effects may be accounted for by modifying Eqs. (1) and (2). In particular, using the radial distortion model of Eq. (8), accounting for the effects of radial distortion in a camera model would introduce three parameters (e.g., K₁, K₂, and K₃), in addition to the interior orientation parameters, that may be used to modify Eqs. (1) and (2) so as to more accurately represent a camera model. Some manufacturers of metric cameras may provide such radial distortion parameters for different focal settings. Alternatively, such parameters may be determined through camera calibration, as discussed below.

Another type of distortion effect is “tangential” (or “decentering”) lens distortion. Tangential distortion refers to a displacement of an image point in the image plane caused by misalignment of focussing elements of the lens system. In conventional photogrammetry techniques, tangential distortion sometimes is not modeled because its contribution typically is much smaller than radial distortion. Hence, accounting for the effects of tangential distortion typically is necessary only for the highest accuracy measurements; in such cases, parameters related to tangential distortion also may be used to modify Eqs. (1) and (2) so as to more accurately represent a camera model.

In sum, a number of interior orientation and lens distortion parameters may be included in a camera model to more accurately represent the projection of an object point of interest in a scene onto an image plane of an image recording device. For example, in a digital recording device, four interior orientation parameters (i.e., principal distance, x- and y-coordinates of the principal point, and aspect ratio) and three radial lens distortion parameters (i.e., K₁, K₂, and K₃ from Eq. (8)) may be included in a camera model, depending on the desired accuracy of measurements. For purposes of designating a general camera model that may include various interior orientation and lens distortion parameters, the notation of Eq. (5) is used to express modified versions of Eqs. (1) and (2) in terms of a coordinate transformation finction, given by

ⁱPₐ=_{c}ⁱT(^{c}P_{A}), (9)

where ⁱPₐ represents the two (x- and y-) coordinates of the image point a in the image plane, ^{c}P_{A} represents the three-dimensional coordinates of the object point A in the camera coordinate system shown in FIG. 1, and the transformation function _{c}ⁱT represents a mapping (i.e., a camera model) from the three-dimensional camera coordinate system to the two-dimensional image plane. The transformation function _{c}ⁱT takes into consideration at least the principal distance of the camera, and optionally may include terms related to other interior orientation and lens distortion parameters, as discussed above, depending on the desired accuracy of the camera model.

F. Determining Camera Modeling Parameters via Resection

From Eqs. (6) and (9), the collinearity equations used in resection (discussed above in Section C of the Description of the Related Art) to relate the coordinates of the object point A in the reference coordinate system of FIG. 1 to image coordinates of the image point a in the image plane 24 may be rewritten as a coordinate transformation, given by the expression

ⁱPₐ=_{c}ⁱT(ᵣ^{c}T(^{r}P_{A}). (10)

It should be appreciated that the transformation given by Eq. (10) represents two collinearity equations for the image point a in the image plane (i.e., one equation for the x-coordinate and one equation for the y-coordinate). The transformation fumction ᵣ^{c}T includes the six parameters of the camera exterior orientation, and the transformation function _{c}ⁱT (i.e., the camera model) may include a number of parameters related to the camera interior orientation and lens distortion (e.g., four interior orientation parameters, three radial distortion parameters, and possibly tangential distortion parameters). As discussed above, the number of parameters included in the camera model _{c}T may depend on the desired level of measurement accuracy in a particular photogrammetry application.

Some or all of the interior orientation and lens distortion parameters of a given camera may be known a priori (e.g., from a metric camera manufacturer) or may be unknown (e.g., for non-metric cameras). If these parameters are known with a high degree of accuracy (i.e., _{c}ⁱT is reliably known), less rigorous conventional resection methods may be employed based on Eq. (10) (e.g., direct evaluation of a system of collinearity equations corresponding to as few as three control points) to obtain the six camera exterior orientation parameters with reasonable accuracy. Again, as discussed above in Section D of the Description of the Related Art, using a greater number of well-distributed control points and an accurate camera model typically improves the accuracy of the exterior orientation parameters obtained by conventional resection methods, in that there are more equations in the system of equations than there are unknowns.

If, on the other hand, some or all of the interior orientation and lens distortion parameters are not known, they may be reasonably estimated a priori or merely not used in the camera model (with the exception of the principal distance; in particular, it should be appreciated that, based on the central perspective projection model of FIG. 1, at least the principal distance must be known or estimated in the camera model _{c}ⁱT). Using a camera model _{c}ⁱT that includes fewer and/or estimated parameters generally decreases the accuracy of the exterior orientation parameters obtained by resection. However, the resulting accuracy may nonetheless be sufficient for some photogrammetry applications; additionally, such estimates of exterior orientation parameters may be useful as initial values in an iterative estimation process, as discussed above in Section D of the Description of the Related Art.

Alternatively, if a more accurate camera model _{c}ⁱT is desired that includes several interior orientation and lens distortion parameters, but some of these parameters are unknown or merely estimated a priori, a greater number of control points may be used in some conventional resection methods to determine both the exterior orientation parameters as well as some or all of the camera model parameters from a single image. Using conventional resection methods to determine camera model parameters is one example of “camera calibration.”

In camera calibration by resection, the number of parameters to be evaluated by the resection method typically determines the number of control points required for a closed-form solution to a system of equations based on Eq. (10). It is particularly noteworthy that for a closed-form solution to a system of equations based on Eq. (10) in which all of the camera model and exterior orientation parameters are unknown (e.g., up to 13 or more unknown parameters), the control points cannot be co-planar (i.e., the control points may not all lie in a same plane in the scene) (see, for example, chapter 3 of the text Three-dimensional Computer Vision: A Geometric Viewpoint, written by Olivier Faugeras, published in 1993 by the MIT Press, Cambridge, Mass., ISBN 0-262-06158-9, hereby incorporated herein by reference).

In one example of camera calibration by resection, the camera model _{c}ⁱT may include at least one estimated parameter for which greater accuracy is desired (i.e., the principal distance of the camera). Additionally, with reference to Eq. (10), there are six unknown parameters of exterior orientation in the transformation ᵣ^{c}T, thereby constituting a total of seven unknown parameters to be determined by resection in this example. Accordingly, at least four control points (generating four expressions similar to Eq. (10) and, hence, eight collinearity equations) are required to evaluate a system of eight equations in seven unknowns. Similarly, if a complete interior orientation calibration of a digital recording device is desired (i.e., there are four unknown or estimated interior orientation parameters a priori), a total of ten parameters (four interior and six exterior orientation parameters) need to be determined by resection. Accordingly, at least five control points (generating five expressions similar to Eq. (10) and, hence, ten collinearity equations) are required to evaluate a system of ten equations in ten unknowns using conventional resection methods.

If a “more complete” camera calibration including both interior orientation and radial distortion parameters (e.g., based on Eq. (8)) is desired for a digital image recording device, for example, and the exterior orientation of the digital device is unknown, a total of thirteen parameters need to be determined by resection; namely, six exterior orientation parameters, four interior orientation parameters, and three radial distortion parameters from Eq. (8). Accordingly, at least seven non-coplanar control points (generating seven expressions similar to Eq. (10) and, hence, fourteen collinearity equations) are required to evaluate a system of fourteen equations in thirteen unknowns using conventional resection methods.

G. Intersection

Eq. (10) may be rewritten to express the three-dimensional coordinates of the object point A shown in FIG. 1 in terms of the two-dimensional image coordinates of the image point a as

^{r}P_{A}=_{c}^{r}T(_{c}ⁱT⁻¹(ⁱPₐ)), (11)

where _{c}ⁱT⁻¹ represents an inverse transformation function from the image plane to the camera coordinate system, and _{c}^{r}T represents a transformation function from the camera coordinate system to the reference coordinate system. Eq. (11) represents one of the primary goals of conventional photogrammetry techniques; namely, to obtain the three-dimensional coordinates of a point in a scene from the two-dimensional coordinates ot a projected image of the point.

As discussed above in Section B of the Description of the Related Art, however, a closed-form solution to Eq. (11) may not be determined merely from the measured image coordinates ⁱPₐ of a single image point a, even if the exterior orientation parameters in _{c}^{r}T and the camera model _{c}ⁱT are known with any degree of accuracy. This is because Eq. (11) essentially represents two collinearity equations based on the fundamental relationships given in Eqs. (1) and (2), but there are three unknowns in the two equations (i.e., the three coordinates of the object point A). In particular, the function _{c}ⁱT⁻¹(ⁱPₐ) in Eq. (11) has no closed-form solution unless more information is known (e.g., “depth” information, such as a distance from the camera origin to the object point A). For this reason, conventional photogrammetry techniques require at least two different images of a scene in which an object point of interest is present to determine the three-dimensional coordinates in the scene of the object point. This process commonly is referred to in photogrammetry as “intersection.”

With reference to FIG. 3, if the exterior orientation and camera model parameters of two cameras represented by the coordinate systems 76₁ and 76₂ are known (e.g., previously determined from two independent resections with respect to a common reference coordinate system 74), the three-dimensional coordinates ^{r}P_{A} of the object point A in the reference coordinate system 74 can be evaluated from the image coordinates ⁱ¹Pₐ₁ of a first image point a, (51′₁) in the image plane 24₁ of a first camera, and from the image coordinates ⁱ²Pₐ₂ of a second image point a₂ (51′₂) in the image plane 24₂ of a second camera. In this case, an expression similar to Eq. (11) is generated for each image point a₁ and a₂, each expression representing two collinearity equations; hence, the two different images of the object point A give rise to a system of four collinearity equations in three unknowns.

As with resection, the intersection method used to evaluate such a system of equations depends on the degree of accuracy desired in the coordinates of the object point A. For example, conventional intersection methods are known for direct evaluation of the system of collinearity equations from two different images of the same point. For higher accuracy, a linearized iterative least squares estimation process may be used, as discussed above.

Regardless of the particular intersection method employed, independent resections of two cameras followed by intersections of object points of interest in a scene using corresponding images of the object points are common procedures in photogrammetry. Of course, it should be appreciated that the independent resections should be with respect to a common reference coordinate system for the scene. In a case where a number of control points (i.e., at least three) are chosen in a scene for a given resection (e.g., wherein at least some of the control points may define the reference coordinate system for the scene), generally the control points need to be carefully selected such that they are visible in images taken by cameras at different locations, so that the exterior orientation of each camera may be determined with respect to a common reference coordinate system. As discussed above in Section D of the Description of the.Related Art, choosing such control points often is not a trivial task, and the reliability and accuracy of multi-camera resection followed by intersection may be vulnerable to analyst errors in matching corresponding images of the control points in the multiple images.

H. Multi-image Photogrammetry and “Bundle Adjustments”

FIG. 4 shows a number of cameras at different locations around an object of interest, represented by the object point A. While FIG. 4 shows five cameras for purposes of illustration, any number of cameras may be used, as indicated by the subscripts 1, 2, 3 . . . j. For example, the coordinate system of the jth camera is indicated in FIG. 4 with the reference character 76ⱼ and has an origin O_{cj}. Similarly, an image point corresponding to the object point A obtained by the jth camera is indicated as aⱼ in the respective image plane 24ⱼ. Each image point a₁-aⱼ is associated with two collinearity equations, which may be alternatively expressed (based on Eqs. (10) and (11), respectively) as

^{ij}Pₐⱼ=_{cj}^{ij}T(ᵣ^{cj}T(^{r}P_{A})) (12)

or

^{r}P_{A}=_{cj}^{r}T(_{cj}^{ij}T⁻¹(^{ij}Pₐⱼ)). (13)

As discussed above, the collinearity equations represented by Eqs. (12) and (13) each include six parameters for the exterior orientation of a particular camera (in _{cj}^{r}T), as well as various camera model parameters (e.g., interior orientation, lens distortion) for the particular camera (in _{cj}^{ij}T⁻¹). Accordingly, for a total of j cameras, it should be appreciated that a number j of expressions each given by Eqs. (12) or (13) represent a system of 2j collinearity equations for the object point A, wherein the system of collinearity equations may have various known and unknown parameters.

A generalized functional model for multi-image photogrammetry based on a system of equations derived from either of Eqs. (12) or (13) for a number of object points of interest in a scene may be given by the expression

F(U,V,W)=0, (14)

where U is a vector representing unknown parameters in the system of equations (i.e., parameters whose values are desired), V is a vector representing measured parameters, and W is a vector representing known parameters. Stated differently, the expression of Eq. (14) represents an evaluation of a system of collinearity equations for parameter values in the vector U, given parameter values for the vectors V and W.

Generally, in multi-image photogrammetry, choices must be made as to which parameters are known or estimated (for the vector g), which parameters are measured (for the vector V), and which parameters are to be determined (in the vector U). For example, in some applications, the vector V may include all measured image coordinates of the corresponding image points for each object point of interest, and also may include the coordinates in the reference coordinate system of any control points in the scene, if known. Likewise, the three-dimensional coordinates of object points of interest in the reference coordinate system may be included in the vector U as unknowns. If the cameras have each undergone prior calibration, and/or accurate, reliable values are known for some or all of the camera model parameters, these parameters may be included in the vector W as known constants. Alternatively, if no prior values for the camera model parameters have been obtained, it is possible to include these parameters in the vector U as unknowns. For example, exterior orientation parameters of the cameras may have been evaluated by a prior resection and can be included as either known constants in the vector W or as measured or reasonably estimated parameters in the vector V, so as to provide for the evaluation of camera model parameters.

The process of simultaneously evaluating, from multiple images of a scene, the three-dimensional coordinates of a number of object points of interest in the scene and the exterior orientation parameters of several cameras using least squares estimation based on a system of collinearity equations represented by the model of Eq. (14) commonly is referred to in photogrammetry as a “bundle adjustment.” When parameters of the camera model (e.g., interior orientation and lens distortion) are also evaluated in this manner, the process often is referred to as a “self-calibrating bundle adjustment.” For a multi-image bundle adjustment, generally at least two control points need to be known in the scene (more specifically, a distance between two points in the scene) so that a relative scale of the reference coordinate system is established. In some cases, based on the number of unknown and known (or measured) parameters, a closed-form solution for U in Eq. (14) may not exist. However, an iterative least squares estimation process may be employed in a bundle adjustment to obtain a solution based on initial estimates of the unknown parameters, using some initial constraints for the system of collinearity equations.

For example, in a multi-image bundle adjustment, if seven unknown parameters initially are assumed for each camera that obtains a respective image (i.e., six exterior orientation parameters and the principal distance d for each camera), and three unknown parameters are assumed for the three-dimensional coordinates of each object point of interest in the scene that appears in each image, a total of 7j+3 unknown parameters initially are assumed for each object point that appears in j different images. Likewise, as discussed above, each object point in the scene corresponds to 2j collinearity equations in the system of equations represented by Eq. (14). To arrive at an initial closed-form solution to Eq. (14), the number of equations in the system should be greater or equal to the number of unknown parameters. Accordingly, for the foregoing example, a constraint relationship for the system of equations represented by Eq. (14) may be given by

2jn≧7j+3n, (15)

where n is the number of object points of interest in the scene that each appears in j different images. For example, using the constraint relationship given by Eq. (15), an initial closed-form solution to Eq. (14) may be obtained using seven control points (n=7) and three different images (j=3), to give a system of 42 collinearity equations in 42 unknowns. It should be appreciated that if more (or less) than seven unknown parameters are initially assumed for each camera, the constant multiplying the variable j on the right side of Eq. (15) changes accordingly. In particular, a generalized constraint relationship that applies to both bundle and self-calibrating bundle adjustments may be given by

2jn≧Cj+3n, (16)

where C indicates the total number of initially assumed unknown exterior orientation and/or camera model parameters for each camera.

Generally, a multi-image bundle (or self-calibrating bundle) adjustment according to Eq. (14) gives results of higher accuracy than resection and intersection, but at a cost. For example, the constraint relationship of Eq. (16) implies that some minimum number of camera locations must be used to obtain multiple (i.e., different) images of some minimum number of object points of interest in the scene for the determination of unknown parameters using a bundle adjustment process. In particular, with reference to Eq. (16), in a bundle adjustment, typically an analyst must select some number n of object points of interest in the scene that each appear in some numberj of different images of the scene, and correctly matchj corresponding image points of each respective object point from image to image. For purposes of the present disclosure, the process of matching corresponding image points of an object point that appear in multiple images is referred to as “referencing.”

In a bundle adjustment, once the image points are “referenced” by an analyst in the multiple images for each object point, typically all measured image coordinates of the referenced image points for all of the object points are processed simultaneously as measured parameters in the vector V of the model of Eq. (14) to evaluate exterior orientation and perhaps camera model parameters, as well as the three-dimensional coordinates of each object point (which would be elements of the vector U in this case). Accordingly, it may be appreciated that the simultaneous solution in a bundle adjustment process of the system of equations modeled by Eq. (14) typically involves large data sets and the computation of inverses of large matrices.

One noteworthy issue with respect to bundle adjustments is that the iterative estimation process makes it difficult to identify errors in any of the measured parameters used in the vector Vof the model of Eq. (14), due to the large data sets involved in the system of several equations. For example, if an analyst makes an error during the referencing process (e.g., the analyst fails to correctly match, or “reference,” an image point a₁ of a first object point A in a first image to an image point a₂ of the first object point A in a second image, and instead references the image point a₁ to an image point b₂ of a second object point B in the second image), the bundle adjustment process will produce erroneous results, the source of which may be quite difficult to trace. An analyst error in referencing (matching) image points of an object point in multiple images commonly is referred to in photogrammetry as a “blunder.” While the constraint relationship of Eq. (16) suggests that more object points and more images obtained from different camera locations are desirable for accurate results from a bundle adjustment process, the need to reference a greater number of object points as they appear in a greater number of images may in some cases increase the probability of analyst blunder, and hence decrease the reliability of the bundle adjustment results.

I. Summary

From the foregoing discussion, it should be appreciated that conventional photogrammetry techniques generally involve obtaining multiple images (from different locations) of an object of interest in a scene, to determine from the images actual three-dimensional position and size information about the object in the scene. Additionally, conventional photogrammetry techniques typically require either specially manufactured or adapted image recording devices (generally referred to herein as “cameras”), for which a variety of calibration information is knowr a priori or obtained via specialized calibration techniques to insure accuracy in measurements.

Furthermore, a proper application of photogrammetry methods often requires a specialized analyst having training and knowledge, for example, in photo-surveying techniques, optics and geometry, computational processes using large data sets and matrices, etc. For example, in resection and intersection processes (as discussed above in Sections D, F, and G of the Description of the Related Art), typically an analyst must know actual relative position and/or size information in the scene of at least three control points, and further must identify (i.e., “reference”) corresponding images of the control points in each of at least two different images. Alternatively, in a multi-image bundle adjustment process (as discussed above in Section H of the Description of the Related Art), an analyst must choose at least two control points in the scene to establish a relative scale for objects of interest in the scene. Additionally, in a bundle adjustment, an analyst must identify (i.e., “reference”) often several corresponding image points in a number of images for each of a number of objects of interest in the scene. This manual referencing process, as well as the manual selection of control points, may be vulnerable to analyst errors or “blunders,” which lead to erroneous results in either the resection/intersection or the bundle adjustment processes.

Additionally, conventional photogrammetry applications typically require sophisticated computational approaches and often require significant computing resources. Accordingly, various conventional photogrammetry techniques generally have found a somewhat limited application by specialized practitioners and analysts (e.g., scientists, military personnel, etc.) who have the availability and benefit of complex and often expensive equipment and instrumentation, significant computational resources, advanced training, and the like.

### SUMMARY OF THE INVENTION

One embodiment of the invention is directed to an image metrology reference target, comprising at least one fiducial mark, and at least one orientation dependent radiation source disposed in a predetermined spatial relationship with respect to the at least one fiducial mark. The at least one orientation dependent radiation source emanates, from an observation surface, orientation dependent radiation having at least one detectable property in an image of the reference target that varies as a function of at least one of a rotation angle of the orientation dependent radiation source and a distance between the orientation dependent radiation source and a camera obtaining the image of the reference target.

Another embodiment of the invention is directed to an apparatus, comprising at least one orientation dependent radiation source to emanate, from an observation surface, orientation dependent radiation having at least one detectable property that varies as a function of at least one of a rotation angle of the orientation dependent radiation source and a distance between the orientation dependent radiation source and a radiation detection device receiving the orientation dependent radiation.

Another embodiment of the invention is directed to a method for processing an image. The image includes at least one orientation dependent radiation source that emanates, from an observation surface, orientation dependent radiation having at least a first detectable property in the image and a second detectable property in the image that each varies as a function of at least one of a rotation angle of the orientation dependent radiation source and a distance between the orientation dependent radiation source and a camera obtaining the image of the at least one orientation dependent radiation source. The method comprises acts of determining the rotation angle of the orientation dependent radiation source from the first detectable property, and determining the distance between the orientation dependent radiation source and the camera from at least the second detectable property.

Another embodiment of the invention is directed to a computer readable medium encoded with a program for execution on at least one processor. The program, when executed on the at least one processor, performs a method for processing an image. The image includes at least one orientation dependent radiation source that emanates, from an observation surface, orientation dependent radiation having at least a first detectable property in the image and a second detectable property in the image that each varies as a function of at least one of a rotation angle of the orientation dependent radiation source and a distance between the orientation dependent radiation source and a camera obtaining an image of the at least one orientation dependent radiation source. The method executed by the program comprises acts of determining the rotation angle of the orientation dependent radiation source from the first detectable property, and determining the distance between the orientation dependent radiation source and the camera from at least the second detectable property.

Another embodiment of the invention is directed to a method in a system including at least one orientation dependent radiation source that emanates, from an observation surface, orientation dependent radiation having at least a first detectable property and a second detectable property that each varies as a function of at least one of a rotation angle of the orientation dependent radiation source and a distance between the orientation dependent radiation source and a radiation detection device receiving the orientation dependent radiation. The method comprises acts of determining the rotation angle of the orientation dependent radiation source from the first detectable property, and determining the distance between the orientation dependent radiation source and the radiation detection device from at least the second detectable property.

Another embodiment of the invention is directed to a computer readable medium encoded with a program for execution on at least one processor. The program, when executed on the at least one processor, performs a method in a system including at least one orientation dependent radiation source that emanates, from an observation surface, orientation dependent radiation having at least a first detectable property and a second detectable property that each varies as a function of at least one of a rotation angle of the orientation dependent radiation source and a distance between the orientation dependent radiation source and a radiation detection device receiving the orientation dependent radiation. The method executed by the program comprises acts of determining the rotation angle of the orientation dependent radiation source from the first detectable property, and determining the distance between the orientation dependent radiation source and the radiation detection device from at least the second detectable property.

Another embodiment of the invention is directed to an image metrology reference target, comprising automatic detection means for facilitating an automatic detection of the reference target in an image of the reference target obtained by a camera, and bearing determination means for facilitating a determination of at least one of a position and at least one orientation angle of the reference target with respect to the camera.

### BRIEF DESCRIPTION OF THE DRAWINGS

The accompanying drawings are not intended to be drawn to scale. In the drawings, each identical or nearly identical component that is illustrated in various figures is represented by a like reference character. For purposes of clarity, not every component may be labeled in every drawing.

FIG. 1 is a diagram illustrating a conventional central perspective projection imaging model using a pinhole camera;

FIG. 2 is a diagram illustrating a coordinate system transformation between a reference coordinate system for a scene of interest and a camera coordinate system in the model of FIG. 1;

FIG. 3 is a diagram illustrating the concept of intersection as a conventional photogrammetry technique;

FIG. 4 is a diagram illustrating the concept of conventional multi-image photogrammetry;

FIG. 5 is a diagram illustrating an example of a scene on which image metrology may be performed using a single image of the scene, according to one embodiment of the invention;

FIG. 6 is a diagram illustrating an example of an image metrology apparatus according to one embodiment of the invention;

FIG. 7 is a diagram illustrating an example of a network implementation of an image metrology apparatus according to one embodiment of the invention;

FIG. 8 is a diagram illustrating an example of the reference target shown in the apparatus of FIG. 6, according to one embodiment of the invention;

FIG. 9 is a diagram illustrating the camera and the reference target shown in FIG. 6, for purposes of illustrating the concept of camera bearing, according to one embodiment of the invention;

FIG. 10A is a diagram illustrating a rear view of the reference target shown in FIG. 8, according to one embodiment of the invention;

FIG. 10B is a diagram illustrating another example of a reference target, according to one embodiment of the invention;

FIG. 10C is a diagram illustrating another example of a reference target, according to one embodiment of the invention;

FIGS. 11A-11C are diagrams showing various views of an orientation dependent radiation source used, for example, in the reference target of FIG. 8, according to one embodiment of the invention;

FIGS. 12A and 122B are diagrams showing particular views of the orientation dependent radiation source shown in FIGS. 11A-11C, for purposes of explaining some fundamental concepts according to one embodiment of the invention;

FIGS. 13A-13D are graphs showing plots of various radiation transmission characteristics of the orientation dependent radiation source of FIGS. 11A-11C, according to one embodiment of the invention;

FIG. 14 is a diagram of landmark for machine vision, suitable for use as one or more of the fiducial marks shown in the reference target of FIG. 8, according to one embodiment of the invention;

FIG. 15 is a diagram of a landmark for machine vision according to another embodiment of the invention;

FIG. 16A is a diagram of a landmark for machine vision according to another embodiment of the invention;

FIG. 16B is a graph of a luminance curve generated by scanning the mark of FIG. 16A along a circular path, according to one embodiment of the invention;

FIG. 16C is a graph of a cumulative phase rotation of the luminance curve shown in FIG. 16B, according to one embodiment of the invention;

FIGS. 17A is a diagram of the landmark shown in FIG. 16A rotated obliquely with respect to the circular scanning path;

FIG. 17B is a graph of a luminance curve generated by scanning the mark of FIG. 17A along the circular path, according to one embodiment of the invention;

FIG. 17C is a graph of a cumulative phase rotation of the luminance curve shown in FIG. 17B, according to one embodiment of the invention;

FIG. 18A is a diagram of the landmark shown in FIG. 16A offset with respect to the circular scanning path;

FIG. 18B is a graph of a luminance curve generated by scanning the mark of FIG. 87A along the circular path, according to one embodiment of the invention;

FIG. 18C is a graph of a cumulative phase rotation of the luminance curve shown in FIG. 18B, according to one embodiment of the invention;

FIG. 19 is a diagram showing an image that contains six marks similar to the mark shown in FIG. 16A, according to one embodiment of the invention;

FIG. 20 is a graph showing a plot of individual pixels that are sampled along the circular path shown in FIGS. 16A, 17A, and 18A, according to one embodiment of the invention;

FIG. 21 is a graph showing a plot of a sampling angle along the circular path of FIG. 20, according to one embodiment of the invention;

FIG. 22A is a graph showing a plot of an unfiltered scanned signal representing a random luminance curve generated by scanning an arbitrary portion of an image that does not contain a landmark, according to one embodiment of the invention;

FIG. 22B is a graph showing a plot of a filtered version of the random luminance curve shown in FIG. 22A;

FIG. 22C is a graph showing a plot of a cumulative phase rotation of the filtered luminance curve shown in FIG. 22B, according to one embodiment of the invention;

FIG. 23A is a diagram of another robust mark according to one embodiment of the invention;

FIG. 23B is a diagram of the mark shown in FIG. 23A after color filtering, according to one embodiment of the invention;

FIG. 24A is a diagram of another fiducial mark suitable for use in the reference target shown in FIG. 8, according to one embodiment of the invention;

FIG. 24B is a diagram showing a landmark printed on a self-adhesive substrate, according to one embodiment of the invention;

FIGS. 25A and 25B are diagrams showing a flow chart of an image metrology method acccruing to one embodiment of the invention;

FIG. 26 is a diagram illustrating multiple images of differently-sized portions of a scene for purposes of scale-up measurements, according to one embodiment of the invention;

FIGS. 27-30 are graphs showing plots of Fourier transforms of front and back gratings of an orientation dependent radiation source, according to one embodiment of the invention;

FIGS. 31 and 32 are graphs showing plots of Fourier transforms of radiation emanated from an orientation dependent radiation source, according to one embodiment of the invention;

FIG. 33 is a graph showing a plot of a triangular waveform representing radiation emanated from an orientation dependent radiation source, according to one embodiment of the invention;

FIG. 34 is a diagram of an orientation dependent radiation source according to one embodiment of the invention, to facilitate a far-field observation analysis;

FIG. 35 is a graph showing a plot of various terms of an equation relating to the determination of rotation or viewing angle of an orientation dependent radiation source, according to one embodiment of the invention;

FIG. 36 is a diagram of an orientation dependent radiation source according to one embodiment of the invention, to facilitate a near-field observation analysis;

FIG. 37 is a diagram of an orientation dependent radiation source according to one embodiment of the invention, to facilitate an analysis of apparent back grating shift in the near-field with rotation of the source;

FIG. 38 is a diagram showing an image including a landmark according to one embodiment of the invention, wherein the background content of the image includes a number of rocks;

FIG. 39 is a diagram showing a binary black and white thresholded image of the image of FIG. 38;

FIG. 40 is a diagram showing a scan of a colored mark, according to one embodiment of the invention;

FIG. 41 is a diagram showing a normalized image coordinate frame according to one embodiment of the invention; and

FIG. 42 is a diagram showing an example of an image of fiducial marks of a reference target to facilitate the concept of fitting image data to target artwork, according to one embodiment of the invention.

### DETAILED DESCRIPTION

### A. Overview

As discussed above in connection with conventional photogrammetry techniques, determining position and/or size information for objects of interest in a three-dimensional scene from two-dimensional images of the scene can be a complicated problem to solve. In particular, conventional photogrammetry techniques often require a specialized analyst to know some relative spatial information in the scene a priori, and/or to manually take some measurements in the scene, so as to establish some frame of reference and relative scale for the scene. Additionally, in conventional photogrammetry techniques, multiple images of the scene (wherein each image includes one or more objects of interest) generally must be obtained from different respective locations, and often an analyst must manually identify corresponding images of the objects of interest that appear in the multiple images. This manual identification process (referred to herein as “referencing”) may be vulnerable to analyst errors or “blunders,” which in turn may lead to erroneous results for the desired information.

Furthermore, conventional photogrammetry techniques typically require sophisticated computational approaches and often require significant computing resources. Accordingly, various conventional photogrammetry techniques generally have found a somewhat limited application by specialized practitioners who have the availability and benefit of complex and often expensive equipment and instrumentation, significant computational resources, advanced training, and the like.

In view of the foregoing, various embodiments of the present invention generally relate to automated, easy-to-use, image metrology methods and apparatus that are suitable for specialist as well as non-specialist users (e.g., those without specialized training in photogrammetry techniques). For purposes of this disclosure, the term “image metrology” generally refers to the concept of image analysis for various measurement purposes. Similarly, for purposes of illustration, some examples of “non-specialist users” include, but are not limited to, general consumers or various non-technical professionals, such as architects, building contractors, building appraisers, realtors, insurance estimators, interior designers, archaeologists, law enforcement agents, and the like. In one aspect of the present invention, various embodiments of image metrology methods and apparatus disclosed herein in general are appreciably more user-friendly than conventional photogrammetry methods and apparatus. Additionally, according to another aspect, various embodiments of methods and apparatus of the invention are relatively inexpensive to implement and, hence, generally more affordable and accessible to non-specialist users than are conventional photogrammetry systems and instrumentation.

Although one aspect of the present invention is directed to ease-of-use for non-specialist users, it should be appreciated nonetheless that image metrology methods and apparatus according to various embodiments of the invention may be employed by specialized users (e.g., photogrammetrists) as well. Accordingly, several embodiments of the present invention as discussed further below are useful in a wide range of applications to not only non-specialist users, but also to specialized practitioners of various photogrammetry techniques and/or other highly-trained technical personnel (e.g., forensic scientists).

In various embodiments of the present invention related to automated image metrology methods and apparatus, particular machine vision methods and apparatus according to the invention are employed to facilitate automation (i.e., to automatically detect particular features of interest in the image of the scene). For purpose of this disclosure, the term “automatic” is used to refer to an action that requires only minimum or no user involvement. For example, as discussed further below, typically some minimum user involvement is required to obtain an image of a scene and download the image to a processor for processing. Additionally, before obtaining the image, in some embodiments the user may place one or more reference objects (discussed further below) in the scene. These fundamental actions of acquiring and downloading an image and placing one or more reference objects in the scene are considered for purposes of this disclosure as minimum user involvement. In view of the foregoing, the term “automatic” is used herein primarily in connection with any one or more of a variety of actions that are carried out, for example, by apparatus and methods according to the invention which do not require user involvement beyond the fundamental actions described above.

In general, machine vision techniques include a process of automatic object recognition or “detection,” which typically involves a search process to find a correspondence between particular features in the image and a model for such features that is stored, for example, on a storage medium (e.g., in computer memory). While a number of conventional machine vision techniques are known, Applicants have appreciated various shortcomings of such conventional techniques, particularly with respect to image metrology applications. For example, conventional machine vision object recognition algorithms generally are quite complicated and computationally intensive, even for a small number of features to identify in an image. Additionally, such conventional algorithms generally suffer (i.e., they often provide false-positive or false-negative results) when the scale and orientation of the,features being searched for in the image are not known in advance (i.e., an incomplete and/or inaccurate correspondence model is used to search for features in the image). Moreover, variable lighting conditions as well as certain types of image content may make feature detection using conventional machine vision techniques difficult. As a result, highly automated image metrology systems employing conventional machine vision techniques historically have been problematic to practically implement.

However, Applicants have identified solutions for overcoming some of the difficulties typically encountered in conventional machine vision techniques, particularly for application to image metrology. Specifically, one embodiment of the present invention is directed to image feature detection methods and apparatus that are notably robust in terms of feature detection, notwithstanding significant variations in scale and orientation of the feature searched for in the image, lighting conditions, camera settings, and overall image content, for example. In one aspect of this embodiment, feature detection methods and apparatus of the invention additionally provide for less computationally intensive detection algorithms than do conventional machine vision techniques, thereby requiring less computational resources and providing for faster execution times. Accerdingly, one aspect of some embodiments of the present invention combines novel machine vision techniques with novel photogrammetry techniques to provide for highly automated, easy-to-use, image metrology methods and apparatus that offer a wide range of applicability and that are accessible to a variety of users.

In addition to automation and ease-of-use, yet another aspect of some embodiments of the present invention relates to image metrology methods and apparatus that are capable of providing position and/or size information associated with objects of interest in a scene from a single image of the scene. This is in contrast to conventional photogrammetry techniques, as discussed above, which typically require multiple different images of a scene to provide three-dimensional information associated with objects in the scene. It should be appreciated that various concepts of the present invention related to image metrology using a single image and automated image metrology, as discussed above, may be employed independently in different embodiments of the invention (e.g., image metrology using a single image, without various automation features). Likewise, it should be appreciated that at least some embodiments of the present invention may combine aspects of image metrology using a single image and automated image metrology.

For example, one embodiment of the present invention is directed to image metrology methods and apparatus that are capable of automatically determining position and/or size information associated with one or more objects of interest in a scene from a single image of the scene. In particular, in one embodiment of the invention, a user obtains a single digital image of the scene (e.g., using a digital camera or a digital scanner to scan a photograph), which is downloaded to an image metrology processor according to one embodiment of the invention. The downloaded digital image is then displayed on a display (e.g., a CRT monitor) coupled to the processor. In one aspect of this embodiment, the user indicates one or more points of interest in the scene via the displayed image using a user interface coupled to the processor (e.g., point and click using a mouse). In another aspect, the processor automatically identifies points of interest that appear in the digital image of the scene using feature detection methods and apparatus according to the invention. In either case, the processor then processes the image to automatically determine various camera calibration information, and ultimately determines position and/or size information associated with the indicated or automatically identified point or points of interest in the scene. In sum, the user obtains a single image of the scene, downloads the image to the processor, and easily obtains position and/or size information associated with objects of interest in the scene.

In some embodiments of the present invention, the scene of interest includes one or more reference objects that appear in an image of the scene. For purposes of this disclosure, the term “reference object” generally refers to an object in the scene for which at least one or more of size (dimensional), spatial position, and orientation information is known a priori with respect to a reference coordinate system for the scene. Various information known a priori in connection with one or more reference objects in a scene is referred to herein generally as “reference information.”

According to one embodiment, one example of a reference object is given by a control point which, as discussed above, is a point in the scene whose three-dimensional coordinates are known with respect to a reference coordinate system for the scene. In this example, the three-dimensional coordinates of the control point constitute the reference information associated with the control point. It should be appreciated, however, that the term “reference object” as used herein is not limited merely to the foregoing example of a control point, but may include other types of objects. Similarly, the term “reference information” is not limited to known coordinates of control points, but may include other types of information, as discussed further below. Additionally, according to some embodiments, it should be appreciated that various types of reference objects may themselves establish the reference coordinate system for the scene.

In general, according to one aspect of the invention, one or more reference objects as discussed above in part facilitate a camera calibration process to determine a variety of camera calibration information. For purposes of this disclosure, the term “camera calibration information” generally refers to one or more exterior orientation, interior orientation, and lens distortion parameters for a given camera. In particular, as discussed above, the camera exterior orientation refers to the position and orientation of the camera relative to the scene of interest, while the interior orientation and lens distortion parameters in general constitute a camera model that describes how a particular camera differs from an idealized pinhole camera. According to one embodiment, various camera calibration information is determined based at least in part on the reference information known a priori that is associated with one or more reference objects included in the scene, together with information that is derived from the image of such reference objects in an image of the scene.

According to one embodiment of the invention, certain types of reference objects are included in the scene to facilitate an automated camera calibration process. In particular, in one embodiment, one or more reference objects included in a scene of interest may be in the form of a “robust fiducial mark” (hereinafter abbreviated as RFID) that is placed in the scene before an image of the scene is taken, such that the RFID appears in the image. For purposes of the this disclosure, the term “robust fiducial mark” generally refers to an object whose image has one or more properties that do not change as a function of point-of-view, various camera settings, different lighting conditions, etc.

In particular, according to one aspect of this embodiment, the image of an RFID has an invariance with respect to scale or tilt; stated differently, a robust fiducial mark has one or more unique detectable properties in an image that do not change as a function of either the size of the mark as it appears in the image, or the orientation of the mark with respect to the camera as the image of the scene is obtained. In other aspects, an RFID preferably has one or more invariant characteristics that are relatively simple to detect in an image, that are unlikely to occur by chance in a given scene, and that are relatively unaffected by different types of general image content.

In general, the above-described characteristics of one or more RFIDs that are included in a scene of interest significantly facilitate automatic feature detection according to various embodiments of the invention. In particular, one or more RFIDs that are placed in the scene as reference objects facilitate an automatic determination of various camera calibration information. However, it should be appreciated that the use of RFIDs in various embodiments of the present invention is not limited to reference objects.

For example, as discussed further below, one or more RFIDs may be arbitrarily placed in the scene to facilitate automatic identification of objects of interest in the scene for which position and/or size information is not known but desired. Additionally, RFIDs may be placed in the scene at particular locations to establish automatically detectable link points between multiple images of a large and/or complex space, for purposes of site surveying using image metrology methods and apparatus according to the invention. It should be appreciated that the foregoing examples are provided merely for purposes of illustration, and that RFIDs have a wide variety of uses in image metrology methods and apparatus according to the invention, as discussed further below. In one embodiment, RFIDs are printed on self-adhesive substrates (e.g., self-stick removable notes) which may be easily affixed at desired locations in a scene prior to obtaining one or more images of the scene to facilitate automatic feature detection.

With respect to reference objects, according to another embodiment of the invention, one or more reference objects in the scene may be in the form of an “orientation-dependent radiation source” (hereinafter abbreviated as ODR) that is placed in the scene before an image of the scene is taken, such that the ODR appears in the image. For purposes of this disclosure, an orientation-dependent radiation source generally refers to an object that emanates radiation having at least one detectable property, based on an orientation of the object, that is capable of being detected from the image of the scene. Some. examples of ODRs suitable for purposes of the present invention include, but ate not limited to, devices described in U.S. Pat. No. 5,936,723, dated Aug. 10, 1999, entitled “Orientation Dependent Reflector,” hereby incorporated herein by reference, and in U.S. patent application Ser. No. 09/317,052, filed May 24, 1999, entitled “Orientation-Dependent Radiation Source,” also hereby incorporated herein by reference, or devices similar to those described in these references.

In particular, according to one embodiment of the present invention, the detectable property of the radiation emanated from a given ODR varies as a function of at least the orientation of the ODR with respect to a particular camera that obtains a respective image of the scene in which the ODR appears. According to one aspect of this embodiment, one or more ODRs placed in the scene directly provide information in an image of the scene that is related to an orientation of the camera relative to the scene, so as to facilitate a determination of at least the camera exterior orientation parameters. According to another aspect, an ODR placed in the, scene provides information in an image that is related to a distance between the camera and the ODR.

According to another embodiment of the invention, one or more reference objects may be provided in the scene in the form of a reference target that is placed in the scene before an image of the scene is obtained, such that thereference target appears in the image. According to one aspect of this embodiment, a reference target typically is essentially planar in configuration, and one or more reference targets may be placed in a scene to establish one or more respective reference planes in the scene. According to another aspect, a particular reference target may be designated as establishing a reference coordinate system for the scene (e.g., the reference target may define an x-y plane of the reference coordinate system, wherein a z-axis of the reference coordinate system is perpendicular to the reference target).

Additionally, according to various aspects of this embodiment. a given reference target may include a variety of different types and numbers of reference objects (e.g., one or more RFIDs and/or one or more ODRs, as discussed above) that are arranged as a group in a particular manner. For example, according to one aspect of this embodiment, one or more RFIDs and/or ODRs included in a given reference target have known particular spatial relationships to one another and to the reference coordinate system for the scene. Additionally, other types of position and/or orientation information associated with one or more reference objects included in a given reference target may be known a priori; accordingly, unique reference information may be associated with a given reference target.

In another aspect of this embodiment, combinations of RFIDs and ODRs employed in reference targets according to the invention facilitate an automatic determination of various camera calibration information, including one or more of exterior orientation, interior orientation, and lens distortion parameters, as discussed above. Furthermore, in yet another aspect, particular combinations and arrangements of RFIDs and ODRs in a reference target according to the invention provide for a determination of extensive camera calibration information (including several or all of the exterior orientation, interior orientation, and lens distortion parameters) using a single planar reference target in a single image.

While the foregoing concepts related to image metrology methods and apparatus according to the invention have been introduced in part with respect to image metrology using single-images, it should be appreciated nonetheless that various embodiments of the present invention incorporating the foregoing and other concepts are directed to image metrology methods and apparatus using two or more images, as discussed further below. In particular, according to various multi-image embodiments, methods and apparatus of the present invention are capable of automatically tying together multiple images of a scene of interest (which in some cases may be too large to capture completely in a single image), to provide for three-dimensional image metrology surveying of large and/or complex spaces. Additionally, some multi-image embodiments provide for three-dimensional image metrology from stereo images, as well as redundant measurements to improve accuracy.

In yet another embodiment, image metrology methods and apparatus according to the present invention may be implemented over a local-area network or a wide-area network, such as the Internet, so as to provide image metrology services to a number of network clients. In one aspect of this embodiment, a number of system users at respective client workstations may upload one or more images of scenes to one or more centralized image metrology servers via the network. Subsequently, clients may download position and/or size information associated with various objects of interest in a particular scene, as calculated by the server from one or more corresponding uploaded images of the scene, and display and/or store the calculated information at the client workstation. Due to the centralized server configuration, more than one client may obtain position and/or size information regarding the same scene or group of scenes. In particular, according to one aspect of this embodiment, one or more images that are uploaded to a server may be archived at the server such that they are globally accessible to a number of designated users for one or more calculated measurements. Alternatively, according to another aspect, uploaded images may be archived such that they are only accessible to particular users.

According to yet another embodiment of the invention related to network implementation of image metrology methods and apparatus, one or more images for processing are maintained at a client workstation, and the client downloads the appropriate image metrology algorithms from the server for one-time use as needed to locally process the images. In this aspect, a security advantage is provided for the client, as it is unnecessary to upload images over the network for processing by one or more servers.

Following below are more detailed descriptions of various concepts related to, and embodiments of, image metrology methods and apparatus according to the present invention. It should be appreciated that various aspects of the invention as introduced above and discussed in greater detail below may be implemented in any of numerous ways, as the invention is not limited to any particular manner of implementation. Examples of specific implementations and applications are provided for illustrative purposes only.

### B. Image Metrology Using A Single Image

As discussed above, various embodiments of the invention are directed to manual or automatic image metrology methods and apparatus using a single image of a scene of interest. For these embodiments, Applicants have recognized that by considering certain types of scenes, for example, scenes that include essentially planar surfaces having known spatial relationships with one another, position and/or size information associated with objects of interest in the scene may be determined with respect to one or more of the planar surfaces from a single image of the scene.

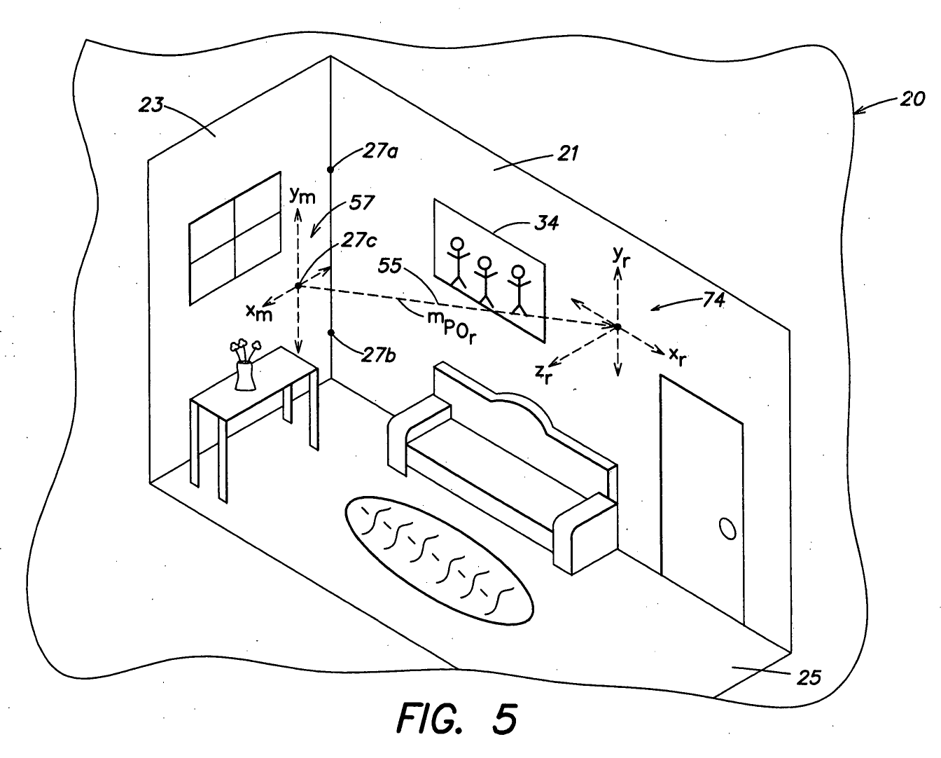

In particular, as shown for example in FIG. 5, Applicants have recognized that a variety of scenes including man-made or “built” spaces particularly lend themselves to image metrology using a single image of the scene, as typically such built spaces include a number of planar surfaces often at essentially right angles to one another (e.g., walls, floors, ceilings, etc.). For purposes of this disclosure, the term “built space” generally refers to any scene that includes at least one essentially planar man-made surface, and more specifically to any scene that includes at least two essentially planar man-made surfaces at essentially right angles to one another. More generally, the term “planar space” as used herein refers to any scene, whether naturally occurring or man-made, that includes at least one essentially planar surface, and more specifically to any scene, whether naturally occurring or man-made, that includes at least two essentially planar surfaces having a known spatial relationship to one another. Accordingly, as illustrated in FIG. 5, the portion of a room (in a home, office, or the like) included in the scene 20 may be considered as a built or planar space.

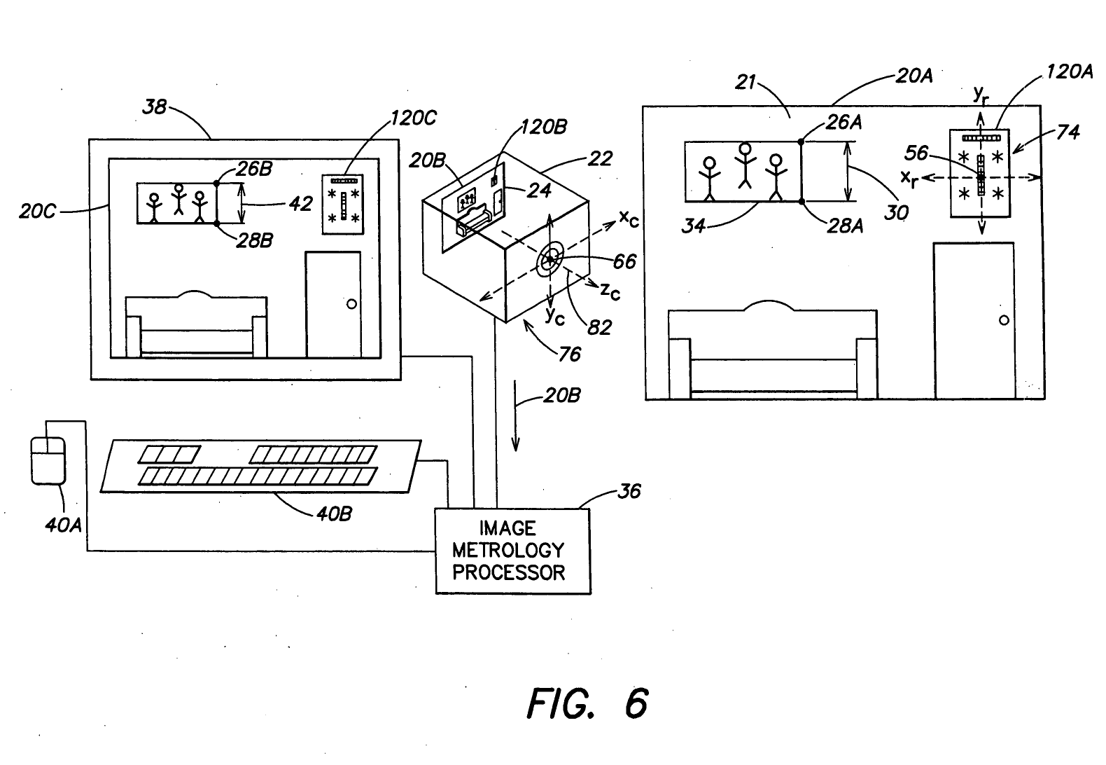

As discussed above in connection with conventional photogrammetry techniques, often the exterior orientation of a particular camera relative to a scene of interest, as well as other camera calibration information, may be unknown a priori but may be determined, for example, in a resection process. According to one embodiment of the invention, at least the exterior orientation of a camera is determined using a number of reference objects that are located in a single plane, or “reference plane,” of the scene. For example, in the scene 20 shown in FIG. 5, the rear wall of the room (including the door, and on which a family portrait 34 hangs) may be designated as a reference plane 21 for the scene 20. According to one aspect of this embodiment, the reference plane may be used to establish the reference coordinate system 74 for the scene; for example, as shown in FIG. 5, the reference plane 21 (i.e., the rear wall) serves as an x-y plane for the reference coordinate system 74, as indicated by the xᵣ and yᵣ axes, with the zᵣ axis of the reference coordinate system 74 perpendicular to the reference plane 21 and intersecting the xᵣ and yᵣ axes at the reference origin 56. The location of the reference origin 56 may be selected arbitrarily in the reference plane 21, as discussed further below in connection with FIG. 6.

In one aspect of this embodiment, once at least the camera exterior orientation is determined with respect to the reference plane 21 (and, hence, the reference coordinate system 74) of the scene 20 in FIG. 5, and given that at least the camera principle distance and perhaps other camera model parameters are known or reasonably estimated a priori (or also determined, for example, in a resection process), the coordinates of any point of interest in the reference plane 21 (e.g., corners of the door or family portrait, points along the backboard of the sofa, etc.) may be determined with respect to the reference coordinate system 74 from a single image of the scene 20, based on Eq. (11) above. This is possible because there are only two unknown (x- and y-) coordinates in the reference coordinate system 74 for points of interest in the reference plane 21; in particular, it should be appreciated that the z-coordinate in the reference coordinate system 74 of all points of interest in the reference plane 21, as defined, is equal to zero. Accordingly, the system of two collinearity equations represented by Eq. (11) may be solved as a system of two equations in two unknowns, using the two (x- and y-) image coordinates of a single corresponding image point (i.e., from a single image) of a point of interest in the reference plane of the scene. In contrast, in a conventional intersection process as discussed above, generally all three coordinates of a point of interest in the scene are unknown; as a result, at least two corresponding image points (i.e., from two different images) of the point of interest are required to generate a system of four collinearity equations in three unknowns to provide for a closed-form solution to Eq. (11) for the coordinates of the point of interest.

It should be appreciated that the three-dimensional coordinates in the reference coordinate system 74 of points of interest in the planar space shown in FIG. 5 may be determined from a single image of the scene 20 even if such points are located in various planes other than the designated reference plane 21. In particular, any plane having a known (or determinable) spatial relationship to the reference plane 21 may serve as a “measurement plane.” For example, in FIG. 5, the side wall (including the window and against which the table with the vase is placed) and the floor of the room have a known or determinable spatial relationship to the reference plane 21 (i.e., they are assumed to be at essentially right angles with the reference plane 21); hence, the side wall may serve as a first measurement plane 23 and the floor may serve as a second measurement plane 25 in which coordinates of points of interest may be determined with respect to the reference coordinate system 74.

For example, if two points 27A and 27B are identified in FIG. 5 at the intersection of the measurement plane 23 and the reference plane 21, the location and orientation of the measurement plane 23 with respect to the reference coordinate system 74 may be determined. In particular, the spatial relationship between the measurement plane 23 and the reference coordinate system 74 shown in FIG. 5 involves a 90 degree yaw rotation about the yᵣ axis, and a translation along one or more of the xᵣ, yᵣ, and zᵣ axes of the reference coordinate system, as shown in FIG. 5 by the translation vector 55 (^{m}P_{O}_{ᵣ}). In one aspect, this translation vector may be ascertained from the coordinates of the points 27A and 27B as determined in the reference plane 21, as discussed further below. It should be appreciated that the foregoing is merely one example of how to link a measurement plane to a reference plane, and that other procedures for establishing such a relationship are suitable according to other embodiments of the invention.

For purposes of illustration, FIG. 5 shows a set of measurement coordinate axes 57 (i.e., an xₘ axis and a yₘ axis) for the measurement plane 23. It should be appreciated that an origin 27C of the measurement coordinate axes 57 may be arbitrarily selected as any convenient point in the measurement plane 23 having known coordinates in the reference coordinate system 74 (e.g., one of the points 27A or 27B at the junction of the measurement and reference planes, other points along the measurement plane 23 having a known spatial relationship to one of the points 27A or 27B, etc.). It should also be appreciated that the yₘ axis of the measurement coordinate axes 57 shown in FIG. 5 is parallel to the yᵣ axis of the reference coordinate system 74, and that the xₘ axis of the measurement coordinate axes 57 is parallel to the zᵣ axis of the reference coordinate system 74.

Once the spatial relationship between the measurement plane 23 and the reference plane 21 is known, and the camera exterior orientation relative to the reference plane 21 is known, the camera exterior orientation relative to the measurement plane 23 may be easily determined. For example, using the notation of Eq. (5), a coordinate system transformation ᵣ^{m}T from the reference coordinate system 74 to the measurement plane 23 may be derived based on the known translation vector 55 (^{m}P_{O}_{ᵣ}) and a rotation matrix ᵣ^{m}R that describes the coordinate axes rotation from the reference coordinate system to the measurement plane. In particular, in the example discussed above in connection with FIG. 5, the rotation matrix ᵣ^{m}R describes the 90 degree yaw rotation between the measurement plane and the reference plane. However, it should be appreciated that, in general, the measurement plane may have any arbitrary known spatial relationship to the reference plane, involving a rotation about one or more of three coordinate system axes.

Once the coordinate system transformation ᵣ^{m}T is derived, the exterior orientation of the camera with respect to the measurement plane, based on the exterior orientation of the camera originally derived with respect to the reference plane, is represented in the transformation

_{c}^{m}T=ᵣ^{m}T _{c}^{r}T (17)

Subsequently, the coordinates along the measurement coordinate axes 57 of any points of interest in the measurement plane 23 (e.g., corners of the window) may be determined from a single image of the scene 20, based on Eq. (11) as discussed above, by substituting _{c}^{r}T in Eq. (11) with _{c}^{m}T of Eq. (17) to give coordinates of a point in the measurement plane from the image coordinates of the point as it appears in the single image. Again, it should be appreciated that closed-form solutions to Eq. (11) adapted in this manner are possible because there are only two unknown (x- and y-) coordinates for points of interest in the measurement plane 23, as the z-coordinate for such points is equal to zero by definition. Accordingly, the system of two collinearity equations represented by Eq. (11) adapted using Eq. (17) may be solved as a system of two equations in two unknowns.

The determined coordinates with respect to the measurement coordinate axes 57 of points of interest in the measurement plane 23 may be subsequently converted to coordinates in the reference coordinate system 74 by applying an inverse transformation ₘ^{r}T, again based on the relationship between the reference origin 56 and the selected origin 27C of the measurement coordinate axes 57,given by the translation vector 55 and any coordinate axis rotations (e.g., a 90 degree yaw rotation). In particular, determined coordinates along the xₘ axis of the measurement coordinate axes 57 maybe converted to coordinates along the zᵣ axis of the reference coordinate system 74, and determined coordinates along the yₘ axis of the measurement coordinate axes 57 may be converted to coordinates along the yᵣ axis of the reference coordinate system 74 by applying the transformation ₘ^{r}T. Additionally, it should be appreciated that all points in the measurement plane 23 shown in FIG. 5 have a same x-coordinate in the reference coordinate system 74. Accordingly, the three-dimensional coordinates in the reference coordinate system 74 of points of interest in the measurement plane 23 may be determined from a single image of the scene 20.

Although one aspect of image metrology methods and apparatus according to the invention for processing a single image of a scene is discussed above using an example of a built space including planes intersecting at essentially right angles, it should be appreciated that the invention is not limited in this respect. In particular, in various embodiments, one or more measurement planes in a planar space may be positioned and oriented in a known manner at other than right angles with respect to a particular reference plane. It should be appreciated that as long as the relationship between a given measurement plane and a reference plane is known, the camera exterior orientation with respect to the measurement plane may be determined, as discussed above in connection with Eq. (17). It should also be appreciated that, according to various embodiments, one or more points in a scene that establish a relationship between one or more measurement planes and a reference plane (e.g., the points 27A and 27B shown in FIG. 5 at the intersection of two walls respectively defining the measurement plane 23 and the reference plane 21) may be manually identified in an image, or may be designated in a scene, for example, by one or more stand-alone robust fiducial marks (RFIDs) that facilitate automatic detection of such points in the image of the scene. In one aspect, each RFID that is used to identify relationships between one or more measurement planes and a reference plane may have one or more physical attributes that enable the RFID to be uniquely and automatically identified in an image. In another aspect, a number of such RFIDs may be formed on self-adhesive substrates that may be easily affixed to appropriate points in the scene to establish the desired relationships.

Once the relationship between one or more measurement planes and a reference plane is known, three-dimensional coordinates in a reference coordinate system for the scene for points of interest in one or more measurement planes (as well as for points of interest in one or more reference planes) subsequently may be determined based on an appropriately adapted version of Eq. (11), as discussed above. The foregoing concepts related to coordinate system transformations between an arbitrary measurement plane and the reference plane are discussed in greater detail below in Section L of the Detailed Description.

Additionally, it should be appreciated that in various embodiments of the invention related to image metrology methods and apparatus using single (or multiple) images of a scene, a variety of position and/or size information associated with objects of interest in the scene may be derived based on three-dimensional coordinates of one or more points in the scene with respect to a reference coordinate system for the scene. For example, a physical distance between two points in the scene may be derived from the respectively determined three-dimensional coordinates of each point based on fundamental geometric principles. From the foregoing, it should be appreciated that by ascribing a number of points to an object of interest, relative position and/or size information for a wide variety of objects may be determined based on the relative location in three dimensions of such points, and distances between points that identify certain features of an object.

### C. Exemplary Image Metrology Apparatus

FIG. 6 is a diagram illustrating an example of an image metrology apparatus according to one embodiment of the invention. In particular, FIG. 6 illustrates one example of an image metrology apparatus suitable for processing either a single image or multiple images of a scene to determine position and/or size information associated with objects of interest in the scene.

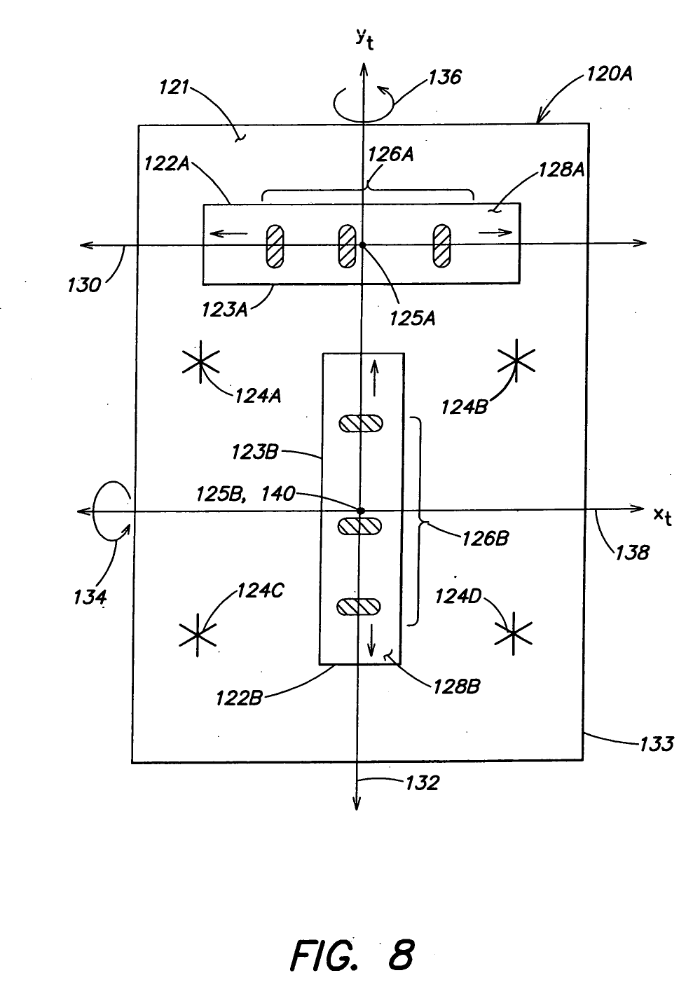

In the embodiment of FIG. 6, the scene of interest 20A is shown, for example, as a portion of a room of some built space (e.g., a home or an office), similar to that shown in FIG. 5. In particular, the scene 20A of FIG. 6 shows an essentially normal (i.e., “head-on”) view of the rear wall of the scene 20 illustrated in FIG. 5, which includes the door, the family portrait 34 and the sofa. FIG. 6 also shows that the scene 20A includes a reference target 120A that is placed in the scene (e.g., also hanging on the rear wall of the room). As discussed further below in connection with FIG. 8, known reference information associated with the reference target 120A, as well as information derived from an image of the reference target, in part facilitates a determination of position and/or size information associated with objects of interest in the scene.

According to one aspect of the embodiment of FIG. 6, the reference target 120A establishes the reference plane 21 for the scene, and more specifically establishes the reference coordinate system 74 for the scene, as indicated schematically in FIG. 6 by the xᵣ and yᵣ axes in the plane of the reference target, and the reference origin 56 (the zᵣ axis of the reference coordinate system 74 is directed out of, and orthogonal to, the plane of the reference target 120A). It should be appreciated that while the xᵣ and yᵣ axes as well as the reference origin 56 are shown in FIG. 6 for purposes of illustration, these axes and origin do not necessarily actually appear per se on the reference target 120A (although they may, according to some embodiments of the invention).

As illustrated in FIG. 6, a camera 22 is used to obtain an image 20B of the scene 20A, which includes an image 120B of the reference target 120A that is placed in the scene. As discussed above, the term “camera” as used herein refers generally to any of a variety of image recording devices suitable for purposes of the present invention, including, but not limited to, metric or non-metric cameras, film or digital cameras, video cameras, digital scanners, and the like. According to one aspect of the embodiment of FIG. 6, the camera 22 may represent one or more devices that are used to obtain a digital image of the scene, such as a digital camera, or the combination of a film camera that generates a photograph and a digital scanner that scans the photograph to generate a digital image of the photograph. In the latter case, according to one aspect, the combination of the film camera and the digital scanner may be considered as a hypothetical single image recording device represented by the camera 22 in FIG. 6. In general, it should be appreciated that the invention is not limited to use with any one particular type of image recording device, and that different types and/or combinations of image recording devices may be suitable for use in various embodiments of the invention.

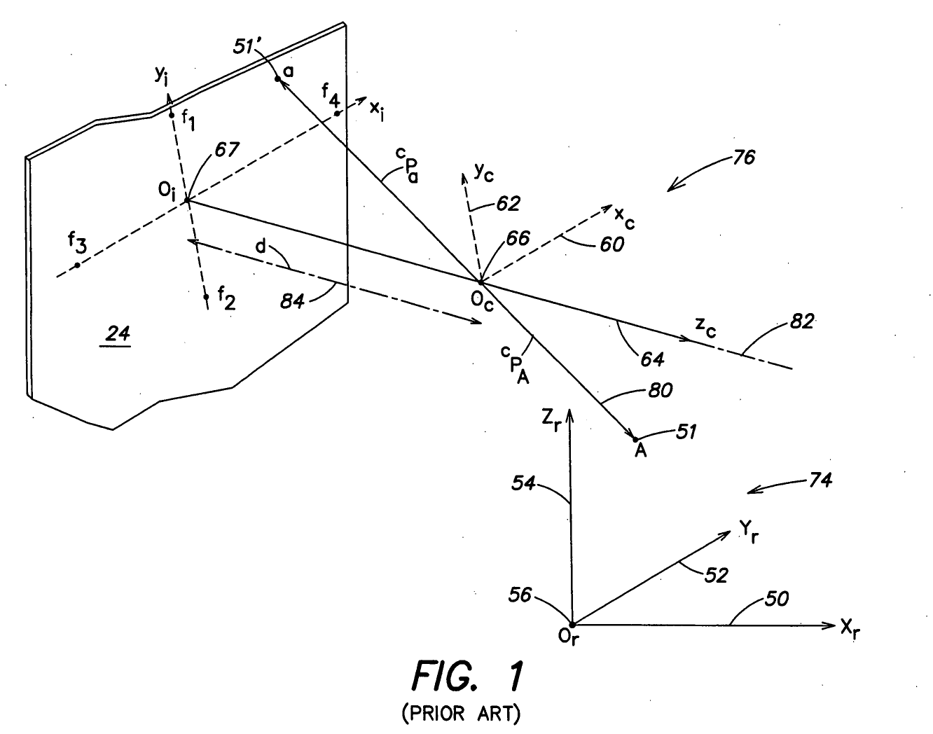

The camera 22 shove in FIG. 6 is associated with a camera coordinate system 76, represented schematically by the axes x_{c}, y_{c}, and z_{c}, and a camera origin 66 (e.g., a nodal point of a lens or lens system of the camera), as discussed above in connection with FIG. 1. An optical axis 82 of the camera 22 lies along the z_{c} axis of the camera coordinate system 76. According to one aspect of this embodiment, the camera 22 may have an arbitrary spatial relationship to the scene 20A; in particular, the camera exterior orientation (i.e., the position and orientation of the camera coordinate system 76 with respect to the reference coordinate system 74) may be unknown a priori.

FIG. 6 also shows that the camera 22 has an image plane 24 on which the image 20B of the scene 20A is formed. As discussed above, the camera 22 may be associated with a particular camera model (e.g., including various interior orientation and lens distortion parameters) that describes the manner in which the scene 20A is projected onto the image plane 24 of the camera to form the image 20B. As discussed above, the exterior orientation of the camera, as well as the various parameters constituting the camera model, collectively are referred to in general as camera calibration information.

According to one embodiment of the invention, the image metrology apparatus shown in FIG. 6 comprises an image metrology processor 36 to receive the image 20B of the scene 20A. According to some embodiments, the apparatus also may include a display 38 (e.g., a CRT device), coupled to the image metrology processor 36, to display a displayed image 20C of the image 20B (including a displayed image 120C of the reference target 120A). Additionally, the apparatus shown in FIG. 6 may include one or more user interfaces, shown for example as a mouse 40A and a keyboard 40B, each coupled to the image metrology processor 36. The user interfaces 40A and/or 40B allow a user to select (e.g., via point and click using a mouse, or cursor movement) various features of interest that appear in the displayed image 20C (e.g., the two points 26B and 28B which correspond to actual points 26A and 28A, respectively, in the scene 20A). It should be appreciated that the invention is not limited to the user interfaces illustrated in FIG. 6; in particular, other types and/or additional user interfaces not explicitly shown in FIG. 6 (e.g., a touch sensitive display screen, various cursor controllers implemented on the keyboard 40B, etc.) may be suitable in other embodiments of the invention to allow a user to select one or more features of interest in the scene.

According to one embodiment, the image metrology processor 36 shown in FIG. 6 determines, from the single image 20B, position and/or size information associated with one or more objects of interest in the scene 20A, based at least in part on the reference information associated with the reference target 120A, and information derived from the image 120B of the reference target 120A. In this respect, it should be appreciated that the image 20B generally includes a variety of other image content of interest from the scene in addition to the image 120B of the reference target. According to one aspect of this embodiment, the image metrology processor 36 also controls the display 38 so as to provide one or more indications of the determined position and/or size information to the user.

For example, according to one aspect of this embodiment, as illustrated in FIG. 6, the image metrology processor 36 may calculate a physical (i.e., actual) distance between any two points in the scene 20A that lie in a same plane as the reference target 120A. Such points generally may be associated, for example, with an object of interest having one or more surfaces in the same plane as the reference target 120A (e.g., the family portrait 34 shown in FIG. 6). In particular, as shown in FIG. 6, a user may indicate (e.g., using one of the user interfaces 40A and 40B) the points of interest 26B and 28B in the displayed image 20C, which points correspond to the points 26A and 28A at two respective corners of the family portrait 34 in the scene 20A, between which a measurement of a physical distance 30 is desired. Alternatively, according to another embodiment of the invention, one or more stand-alone robust fiducial marks (RFIDs) may be placed in the scene to facilitate automatic detection of points of interest for which position and/or size information is desired. For example, an RFID may placed in the scene at each of the points 26A and 28A, and these RFIDs appearing in the image 20B of the scene may be automatically detected in the image to indicate the points of interest.

In this aspect of the embodiment shown in FIG. 6, the processor 36 calculates the distance 30 and controls the display 38 so as to display one or more indications 42 of the calculated distance. For example, an indication 42 of the calculated distance 30 is shown in FIG. 6 by the double-headed arrow and proximate alphanumeric characters “1 m.” (i.e., one meter), which is superimposed on the displayed image 20C near the selected points 26B and 28B. It should be appreciated, however, that the invention is not limited in this respect, as other methods for providing one or more indications of calculated physical distance measurements, or various other position and/or size information of objects of interest in the scene, may be suitable in other embodiments (e.g., one or more audible indications, a hard-copy printout of the displayed image with one or more indications superimposed thereon, etc.).

According to another aspect of the exemplary image metrology apparatus shown in FIG. 6, a user may select (e.g., via one or more user interfaces) a number of different pairs of points in the displayed image 20C from time to time (or alternatively, a number of different pairs of points may be uniquely and automatically identified by placing a number of stand-alone RFIDs in the scene at desired locations), for which physical distances between corresponding pairs of points in the reference plane 21 of the scene 20A are calculated. As discussed above, indications of the calculated distances subsequently may be indicated to the user in a variety of manners (e.g., displayed/superimposed on the displayed image 20C, printed out, etc.).

In the embodiment of FIG. 6, it should be appreciated that the camera 22 need not be coupled to the image metrology processor 36 at all times. In particular, while the processor may receive the image 20B shortly after the image is obtained, alternatively the processor 36 may receive the image 20B of the scene 20A at any time, from a variety of sources. For example, the image 20B may be obtained by a digital camera, and stored in either camera memory or downloaded to some other memory (e.g., a personal computer memory) for a period of time. Subsequently, the stored image may be downloaded to the image metrology processor 36 for processing at any time. Alternatively, the image 20B may be recorded using a film camera from which a print (i.e., photograph) of the image is made. The print of the image 20B may then be scanned by a digital scanner (not shown specifically in FIG. 5), and the scanned print of the image may be directly downloaded to the processor 36 or stored in scanner memory or other memory for a period of time for subsequent downloading to the processor 36.

From the foregoing, as discussed above, it should be appreciated that a variety of image recording devices (e.g., digital or film cameras, digital scanners, video recorders, etc.) may be used from time to time to acquire one or more images of scenes suitable for image metrology processing according to various embodiments of the present invention. In any case, according to one aspect of the embodiment of FIG. 6, a user places the reference target 120A in a particular plane of interest to establish the reference plane 21 for the scene, obtains an image of the scene including the reference target 120A, and downloads the image at some convenient time to the image metrology processor 36 to obtain position and/or size information associated with objects of interest in the reference plane of the scene.

### D. Exemplary Image Metrology Applications

The exemplary image metrology apparatus of FIG. 6, as well as image metrology apparatus according to other embodiments of the invention, generally are suitable for a wide variety of applications, including those in which users desire measurements of indoor or outdoor built (or, in general, planar) spaces. For example, contractors or architects may use an image metrology apparatus of the invention for project design, remodeling and estimation of work on built (or to-be-built) spaces. Similarly, building appraisers and insurance estimators may derive useful measurement-related information using an image metrology apparatus of the invention. Likewise, realtors may present various building floor plans to potential buyers who can compare dimensions of spaces and/or ascertain if various furnishings will fit in spaces, and interior designers can demonstrate interior design ideas to potential customers.

Additionally, law enforcement agents may use an image metrology apparatus according to the invention for a variety of forensic investigations in which spatial relationships at a crime scene may be important. In crime scene analysis, valuable evidence often may be lost if details of the scene are not observed and/or recorded immediately. An image metrology apparatus according to the invention enables law enforcement agents to obtain images of a crime scene easily and quickly, under perhaps urgent and/or emergency circumstances, and then later download the images for subsequent processing to obtain a variety of position and/or size information associated with objects of interest in the scene.

It should be appreciated that various embodiments of the invention as discussed herein may be suitable for one or more of the foregoing applications, and that the foregoing applications are not limited to the image metrology apparatus discussed above in connection with FIG. 6. Likewise, it should be appreciated that image metrology methods and apparatus according to various embodiments of the present invention are not limited to the foregoing applications, and that such exemplary applications are discussed herein for purposes of illustration only.

### E. Exemplary Network Implementations of Image Metrology Methods and Apparatus

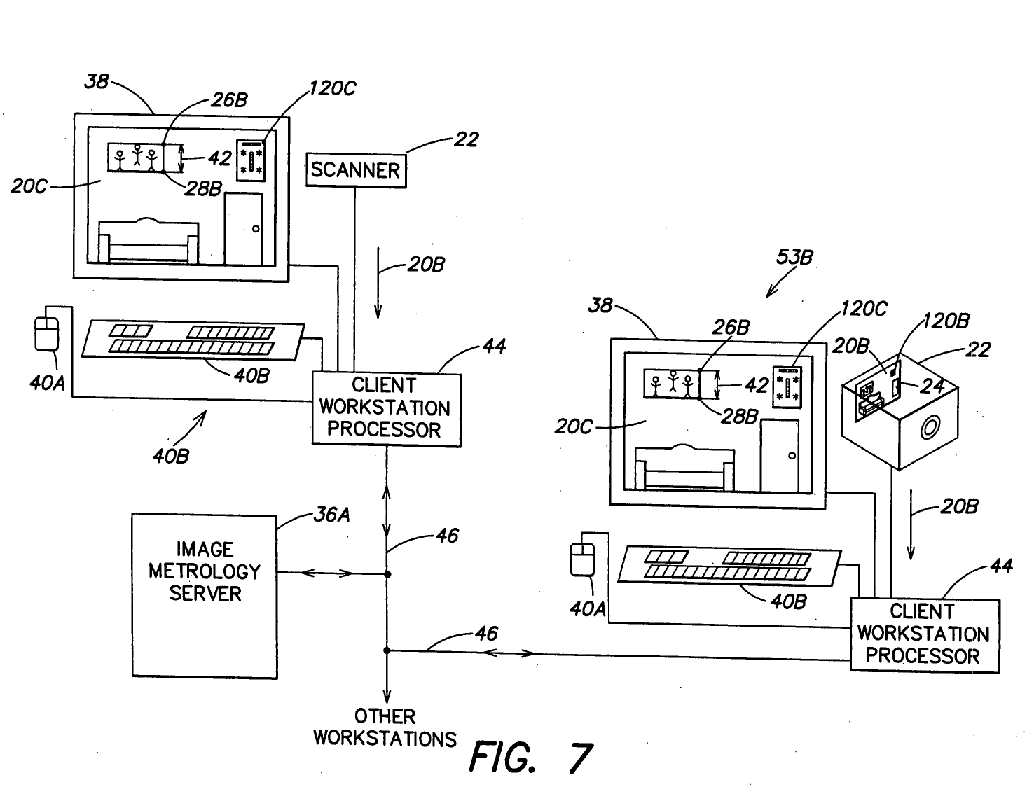

FIG. 7 is a diagram illustrating an image metrology apparatus according to another embodiment of the invention. The apparatus of FIG. 7 is configured as a “client-server” image metrology system suitable for implementation over a local-area network or a wide-area network, such as the Internet. In the system of FIG. 7, one or more image metrology servers 36A, similar to the image metrology processor 36 of FIG. 6, are coupled to a network 46, which may be a local-area or wide-area network (e.g., the Internet). An image metrology server 36A provides image metrology processing services to a number of users (i.e., clients) at client workstations, illustrated in FIG. 7 as two PC-based workstations 50A and 50B, that are also coupled to the network 46. While FIG. 7 shows only two client workstations 50A and 50B, it should be appreciated that any number of client workstations may be coupled to the network 46 to download information from, and upload information to, one or more image metrology servers 36A.

FIG. 7 shows that each client workstation 50A and 50B may include a workstation processor 44, (e.g., a personal computer), one or more user interfaces (e.g., a mouse 40A and a keyboard 40B), and a display 38. FIG. 7 also shows that one or more cameras 22 may be coupled to each workstation processor 44 from time to time, to download recorded images locally at the client workstations. For example, FIG. 7 shows a scanner coupled to the workstation 50A and a digital camera coupled to the workstation 50B. Images recorded by either of these recording devices (or other types of recording devices) may be downloaded to any of the workstation processors 44 at any time, as discussed above in connection with FIG. 6. It should be appreciated that one or more same or different types of cameras 22 may be coupled to any of the client workstations from time to time, and that the particular arrangement of client workstations and image recording devices shown in FIG. 7 is for purposes of illustration only. Additionally, for purposes of the present discussion, it is understood that each workstation processor 44 is operated using one or more appropriate conventional software programs for routine acquisition, storage, and/or display of various information (e.g., images recorded using various recording devices).

In the embodiment of an image metrology apparatus shown in FIG. 7, it should also be appreciated for purposes of the present discussion that each client workstation 44 coupled to the network 46 is operated using one or more appropriate conventional client software programs that facilitate the transfer of information across the network 46. Similarly, it is understood that the image metrology server 36A is operated using one or more appropriate conventional server software programs that facilitate the transfer of information across the network 46. Accordingly, in embodiments of the invention discussed further below, the image metrology server 36A shown in FIG. 7 and the image metrology processor 36 shown in FIG. 6 are described similarly in terms of those components and functions specifically related to image metrology that are common to both the server 36A and the processor 36. In particular, in embodiments discussed further below, image metrology concepts and features discussed in connection with the image metrology processor 36 of FIG. 6 similarly relate and apply to the image metrology server 36A of FIG. 7.

According to one aspect of the network-based image metrology apparatus shown in FIG. 7, each of the client workstations 50A and 50B may upload image-related information to the image metrology server 36A at any time. Such image-related information may include, for example, the image of the scene itself (e.g., the image 20B from FIG. 6), as well as any points selected in the displayed image by the user (e.g., the points 26B and 28B in the displayed image 20C in FIG. 6) which indicate objects of interest for which position and/or size information is desired. In this aspect, the image metrology server 36A processes the uploaded information to determine the desired position and/or size information, after which the image metrology server downloads to one or more client workstations the desired information, which may be communicated to a user at the client workstations in a variety of manners (e.g., superimposed on the displayed image 20C).

In yet another aspect of the network-based image metrology apparatus shown in FIG. 7, rather than uploading images from one or more client workstations to an image metrology server, images are maintained at client workstations and the appropriate image metrology algorithms are downloaded from the server to the clients for use as needed to locally process the images. In this aspect, a security advantage is provided for the client, as it is unnecessary to upload images over the network for processing by one or more image metrology servers.

### F. Exemplary Network-based Image Metrology Applications

As with the image metrology apparatus of FIG. 6, various embodiments of the network-based image metrology apparatus shown in FIG. 7 generally are suitable for a wide variety of applications in which users require measurements of objects in a scene. However, unlike the apparatus of FIG. 6, in one embodiment the network-based apparatus of FIG. 7 may allow a number of geographically dispersed users to obtain measurements from a same image or group of images.

For example, in one exemplary application of the network-based image metrology apparatus of FIG. 7, a realtor (or interior designer, for example) may obtain images of scenes in a number of different rooms throughout a number of different homes, and upload these images (e.g., from their own client workstation) to the image metrology server 36A. The uploaded images may be stored in the server for any length of time. Interested buyers or customers may connect to the realtor's (or interior designer's) webpage via a client workstation, and from the webpage subsequently access the image metrology server 36A. From the uploaded and stored images of the homes, the interested buyers or customers may request image metrology processing of particular images to compare dimensions of various rooms or other spaces from home to home. In particular, interested buyers or customers may determine whether personal furnishings and other belongings, such as furniture and decorations, will fit in the various living spaces of the home. In this manner, potential buyers or customers can compare homes in a variety of geographically different locations from one convenient location, and locally display and/or print out various images of a number of rooms in different homes with selected measurements superimposed on the images.

As discussed above, it should be appreciated that network implementations of image metrology methods and apparatus according to various embodiments of the present invention are not limited to the foregoing exemplary application, and that this application is discussed herein for purposes of illustration only. Additionally, as discussed above in connection with FIG. 7, it should be appreciated in the foregoing example that images alternatively may be maintained at client workstations, and the appropriate image metrology algorithms may be downloaded from the server (e.g., via a service provider's webpage) to the clients for use as needed to locally process the images and preserve security.

### G. Exemplary Reference Objects for Image Metrology Methods and Apparatus

According to one embodiment of the invention as discussed above in connection with FIGS. 5 and 6, the image metrology processor 36 shown in FIG. 6 first determines various camera calibration information associated with the camera 22 in order to ultimately determine position and/or size information associated with one or more objects of interest in the scene 20A that appear in the image 20B obtained by the camera 22. For example, according to one embodiment, the image metrology processor 36 determines at least the exterior orientation of the camera 22 (i.e., the position and orientation of the camera coordinate system 76 with respect to the reference coordinate system 74 for the scene 20A, as shown in FIG. 6).

In one aspect of this embodiment, the image metrology processor 36 determines at least the camera exterior orientation using a resection process, as discussed above, based at least in part on reference information associated with reference objects in the scene, and information derived from respective images of the reference objects as they appear in an image of the scene. In other aspects, the image metrology processor 36 determines other camera calibration information (e.g., interior orientation and lens distortion parameters) in a similar manner. As discussed above, the term “reference information” generally refers to various information (e.g., position and/or orientation information) associated with one or more reference objects in a scene that is known a priori with respect to a reference coordinate system for the scene.

In general, it should be appreciated that a variety of types, numbers, combinations and arrangements of reference objects may be included in a scene according to various embodiments of the invention. For example, various configurations of reference objects suitable for purposes of the invention include, but are not limited to, individual or “stand-alone” reference objects, groups of objects arranged in a particular manner to form one or more reference targets, various combinations and arrangements of stand-alone reference objects and/or reference targets, etc. The configuration of reference objects provided in different embodiments may depend, in part, upon the particular camera calibration information (e.g., the number of exterior orientation, interior orientation, and/or lens distortion parameters) that an image metrology method or apparatus of the invention needs to determine for a given application (which, in turn, may depend on a desired measurement accuracy). Additionally, according to some embodiments, particular types of reference objects may be provided in a scene depending, in part, on whether one or more reference objects are to be identified manually or automatically from an image of the scene, as discussed further below.

G1. Exemplary Reference Targets

In view of the foregoing, one embodiment of the present invention is directed to a reference target that, when placed in a scene of interest, facilitates a determination of various camera calibration information. In particular, FIG. 8 is a diagram showing an example of the reference target 120A that is placed in the scene 20A of FIG. 6, according to one embodiment of the invention. It should be appreciated however, as discussed above, that the invention is not limited to the particular example of the reference target 120A shown in FIG. 8, as numerous implementations of reference targets according to various embodiments of the invention (e.g., including different numbers, types, combinations and arrangements of reference objects) are possible.

According to one aspect of the embodiment shown in FIG. 8, the reference target 120A is designed generally to be portable, so that it is easily transferable amongst different scenes and/or different locations in a given scene. For example, in one aspect, the reference target 120A has an essentially rectangular shape and has dimensions on the order of 25 cm. In another aspect, the dimensions of the reference target 120A are selected for particular image metrology applications such that the reference target occupies on the order of 100 pixels by 100 pixels in a digital image of the scene in which it is placed. It should be appreciated, however, that the invention is not limited in these respects, as reference targets according to other embodiments may have different shapes and sizes than those indicated above.

In FIG. 8, the example of the reference target 120A has an essentially planar front (i.e., viewing) surface 121, and includes a variety of reference objects that are observable on at least the front surface 121. In particular, FIG. 8 shows that the reference target 120A includes four fiducial marks 124A, 124B, 124C, and 124D, shown for example in FIG. 8 as asterisks. In one aspect, the fiducial marks 124A-124D are similar to control points, as discussed above in connection with various photogrammetry techniques (e.g., resection). FIG. 8 also shows that the reference target 120A includes a first orientation-dependent radiation source (ODR) 122A and a second ODR 122B.

According to one aspect of the embodiment of the reference target 120A shown in FIG. 8, the fiducial marks 124A-124D have known spatial relationships to each other. Additionally, each fiducial mark 124A-124D has a known spatial relationship to the ODRs 122A and 122B. Stated differently, each reference object of the reference target 120A has a known spatial relationship to at least one point on the target, such that relative spatial information associated with each reference object of the target is known a priori. These various spatial relationships constitute at least some of the reference information associated with the reference target 120A. Other types of reference information that may be associated with the reference target 120A are discussed further below.

In the embodiment of FIG. 8, each ODR 122A and 122B emanates radiation having at least one detectable property, based on an orientation of the ODR, that is capable of being detected from an image of the reference target 120A (e.g., the image 120B shown in FIG. 6). According to one aspect of this embodiment, the ODRs 122A and 122B directly provide particular information in an image that is related to an orientation of the camera relative to the reference target 120A, so as to facilitate a determination of at least some of the camera exterior orientation parameters. According to another aspect, the ODRs 122A and 122B directly provide particular information in an image that is related to a distance between the camera (e.g. the camera origin 66 shown in FIG. 6) and the reference target 120A. The foregoing and other aspects of ODRs in general are discussed in greater detail below, in Sections G2 and J of the Detailed Description.

As illustrated in FIG. 8, each ODR 122A and 122B has an essentially rectangular shape defined by a primary axis that is parallel to a long side of the ODR, and a secondary axis, orthogonal to the primary axis, that is parallel to a short side of the ODR. In particular, in the exemplary reference target shown in FIG. 8, the ODR 122A has a primary axis 130 and a secondary axis 132 that intersect at a first ODR reference point 125A. Similarly, in FIG. 8, the ODR 122B has a secondary axis 138 and a primary axis which is coincident with the secondary axis 132 of the ODR 122A. The axes 138 and 132 of the ODR 122B intersect at a second ODR reference point 125B. It should be appreciated that the invention is not limited to the ODRs 122A and 122B sharing one or more axes (as shown in FIG. 8 by the axis 132), and that the particular arrangement and general shape of the ODRs shown in FIG. 8 is for purposes of illustration only. In particular, according to other embodiments, the ODR 122B may have a primary axis that does not coincide with the secondary axis 132 of the ODR 122A.

According to one aspect of the exemplary embodiment shown in FIG. 8, the ODRs 122A and 122B are arranged in the reference target 120A such that their respective primary axes 130 and 132 are orthogonal to each other and each parallel to a side of the reference target. However, it should be appreciated that the invention is not limited in this respect, as various ODRs may be differently oriented (i.e., not necessarily orthogonal to each other) in a reference target having an essentially rectangular or other shape, according to other embodiments. Arbitrary orientations of ODRs (e.g., orthogonal vs. non-orthogonal) included in reference targets according to various embodiments of the invention are discussed in greater detail in Section L of the Detailed Description.

According to another aspect of the exemplary embodiment shown in FIG. 8, the ODRs 122A and 122B are arranged in the reference target 120A such that each of their respective secondary axes 132 and 138 passes through a common intersection point 140 of the reference target. While FIG. 8 shows the primary axis of the ODR 122B also passing through the common intersection point 140 of the reference target 120A, it should be appreciated that the invention is not limited in this respect (i.e., the primary axis of the ODR 122B does not necessarily pass through the common intersection point 140 of the reference target 120A according to other embodiments of the invention). In particular, as discussed above, the coincidence of the primary axis of the ODR 122B and the secondary axis of the ODR 122A (such that the second ODR reference point 125B coincides with the common intersection point 140) is merely one design option implemented in the particular example shown in FIG. 8. In yet another aspect, the common intersection point 140 may coincide with a geometric center of the reference target, but again it should be appreciated that the invention is not limited in this respect.

According to one embodiment of the invention, as shown in FIG. 8, the secondary axis 138 of the ODR 122B serves as an xₜ axis of the reference target 120A, and the secondary axis 132 of the ODR 122A serves as a yₜ axis of the reference target. In one aspect of this embodiment, each fiducial mark 124A-124D shown in the target of FIG. 8 has a known spatial relationship to the common intersection point 140. In particular, each fiducial mark 124A-124D has known “target” coordinates with respect to the xₜ axis 138 and they, axis 132 of the reference target 120A. Likewise, the target coordinates of the first and second ODR reference points 125A and 125B are known with respect to the xₜ axis 138 and the yₜ axis 132. Additionally, the physical dimensions of each of the ODRs 122A and 122B (e.g., length and width for essentially rectangular ODRs) are known by design. In this manner, a spatial position (and, in some instances, extent) of each reference object of the reference target 120A shown in FIG. 8 is known apriori with respect to the xₜ axis 138 and the yₜ axis 132 of the reference target 120A. Again, this spatial information constitutes at least some of the reference information associated with the reference target 120A.

With reference again to both FIGS. 6 and 8, in one embodiment, the common intersection point 140 of the reference target 120A shown in FIG. 8 defines the reference origin 56 of the reference coordinate system 74 for the scene in which the reference target is placed. In one aspect of this embodiment, the xₜ axis 138 and the yₜ axis 132 of the reference target lie in the reference plane 21 of the reference coordinate system 74, with a normal to the reference target that passes through the common intersection point 140 defining the zᵣ axis of the reference coordinate system 74 (i.e., out of the plane of both FIGS. 6 and 8).

In particular, in one aspect of this embodiment, as shown in FIG. 6, the reference target 120A may be placed in the scene such that the xₜ axis 138 and the yₜ axis 132 of the reference target respectively correspond to the xᵣ axis 50 and the yᵣ axis 52 of the reference coordinate system 74 (i.e., the reference target axes essentially define the xᵣ axis 50 and the yᵣ axis 52 of the reference coordinate system 74). Alternatively, in another aspect (not shown in the figures), the xₜ and yₜ axes of the reference target may lie in the reference plane 21, but the reference target may have a known “roll” rotation with respect to the xᵣ axis 50 and the yᵣ axis 52 of the reference coordinate system 74; namely, the reference target 120A shown in FIG. 8 may be rotated by a known amount about the normal to the target passing through the common intersection point 140 (i.e., about the zᵣ axis of the reference coordinate system shown in FIG. 6), such that the xₜ and yₜ axes of the reference target are not respectively aligned with the xᵣ and yᵣ axes of the reference coordinate system 74. Such a roll rotation of the reference target 120A is discussed in greater detail in Section L of the Detailed Description. In either of the above situations, however, in this embodiment the reference target 120A essentially defines the reference coordinate system 74 for the scene, either explicitly or by having a known roll rotation with respect to the reference plane 21.

As discussed in greater detail further below in Sections G2 and J of the Detailed Description, according to one embodiment the ODR 122A shown in FIG. 8 emanates orientation-dependent radiation 126A that varies as a function of a rotation 136 of the ODR 122A about its secondary axis 132. Similarly, the ODR 122B in FIG. 8 emanates orientation-dependent radiation 126B that varies as a function of a rotation 134 of the ODR 122B about its secondary axis 138.

For purposes of providing an introductory explanation of the operation of the ODRs 122A and 122B of the reference target 120A, FIG. 8 schematically illustrates each of the orientation dependent radiation 126A and 126B as a series of three oval-shaped radiation spots emanating from a respective observation surface 128A and 128B of the ODRs 122A and 122B. It should be appreciated, however, that the foregoing is merely one exemplary representation of the orientation dependent radiation 126A and 126B, and that the invention is not limited in this respect. With reference to the illustration of FIG. 8, according to one embodiment, the three radiation spots of each ODR collectively move along the primary axis of the ODR (as indicated in FIG. 8 by the oppositely directed arrows on the observation surface of each ODR) as the ODR is rotated about its secondary axis. Hence, in this example, at least one detectable property of each of the orientation dependent radiation 126A and 126B is related to a position of one or more radiation spots (or, more generally, a spatial distribution of the orientation dependent radiation) along the primary axis on a respective observation surface 128A and 128B of the ODRs 122A and 122B. Again, it should be appreciated that the foregoing illustrates merely one example of orientation dependent radiation (and a detectable property thereof) that may be emanated by an ODR according to various embodiments of the invention, and that the invention is not limited to this particular example.

Based on the general operation of the ODRs 122A and 122B as discussed above, in one aspect of the embodiment shown in FIG. 8, a “yaw” rotation 136 of the reference target 120A about its yₜ axis 132 (i.e., the secondary axis of the ODR 122A) causes a variation of the orientation-dependent radiation 126A along the primary axis 130 of the ODR 122A (i.e., parallel to the xₜ axis 138). Similarly, a “pitch” rotation 134 of the reference target 120A about its xₜ axis 138 (i.e., the secondary axis of the ODR 122B) causes a variation in the orientation-dependent radiation 126B along the primary axis 132 of the ODR 122B (i.e., along the yₜ axis). In this manner, the ODRs 122A and 122B of the reference target 120A shown in FIG. 8 provide orientation information associated with the reference target in two orthogonal directions. According to one embodiment, by detecting the orientation-dependent radiation 126A and 126B from an image 120B of the reference target 120A, the image metrology processor 36 shown in FIG. 6 can determine the pitch rotation 134 and the yaw rotation 136 of the reference target 120A. Examples of such a process are discussed in greater detail in Section L of the Detailed Description.

According to one embodiment, the pitch rotation 134 and the yaw rotation 136 of the reference target 120A shown in FIG. 8 correspond to a particular “camera bearing” (i.e., viewing perspective) from which the reference target is viewed. As discussed further below and in Section L of the Detailed Description, the camera bearing is related to at least some of the camera exterior orientation parameters. Accordingly, by directly providing information with respect to the camera bearing in an image of the scene, in one aspect the reference target 120A advantageously facilitates a determination of the exterior orientation of the camera (as well as other camera calibration information). In particular, a reference target according to various embodiments of the invention generally may include automatic detection means for facilitating an automatic detection of the reference target in an image of the reference target obtained by a camera (some examples of such automatic detection means are discussed below in Section G3 of the Detailed Description), and bearing determination means for facilitating a determination of one or more of a position and at least one orientation angle of the reference target with respect to the camera (i.e., at least some of the exterior orientation parameters). In one aspect of this embodiment, one or more ODRs may constitute the bearing determination means.

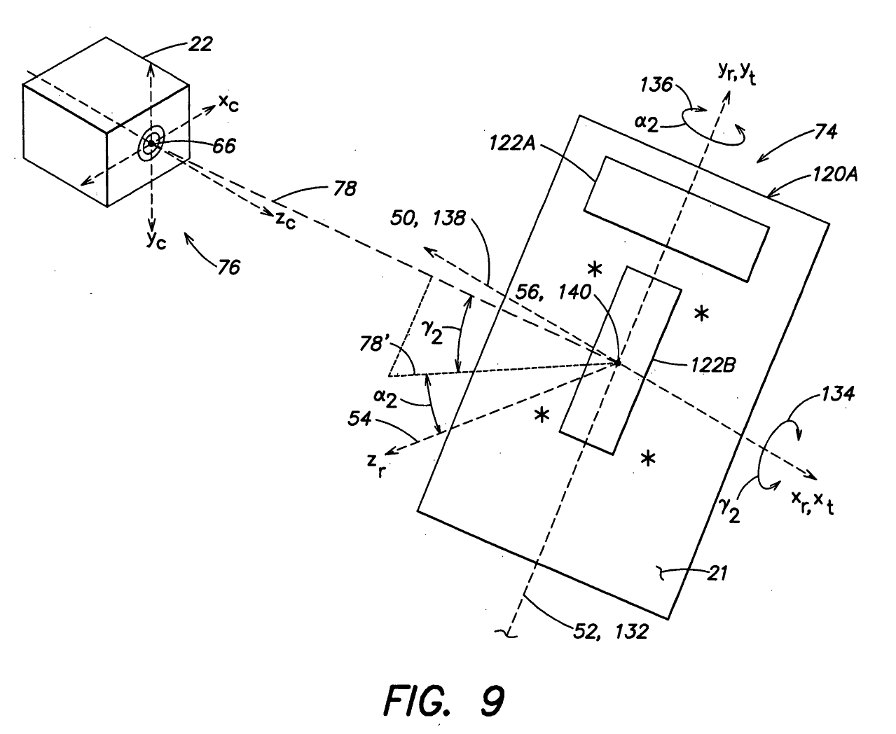

FIG. 9 is a diagram illustrating the concept of camera bearing, according to one embodiment of the invention. In particular, FIG. 9 shows the camera 22 of FIG. 6 relative to the reference target 120A that is placed in the scene 20A. In the example of FIG. 9, for purposes of illustration, the reference target 120A is shown as placed in the scene such that its xₜ axis 138 and its yₜ axis 132 respectively correspond to the xᵣ axis 50 and the yᵣ axis 52 of the reference coordinate system 74 (i.e., there is no roll of the reference target 120A with respect to the reference plane 21 of the reference coordinate system 74). Additionally, in FIG. 9, the common intersection point 140 of the reference target coincides with the reference origin 56, and the zᵣ axis 54 of the reference coordinate system 74 passes through the common intersection point 140 normal to the reference target 120A.

For purposes of this disclosure, the term “camera bearing” generally is defined in terms of an azimuth angle α₂ and an elevation angle γ₂ of a camera bearing vector with respect to a reference coordinate system for an object being imaged by the camera. In particular, with reference to FIG. 9, in one embodiment, the camera bearing refers to an azimuth angle α₂ and an elevation angle γ₂ of a camera bearing vector 78, with respect to the reference coordinate system 74. As shown in FIG. 9 (and also in FIG. 1), the camera bearing vector 78 connects the origin 66 of the camera coordinate system 76 (e.g., a nodal point of the camera lens system) and the origin 56 of the reference coordinate system 74 (e.g., the common intersection point 140 of the reference target 120A). In other embodiments, the camera bearing vector may connect the origin 66 to a reference point of a particular ODR.

FIG. 9 also shows a projection 78′ (in the xᵣ-zᵣ plane of the reference coordinate system 74) of the camera bearing vector 78, for purposes of indicating the azimuth angle α₂ and the elevation angle γ₂ of the camera bearing vector 78; in particular, the azimuth angle α₂ is the angle between the camera bearing vector 78 and the yᵣ-zᵣ plane of the reference coordinate system 74, and the elevation angle γ₂ is the angle between the camera bearing vector 78 and the xᵣ-zᵣ plane of the reference coordinate system.

From FIG. 9, it may be appreciated that the pitch rotation 134 and the yaw rotation 136 indicated in FIGS. 8 and 9 for the reference target 120A correspond respectively to the elevation angle γ₂ and the azimuth angle α₂ of the camera bearing vector 78. For example, if the reference target 120A shown in FIG. 9 were originally oriented such that the normal to the reference target passing through the common intersection point 140 coincided with the camera bearing vector 78, the target would have to be rotated by γ₂ degrees about its xₜ axis (i.e., a pitch rotation of γ₂ degrees) and by α₂ degrees about its yₜ axis (i.e., a yaw rotation of α₂ degrees) to correspond to the orientation shown in FIG. 9. Accordingly, from the discussion above regarding the operation of the ODRs 122A and 122B with respect to pitch and yaw rotations of the reference target 120A, it may be appreciated from FIG. 9 that the ODR 122A facilitates a determination of the azimuth angle α₂ of the camera bearing vector 78, while the ODR 122B facilitates a determination of the elevation angle γ₂ of the camera bearing vector. Stated differently, each of the respective oblique viewing angles of the ODRs 122A and 122B (i.e., rotations about their respective secondary axes) constitutes an element of the camera bearing.

In view of the foregoing, it should be appreciated that other types of reference information associated with reference objects of the reference target 120A shown in FIG. 8 that may be known a priori (i.e., in addition to the relative spatial information of reference objects with respect to the xₜ and yₜ axes of the reference target, as discussed above) relates particularly to the ODRs 122A and 122B. In one aspect, such reference information associated with the ODRs 122A and 122B facilitates an accurate determination of the camera bearing based on the detected orientation-dependent radiation 126A and 126B.

More specifically, in one embodiment, a particular characteristic of the detectable property of the orientation-dependent radiation 126A and 126B respectively emanated from the ODRs 122A and 122B as the reference target 120A is viewed “head-on” (i.e., the reference target is viewed along the normal to the target at the common intersection point 140) may be known a priori and constitute part of the reference information for the target 120A. For instance, as illustrated in the example of FIG. 8, a particular position along an ODR primary axis of one or more of the oval-shaped radiation spots representing the orientation-dependent radiation 126A and 126B, as the reference target is viewed along the normal, may be known a priori for each ODR and constitute part of the reference information for the target 120A. In one aspect, this type of reference information establishes baseline data for a “normal camera bearing” to the reference target (e.g., corresponding to a camera bearing having an azimuth angle α₂ of 0 degrees and an elevation angle γ₂ of 0 degrees, or no pitch and yaw rotation of the reference target).

Furthermore, a rate of change in the characteristic of the detectable property of the orientation-dependent radiation 126A and 126B, as a function of rotating a given ODR about its secondary axis (i.e., a “sensitivity” of the ODR to rotation), may be known a priori for each ODR and constitute part of the reference information for the target 120A. For instance, as illustrated in the example of FIG. 8 (and discussed in detail in Section J of the Detailed Description), how much the position of one or more radiation spots representing the orientation-dependent radiation moves along the primary axis of an ODR for a particular rotation of the ODR about its secondary axis may be known a priori for each ODR and constitute part of the reference information for the target 120A.

In sum, examples of reference information that may be known a priori in connection with reference objects of the reference target 120A shown in FIG. 8 include, but are not necessarily limited to, a size of the reference target 120A (i.e. physical dimensions of the target), the coordinates of the fiducial marks 124A-124D and the ODR reference points 125A and 125B with respect to the xₜ and yₜ axes of the reference target, the physical dimensions (e.g., length and width) of each of the ODRs 122A and 122B, respective baseline characteristics of one or more detectable properties of the orientation-dependent radiation emanated from each ODR at normal or “head-on” viewing of the target, and respective sensitivities of each ODR to rotation. Based on the foregoing, it should be appreciated that the various reference information associated with a given reference target may be unique to that target (i.e., “target-specific” reference information), based in part on the type, number, and particular combination and arrangement of reference objects included in the target.

As discussed above (and in greater detail further below in Section L of the Detailed Description), according to one embodiment of the invention, the image metrology processor 36 of FIG. 6 uses target-specific reference information associated with reference objects of a particular reference target, along with information derived from an image of the reference target (e.g., the image 120B in FIG. 6), to determine various camera calibration information. In one aspect of this embodiment, such target-specific reference information may be manually input to the image metrology processor 36 by a user (e.g., via one or more user interfaces 40A and 40B). Once such reference information is input to the image metrology processor for a particular reference target, that reference target may be used repeatedly in different scenes for which one or more images are downloaded to the processor for various image metrology purposes.

In another aspect, target-specific reference information for a particular reference target may be maintained on a storage medium (e.g., floppy disk, CD-ROM) and downloaded to the image metrology processor at any convenient time. For example, according to one embodiment, a storage medium storing target-specific reference information for a particular reference target may be packaged with the reference target, so that the reference target could be portably used with different image metrology processors by downloading to the processor the information stored on the medium. In another embodiment, target-specific information for a particular reference target may be associated with a unique serial number, so that a given image metrology processor can download and/or store, and easily identify, the target-specific information for a number of different reference targets that are catalogued by unique serial numbers. In yet another embodiment, a particular reference target and image metrology processor may be packaged as a system, wherein the target-specific information for the reference target is initially maintained in the image metrology processor's semi-permanent or permanent memory (e.g., ROM, EEPROM). From the foregoing, it should be appreciated that a wide variety of methods for making reference information available to an image metrology processor are suitable according to various embodiments of the invention, and that the invention is not limited to the foregoing examples.

In yet another embodiment, target-specific reference information associated with a particular reference target may be transferred to an image metrology processor in a more automated fashion. For example, in one embodiment, an automated coding scheme is used to transfer target-specific reference information to an image metrology processor. According to one aspect of this embodiment, at least one automatically readable coded pattern may be coupled to the reference target, wherein the automatically readable coded pattern includes coded information relating to at least one physical property of the reference target (e.g., relative spatial positions of one or more fiducial marks and one or more ODRs, physical dimensions of the reference target and/or one or more ODRs, baseline characteristics of detectable properties of the ODRs, sensitivities of the ODRs to rotation, etc.)

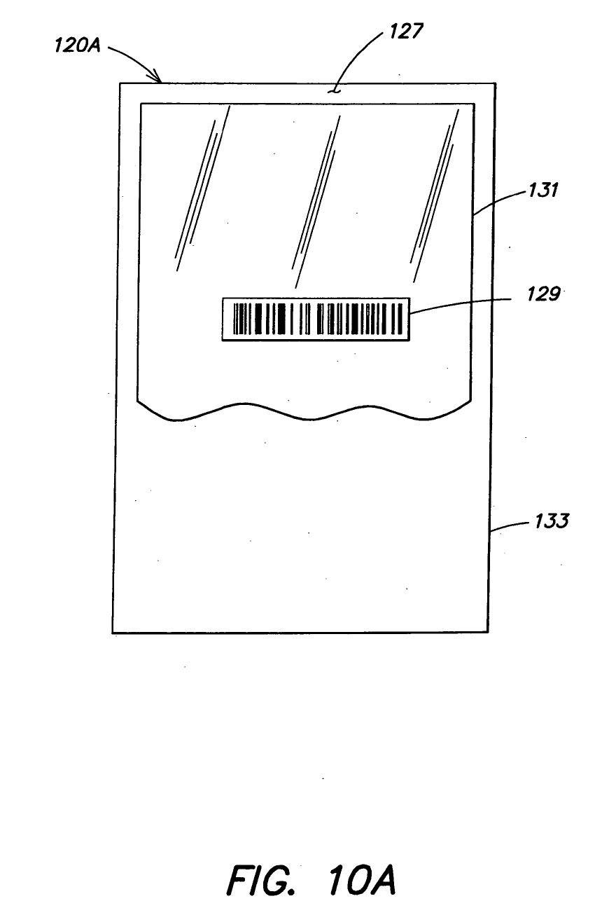

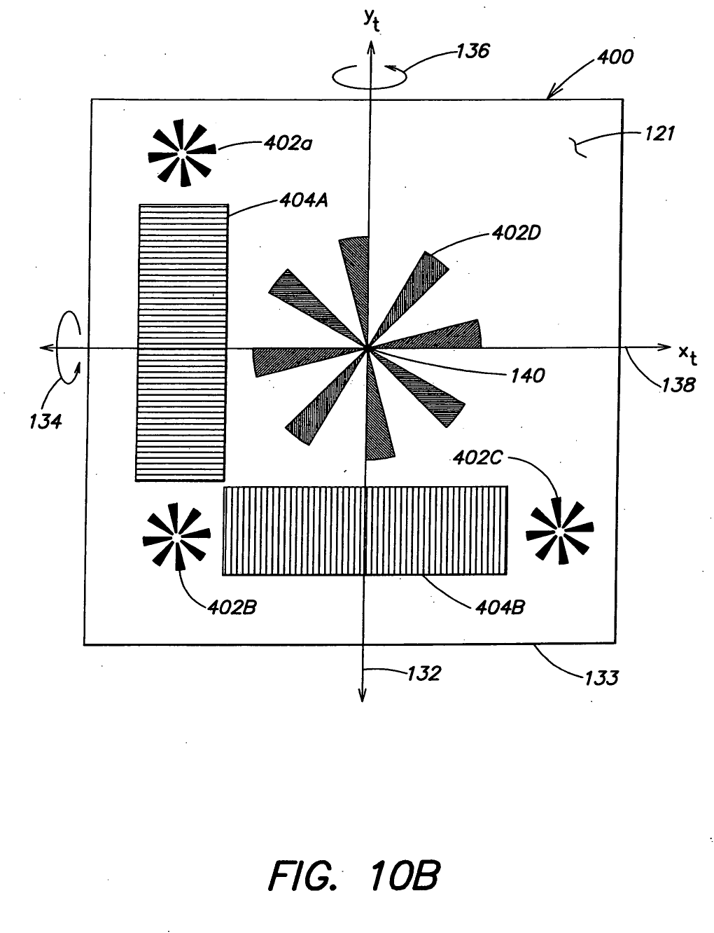

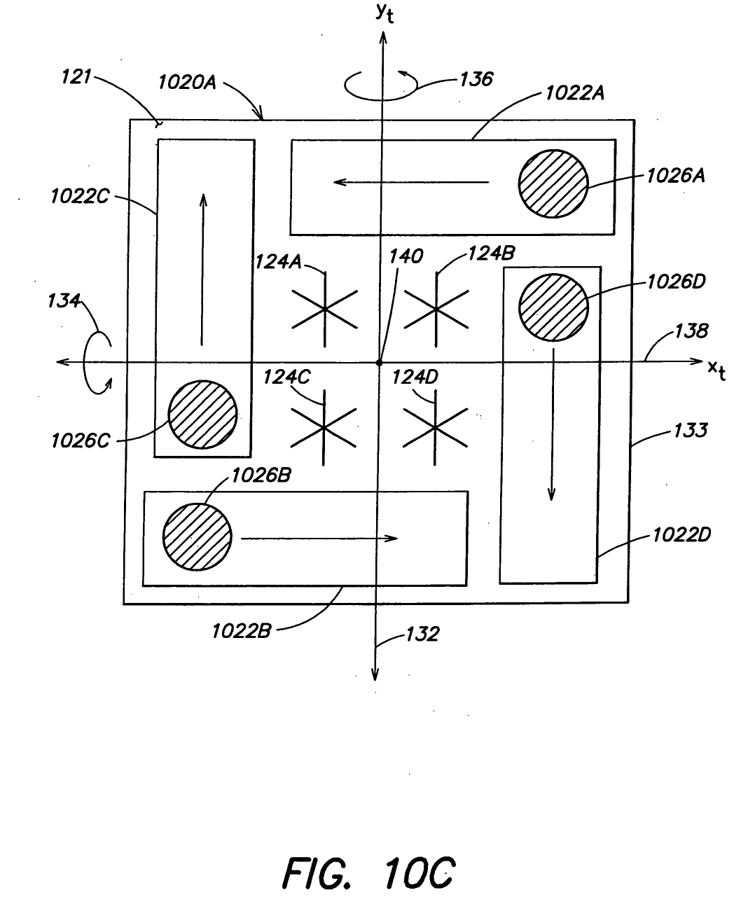

FIG. 10A illustrates a rear view of the reference target 120A shown in FIG. 8. According to one embodiment for transferring target-specific reference information to an image metrology processor in a more automated manner, FIG. 10A shows that a bar code 129 containing coded information may be affixed to a rear surface 127 of the reference target 120A. The coded information contained in the bar code 129 may include, for example, the target-specific reference information itself, or a serial number that uniquely identifies the reference target 120A. The serial number in turn may be cross-referenced to target-specific reference information which is previously stored, for example, in memory or on a storage medium of the image metrology processor.

In one aspect of the embodiment shown in FIG. 10A, the bar code 129 may be scanned, for example, using a bar code reader coupled to the image metrology processor, so as to extract and download the coded information contained in the bar code. Alternatively, in another aspect, an image may be obtained of the rear surface 127 of the target including the bar code 129 (e.g., using the camera 22 shown in FIG. 6), and the image may be analyzed by the image metrology processor to extract the coded information. Again, once the image metrology processor has access to the target-specific reference information associated with a particular reference target, that target may be used repeatedly in different scenes for which one or more images are downloaded to the processor for a various image metrology purposes.

With reference again to FIGS. 8 and 10A, according to one embodiment of the invention, the reference target 120A may be fabricated such that the ODRs 122A and 122B and the fiducial marks 124A-124D are formed as artwork masks that are coupled to one or both of the front surface 121 and the rear surface 127 of an essentially planar substrate 133 which serves as the body of the reference target. For example, in one aspect of this embodiment, conventional techniques for printing on a solid body may be employed to print one or more artwork masks of various reference objects on the substrate 133. According to various aspects of this embodiment, one or more masks may be monolithically formed and include a number of reference objects; alternatively, a number of masks including a single reference object or particular sub-groups of reference objects may be coupled to (e.g., printed on) the substrate 133 and arranged in a particular manner.

Furthermore, in one aspect of this embodiment, the substrate 133 is essentially transparent (e.g., made from one of a variety of plastic, glass, or glass-like materials). Additionally, in one aspect, one or more reflectors 131 may be coupled, for example, to at least a portion of the rear surface 127 of the reference target 120A, as shown in FIG. 10A. In particular, FIG. 10A shows the reflector 131 covering a portion of the rear surface 127, with a cut-away view of the substrate 133 beneath the reflector 131. Examples of reflectors suitable for purposes of the invention include, but are not limited to, retro-reflective films such as 3M Scotchlite™ reflector films, and Lambertian reflectors, such as white paper (e.g., conventional printer paper). In this aspect, the reflector 131 reflects radiation that is incident to the front surface 121 of the reference target (shown in FIG. 8), and which passes through the reference target substrate 133 to the rear surface 127. In this manner, either one or both of the ODRs 122A and 122B may function as “reflective” ODRs (i.e., with the reflector 131 coupled to the rear surface 127 of the reference target). Alternatively, in other embodiments of a reference target that do not include one or more reflectors 131, the ODRs 122A and 122B may function as “back-lit” or “transmissive” ODRs.

According to various embodiments of the invention, a reference target may be designed based at least in part on the particular camera calibration information that is desired for a given application (e.g., the number of exterior orientation, interior orientation, lens distortion parameters that an image metrology method or apparatus of the invention determines in a resection process), which in turn may relate to measurement accuracy, as discussed above. In particular, according to one embodiment of the invention, the number and type of reference objects required in a given reference target may be expressed in terms of the number of unknown camera calibration parameters to be determined for a given application by the relationship

2F≧U−#ODR, (18)

where U is the number of initially unknown camera calibration parameters to be determined, #ODR is the number of out-of-plane rotations (i.e., pitch and/or yaw) of the reference target that may be determined from differently-oliented (e.g., orthogonal) ODRs included in the reference target (i.e., #ODR=zero, one, or two), and F is the number of fiducial marks included in the reference target.

The relationship given by Eq. (18) may be understood as follows. Each fiducial mark F generates two collinearity equations represented by the expression of Eq. (10), as discussed above. Typically, each collinearity equation includes at least three unknown position parameters and three unknown orientation parameters of the camera exterior orientation (i.e., U≧6 in Eq. (17)), to be determined from a system of collinearity equations in a resection process. In this case, as seen from Eq. (18), if no ODRs are included in the reference target (i.e., #ODR=0), at least three fiducial marks F are required to generate a system of at least six collinearity equations in at least six unknowns. This situation is similar to that discussed above in connection with a conventional resection process using at least three control points.

Alternatively, in embodiments of reference targets according to the invention that include one or more differently-oriented ODRs, each ODR directly provides orientation (i.e., camera bearing) information in an image that is related to one of two orientation parameters of the camera exterior orientation (i.e. pitch or yaw), as discussed above and in greater detail in Section L of the Detailed Description. Stated differently, by employing one or more ODRs in the reference target, one or two (i.e., pitch and/or yaw) of the three unknown orientation parameters of the camera exterior orientation need not be determined by solving the system of collinearity equations in a resection process; rather, these orientation parameters may be substituted into the collinearity equations as a previously determined parameter that is derived from camera bearing information directly provided by one or more ODRs in an image. In this manner, the number of unknown orientation parameters of the camera exterior orientation to be determined by resection effectively is reduced by the number of out-of-plane rotations of the reference target that may be determined from differently-oriented ODRs included in the reference target. Accordingly, in Eq. (18), the quantity #ODR is subtracted from the number of initially unknown camera calibration parameters U.

In view of the foregoing, with reference to Eq. (18), the particular example of the reference target 120A shown in FIG. 8 (for which F=4 and #ODR=2) provides information sufficient to determine ten initially unknown camera calibration parameters U. Of course, it should be appreciated that if fewer than tern camera calibration parameters are unknown, all of the reference objects included in the reference target 120A need not be considered in the determination of the camera calibration information, as long as the inequality of Eq. (18) is minimally satisfied (i.e., both sides of Eq. (18) are equal). Alternatively, any “excessive” information provided by the reference target 120A (i.e., the left side of Eq. (18) is greater than the right side) may nonetheless be used to obtain more accurate results for the unknown parameters to be determined, as discussed in greater detail in Section L of the Detailed Description.

Again with reference to Eq. (18), other examples of reference targets according to various embodiments of the invention that are suitable for determining at least the six camera exterior orientation parameters include, but are not limited to, reference targets having three or more fiducial marks and no ODRs, reference targets having three or more fiducial marks and one ODR, and reference targets having two or more fiducial marks and two ODRs (i.e., a generalization of the reference target 120A of FIG. 8). From each of the foregoing combinations of reference objects included in a given reference target, it should be appreciated that a wide variety of reference target configurations, as well as configurations of individual reference objects located in a single plane or throughout three dimensions of a scene of interest, used alone or in combination with one or more reference targets, are suitable for purposes of the invention to determine various camera calibration information.

With respect to camera calibration by resection, it is particularly noteworthy that for a closed-form solution to a system of equations based on Eq. (10) in which all of the camera model and exterior orientation parameters are unknown (e.g., up to 13 or more unknown parameters), control points may not all lie in a same plane in the scene (as discussed in Section F in the Description of the Related Art). In particular, to solve for extensive camera calibration information (including several or all of the exterior orientation, interior orientation, and lens distortion parameters), some “depth” information is required related to a distance between the camera (i.e., the camera origin) and the reference target, which information generally would not be provided by a number of control points all lying in a same plane (e.g., on a planar reference target) in the scene.

In view of the foregoing, according to another embodiment of the invention, a reference target is particularly designed to include combinations and arrangements of RFIDs and ODRs that enable a determination of extensive camera calibration information using a single planar reference target in a single image. In particular, according to one aspect of this embodiment, one or more ODRs of the reference target provide information in the image of the scene in which the target is placed that is related to a distance between the camera and the ODR (and hence the reference target).

FIG. 10B is a diagram illustrating an example of a reference target 400 according to one embodiment of the invention that may be placed in a scene to facilitate a determination of extensive camera calibration information from an image of the scene. According to one aspect of this embodiment, dimensions of the reference target 400 may be chosen based on a particular image metrology application such that the reference target 400 occupies on the order of approximately 250 pixels by 250 pixels in an image of a scene. It should be appreciated, however, that the particular arrangement of reference objects shown in FIG. 10B and the relative sizes of the reference objects and the target are for purposes of illustration only, and that the invention is not limited in these respects.

The reference target 400 of FIG. 10B includes four fiducial marks 402A-402D and two ODRs 404A and 404B. Fiducial marks similar to those shown in FIG. 10B are discussed in detail in Sections G3 and K of the Detailed Description. In particular, according to one embodiment, the exemplary fiducial marks 402A-402D shown in FIG. 10B facilitate automatic detection of the reference target 400 in an image of a scene containing the target. The ODRs 404A and 404B shown in FIG. 10B are discussed in detail in Sections G2 and J of the Detailed Description. In particular, near-field effects of the ODRs 404A and 404B that facilitate a determination of a distance between the reference target 400 and a camera obtaining an image of the reference target 400 are discussed in Sections G2 and J of the Detailed Description. Exemplary image metrology methods for processing images containing the reference target 400 (as well as the reference target 120A and similar targets according to other embodiments of the invention) to determine various camera calibration information are discussed in detail in Sections H and L of the Detailed Description.

FIG. 10C is a diagram illustrating yet another example of a reference target 1020A according to one embodiment of the invention. In one aspect, the reference target 1020A facilitates a differential measurement of orientation dependent radiation emanating from the target to provide for accurate measurements of the target rotations 134 and 136. In yet another aspect, differential near-field measurements of the orientation dependent radiation emanating from the target provide for accurate measurements of the distance between the target and the camera.

FIG. 10C shows that, similar to the reference target 120A of FIG. 8, the target 1020A has a geometric center 140 and may include four fiducial marks 124A-124D. However, unlike the target 120A shown in FIG. 8, the target 1020A includes four ODRs 1022A-1022D, which may be constructed similarly to the ODRs 122A and 122B of the target 120A (which are discussed in greater detail in Sections G2 and J of the Detailed Description). In the embodiment of FIG. 10C, a first pair of ODRs includes the ODRs 1022A and 1022B, which are parallel to each other and each disposed essentially parallel to the xₜ axis 138. A second pair of ODRs includes the ODRs 1022C and 1022D, which are parallel to each other and each disposed essentially parallel to the yₜ axis 132. Hence, in this embodiment, each of the ODRs 1022A and 1022B of the first pair emanates orientation dependent radiation that facilitates a determination of the yaw rotation 136, while each of the ODRs 1022C and 1022D of the second pair emanates orientation dependent radiation that facilitates a determination of the pitch angle 134.

According to one embodiment, each ODR of the orthogonal pairs of ODRs shown in FIG. 10C is constructed and arranged such that one ODR of the pair has at least one detectable property that varies in an opposite manner to a similar detectable property of the other ODR of the pair. This phenomenon may be illustrated using the example discussed above in connection with FIG. 8 of the orientation dependent radiation emanated from each ODR being in the form of one or more radiation spots that move along a primary or longitudinal axis of an ODR with a rotation of the ODR about its secondary axis.

Using this example, according to one embodiment, as indicated in FIG. 10C by the oppositely directed arrows shown in the ODRs of a given pair, a given yaw rotation 136 causes a position of a radiation spot 1026A of the ODR 1022A to move to the left along the longitudinal axis of the ODR 1022A, while the same yaw rotation causes a position of a radiation spot 1026B of the ODR 1022B to move to the left along the longitudinal axis of the ODR 1022B. Similarly, as illustrated in FIG. 10C, a given pitch rotation 134 causes a position of a radiation spot 1026C of the ODR 1022C to move upward along the longitudinal axis of the ODR 1022C, while the same pitch rotation causes a position of a radiation spot 1026D of the ODR 1022D to move downward along the longitudinal axis of the ODR 1022D.

In this manner, various image processing methods according to the invention (e.g., as discussed below in Sections H and L) may obtain information relating to the pitch and yaw rotations of the reference target 1020A (and, hence, the camera bearing) by observing differential changes of position between the radiation spots 1026A and 1026B for a given yaw rotation, and between the radiation spots 1026C and 1026D for a given pitch rotation. It should be appreciated, however, that this embodiment of the invention relating to differential measurements is not limited to the foregoing example using radiation spots, and that other detectable properties of an ODR (e.g., spatial period, wavelength, polarization, various spatial patterns, etc.) may be exploited to achieve various differential effects. A more detailed example of an ODR pair in which each ODR is constructed and arranged to facilitate measurement of differential effects is discussed below in Sections G2 and J of the Detailed Description.

G2. Exemplary Orientation-Dependent Radiation Sources (ODRs)

As discussed above, according to one embodiment of the invention, an orientation-dependent radiation source (ODR) may serve as a reference object in a scene of interest (e.g., as exemplified by the ODRs 122A and 122B in the reference target 120A shown in FIG. 8). In general, an ODR emanates radiation having at least one detectable property (which is capable of being detected from an image of the ODR) that varies as a function of a rotation (or alternatively “viewing angle”) of the ODR. In one embodiment, an ODR also may emanate radiation having at least one detectable property that varies as a function of an observation distance from the ODR (e.g., a distance between the ODR and a camera obtaining an image of the ODR).

A particular example of an ODR according to one embodiment of the invention is discussed below with reference to the ODR 122A shown in FIG. 8. It should be appreciated, however, that the following discussion of concepts related to an ODR may apply similarly, for example, to the ODR 122B shown in FIG. 8, as well as to ODRs generally employed in various embodiments of the present invention.

As discussed above, the ODR 122A shown in FIG. 8 emanates orientation-dependent radiation 126A from an observation surface 128A. According to one embodiment, the observation surface 128A is essentially parallel with the front surface 121 of the reference target 120A. Additionally, according to one embodiment, the ODR 122A is constructed and arranged such that the orientation-dependent radiation 126A has at least one detectable property that varies as a finction of a rotation of the ODR 122A about the secondary axis 132 passing through the ODR 122A.

According to one aspect of this embodiment, the detectable property of the orientation-dependent radiation 126A that varies with rotation includes a position of the spatial distribution of the radiation on the observation surface 128A along the primary axis 130 of the ODR 122A. For example, FIG. 8 shows that, according to this aspect, as the ODR 122A is rotated about the secondary axis 132, the position of the spatial distribution of the radiation 126A moves from left to right or vice versa, depending on the direction of rotation, in a direction parallel to the primary axis 130 (as indicated by the oppositely directed arrows shown schematically on the observation surface 128A). According to various other aspects of this embodiment, a spatial period of the orientation-dependent radiation 126A (e.g., a distance between adjacent oval-shaped radiation spots shown in FIG. 8), a polarization of the orientation-dependent radiation 126A, and/or a wavelength of the orientation-dependent radiation 126A, may vary with rotation of the ODR 122A about the secondary axis 132.

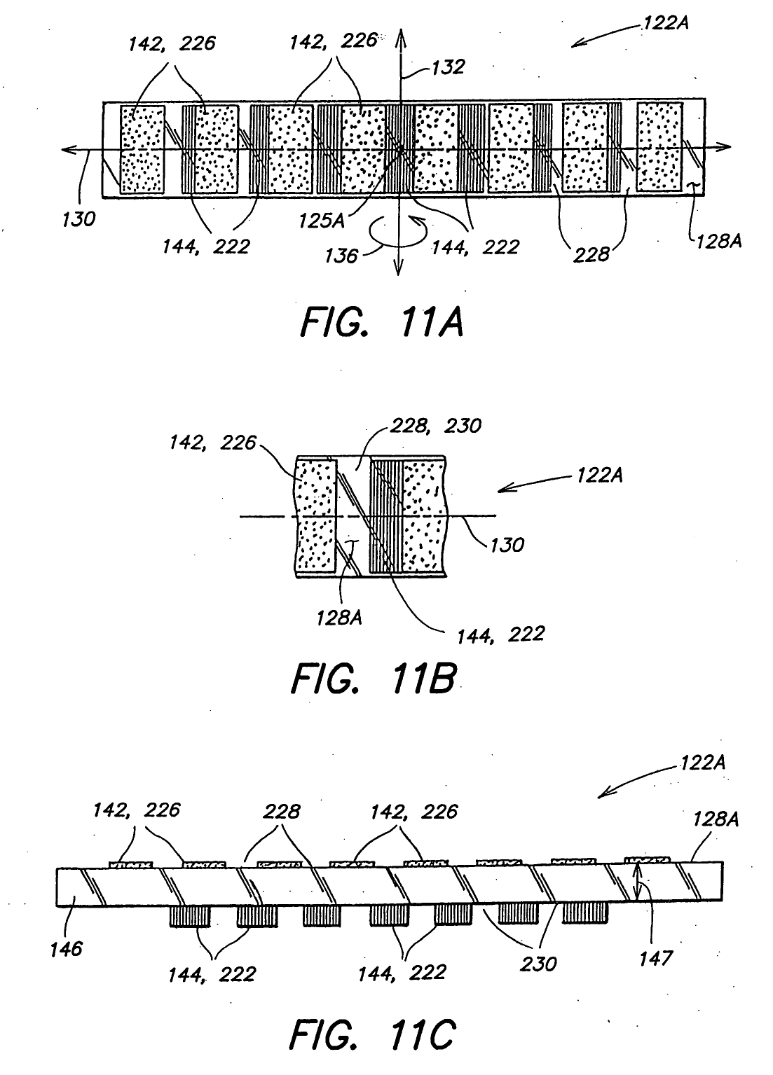

FIGS. 11A, 11B, and 11C show various views of a particular example of the ODR 122A suitable for use in the reference target 120A shown in FIG. 8, according to one embodiment of the invention. As discussed above, an ODR similar to that shown in FIGS. 11A-C also may be used as the ODR 122B of the reference target 120A shown in FIG. 8, as well as in various other embodiments of the invention. In one aspect, the ODR 122A shown in FIGS. 11A-C may be constructed and arranged as described in U.S. Pat. No. 5,936,723, entitled “Orientation Dependent Reflector,” hereby incorporated herein by reference, or may be constructed and arranged in a manner similar to that described in this reference. In other aspects, the ODR 122A may be constructed and arranged as described in U.S. patent application Ser. No. 09/317,052, filed May 24, 1999, entitled “Orientation-Dependent Radiation Source,” also hereby incorporated herein by reference, or may be constructed and arranged in a manner similar to that described in this reference. A detaied mathematical and geometric analysis and discussion of ODRs similar to that shown in FIGS. 11A-C is presented in Section J of the Detailed Description.

FIG. 11A is a front view of the ODR 122A, looking on to the observation surface 128A at a normal viewing angle (i.e., perpendicular to the observation surface), in which the primary axis 130 is indicated horizontally. FIG. 11B is an enlarged front view of a portion of the ODR 122A shown in FIG. 11A, and FIG. 11C is a top view of the ODR 122A. For purposes of this disclosure, a normal viewing angle of the ODR alternatively may be considered as a 0 degree rotation.

FIGS. 11A-11C show that, according to one embodiment, the ODR 122A includes a first grating 142 and a second grating 144. Each of the first and second gratings include substantially opaque regions separated by substantially transparent regions. For example, with reference to FIG. 11C, the first grating 142 includes substantially opaque regions 226 (generally indicated in FIGS. 11A-11C as areas filled with dots) which are separated by openings or substantially transparent regions 228. Similarly, the second grating 144 includes substantially opaque regions 222 (generally indicated in FIGS. 11A-11C by areas shaded with vertical lines) which are separated by openings or substantially transparent regions 230. The opaque regions of each grating may be made of a variety of materials that at least partially absorb, or do not fully transmit, a particular wavelength range or ranges of radiation. It should be appreciated that the particular relative arrangement and spacing of respective opaque and transparent regions for the gratings 142 and 144 shown in FIGS. 11A-11C is for purposes of illustration only, and that a number of arrangements and spacings are possible according to various embodiments of the invention.

In one embodiment, the first grating 142 and the second grating 144 of the ODR 122A shown in FIGS. 11A-11C are coupled to each other via a substantially transparent substrate 146 having a thickness 147. In one aspect of this embodiment, the ODR 122A may be fabricated using conventional semiconductor fabrication techniques, in which the first and second gratings are each formed by patterned thin films (e.g., of material that at least partially absorbs radiation at one or more appropriate wavelengths) disposed on opposite sides of the substantially transparent substrate 146. In another aspect, conventional techniques for printing on a solid body may be employed to print the first and second gratings on the substrate 146. In particular, it should be appreciated that in one embodiment, the substrate 146 of the ODR 122A shown in FIGS. 11A-11C coincides with (i.e., is the same as) the substrate 133 of the reference target 120A of FIG. 8 which includes the ODR. In one aspect of this embodiment, the first grating 142 may be coupled to (e.g., printed on) one side (e.g., the front surface 121) of the target substrate 133, and the second grating 144 may be coupled to (e.g., printed on) the other side (e.g., the rear surface 127 shown in FIG. 10) of the substrate 133. It should be appreciated, however, that the invention is not limited in this respect, as other fabrication techniques and arrangements suitable for purposes of the invention are possible.

As can be seen in FIGS. 11A-11C, according to one embodiment, the first grating 142 of the ODR 122A essentially defines the observation surface 128A. Accordingly, in this embodiment, the first grating may be referred to as a “front” grating, while the second grating may be referred to as a “back” grating of the ODR. Additionally, according to one embodiment, the first and the second gratings 142 and 144 have different respective spatial frequencies (e.g., in cycles/meter); namely either one or both of the substantially opaque regions and the substantially transparent regions of one grating may have different dimensions than the corresponding regions of the other grating. As a result of the different spatial frequencies of the gratings and the thickness 147 of the transparent substrate 146. the radiation transmission properties of the ODR 122A depends on a particular rotation 136 of the ODR about the axis 132 shown in FIG. 11A (i.e., a particular viewing angle of the ODR relative to a normal to the observation surface 128A).

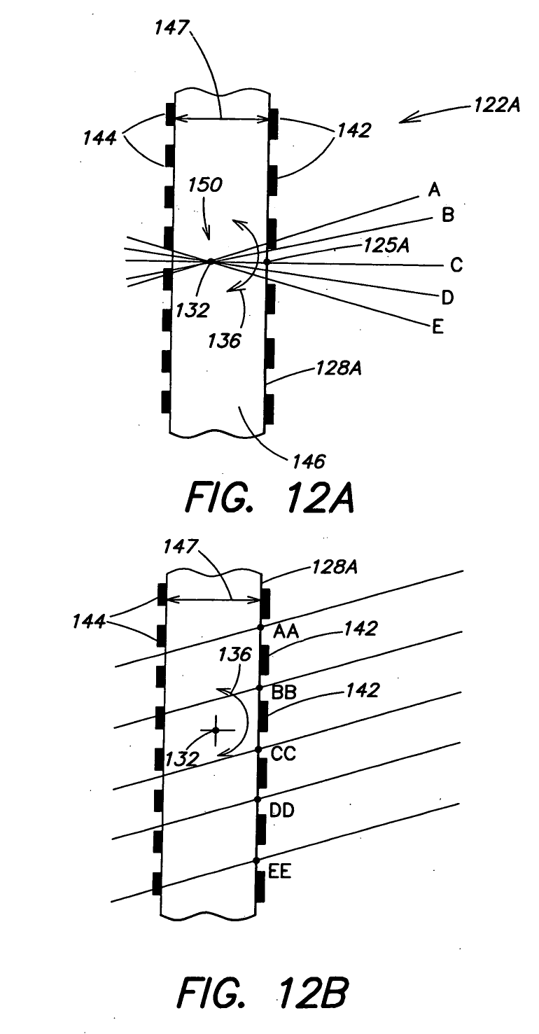

For example, with reference to FIG. 11A, at a zero degree rotation (i.e., a normal viewing angle) and given the particular arrangement of gratings shown for example in the figure, radiation essentially is blocked in a center portion of the ODR 122A, whereas the ODR becomes gradually more transmissive moving away from the center portion, as indicated in FIG. 11A by clear regions between the gratings. As the ODR 122A is rotated about the axis 132, however, the positions of the clear regions as they appear on the observation surface 128A change. This phenomenon may be explained with the assistance of FIGS. 12A and 12B, and is discussed in detail in Section J of the Detailed Description. Both FIGS. 12A and 12B are top views of a portion of the ODR 122A, similar to that shown in FIG. 11C.

In FIG. 12A, a central region 150 of the ODR 122A (e.g., at or near the reference point 125A on the observation surface 128A) is viewed from five different viewing angles with respect to a normal to the observation surface 128A, represented by the five positions A, B, C, D, and E (corresponding respectively to five different rotations 136 of the ODR about the axis 132, which passes through the central region 150 orthogonal to the plane of the figure). From the positions A and B in FIG. 12A, a “dark” region (i.e., an absence of radiation) on the observation surface 128A in the vicinity of the central region 150 is observed. In particular, a ray passing through the central region 150 from the point A intersects an opaque region on both the first grating 142 and the second grating 144. Similarly, a ray passing through the central region 150 from the point B intersects a transparent region of the first grating 142, but intersects an opaque region of the second grating 144. Accordingly, at both of the viewing positions A and B, radiation is blocked by the ODR 122A.

In contrast, from positions C and D in FIG. 12A, a “bright” region (i.e., a presence of radiation) on the observation surface 128A in the vicinity of the central region 150 is observed. In particular, both of the rays from the respective viewing positions C and D pass through the central region 150 without intersecting an opaque region of either of the gratings 142 and 144. From position E, however, a relatively less “bright” region is observed on the observation surface 128A in the vicinity of the central region 150; more specifically, a ray from the position E through the central region 150 passes through a transparent region of the first grating 142, but closely intersects an opaque region of the second grating 144, thereby partilly obscurinf some radiation.

FIG. 12B is a diagram similar to FIG. 12A showing several parallel rays of radiation, which corresponds to observing the ODR 122A from a distance (i.e., a far-field observation) at a particular viewing angle (i.e., rotation). In particular, the points AA, BB, CC, DD, and EE on the observation surface 128A correspond to points of intersection of the respective far-field parallel rays at a particular viewing angle of the observation surface 128A. From FIG. 12B, it can be seen that the surface points AA and CC would appear “brightly” illuminated (i.e., a more intense radiation presence) at this viewing angle in the far-field, as the respective parallel rays passing through these points intersect transparent regions of both the first grating 142 and the second grating 144. In contrast, the points BB and EE on the observation surface 128A would appear “dark” (i.e., no radiation) at this viewing angle, as the rays passing through these points respectively intersect an opaque region of the second grading 144. The point DD on the observation surface 128A may appear “dimly” illuminated at this viewing angle as observed in the far-field, because the ray passing through the point DD nearly intersects an opaque region of the second grating 144.

Thus, from the foregoing discussion in connection with both FIGS. 12A and 12B, it may be appreciated that each point on the observation surface 128A of the orientation-dependent radiation source 122A may appear “brightly” illuminated from some viewing angles and “dark” from other viewing angles.

According to one embodiment, the opaque regions of each of the first and second gratings 142 and 144 have an essentially rectangular shape. In this embodiment, the spatial distribution of the orientation-dependent radiation 126A observed on the observation surface 128A of the ODR 122A may be understood as the product of two square waves. In particular, the relative arrangement and different spatial frequencies of the first and second gratings produce a “Moire” pattern on the observation surface 128A that moves across the observation surface 128A as the ODR 122A is rotated about the secondary axis 132. A Moire pattern is a type of interference pattern that occurs whcn two similar repeating patterns are almost, but not quite, the same frequency, as is the case with the first and second gratings of the ADR 122A according to one embodiment of the invention.

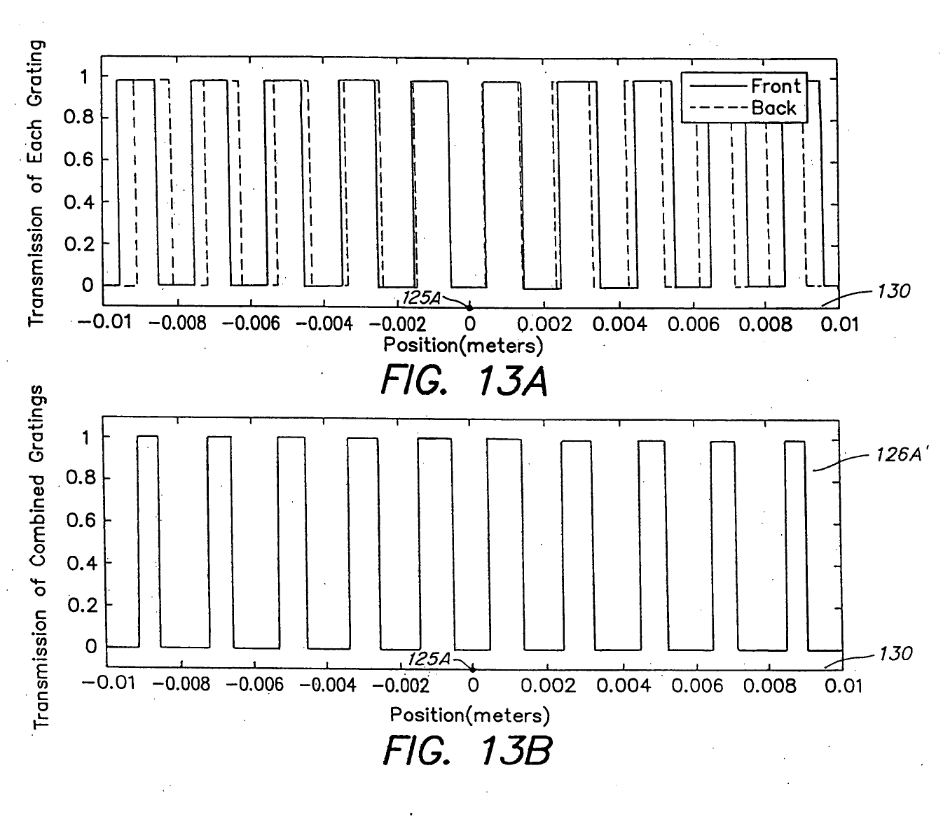

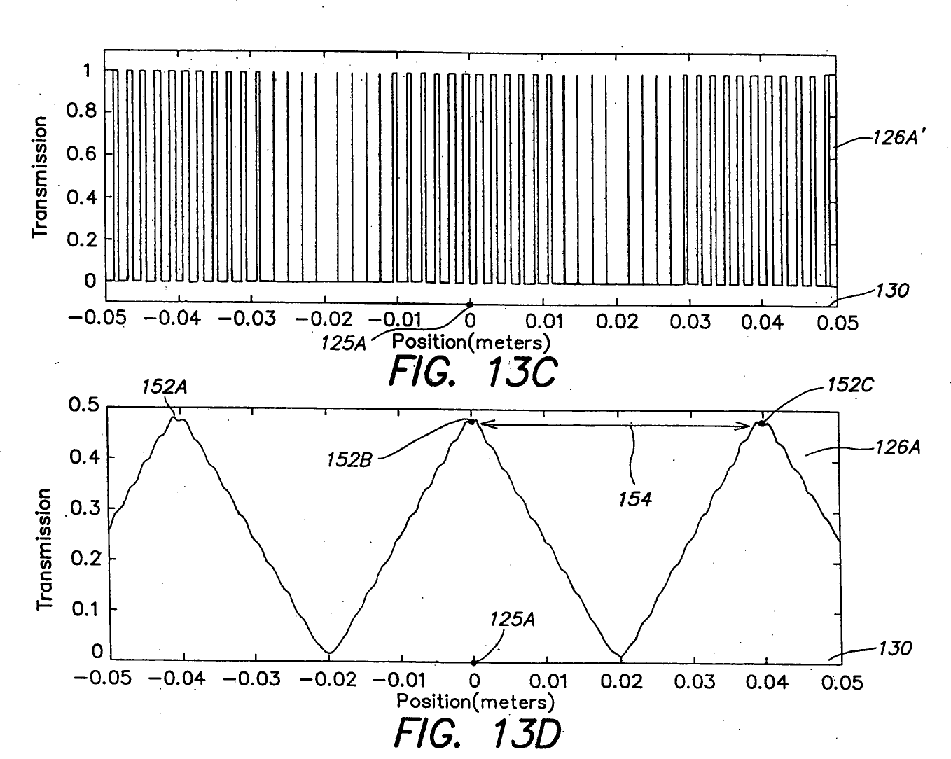

FIGS. 13A, 13B, 13C, and 13D show various graphs of transmission characteristics of the ODR 122A at a particular rotation (e.g., zero degrees, or normal viewing.) In FIGS. 13A-13D, a relative radiation transmission level is indicated on the vertical axis of each graph, while a distance (in meters) along the primary axis 130 of the ODR 122A is represented by the horizontal axis of each graph. In particular, the ODR reference point 125A is indicated at x=0 along the horizontal axis of each graph.

The graph of FIG. 13A shows two plots of radiation transmission, each plot corresponding to the transmission through one of the two gratings of the ODR 122A if the grating were used alone. In particular, the legend of the graph in FIG. 13A indicates that radiation transmission through a “front” grating is represented by a solid line (which in this example corresponds to the first grating 142) and through a “back” grating by a dashed line (which in this example corresponds to the second grating 144). In the example of FIG. 13A, the first grating 142 (i.e., the front grating) has a spatial frequency of 500 cycles per meter, and the second grating 144 (i.e., the back grating) has a spatial frequency of 525 cycles per meter. It should be appreciated, however, that the invention is not limited in this respect, and that these respective spatial frequencies of the gratings are used here for purposes of illustration only. In particular, various relationships between the front and back grating frequency may be exploited to achieve near-field and/or differential effects from ODRs, as discussed further below in this section and in Section J of the Detailed Description.

The graph of FIG. 13B represents the combined effect of the two gratings at the particular rotation shown in FIG. 13A. In particular, the graph of FIG. 13B shows a plot 126A′ of the combined transmission characteristics of the first and second gratings along the primary axis 130 of the ODR over a distance of ±0.01 meters from the ODR reference point 125A. The plot 126A′ may be considered essentially as the product of two square waves, where each square wave represents one of the first and second gratings of the ODR.

The graph of FIG. 13C shows the plot 126A′ using a broader horizontal scale than the graphs of FIGS. 13A and 13B. In particular, whereas the graphs of FIGS. 13A and 13B illustrate radiation transmission characteristics over a lateral distance along the primary axis 130 of ±0.01 meters from the ODR reference point 125A, the graph of FIG. 13C illustrates radiation transmission characteristics over a lateral distance of ±0.05 meters from the reference point 125A. Using the broader horizontal scale of FIG. 13C, it is easier to observe the Moire pattern that is generated due to the different spatial frequencies of the first (front) and second (back) gratings of the ODR 122A (shown in the graph of FIG. 13A). The Moire pattern shown in FIG. 13C is somewhat related to a pulse-width modulated signal, but differs from such a signal in that neither the boundaries nor the centers of the individual rectangular “pulses” making up the Moire pattern are perfectly periodic.

In the graph of FIG. 13D, the Moire pattern shown in the graph of FIG. 13C has been low-pass filtered (e.g., by convolution with a Gaussian having a −3 dB frequency of approximately 200 cycles/meter, as discussed in Section J of the Detailed Description) to illustrate the spatial distribution (i.e., essentially a triangular waveform) of orientation-dependent radiation 126A that is ultimately observed on the observation surface 128A of the ODR 122A. From the filtered Moire pattern, the higher concentrations of radiation on the observation surface appear as three peaks 152A, 152B, and 152C in the graph of FIG. 13D, which may be symbolically represented by three “centroids” of radiation detectable on the observation surface 128A (as illustrated for example in FIG. 8 by the three oval-shaped radiation spots). As shown in FIG. 13D, a period 154 of the triangular waveform representing the radiation 126A is approximately 0.04 meters, corresponding to a spatial frequency of approximately 25 cycles/meter (i.e., the difference between the respective front and back grating spatial frequencies).

As may be observed from FIGS. 13A-13D, one interesting attribute of the ODR 122A is that a transmission peak in the observed radiation 126A may occur at a location on the observation surface 128A that corresponds to an opaque region of one or both of the gratings 142 and 144. For example, with reference to FIG. 13B and 13C, the unfiltered Moire pattern 126A′ indicates zero transmission at x=0; however, the filtered Moire pattern 126A shown in FIG. 13D indicates a transmission peak 152B at x=0. This phenomenon is primarily a consequence of filtering; in particular, the high frequency components of the signal 126A corresponding to each of the gratings are nearly removed from the signal 126A, leaving behind an overall radiation density corresponding to a cumulative effect of radiation transmitted through a number of gratings. Even in the filtered signal 126A, however, some artifacts of the high frequency components may be observed (e.g., the small troughs or ripples along the triangular waveform in FIG. 13D.)

Additionally, it should be appreciated that the filtering characteristics (i.e., resolution) of the observation device employed to view the ODR 122A may determine what type of radiation signal is actually observed by the device. For example, a well-focussed or high resolution camera may be able to distinguish and record a radiation pattern having features closer to those illustrated in FIG. 13C. In this case, the recorded image may be filtered as discussed above to obtain the signal 126A shown in FIG. 13D. In contrast, a somewhat defocused or low resolution camera (or a human eye) may observe an image of the orientation dependent radiation closer to that shown in FIG. 13D without any filtering.

With reference again to FIGS. 11A, 12A, and 12B, as the ODR 122A is rotated about the secondary axis 132, the positions of the first and second gratings shift with respect to one another from the point of view of an observer. As a result, the respective positions of the peaks 152A-152C of the observed orientation-dependent radiation 126A shown in FIG. 13D move either to the left or to the right along the primary axis 130 as the ODR is rotated. Accordingly, in one embodiment, an orientation (i.e., a particular rotation angle about the secondary axis 132) of the ODR 122A is related to the respective positions along the observation surface 128A of one or more radiation peaks 152A-152C of the filtered Moire pattern. If particular positions of the radiation peaks 152A-152C are known a priori with respect to the ODR reference point 125A at a particular “reference” rotation or viewing angle (e.g., zero degrees, or normal viewing), then arbitrary rotations of the ODR may be determined by observing position shifts of the peaks relative to the positions of the peaks at the reference viewing angle (or, alternatively, by observing a phase shift of the triangular waveform at the reference point 125A with rotation of the ODR).

With reference to FIGS. 11A, 11C, 12A and 12B, it should be appreciated that a horizontal length of the ODR 122A along the axis 130, as well as the relative spatial frequencies of the first grating 142 and the second grating 144, may be chosen such that different numbers of peaks (other than three) in the spatial distribution of the orientation-dependent radiation 126A shown in FIG. 13D may be visible on the observation surface at various rotations of the ODR. In particular, the ODR 122A may be constructed and arranged such that only one radiation peak is detectable on the observation surface 128A of the source at any given rotation, or several peaks are detectable.

Additionally, according to one embodiment, the spatial frequencies of the first grating 142 and the second grating 144, each may be particularly chosen to result in a particular direction along the primary axis of the ODR for the change in position of the spatial distribution of the orientation-dependent radiation with rotation about the secondary axis. For example, a back grating frequency higher than a front grating frequency may dictate a first direction for the change in position with rotation, while a back grating frequency lower than a front grating frequency may dictate a second direction opposite to the first direction for the change in position with rotation. This effect may be exploited using a pair of ODRs constructed and arranged to have opposite directions for a change in position with the same rotation to facilitate differential measurements, as discussed above in Section G1 of the Detailed Description in connection with FIG. 10C.

Accordingly, it should be appreciated that the foregoing discussion of ODRs is for purposes of illustration only, and that the invention is not limited to the particular manner of implementing and utilizing ODRs as discussed above. Various effects resulting from particular choices of grating frequencies and other physical characteristics of an ODR are discussed further below in Section J of the Detailed Description.

According to another embodiment, an ODR may be constructed and arranged so as to emanate radiation having at least one detectable property that facilitates a determination of an observation distance at which the ODR is observed (e.g., the distance between the ODR reference point and the origin of a camera which obtains an image of the ODR). For example, according to one aspect of this embodiment, an ODR employed in a reference target similar to the reference target 120A shown in FIG. 9 may be constructed and arranged so as to facilitate a determination of the length of the camera bearing vector 78. More specifically, according to one embodiment, with reference to the ODR 122A illustrated in FIGS. 11A-11C, 12A, 12B and the radiation transmission characteristics shown in FIG. 13D, a period 154 of the orientation-dependent radiation 126A varies as a function of the distance from the observation surface 128A of the ODR at a particular rotation at which the ODR is observed.

In this embodiment, the near-field effects of the ODR 122A are exploited to obtain observation distance information related to the ODR. In particular, while far-field observation was discussed above in connection with FIG. 12B as observing the ODR from a distance at which radiation emanating from the ODR may be schematically represented as essentially parallel rays, near-field observation geometry instead refers to observing the ODR from a distance at which radiation emanating from the ODR is more appropriately represented by non-parallel rays converging at the observation point (e.g., the camera origin, or nodal point of the camera lens system). One effect of near-field observation geometry is to change the apparent frequency of the back grating of the ODR, based on the rotation of the ODR and the distance from which the ODR is observed. Accordingly, a change in the apparent frequency of the back grating is observed as a change in the period 154 of the radiation 126A. If the rotation of the ODR is known (e.g., based on far-field effects, as discussed above), the observation distance may be determined from the change in the period 154.

Both the far-field and near-field effects of the ODR 122A, as well as both far-field and near-field differential effects from a pair of ODRs, are analyzed in detail in Section J of the Detailed Description and the figures associated therewith. An exemplary reference target particularly designed to exploit the near-field effects of the ODR 122A is discussed above in Section G1 of the Detailed Description, in connection with FIG. 10B. An exemplary reference target particularly designed to exploit differential effects from pairs of ODRs is discussed above in Section G1 of the Detailed Description, in connection with FIG. 10C. Exemplary detection methods for detecting both far-field and near-field characteristics of one or more ODRs in an image of a scene are discussed in detail in Sections J and L of the Detailed Description and the figures associated therewith.

G3. Exemplary Fiducial Marks and Exemplary Methods for Detecting such Marks

As discussed above, one or more fiducial marks may be included in a scene of interest as reference objects for which reference information is known a priori. For example, as discussed above in Section G1 of the Detailed Description, the reference target 120A shown in FIG. 8 may include a number of fiducial marks 124A-124D, shown for example in FIG. 8 as four asterisks having known relative spatial positions on the reference target. While FIG. 8 shows asterisks as fiducial marks, it should be appreciated that a number of different types of fiducial marks are suitable for purposes of the invention according to various embodiments, as discussed further below.

In view of the foregoing, one embodiment of the invention is directed to a fiducial mark (or, more generally, a “landmark,” hereinafter “mark”) which has at least one detectable property that facilitates either manual or automatic identification of the mark in an image containing the mark: Examples of a detectable property of such a mark may include, but are not limited to, a shape of the mark (e.g., a particular polygon form or perimeter shape), a spatial pattern including a particular number of features and/or a unique sequential ordering of features (e.g., a mark having repeated features in a predetermined manner), a particular color pattern, or any combination or subset of the foregoing properties.

In particular, one embodiment of the invention is directed generally to robust landmark for machine vision (and, more specifically, robust fiducial marks in the context of image metrology applications), and methods for detecting such marks. For purposes of this disclosure, as discussed above, a “robust” mark generally refers to an object whose image has one or more detectable properties that do not change as a function of viewing angle, various camera settings, different lighting conditions, etc. In particular, according to one aspect of this embodiment, the image of a robust mark has an invariance with respect to scale or tilt; stated differently, a robust mark has one or more unique detectable properties in an image that do not change as a function of the size of the mark as it appears in the image, and/or an orientation (rotation) and position (translation) of the mark with respect to a camera (i.e., a viewing angle of the mark) as an image of a scene containing the mark is obtained. In other aspects, a robust mark preferably has one or more invariant characteristics that are relatively simple to detect in an image, that are unlikely to occur by chance in a given scene, and that are relatively unaffected by different types of general image content. These properties generally facilitate automatic identification of the mark under a wide variety of imaging conditions.

In a relatively straightforward exemplary scenario of automatic detection of a mark in an image using conventional machine vision techniques, the position and orientation of the mark relative to the camera obtaining the image may be at least approximately, if not more precisely, known. Hence, in this scenario, the shape that the mark ultimately takes in the image (e.g., the outline of the mark in the image) is also known. However, if this position and orientation, or viewing angle, of the mark is not known at the time the image is obtained, the precise shape of the mark as it appears in the image is also unknown, as this shape typically changes with viewing angle (e.g., from a particular observation point, the outline of a circle becomes an ellipse as the circle is rotated out-of-plane so that it is viewed obliquely, as discussed further below). Generally, with respect to conventional machine vision techniques, it should be appreciated that the number of unknown parameters or characteristics associated with the mark to be detected (e.g., due to an unknown viewing angle when an image of the mark is obtained) significantly impacts the complexity of the technique used to detect the mark.

Conventional machine vision is a well-developed art, and the landmark detection problem has several known and practiced conventional solutions. For example, conventional “statistical” algorithms are based on a set of characteristics (e.g., area, perimeter, first and second moments, eccentricity, pixel density, etc.) that are measured for regions in an image. The measured characteristics of various regions in the image are compared to predetermined values for these characteristics that identify the presence of a mark, and close matches are sought. Alternatively, in conventional “template matching” algorithms, a template for a mark is stored on a storage medium (e.g., in the memory of the processor 36 shown in FIG. 6), and various regions of an image are searched to seek matches to the stored template. Typically, the computational costs for such algorithms are quite high. In particular, a number of different templates may need to be stored for comparison with each region of an image to account for possibly different viewing angles of the mark relative to the camera (and hence a number of potentially different shapes for the mark as it appears in the image).

Yet other examples of conventional machine vision algorithms employ a Hough Transform, which essentially describes a mapping from image-space to shape-space. In algorithms employing the Hough Transform, the “dimensionality” of the shape-space is given by the number of parameters needed to describe all possible shapes of a mark as it might appear in an image (e.g., accounting for a variety of different possible viewing angles of the mark with respect to the camera). Generally, the Hough Transform approach is somewhat computationally less expensive than template matching algorithms.

The foregoing examples of conventional machine vision detection algorithms generally may be classified based on whether they operate on a very small region of an image (“point” algorithms), involve a scan of a portion of the image along a line or a curve (“open curve” algorithms), or evaluate a larger area region of an image (“area” algorithms). In general, the more pixels of a digital image that are evaluated by a given detection algorithm, the more robust the results are with respect to noise (background content) in the image; in particular, algorithms that operate on a greater number of pixels generally are more efficient at rejecting false positives (i.e., incorrect identifications of a mark).

For example, “point” algorithms generally involve edge operators that detect various properties of a point in an image. Due to the discrete pixel nature of digital images, point algorithms typically operate on a small region comprising 9 pixels (e.g., a 3 pixel by 3 pixel area). In these algorithms, the Hough Transform is often applied to pixels detected with an edge operator. Alternatively, in “open curve” algorithms, a one-dimensional region of the image is scanned along a line or a curve having two endpoints. In these algorithms, generally a greater number of pixels are grouped for evaluation, and hence robustness is increased over point algorithms (albeit at a computational cost). In one example of an open curve algorithm, the Hough Transform may be used to map points along the scanned line or curve into shape space. Template matching algorithms and statistical algorithms are examples of “area” algorithms, in which image regions of various sizes (e.g., a 30 pixel by 30 pixel region) are evaluated. Generally, area algorithms are more computationally expensive than point or curve algorithms.

Each of the foregoing conventional algorithms suffer to some extent if the scale and orientation of the mark that is searched for in an image are not known a priori. For example, statistical algorithms degrade because the characteristics of the mark (i.e., parameters describing the possible shapes of the mark as it appears in the image) co-vary with viewing angle, relative position of the camera and the mark, camera settings, etc. In particular, the larger the range that must be allowed for each characteristic of the mark, the greater the potential number of false-positives that are detected by the algorithm. Conversely, if the allowed range is not large enough to accommodate variations of mark characteristics due, for example, to translations and/or rotations of the mark, excessive false-negatives may result. Furthermore, as the number of unknown characteristics for a mark increases, template matching algorithms and algorithms employing the Hough Transform become intractable (i.e., the number of cases that must be tested may increase dramatically as dimensions are added to the search).

Some of the common challenges faced by conventional machine vision techniques such as those discussed above may be generally illustrated using a circle as an example of a feature to detect in an image via a template matching algorithm. With respect to a circular mark, if the distance between the circle and the camera obtaining an image of the circle is known, and there are no out-of-plane rotations (e.g., the optical axis of the camera is orthogonal to the plane of the circle), locating the circle in the image requires resolving two unknown parameters; namely, the x and y coordinates of the center of the circle (wherein an x-axis and a y-axis defines the plane of the circle). If a conventional template matching algorithm searches for such a circle by testing each x and y dimension at 100 test points in the image, for example, then 10,000 (i.e., 100²) test conditions are required to determine the x and y coordinates of the center of the circle.

However, if the distance between the circular mark and the camera is unknown, three unknown parameters are associated with the mark; namely, the x and y coordinates of the center of the circle and the radius r of the circle, which changes in the image according to the distance between the circle and the camera. Accordingly, a conventional template matching algorithm must search a three-dimensional space (x, y, and r) to locate and identify the circle. If each of these dimensions is tested by such an algorithm at 100 points, 1 million (i.e., 100³) test conditions are required.

As discussed above, if a mark is arbitrarily oriented and positioned with respect to the camera (i.e., the mark is rotated “out-of-plane” about one or both of two axes that define the plane of the mark at normal viewing, such that the mark is viewed obliquely), the challenge of finding the mark in an image grows exponentially. In general, two out-of-plane rotations are possible (i.e., pitch and yaw, wherein an in-plane rotation constitutes roll). In the particular example of the circular mark introduced above, one or more out-of-plane rotations transform the circular mark into an ellipse and rotate the major axis of the ellipse to an unknown orientation.

One consequence of such out-of-plane rotations, or oblique viewing angles, of the circular mark is to expand the number of dimensions that a conventional template matching algorithm (as well as algorithms employing the Hough Transform, for example) must search to five dimensions; namely, x and y coordinates of the center of the circle, a length of the major axis of the elliptical image of the rotated circle, a length of the minor axis of the elliptical image of the rotated circle, and the rotation of the major axis of the elliptical image of the rotated circle. The latter three dimensions or parameters correspond via a complex mapping to a pitch rotation and a yaw rotation of the circle, and the distance between the camera and the circle. If each of these five dimensions is tested by a conventional template matching algorithm at 100 points, 10 billion (i.e., 100⁵) test conditions are required. Accordingly, it should be appreciated that with increased dimensionality (i.e., unknown parameters or characteristics of the mark), the conventional detection algorithm quickly may become intractable; more specifically, in the current example, testing 100⁵ templates likely is impractical for many applications, particularly from a computational cost standpoint.

Conventional machine vision algorithms often depend on properties of a feature to be detected that are invariant over a set of possible presentations of the feature (e.g., rotation, distance, etc). For example, with respect to the circular mark discussed above, the property of appearing as an ellipse is an invariant property at least with respect to viewing the circle at an oblique viewing angle. However, this property of appearing as an ellipse may be quite complex to detect, as illustrated above.

In view of the foregoing, one aspect of the present invention relates to various robust marks that overcome some of the challenges discussed above. In particular, according to one embodiment, a robust mark has one or more detectable properties that significantly facilitate detection of the mark in an image essentially irrespective of the image contents (i.e., the mark is detectable in an image having a wide variety of arbitrary contents), and irrespective of position and/or orientation of the mark relative to the camera (i.e., the viewing angle). Additionally, according to other aspects, such marks have one or more detectable properties that do not change as a function of the size of the mark as it appears in the image and that are very unlikely to occur by chance in an image, given the possibility of a variety of imaging conditions and contents.

According to one embodiment of the invention, one or more translation and/or rotation invariant topological properties of a robust mark are particularly exploited to facilitate detection of the mark in an image. According to another embodiment of the invention, such properties are exploited by employing detection algorithms that detect a presence (or absence) of the mark in an image by scanning at least a portion of the image along a scanning path (e.g., an open line or curve) that traverses a region of the image having a region area that is less than or equal to a mark area (i.e., a spatial extent) of the mark as it appears in the image, such that the scanning path falls within the mark area if the scanned region contains the mark. In this embodiment, all or a portion of the image may be scanned such that at least one such scanning path in a series of successive scans of different regions of the image traverses the mark and falls within the spatial extent of the mark as it appears in the image (i.e., the mark area).

According to another embodiment of the invention, one or more translation and/or rotation invariant topological properties of a robust mark are exploited by employing detection algorithms that detect a presence (or absence) of the mark in an image by scanning at least a portion of the image in an essentially closed path. For purposes of this disclosure, an essentially closed path refers to a path having a starting point and an ending point that are either coincident with one another, or sufficiently proximate to one another such that there is an insignificant linear distance between the starting and ending points of the path, relative to the distance traversed along the path itself. For example, in one aspect of this embodiment, an essentially closed path may have a variety of arcuate or spiral forms (e.g., including an arbitrary curve that continuously winds around a fixed point at an increasing or decreasing distance). In yet another aspect, an essentially closed path may be an elliptical or circular path.

In yet another aspect of this embodiment, as discussed above in connection with methods of the invention employing open line or curve scanning, an essentially closed path is chosen so as to traverse a region of the image having a region area that is less than or equal to a mark area (i.e., a spatial extent) of the mark as it appears in the image. In this aspect, all or a portion of the image may be scanned such that at least one such essentially closed path in a series of successive scans of different regions of the image traverses the mark and falls within the spatial extent of the mark as it appears in the image. In a particular example of this aspect, the essentially closed path is a circular path, and a radius of a circular path is selected based on the overall spatial extent or mark area (e.g., a radial dimension from a center) of the mark to be detected as it appears in the image.

In one aspect, detection algorithms according to various embodiments of the invention analyze a digital image that contains at least one mark and that is stored on a storage medium (e.g., the memory of the processor 36 shown in FIG. 6). In this aspect, the detection algorithm analyzes the stored image by sampling a plurality of pixels disposed in the scanning path. More generally, the detection algorithm may successively scan a number of different regions of the image by sampling a plurality of pixels disposed in a respective scanning path for each different region. Additionally, it should be appreciated that according to some embodiments, both open line or curve as well as essentially closed path scanning techniques may be employed, alone or in combination, to scan an image. Furthermore, some invariant topological properties of a mark according to the present invention may be exploited by one or more of various point and area scanning methods, as discussed above, in addition to, or as an alternative to, open line or curve and/or essentially closed path scanning methods.

According to one embodiment of the invention, a mark generally may include two or more separately identifiable features disposed with respect to each other such that when the mark is present in an image having an arbitrary image content, and at least a portion of the image is scanned along either an open line or curve or an essentially closed path that traverses each separately identifiable features of the mark, the mark is capable of being detected at an oblique viewing angle with respect to a normal to the mark ofat least 15 degrees. In particular, according to various embodiments of the invention, a mark may be detected at any viewing angle at which the number of separately identifiable regions of the mark can be distinguished (e.g., any angle less than 90 degrees). More specifically, according to one embodiment, the separately identifiable features of a mark are disposed with respect to each other such that the mark is capable of being detected at an oblique viewing angle with respect to a normal to the mark of at least 25 degrees. In one aspect of this embodiment, the separately identifiable features are disposed with respect to each other such that the mark is capable of being detected at an oblique viewing angle of at least 30 degrees. In yet another aspect, the separately identifiable features are disposed with respect to each other such that the mark is capable of being detected at an oblique viewing angle of at least 45 degrees. In yet another aspect, the separately identifiable features are disposed with respect to each other such that the mark is capable of being detected at an oblique viewing angle of at least 60 degrees.

One example of an invariant topological property of a mark according to one embodiment of the invention includes a particular ordering of various regions or features, or an “ordinal property,” of the mark. In particular, an ordinal property of a mark refers to a unique sequential order of at least three separately identifiable regions or features that make up the mark which is invariant at least with respect to a viewing angle of the mark, given a particular closed sampling path for scanning the mark.

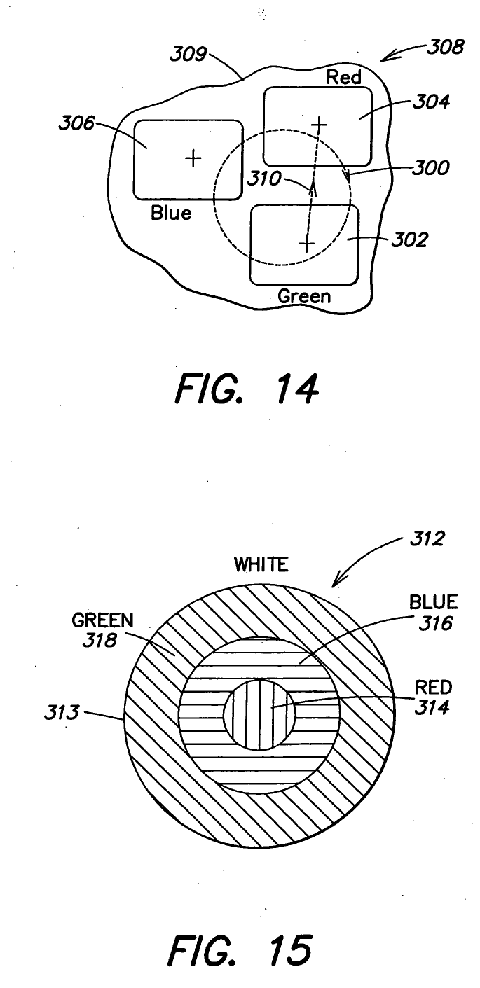

FIG. 14 illustrates one example of a mark 308 that has at least an invariant ordinal property, according to one embodiment of the invention. It should be appreciated, however, that marks having invariant ordinal as well as other topological properties according to other embodiments of the invention are not limited to the particular exemplary mark 308 shown in FIG. 14. The mark 308 includes three separately identifiable differently colored regions 302 (green), 304 (red), and 306 (blue), respectively disposed with in a general mark area or spatial extent 309. FIG. 14 also shows an example of a scanning path 300 used to scan at least a portion of an image for the presence of the mark 308. The scanning path 300 is formed such that it falls within the mark area 309 when a portion of the image containing the mark 308 is scanned. While the scanning path 300 is shown in FIG. 14 as an essentially circular path, it should be appreciated that the invention is not limited in this respect; in particular, as discussed above, according to other embodiments, the scanning path 300 in FIG. 14 may be either an open line or curve or an essentially closed path that falls within the mark area 309 when a portion of the image containing the mark 308 is scanned.

In FIG. 14, the blue region 306 of the mark 308 is to the left of a line 310 between the green region 302 and the red region 304. It should be appreciated from the figure that the blue region 306 will be on the left of the line 310 for any viewing angle (i.e., normal or oblique) of the mark 308. According to one embodiment, the ordinal property of the mark 308 may be uniquely detected by a scan along the scanning path 300 in either a clockwise or counter-clockwise direction. In particular, a clockwise scan along the path 300 would result in an order in which the green region always preceded the blue region, the blue region always preceded the red region, and the red region always preceded the green region (e.g., green-blue-red, blue-red-green, or red-green-blue). In contrast, a counter-clockwise scan along the path 300 would result in an order in which green always preceded red, red always preceded blue, and blue always preceded green. In one aspect of this embodiment, the various regions of the mark 308 may be arranged such that for a grid of scanning paths that are sequentially used to scan a given image (as discussed further below), there would be at least one scanning path that passes through each of the regions of the mark 308.

Another example of an invariant topological property of a mark according to one embodiment of the invention is an “inclusive property” of the mark. In particular, an inclusive property of a mark refers to a particular arrangement of a number of separately identifiable regions or features that make up a mark, wherein at least one region or feature is completely included within the spatial extent of another region or feature. Similar to marks having an ordinal property, inclusive marks are particularly invariant at least with respect to viewing angle and scale of the mark.

FIG. 15 illustrates one example of a mark 312 that has at least an invariant inclusive property, according to one embodiment of the invention. It should be appreciated, however, that marks having invariant inclusive as well as other topological properties according to other embodiments of the invention are not limited to the particular exemplary mark 312 shown in FIG. 15. The mark 312 includes three separately identifiable differently colored regions 314 (red), 316 (blue), and 318 (green), respectively, disposed within a mark area or spatial extent 313. As illustrated in FIG. 15, the blue region 316 completely surrounds (i.e., includes) the red region 314, and the green region 318 completely surrounds the blue region 316 to form a multi-colored bulls-eye-like pattern. While not shown explicitly in FIG. 15, it should be appreciated that in other embodiments of inclusive marks according to the invention, the boundaries of the regions 314, 316, and 318 need not necessarily have a circular shape, nor do the regions 314, 316, and 318 need to be contiguous with a neighboring region of the mark. Additionally, while in the exemplary mark 312 the different regions are identifiable primarily by color, it should be appreciated that other attributes of the regions may be used for identification (e.g., shading or gray scale, texture or pixel density, different types of hatching such as diagonal lines or wavy lines, etc.)

Marks having an inclusive property such as the mark 312 shown in FIG. 15 may not always lend themselves to detection methods employing a circular path (i.e., as shown in FIG. 14 by the path 300) to scan portions of an image, as it may be difficult to ensure that the circular path intersects each region of the mark when the path is centered on the mark (discussed fuirther below). However, given a variety of possible overall shapes for a mark having an inclusive property, as well as a variety of possible shapes (e.g., other than circular) for an essentially closed path or open line or curve path to scan a portion of an image, detection methods employing a variety of scanning paths other than circular paths may be suitable to detect the presence of an inclusive mark according to some embodiments of the invention. Additionally, as discussed above, other scanning methods employing point or area techniques may be suitable for detecting the presence of an inclusive mark.

Yet another example of an invariant topological property of a mark according to one embodiment of the invention includes a region or feature count, or “cardinal property,” of the mark. In particular, a cardinal property of a mark refers to a number N of separately identifiable regions or features that make up the mark which is invariant at least with respect to viewing angle. In one aspect, the separately identifiable regions or features of a mark having an invariant cardinal property are arranged with respect to each other such that each region or feature is able to be sampled in either an open line or curve or essentially closed path that lies entirely within the overall mark area (spatial extent) of the mark as it appears in the image.

In general, according to one embodiment, for marks that have one or both of a cardinal property and an ordinal property, the separately identifiable regions or features of the mark may be disposed with respect to each other such that when the mark is scanned in a scanning path enclosing the center of the mark (e.g., an arcuate path, a spiral path, or a circular path centered on the mark and having a radius less than the radial dimension of the mark), the path traverses a significant dimension (e.g., more than one pixel) of each separately identifiable region or feature of the mark. Furthermore, in one aspect, each of the regions or features of a mark having an invariant cardinal and/or ordinal property may have similar or identical geometric characteristics (e.g., size, shape); alternatively, in yet another aspect, two or more of such regions or features may have different distinct characteristics (e.g., different shapes and/or sizes). In this aspect, distinctions between various regions or features of such a mark may be exploited to encode information into the mark. For example, according to one embodiment, a mark having a particular unique identifying feature not shared with other marks may be used in a reference target to distinguish the reference target from other targets that may be employed in an image metrology site survey, as discussed further below in Section I of the Detailed Description.

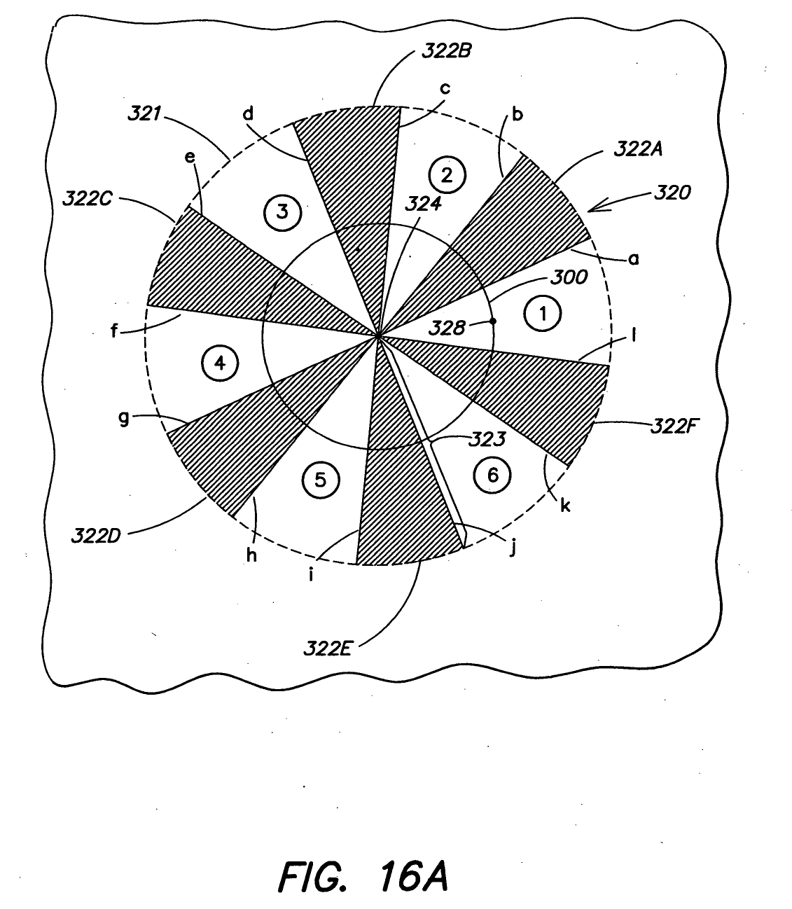

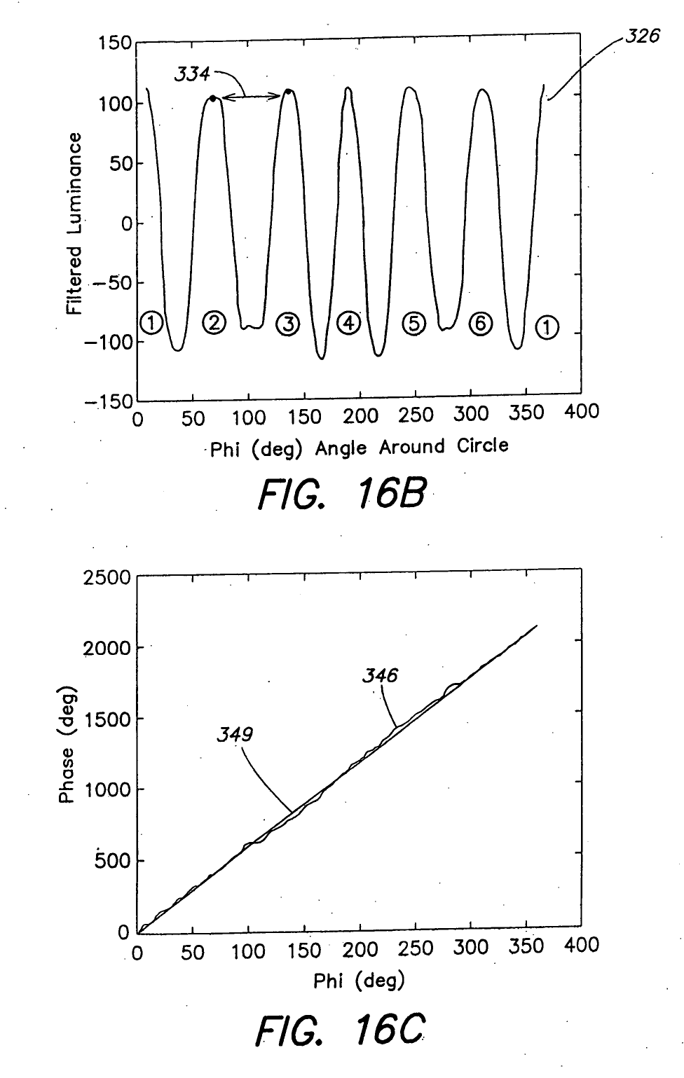

FIG. 16A illustrates one example of a mark 320 that is viewed normally and that has at least an invariant cardinal property, according to one embodiment of the invention. It should be appreciated, however, that marks having invariant cardinal as well as other topological properties according to other embodiments of the invention are not limited to the particular exemplary mark 320 shown in FIG. 16A. In this embodiment, the mark 320 includes at least six separately identifiable two-dimensional regions 322A-322F (i.e., N=6) that each emanates along a radial dimension 323 from a common area 324 (e.g., a center) of the mark 320 in a spoke-like configuration. In FIG. 16A, a dashed-line perimeter outlines the mark area 321 (i.e., spatial extent) of the mark 320. While FIG. 16A shows six such regions having essentially identical shapes and sizes disposed essentially symmetrically throughout 360 degrees about the common area 324, it should be appreciated that the invention is not limited in this respect; namely, in other embodiments, the mark may have a different number N of separately identifiable regions, two or more regions may have different shapes and/or sizes, and/or the regions may be disposed asymmetrically about the common area 324.

In addition to the cardinal property of the exemplary mark 320 shown in FIG. 16A (i.e., the number N of separately identifiable regions), the mark 320 may be described in terms of the perimeter shapes of each of the regions 322A-322F and their relationship with one another. For example, as shown in FIG. 16A, in one aspect of this embodiment, each region 322A-322F has an essentially wedge-shaped perimeter and has a tapered end which is proximate to the common area 324. Additionally, in another aspect, the perimeter shapes of regions 322A-322F are capable of being collectively represented by a plurality of intersecting edges which intersect at the center or common area 324 of the mark. In particular, it may be observed in FIG. 16A that lines connecting points on opposite edges of opposing regions must intersect at the common area 324 of the mark 320. Specifically, as illustrated in FIG. 16A, starting from the point 328 indicated on the circular path 300 and proceeding counter-clockwise around the circular path, each edge of a wedge-shaped region of the mark 320 is successively labeled with a lower case letter, from a to l. It may be readily seen from FIG. 16A that each of the lines connecting the edges a-g, b-h, c-i, d-j, etc., pass through the common area 324. This characteristic of the mark 320 is exploited in a detection algorithm according to one embodiment of the invention employing an “intersecting edges anaiysis,” as discussed in greater detail in Section K of the Detailed Description.

As discussed above, the invariant cardinal property of the mark 320 shown in FIG. 16A is the number N of the regions 320A-320F making up the mark (i.e., N=6 in this example). More specifically, in this embodiment, the separately identifiable two-dimensional regions of the mark 320 are arranged to create alternating areas of different radiation luminance as the mark is scanned along the scanning path 300, shown for example in FIG. 16A as a circular path that is approximately centered around the common area 324. Stated differently, as the mark is scanned along the scanning path 300, a significant dimension of each region 322A-322F is traversed to generate a scanned signal representing an alternating radiation luminance. At least one property of this alternating radiation luminance, namely a total number of cycles of the radiation luminance, is invariant at least with respect to viewing angle, as well as changes of scale (i.e., observation distance from the mark), in-plane rotations of the mark, lighting conditions, arbitrary image content, etc., as discussed further below.

FIG. 16B is a graph showing a plot 326 of a luminance curve (i.e., a scanned signal) that is generated by scanning the mark 320 of FIG. 16A along the scanning path 300, starting from the point 328 shown in FIG. 16A and proceeding counter-clockwise (a similar luminance pattern would result from a clockwise scan). In FIG. 16A, the lighter areas between the regions 322A-322F are respectively labeled with encircled numbers 1-6, and each corresponds to a respective successive half-cycle of higher luminance shown in the plot 326 of FIG. 16B. In particular, for the six region mark 320, the luminance curve shown in FIG. 16B has six cycles of alternating luminance over a 360 degree scan around the path 300, as indicated in FIG. 16B by the encircled numbers 1-6 corresponding to the lighter areas between the regions 322A-322F of the mark 320.

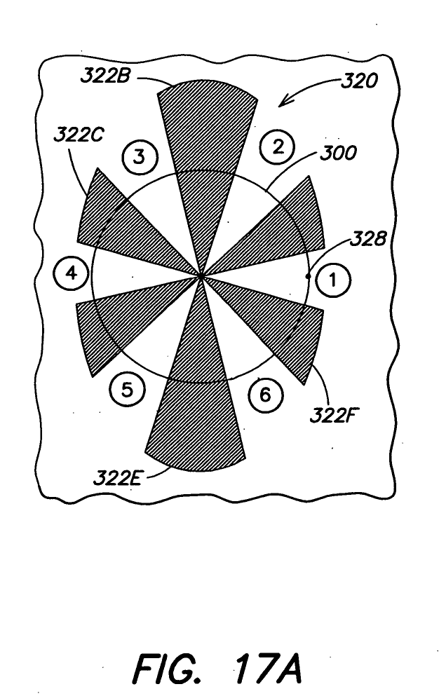

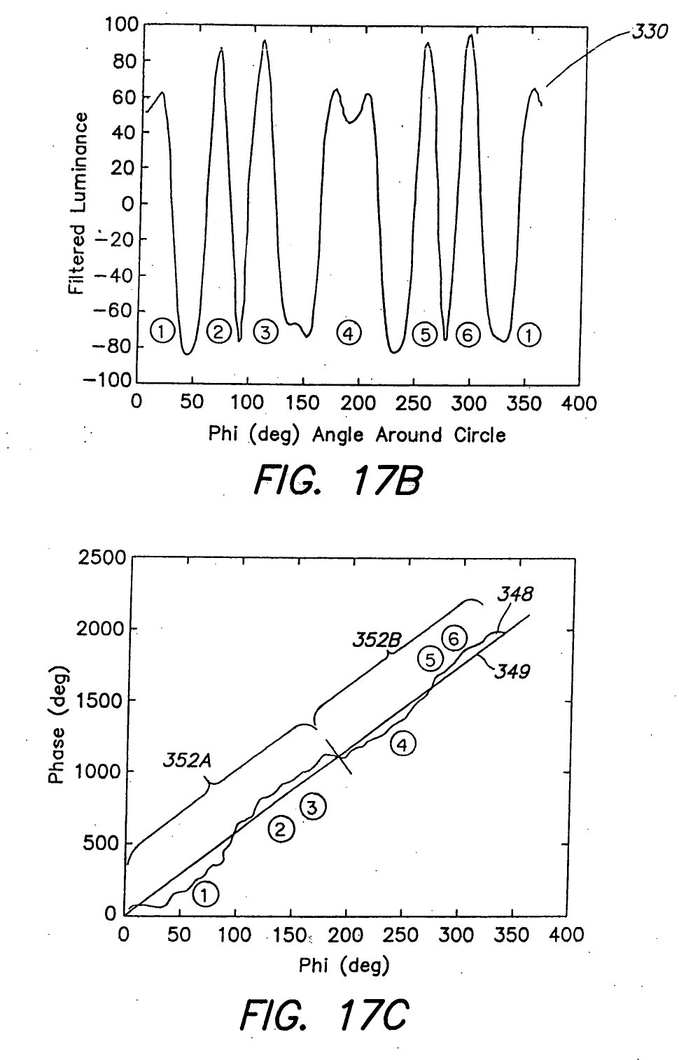

While FIG. 16A shows the mark 320 at essentially a normal viewing angle, FIG. 17A shows the same mark 320 at an oblique viewing angle of approximately 60 degrees off-normal. FIG. 17B is a graph showing a plot 330 of a luminance curve (i.e., a scanned signal) that is generated by scanning the obliquely imaged mark 320 of FIG. 17A along the scanning path 300, in a manner similar to that discussed above in connection with FIGS. 16A and 16B. From FIG. 17B, it is still clear that there are six cycles of alternating luminance over a 360 degree scan around the path 300, although the cycles are less regularly spaced than those illustrated in FIG. 16B.

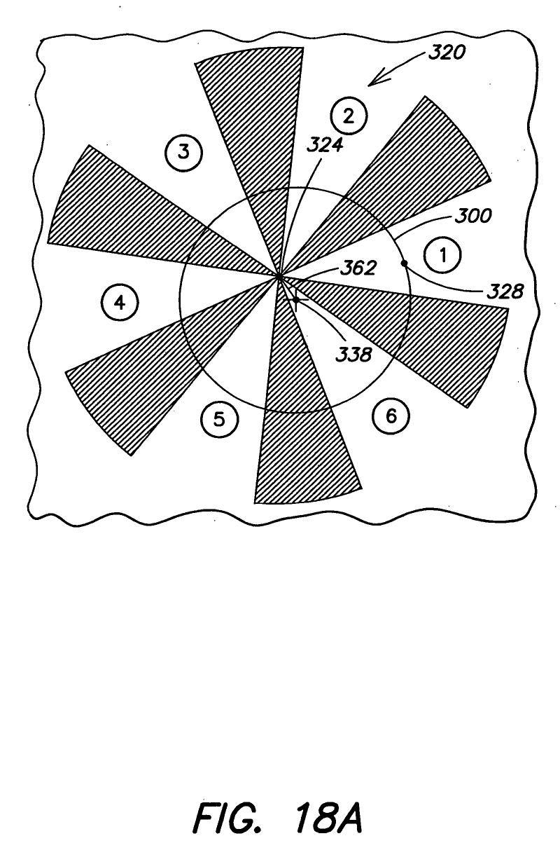

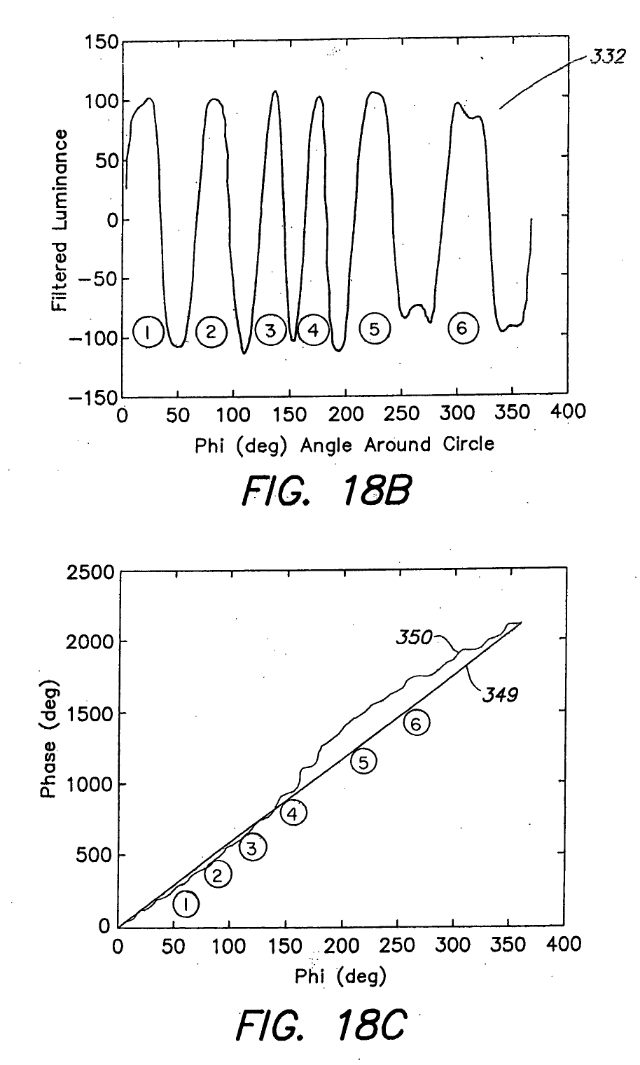

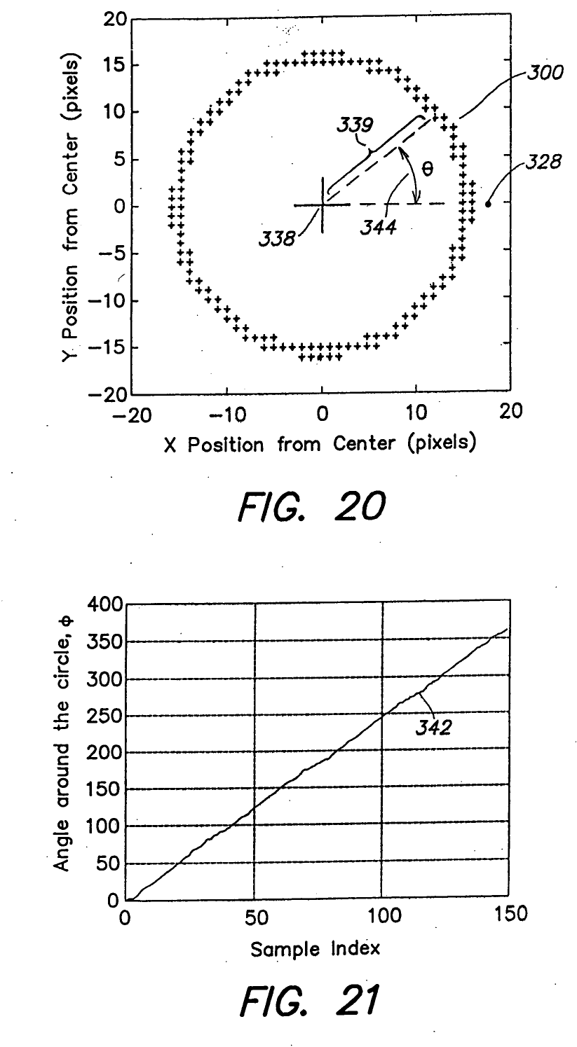

FIG. 18A shows the mark 320 again at essentially a normal viewing angle, but translated with respect to the scanning path 300; in particular, in FIG. 18A, the path 300 is skewed off-center from the common area 324 of the mark 320 by an offset 362 between the common area 324 and a scanning center 338 of the path 300 (discussed further below in connection with FIG. 20). FIG. 18B is a graph showing a plot 332 of a luminance curve (i.e., a scanned signal) that is generated by scanning the mark 320 of FIG. 18A along the skewed closed path 300, in a manner similar to that discussed above in connection with FIGS. 16A, 16B, 17A, and 17B. Again, from FIG. 18B, it is still clear that, although the cycles are less regular, there are six cycles of alternating luminance over a 360 degree scan around the path 300.

In view of the foregoing, it should be appreciated that once the cardinal property of a mark is selected (i.e., the number N of separately identifiable regions of the mark is known a priori), the number of cycles of the luminance curve generated by scanning the mark along the scanning path 300 (either clockwise or counter-clockwise) is invariant with respect to rotation and/or translation of the mark; in particular, for the mark 320 (i.e., N=6), the luminance curve (i.e., the scanned signal) includes six cycles of alternating luminance for any viewing angle at which the N regions can be distinguished (e.g., any angle less than 90 degrees) and translations of the mark relative to the path 300 (provided that the path 300 lies entirely within the mark). Hence, an automated feature detection algorithm according to one embodiment of the invention may employ open line or curve and/or essentially closed path (i.e., circular path) scanning and use any one or more of a variety of signal recovery techniques (as discussed further below) to reliably detect a signal having a known number of cycles per scan from a scanned signal based at least on a cardinal property of a mark to identify the presence (or absence) of the mark in an image under a variety of imaging conditions.

According to one embodiment of the invention, as discussed above, an automated feature detection algorithm for detecting a presence of a mark having a mark area in an image includes scanning at least a portion of the image along a scanning path to obtain a scanned signal, wherein the scanning path is formed such that the scanning path falls entirely within the mark area if the scanned portion of the image contains the mark, and determining one of the presence and an absence of the mark in the scanned portion of the image from the scanned signal. In one aspect of this embodiment, the scanning path may be an essentially closed path. In another aspect of this embodiment, a number of different regions of a stored image are successively scanned, each in a respective scanning path to obtain a scanned signal. Each scanned signal is then respectively analyzed to determine either the presence or absence of a mark, as discussed further below and in greater detail in Section K of the Detailed Description.

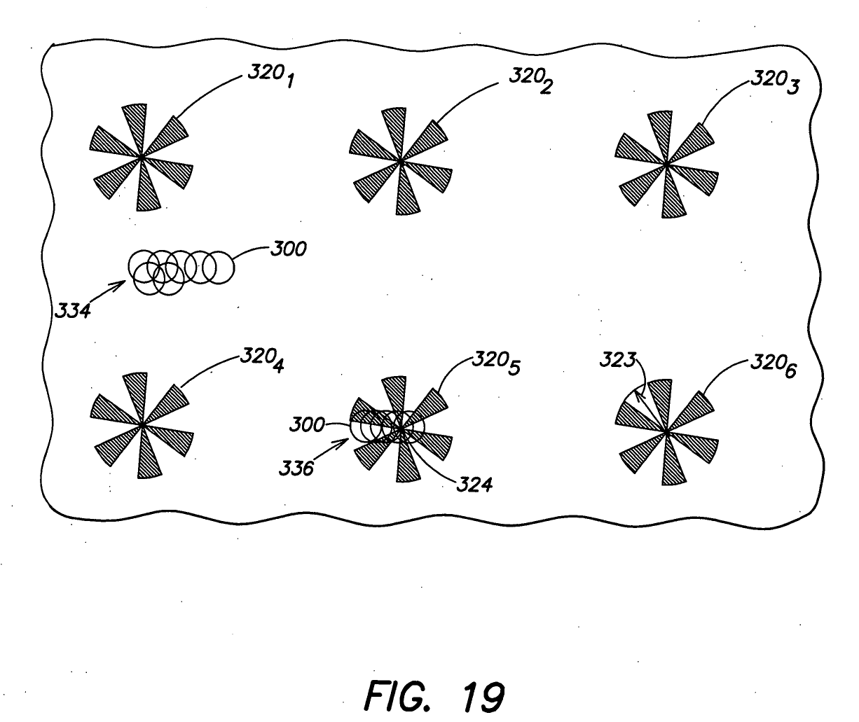

FIG. 19 is a diagram showing an image that contains six marks 320₁ through 320₆, each mark similar to the mark 320 shown in FIG. 16A. In FIG. 19, a number of circular paths 300 are also illustrated as white outlines superimposed on the image. In particular, a first group 334 of circular paths 300 is shown in a left-center region of the image of FIG. 19. More specifically, the first group 334 includes a portion of two horizontal scanning rows of circular paths, with some of the paths in one of the rows not shown so as to better visualize the paths. Similarly, a second group 336 of circular paths 300 is also shown in FIG. 19 as white outlines superimposed over the mark 320₅ in the bottom-center region of the image. From the second group 336 of paths 300, it may be appreciated that the common area or center 324 of the mark 320₅ falls within a number of the paths 300 of the second group 336.

Accordingto one embodiment, a stored digital image containing one or more marks may be successively scanned over a plurality of different regions using a number of respective circular paths 300. For example, with the aid of FIG. 19, it may be appreciated that according to one embodiment, the stored image may be scanned using a number of circular paths, starting at the top left-hand corner of the image, proceeding horizontally to the right until the right-most extent of the stored image, and then moving down one row and continuing the scan from either left to right or right to left. In this manner, a number of successive rows of circular paths may be used to scan through an entire image to determine the presence or absence of a mark in each region. In general, it should be appreciated that a variety of approaches for scanning all or one or more portions of an image using a succession of circular paths is possible according to various embodiments of the invention, and that the specific implementation described above is provided for purposes of illustration only. In particular, according to other embodiments, it may be sufficient to scan less than an entire stored image to determine the presence or absence of marks in the image.

For purposes of this disclosure, a “scanning center” is a point in an image to be tested for the presence of a mark. In one embodiment of the invention as shown in FIG. 19, a scanning center corresponds to a center of a circular sampling path 300. In particular, at each scanning center, a collection of pixels disposed in the circular path are tested. FIG. 20 is a graph showing a plot of individual pixels that are tested along a circular sampling path 300 having a scanning center 338. In the example of FIG. 20, 148 pixels each having a radius of approximately 15.5 pixels from the scanning center 338 are tested. It should be appreciated, however, that the arrangement and number of pixels sampled along the path 300 shown in FIG. 20 are shown for purposes of illustration only, and that the invention is not limited to the example shown in FIG. 20.

In particular, according to one embodiment of the invention, a radius 339 of the circular path 300 from the scanning center 338 is a parameter that may be predetermined (fixed) or adjustable in a detection algorithm according to one embodiment of the invention. In particular, according to one aspect of this embodiment, the radius 339 of the path 300 is less than or equal to approximately two-thirds of a dimension in the image corresponding to the overall spatial extent of the mark or marks to be detected in the image. For example, with reference again to FIG. 16A, a radial dimension 323 is shown for the mark 320, and this radial dimension 323 is likewise indicated for the mark 320₆ in FIG. 19. According to one embodiment, the radius 339 of the circular paths 300 shown in FIG. 19 (and similarly, the path shown in FIG. 20) is less than or equal to approximately two-thirds of the radial dimension 323. From the foregoing, it should be appreciated that the range of possible radii 339 for various paths 300, in terms of numbers of pixels between the scanning center 338 and the path 300 (e.g., as shown in FIG. 20), is related at least in part to the overall size of a mark (e.g., a radial dimension of the mark) as it is expected to appear in an image. In particular, in a detection algorithm according to one embodiment of the invention, the radius 339 of a given circular scanning path 300 may be adjusted to account for various observation distances between a scene containing the mark and a camera obtaining an image of the scene.

FIG. 20 also illustrates a sampling angle 344 (φ), which indicates a rotation from a scanning reference point (e.g., the starting point 328 shown in FIG. 20) of a particular pixel being sampled along the path 300. Accordingly, it should be appreciated that the sampling angle φ ranges from zero degrees to 360 degrees for each scan along a circular path 300. FIG. 21 is a graph of a plot 342 showing the sampling angle φ (on the vertical axis of the graph) for each sampled pixel (on the horizontal axis of the graph) along the circular path 300. From FIG. 21, it may be seen that, due to the discrete pixel nature of the scanned image, the graph of the sampling angle φ is not uniform as the sampling progresses around the circular path 300 (i.e., the plot 342 is not a straight line between zero degrees and 360 degrees). Again, this phenomenon is an inevitable consequence of the circular path 300 being mapped on to a rectangular grid of pixels.

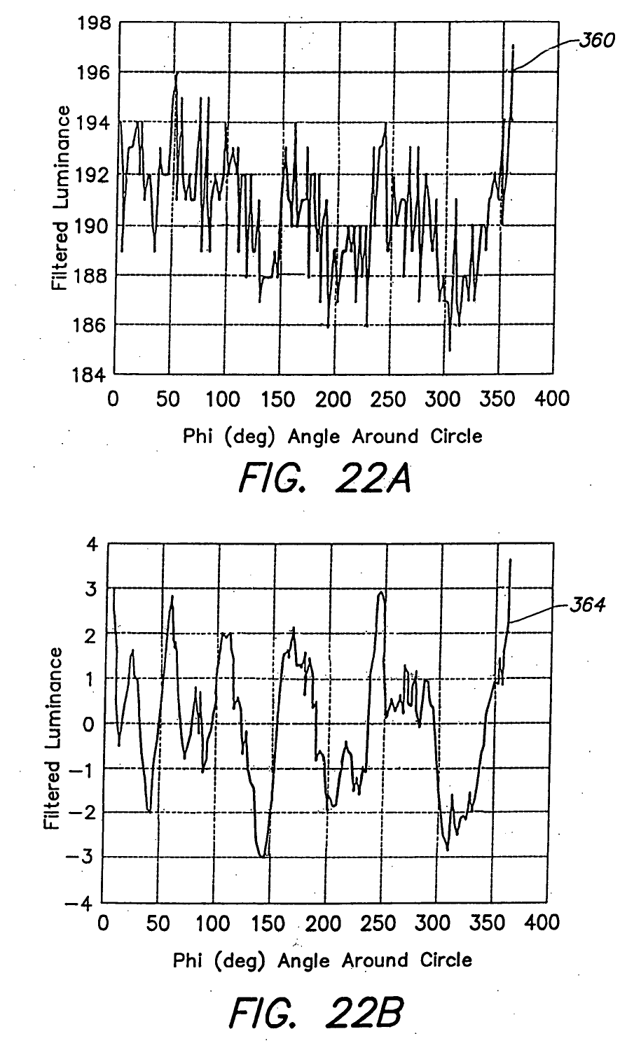

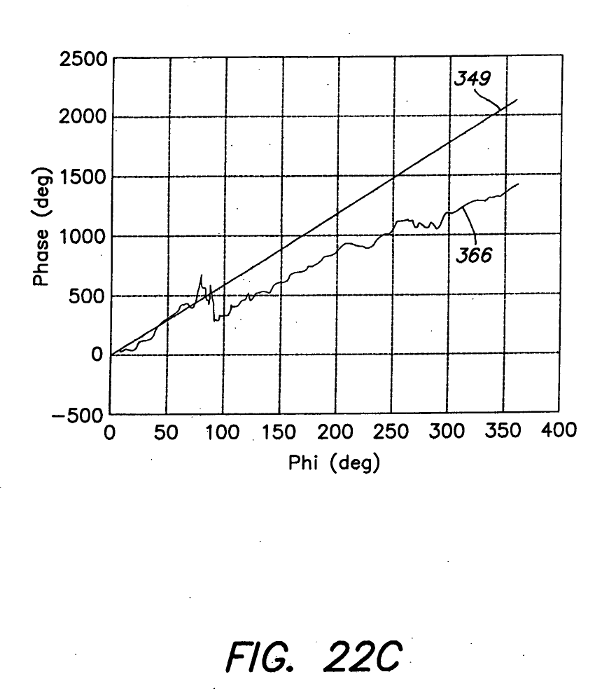

With reference again to FIG. 19, as pixels are sampled along a circular path that traverses each separately identifiable region or feature of a mark (i.e., one or more of the circular paths shown in the second group 336 of FIG. 19), a scanned signal may be generated that represents a luminance curve having a known number of cycles related to a cardinal property of the mark, similar to that shown in FIGS. 16B, 17B, and 18B. Alternatively, as pixels are sampled along a circular path that lies in regions of an image that do not include a mark, a scanned signal may be generated that represents a luminance curve based on the arbitrary contents of the image in the scanned region. For example, FIG. 22B is a graph showing a plot 364 of a filtered scanned signal representing a luminance curve in a scanned region of an image of white paper having an uneven surface (e.g., the region scanned by the first group 334 of paths shown in FIG. 19). As discussed further below, it may be appreciated from FIG. 22B that a particular number of cycles is not evident in the random signal.

As can be seen, however, from a comparison of the luminance curves shown in FIGS. 16B, 17B, and 18B, in which a particular number of cycles is evident in the curves, both the viewing angle and translation of the mark 320 relative to the circular path 300 affects the “uniformity” of the luminance curve. For purposes of this disclosure, the term “uniformity” refers to the constancy or regularity of a process that generates a signal which may include some noise statistics. One example of a uniform signal is a sine wave having a constant frequency and amplitude. In view of the foregoing, it can be seen from FIG. 16B that the luminance curve obtained by circularly scanning the normally viewed mark 320 shown in FIG. 16A (i.e., when the path 300 is essentially centered about the common area 324) is essentially uniform, as a period 334 between two consecutive peaks of the luminance curve is approximately the same for each pair of peaks shown in FIG. 16B. In contrast, the luminance curve of FIG. 17B (obtained by circularly scanning the mark 320 at an oblique viewing angle of approximately 60 degrees) as well as the luminance curve of FIG. 18B (where the path 300 is skewed off-center from the common area 324 of the mark by an offset 362) is non-uniform, as the regularity of the circular scanning process is disrupted by the rotation or the translation of the mark 320 with respect to the path 300.

Regardless of the uniformity of the luminance curves shown in FIGS. 16B, 17B, and 18B, however, as discussed above, it should be appreciated that a signal having a known invariant number of cycles based on the cardinal property of a mark can be recovered from a variety of luminance curves which may indicate translation and/or rotation of the mark; in particular, several conventional methods are known for detecting both uniform signals and non-uniform signals in noise. Conventional signal recovery methods may employ various processing techniques including, but not limited to, Kalman filtering, short-time Fourier transform, parametric model-based detection, and cumulative phase rotation analysis, some of which are discussed in greater detail below.

One method that may be employed by detection algorithms according to various embodiments of the present invention for processing either uniform or non-uniform signals involves detecting an instantaneous phase of the signal. This method is commonly referred to as cumulative phase rotation analysis and is discussed in greater detail in Section K of the Detailed Description. FIGS. 16C, 17C, 18C are graphs showing respective plots 346, 348 and 350 of a cumulative phase rotation for the luminance curves shown in FIGS. 16B, 17B and 18B, respectively. Similarly, FIG. 22C is a graph showing a plot 366 of a cumulative phase rotation for the luminance curve shown in FIG. 22B (i.e., representing a signal generated from a scan of an arbitrary region of an image that does not include a mark). According to one embodiment of the invention discussed fuirther below, the non-uniform signals of FIGS. 17B and 18B may be particularly processed, for example using cumulative phase rotation analysis, to not only detect the presence of a mark but to also derive the offset (skew or translation) and/or rotation (viewing angle) of the mark. Hence, valuable information may be obtained from such non-uniform signals.

Given a mark having N separately identifiable features symmetrically disposed around a center of the mark and scanned by a circular path centered on the mark, the instantaneous cumulative phase rotation of a perfectly uniform luminance curve (i.e., no rotation or translation of the mark with respect to the circular path) is given by Nφ as the circular path is traversed, where φ is the sampling angle discussed above in connection with FIGS. 20 and 21. With respect to the mark 320 in which N=6, a reference cumulative phase rotation based on a perfectly uniform luminance curve having a frequency of 6 cycles/scan is given by 6φ, as shown by the straight line 349 indicated in each of FIGS. 16C, 17C, 18C, and 22C. Accordingly, for a maximum sampling angle of 360 degrees, the maximum cumulative phase rotation of the luminance curves shown in FIGS. 16B, 17B, and 18B is 6×360 degrees=2160 degrees.

For example, the luminance curve of FIG. 16B is approximately a stationary sine wave that completes six 360 degree signal cycles. Accordingly, the plot 346 of FIG. 16C representing the cumulative phase rotation of the luminance curve of FIG. 16B shows a relatively steady progression, or phase accumulation,as the circular path is traversed, leading to a maximum of 2160 degrees, with relatively minor deviations from the reference cumulative phase rotation line 349.

Similarly, the luminance curve shown in FIG. 17B includes six 360 degree signal cycles; however, due to the 60 degree oblique viewing angle of the mark 320 shown in FIG. 17A, the luminance curve of FIG. 17B is not uniform. As a result, this signal non-uniformity is reflected in the plot 348 of the cumulative phase rotation shown in FIG. 17C, which is not a smooth, steady progression leading to 2016 degrees. In particular, the plot 348 deviates from the reference cumulative phase rotation line 349, and shows two distinct cycles 352A and 352B relative to the line 349. These two cycles 352A and 352B correspond to the cycles in FIG. 17B where the regions of the mark are foreshortened by the perspective of the oblique viewing angle. In particular, in FIG. 17B, the cycle labeled with the encircled number 1 is wide and hence phase accumulates more slowly than in a uniform signal, as indicated by the encircled number 1 in FIG. 17C. This initial wide cycle is followed by two narrower cycles 2 and 3, for which the phase accumulates more rapidly. This sequence of cycles is followed by another pattern of a wide cycle 4, followed by two narrow cycles 5 and 6, as indicated in both of FIGS. 17B and 17C.

The luminance curve shown in FIG. 18B also includes six 360 degree signal cycles, and so again the total cumulative phase rotation shown in FIG. 18C is a maximum of 2160 degrees. However, as discussed above, the luminance curve of FIG. 18B is also non-uniform, similar to that of the curve shown in FIG. 17B, because the circular scanning patin 300 shown in FIG. 18A is skewed off-center by the offset 362. Accordingly, the plot 350 of the cumulative phase rotation shown in FIG. 18C also deviates from the reference cumulative phase rotation line 349. In particular, the cumulative phase rotation shown in FIG. 18C includes one half-cycle of lower phase accumulation followed by one half-cycle of higher phase accumulation relative to the line 349. This cycle of lower-higher phase accumulation corresponds to the cycles in FIG. 18B where the common area or center 324 of the mark 320 is farther from the circular path 300, followed by cycles when the center of the mark is closer to the path 300.

In view of the foregoing, it should be appreciated that according to one embodiment of the invention, the detection of a mark using a cumulative phase rotation analysis may be based on a deviation of the measured cumulative phase rotation of a scanned signal from the reference cumulative phase rotation line 349. In particular, such a deviation is lowest in the case of FIGS. 16A, 16B, and 16C, in which a mark is viewed normally and is scanned “on-center” by the circular path 300. As a mark is viewed obliquely (as in FIGS. 17A, 17B, and 17C), and/or is scanned “off-center” (as in FIGS. 18A, 18B, and 18C), the deviation from the reference cumulative phase rotation line increases. In an extreme case in which a portion of an image is scanned that does not contain a mark (as in FIGS. 22A, 22B, and 22C), the deviation of the measured cumulative phase rotation (i.e., the plot 366 in FIG. 22C) of the scanned signal from the reference cumulative phase rotation line 349 is significant, as illustrated in FIG. 22C. Hence, according to one embodiment, a threshold for this deviation may be selected such that a presence of a mark in a given scan may be distinguished from an absence of the mark in the scan. Furthermore, according to one aspect of this embodiment, the tilt (rotation) and offset (translation) of a mark relative to a circular scanning path may be indicated by period-two and period-one signals, respectively, that are present in the cumulative phase rotation curves shown in FIG. 17C and FIG. 18C, relative to the reference cumulative phase rotation line 349. The mathematical details of a detection algorithm employing a cumulative phase rotation analysis according to one embodiment of the invention, as well as a mathematical derivation of mark offset and tilt from the cumulative phase rotation curves, are discussed in greater detail in Section K of the Detailed Description.

According to one embodiment of the invention, a detection algorithm employing cumulative phase rotation analysis as discussed above may be used in an initial scanning of an image to identify one or more likely candidates for the presence of a mark in the image. However, it is possible that one or more false positive candidates may be identified in an initial pass through the image. In particular, the number of false positives identified by the algorithm may be based in part on the selected radius 339 of the circular path 300 (e.g., see FIG. 20) with respect to the overall size or spatial extent of the mark being sought (e.g., the radial dimension 323 of the mark 320). According to one aspect of this embodiment, however, it may be desirable to select a radius 339 for the circular path 300 such that no valid candidate be rejected in an initial pass through the image, even though false positives may be identified. In general, as discussed above, in one aspect the radius 339 should be small enough relative to the apparent radius of the image of the mark to ensure that at least one of the paths lies entirely within the mark and encircles the center of the mark.

Once a detection algorithm initially identifies a candidate mark in an image (e.g., based on either a cardinal property, an ordinal property, or an inclusive property of the mark, as discussed above), the detection algorithm can subsequently include a refinement process that further tests other properties of the mark that may not have been initially tested, using alternative detection algorithms. Some alternative detection algorithms according to other embodiments of the invention, that may be used either alone or in various combinations with a cumulative phase rotation analysis, are discussed in detail in Section K of the Detailed Description.

With respect to detection refinement, for example, based on the cardinal property of the mark 320, some geometric properties of symmetrically opposed regions of the mark are similarly affected by translation and rotation. This phenomenon may be seen, for example, in FIG. 17A, in which the upper and lower regions 322B and 322E are distorted due to the oblique viewing angle to be long and narrow, whereas the upper left region 322C and the lower right region 322F are distorted to be shorter and wider. According to one embodiment, by comparing the geometric properties of area, major and minor axis length, and orientation of opposed regions (e.g., using a “regions analysis” method discussed in Section K of the Detailed Description), many candidate marks that resemble the mark 320 and that are falsely identified in a first pass through the image may be eliminated.

Additionally, a particular artwork sample having a number of marks may have one or more properties that may be exploited to rule out false positive indications. For example, as shown in FIG. 16A and discussed above, the arrangement of the separately identifiable regions of the mark 320 is such that opposite edges of opposed regions are aligned and may be represented by lines that intersect in the center or common area 324 of the mark. As discussed in greater detail in Section K of the Detailed Description, a detection algorithm employing an “intersecting edges” analysis exploiting this characteristic may be used alone, or in combination with one or both of regions analysis or cumulative phase rotation analysis, to refine detection of the presence of one or more such marks in an image.

Similar refinement techniques may be employed for marks having ordinal and inclusive properties as well. In particular, as a further example of detection algorithm refinement considering a mark having an ordinal property such as the mark 308 shown in FIG. 14, the different colored regions 302, 304 and 306 of the mark 308, according to one embodiment of the invention, may be designed to also have translation and/or rotation invariant properties in addition to the ordinal property of color order. These additional properties can include, for example, relative area and orientation. Similarly, with respect to a mark having an inclusive property such as the mark 312 shown in FIG. 15, the various regions 314, 316 and 318 of the mark 312 could be designed to have additional translation and/or rotation invariant properties such as relative area and orientation. In each of these cases, the property which can be evaluated by the detection algorithm most economically may be used to reduce the number of candidates which are then considered by progressively more intensive computational methods. In some cases, the properties evaluated also can be used to improve an estimate of a center location of an identified mark in an image.

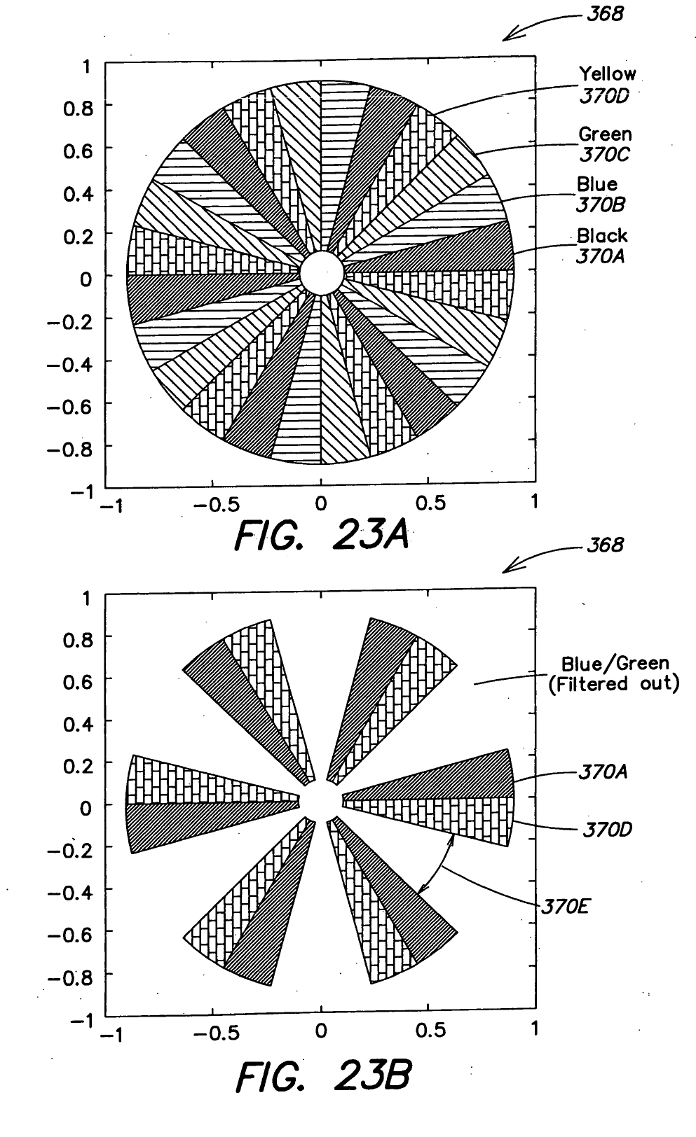

While the foregoing discussion has focussed primarily on the exemplary mark 320 shown in FIG. 16A and detection algorithms suitable for detecting such a mark, it should be appreciated that a variety of other types of marks may be suitable for use in an image metrology reference target (similar to the target 120A shown in FIG. 8), according to other embodiments of the invention (e.g., marks having an ordinal property similar to the mark 308 shown in FIG. 14, marks having an inclusive property similar to the mark 312 shown in FIG. 15, etc.). In particular, FIGS. 23A and 23B show yet another example of a robust mark 368 according to one embodiment of the invention that incorporates both cardinal and ordinal properties.

The mark 368 shown in FIG. 23A utilizes at least two primary colors in an arrangement of wedge-shaped regions similar to that shown in FIG. 16A for the mark 320. Specifically, in one aspect of this embodiment, the mark 368 uses to the primary colors blue and yellow in a repeating pattern of wedge-shaped regions. FIG. 23A shows a number of black colored regions 320A, each followed in a counter-clockwise order by a blue colored region 370B, a green colored region 370C (a combination of blue and yellow), and a yellow colored region 370D. FIG. 23B shows the image of FIG. 23A filtered to pass only blue light. Hence, in FIG. 23B the “clear” regions 370E between two darker regions represent a combination of the blue and green regions 370B and 370C of the mark 368, while the darker regions represent a combination of the black and yellow regions 370A and 370D of the mark 368. An image similar to that shown in FIG. 23B, although rotated, is obtained by filtering the image of FIG. 23A to show only yellow light. The two primary colors used in the mark 368 establish quadrature on a color plane, from which it is possible to directly generate a cumulative phase rotation, as discussed further in Section K of the Detailed Description.

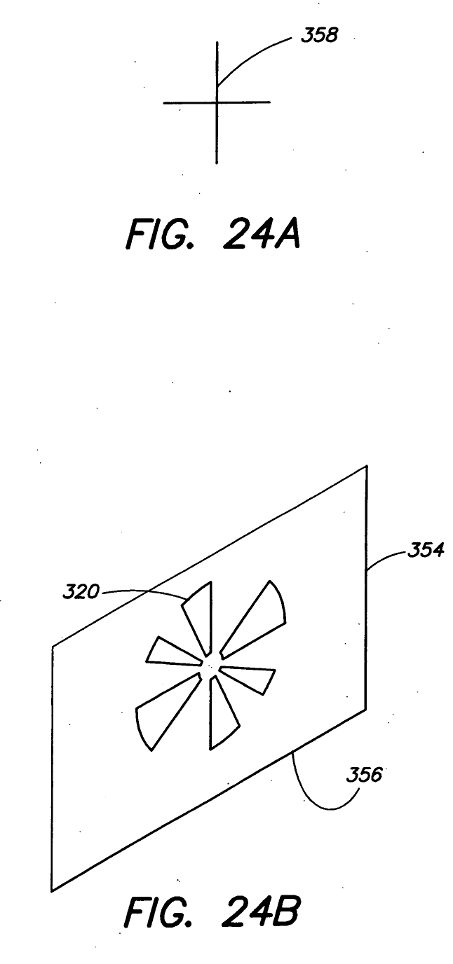

Additionally, FIG. 24A shows yet another example of a mark suitable for some embodiments of the present invention as a cross-hair mark 358 which, in one embodiment, may be used in place of any one or more of the asterisks serving as the fiducial marks 124A-124D in the example of the reference target 120A shown in FIG. 8. Additionally, according to one embodiment, the example of the inclusive mark 312 shown in FIG. 15 need not necessarily include a number of respective differently colored regions, but instead may include a number of alternating colored, black and white regions, or differently shaded and/or hatched regions. From the foregoing, it should be appreciated that a wide variety of landmarks for machine vision in general, and in particular fiducial marks for image metrology applications, are provided according to various embodiments of the present invention.

According to another embodiment of the invention, a landmark or fiducial mark according to any of the foregoing embodiments discussed above may be printed on or otherwise coupled to a substrate (e.g., the substrate 133 of the reference target 120A shown in FIGS. 8 and 9). In particular, in one aspect of this embodiment, a landmark or fiducial mark according to any of the foregoing embodiments may be printed on or otherwise coupled to a self-adhesive substrate that can be affixed to an object. For example, FIG. 24B shows a substrate 354 having a self-adhesive surface 356 (i.e., a rear surface), on which is printed (i.e., on a front surface) the mark 320 of FIG. 16A. In one aspect, the substrate 354 of FIG. 24B may be a self-stick removable note that is easily affixed at a desired location in a scene prior to obtaining one or more images of the scene to facilitate automatic feature detection.

In particular, according to one embodiment, marks printed on self-adhesive substrates may be affixed at desired locations in a scene to facilitate automatic identification of objects of interest in the scene for which position and/or size information is not known but desired. Additionally, such self-stick notes including prints of marks, according to one embodiment of the invention, may be placed in the scene at particular locations to establish a relationship between one or more measurement planes and a reference plane (e.g., as discussed above in Section C of the Detailed Description in connection with FIG. 5). In yet another embodiment, such self-stick notes may be used to facilitate automatic detection of link points between multiple images of a large and/or complex space, for purposes of site surveying using image metrology methods and apparatus according to the invention. In yet another embodiment, a plurality of uniquely identifiable marks each printed on a self-adhesive substrate may be placed in a scene as a plurality of objects of interest, for purposes of facilitating an automatic multiple-image bundle adjustment process (as discussed above in Section H of the Description of the Related Art), wherein each mark has a uniquely identifiable physical attribute that allows for automatic “referencing” of the mark in a number of images. Such an automatic referencing process significantly reduces the probability of analyst blunders that may occur during a manual referencing process. These and other exemplary applications for “self-stick landmarks” or “self-stick fiducial marks” are discussed further below in Section I of the Detailed Description.

H. Exemplary Image Processing Methods for Image Metrology

According to one embodiment of the invention, the image metrology processor 36 of FIG. 6 and the image metrology server 36A of FIG. 7 function similarly (i.e., may perform similar methods) with respect to image processing for a variety of image metrology applications. Additionally, according to one embodiment, one or more image metrology servers similar to the image metrology server 36A shown in FIG. 7, as well as the various client processors 44 shown in FIG. 7, may perform various image metrology methods in a distributed manner; in particular, as discussed above, some of the functions described herein with respect to image metrology methods may be performed by one or more image metrology servers, while other functions of such image metrology methods may be performed by one or more client processors 44. In this manner, in one aspect, various image metrology methods according to the invention may be implemented in a modular manner, and executed in a distributed fashion amongst a number of different processors.

Following below is a discussion of exemplary automated image processing methods for image metrology applications according to various embodiments of the invention. The material in this section is discussed in greater detail (including several mathematical derivations) in Section L of the Detailed Description. Although the discussion below focuses on automated image processing methods based in part on some of the novel machine vision techniques discussed above in Sections G3 and K of the Detailed Description, it should be appreciated that such image processing methods may be modified to allow for various levels of user interaction if desired for a particular application (e.g., manual rather than automatic identification of one or more reference targets or control points in a scene, manual rather than automatic identification of object points of interest in a scene, manual rather than automatic identification of multi-image link points or various measurement planes with respect to a reference plane for the scene, etc.). A number of exemplary implementations for the image metrology methods discussed herein, as well as various image metrology apparatus according to the invention, are discussed further in Section I of the Detailed Description.

According to one embodiment, an image metrology method first determines an initial estimate of at least some camera calibration information. For example, the method may determine an initial estimate of camera exterior orientation based on assumed or estimated interior orientation parameters of the camera and reference information (e.g., a particular artwork model) associated with a reference target placed in the scene. In this embodiment, based on these initial estimates of camera calibration information, a least-squares iterative algorithm subsequently is employed to refine the estimates. In one aspect, the only requirement of the initial estimation is that it is sufficiently close to the true solution so that the iterative algorithm converges. Such an estimation/refinement procedure may be performed using a single image of a scene obtained at each of one or more different camera locations to obtain accurate camera calibration information for each camera location. Subsequently, this camera calibration information may be used to determine actual position and/or size information associated with one or more objects of interest in the scene that are identified in one or more images of the scene.

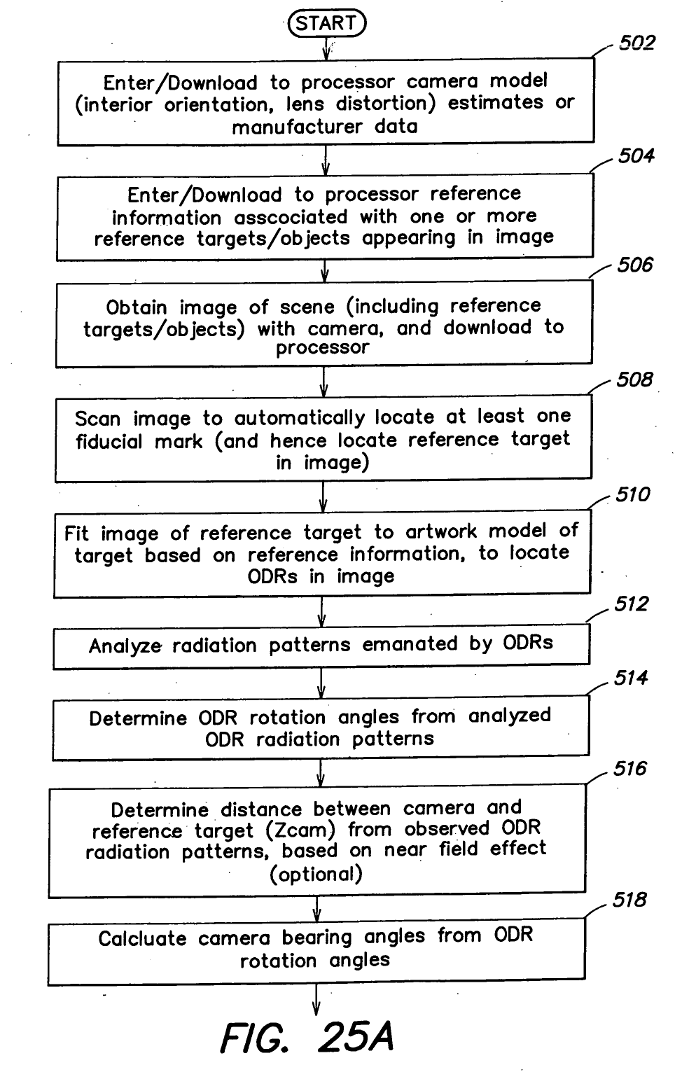

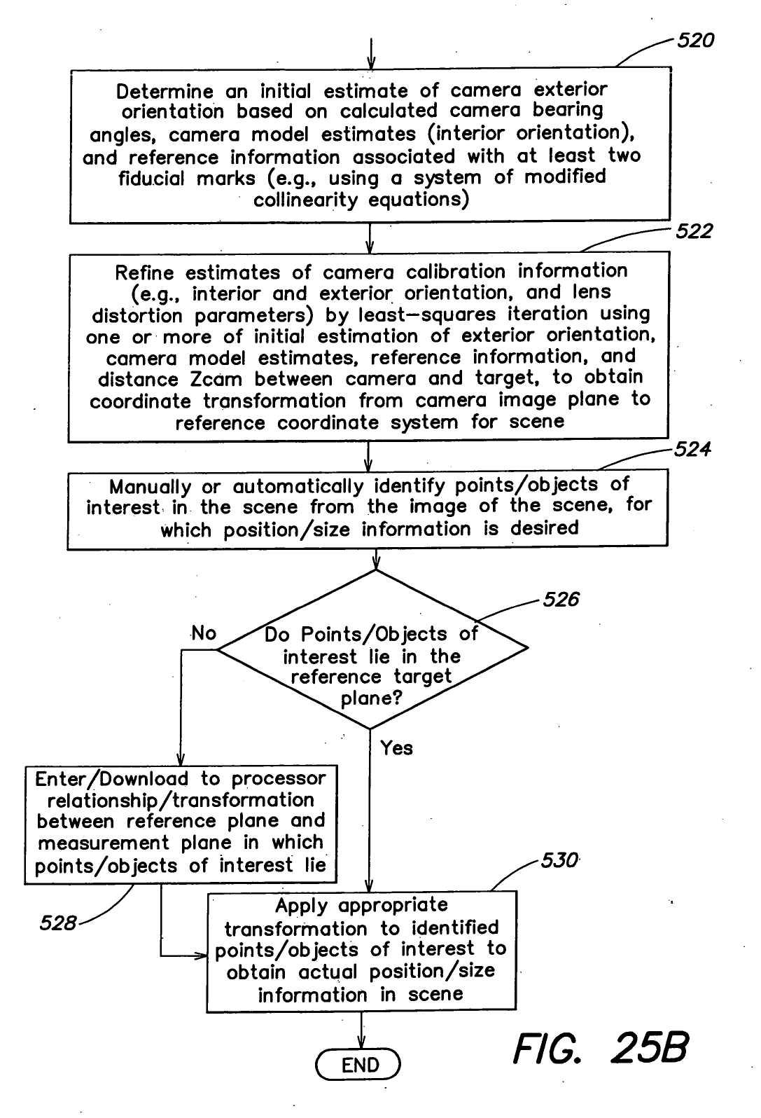

FIGS. 25A and 25B illustrate a flow chart for an image metrology method according to one embodiment of the invention. As discussed above, the method outlined in FIGS. 25A and 25B is discussed in greater detail in Section L of the Detailed Description. It should be appreciated that the method of FIGS. 25A and 25B provides merely one example of image processing for image metrology applications, and that the invention is not limited to this particular exemplary method. Some examples of alternative methods and/or alternative steps for the methods of FIGS. 25A and 25B are also discussed below and in Section L of the Detailed Description.

The method of FIGS. 25A and 25B is described below, for purposes of illustration, with reference to the image metrology apparatus shown in FIG. 6. As discussed above, it should be appreciated that the method of FIGS. 25A and 25B similarly may be performed using the various image metrology apparatus shown in FIG. 7 (i.e., network implementation).

With reference to FIG. 6, in block 502 of FIG. 25A, a user enters or downloads to the processor 36, via one or more user interfaces (e.g., the mouse 40A and/or keyboard 40B), camera model estimates or manufacturer data for the camera 22 used to obtain an image 20B of the scene 20A. As discussed above in Section E of the Description of the Related Art, the camera model generally includes interior orientation parameters of the camera, such as the principal distance for a particular focus setting, the respective x- and y-coordinates in the image plane 24 of the principal point (i.e., the point at which the optical axis 82 of the camera actually intersects the image plane 24 as shown in FIG. 1), and the aspect ratio of the CCD array of the camera. Additionally, the camera model may include one or more parameters relating to lens distortion effects. Some or all of these camera model parameters may be provided by the manufacturer of the camera and/or may be reasonably estimated by the user. For example, the user may enter an estimated principal distance based on a particular focal setting of the camera at the time the image 20B is obtained, and may also initially assume that the aspect ratio is equal to one, that the principal point is at the origin of the image plane 24 (see, for example, FIG. 1), and that there is no significant lens distortion (e.g., each lens distortion parameter, for example as discussed above in connection with Eq. (8), is set to zero). It should be appreciated that the camera model estimates or manufacturer data may be manually entered to the processor by the user or downloaded to the processor, for example, from any one of a variety of portable storage media on which the camera model data is stored.

In block 504 of FIG. 25A, the user enters or downloads to the processor 36 (e.g., via one or more of the user interfaces) the reference information associated with the reference target 120A (or any of a variety of other reference targets according to other embodiments of the invention). In particular, as discussed above in Section G1 of the Detailed Description in connection with FIG. 10, in one embodiment, target-specific reference information associated with a particular reference target may be downloaded to the image metrology processor 36 using an automated coding scheme (e.g., a bar code affixed to the reference target, wherein the bar code includes the target-specific reference information itself, or a serial number that uniquely identifies the reference target, etc.).

It should be appreciated that the method steps outlined in blocks 502 and 504 of FIG. 25A need not necessarily be performed for every image processed. For example, once camera model data for a particular camera and reference target information for a particular reference target is made available to the image metrology processor 36, that particular camera and reference target may be used to obtain a number of images that may be processed as discussed below.

In block 506 of FIG. 25A, the image 20B of the scene 20A shown in FIG. 6 (including the reference target 120A) is obtained by the camera 22 and downloaded to the processor 36. In one aspect, as shown in FIG. 6, the image 20B includes a variety of other image content of interest from the scene in addition to the image 120B of the reference target (and the fiducial marks thereon). As discussed above in connection with FIG. 6, the camera 22 may be any of a variety of image recording devices, such as metric or non-metric cameras, film or digital cameras, video cameras, digital scanners, and the like. Once the image is downloaded to the processor, in block 508 of FIG. 25A the image 20B is scanned to automatically locate at least one fiducial mark of the reference target (e.g., the fiducial marks 124A-124D of FIG. 8 or tne fiducial marks 402A-402D of FIG. 10B), and hence locate the image 120B of the reference target. A number of exemplary fiducial marks and exemplary methods for detecting such marks are discussed in Sections G3 and K of the Detailed Description.

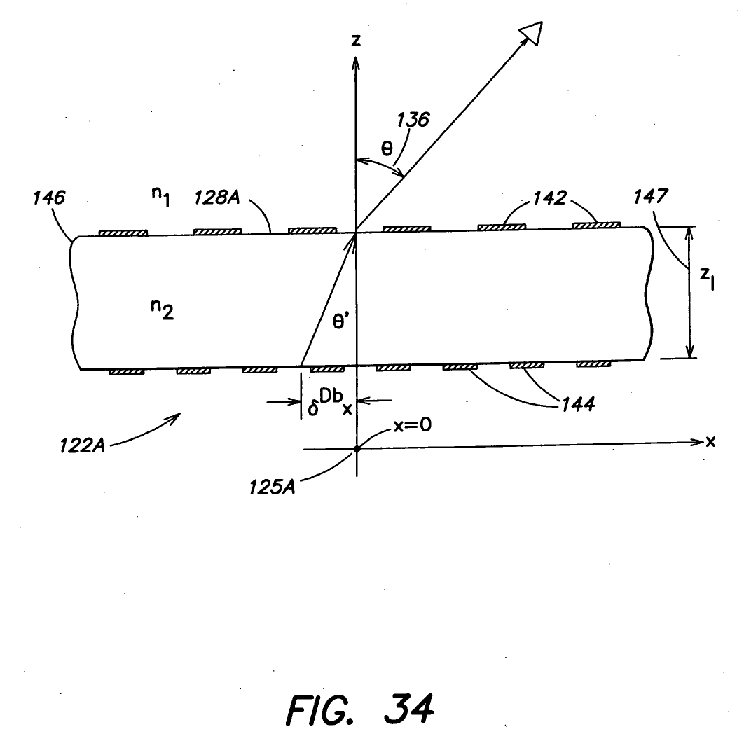

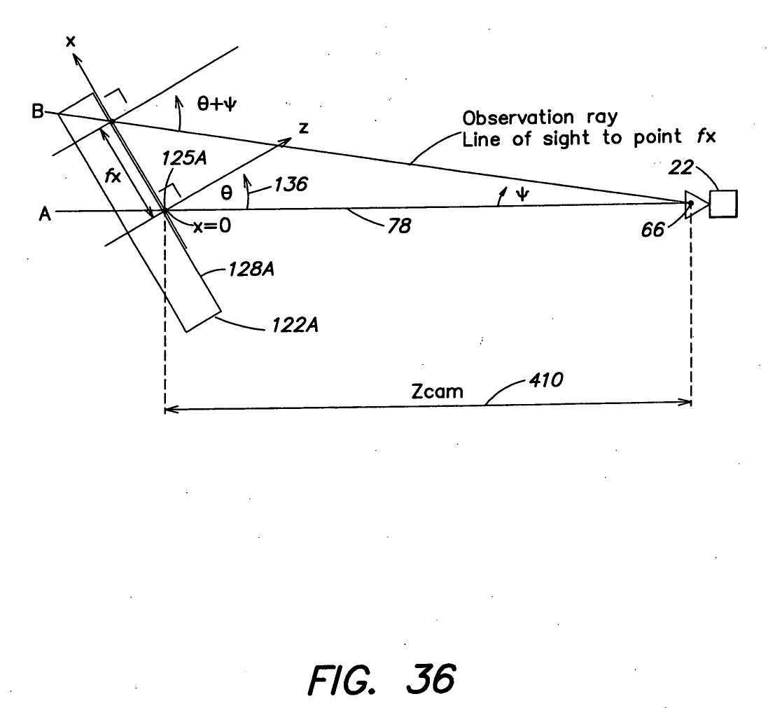

In block 510 of FIG. 25A, the image 120B of the reference target 120A is fit to an artwork model of the reference target based on the reference information. Once the image of the reference target is reconciled with the artwork model for the target, the ODRs of the reference target (e.g., the ODRs 122A and 122B of FIG. 8 or the ODRs 404A and 404B of FIG. 10B) may be located in the image. Once the ODRs are located, the method proceeds to block 512, in which the radiation patterns emanated by each ODR of the reference target are analyzed. In particular, as discussed in detail in Section L of the Detailed Description, in one embodiment, two-dimensional image regions are determined for each ODR of the reference target, and the ODR radiation pattern in the two-dimensional region is projected onto the longitudinal or primary axis of the ODR and accumulated so as to obtain a waveform of the observed orientation dependent radiation similar to that shown, for example, in FIGS. 13D and FIG. 34. In blocks 514 and 516 of FIG. 25A, the rotation angle of each ODR in the reference target is determined from the analyzed ODR radiation, as discussed in detail in Sections J and L of the Detailed Description. Similarly, according to one embodiment, the near-field effect of one or more ODRs of the reference target may also be exploited to determine a distance z_{cam} between the camera and the reference target (e.g., see FIG. 36) from the observed ODR radiation, as discussed in detail in Section J of the Detailed Description.

In block 518 of FIG. 25A, the camera bearing angles α₂ and γ₂ (e.g., see FIG. 9) are calculated from the ODR rotation angles that were determined in block 514. The relationship between the camera bearing angles and the ODR rotation angles is discussed in detail in Section L of the Detailed Description. In particular, according to one embodiment, the camera bearing angles define an intermediate link frame between the reference coordinate system for the scene and the camera coordinate system. The intermediate link frame facilitates an initial estimation of the camera exterior orientation based on the camera bearing angles, as discussed further below.

After the block 518 of FIG. 25A, the method proceeds to block 520 of FIG. 25B. In block 520, an initial estimate of the camera exterior orientation parameters is determined based on the camera bearing angles, the camera model estimates (e.g., interior orientation and lens distortion parameters), and the reference information associated with at least two fiducial marks of the reference target. In particular, in block 520, the relationship between the camera coordinate system and the intermediate link frame is established using the camera bearing angles and the reference information associated with at least two fiducial marks to solve a system of modified collinearity equations. As discussed in detail in Section L of the Detailed Description, once the relationship between the camera coordinate system and the intermediate link frame is known, an initial estimate of the camera exterior orientation may be obtained by a series of transformations from the reference coordinate system to the link frame, the link frame to the camera coordinate system, and the camera coordinate system to the image plane of the camera.

Once an initial estimate of camera exterior orientation is determined, block 522 of FIG. 25B indicates that estimates of camera calibration information in general (e.g., interior and exterior orientation, as well as lens distortion parameters) may be refined by least-squares iteration. In particular, in block 522, one or more of the initial estimation of exterior orientation from block 520, any camera model estimates from block 502, the reference information from block 504, and the distance z_{cam} from block 516 may be used as input parameters to an iterative least-squares algorithm (discussed in detail in Section L of the Detailed Description) to obtain a complete coordinate system transformation from the camera image plane 24 to the reference coordinate system 74 for the scene (as shown, for example, in FIGS. 1 or 6, and as discussed above in connection with Eq. (11)).

In block 524 of FIG. 25B, one or more points or objects of interest in the scene for which position and/or size information is desired are manually or automatically identified from the image of the scene. For example, as discussed above in Section C of the Detailed Description and in connection with FIG. 6, a user may use one or more user interfaces to select (e.g., via point and click using a mouse, or a cursor movement) various features of interest that appear in a displayed image 20C of a scene. Alternatively, one or more objects of interest in the scene may be automatically identified by attaching to such objects one or more robust fiducial marks (RFIDs) (e.g., using self-adhesive removable notes having one or more RFIDs printed thereon), as discussed further below in Section I of the Detailed Description.

In block 526 of FIG. 25B, the method queries if the points or objects of interest identified in the image lie in the reference plane of the scene (e.g., the reference plane 21 of the scene 20A shown in FIG. 6). If such points of interest do not lie in the reference plane, the method proceeds to block 528, in which the user enters or downloads to the processor the relationship or transformation between the reference plane and a measurement plane in which the points of interest lie. For example, as illustrated in FIG. 5, a measurement plane 23 in which points or objects of interest lie may have any known arbitrary relationship to the reference plane 21. In particular, for built or planar spaces, a number of measurement planes may be selected involving 90 degree transformations between a given measurement plane and the reference plane for the scene.

In block 530 of FIG. 25B, once it is determined whether or not the points or objects of interest lie in the reference plane, the appropriate coordinate system transformation may be applied to the identified points or objects of interest (e.g., either a transformation between the camera image plane and the reference plane or the camera image plane and the measurement plane) to obtain position and/or size information associated with the points or objects of interest. As shown in FIG. 6, such position and/or size information may include, but is not limited to, a physical distance 30 between two indicated points 26A and 28A in the scene 20A.

In the image metrology method outlined in FIGS. 25A and 25B, it should be appreciated that other alternative steps for the method to determine an initial estimation of the camera exterior orientation parameters, as set forth in blocks 510-520, are possible. In particular, according to one alternative embodiment, an initial estimation of the exterior orientation may be determined solely from a number of fiducial marks of the reference target without necessarily using data obtained from one or more ODRs of the reference target. For example, reference target orientation (e.g., pitch and yaw) in the image, and hence camera bearing, may be estimated from cumulative phase rotation curves (e.g., shown in FIGS. 16C, 17C, and 18C) generated by scanning a fiducial mark in the image, based on a period-two signal representing mark tilt that is present in the cumulative phase rotation curves, as discussed in detail in Sections G3 and K of the Detailed Description. Subsequently, initial estimates of exterior orientation made in this manner, taken alone or in combination with actual camera bearing data determined from the ODR radiation patterns, may be used in a least squares iterative algorithm to refine estimates of various camera calibration information.

### I. Exemplary Multiple-image Implementations

This section discusses a number of exemplary multiple-image implementations of image metrology methods and apparatus according to the invention. The implementations discussed below may be appropriate for any one or more of the various image metrology applications discussed above (e.g., see Sections D and F of the Detailed Description), but are not limited to these applications. Additionally, the multiple-image implementations discussed below may involve and/or build upon one or more of the various concepts discussed above, for example, in connection with single-image processing techniques, automatic feature detection techniques, various types of reference objects according to the invention (e.g., see Sections B, C, G, G1, G2, and G3 of the Detailed Description), and may incorporate some or all of the techniques discussed above in Section H of the Detailed Description, particularly in connection with the determination of various camera calibration information. Moreover, in one aspect, the multiple-image implementations discussed below may be realized using image metrology methods and apparatus in a network configuration, as discussed above in Section E of the Detailed Description.

Four exemplary multi-image implementations are presented below for purposes of illustration, namely: 1) processing multiple images of a scene that are obtained from different camera locations to corroborate measurements and increase accuracy; 2) processing a series of similar images of a scene that are obtained from a single camera location, wherein the images have consecutively larger scales (i.e. the images contain consecutively larger portions of the scene), and camera calibration information is interpolated (rather than extrapolated) from smaller-scale images to larger-scale images; 3) processing multiple images of a scene to obtain three-dimensional information about objects of interest in the scene (e.g., based on an automated intersection or bundle adjustment process); and 4) processing multiple different images, wherein each image contains some shared image content with another image, and automatically linking the images together to form a site survey of a space that may be too large to capture in a single image. It should be appreciated that various multiple image implementations of the present invention are not limited to these examples, and that other implementations are possible, some of which may be based on various combinations of features included in these examples.

I1. Processing Multiple Images to Corroborate Measurements and Increase Accuracy

According to one embodiment of the invention, a number of images of a scene that are obtained from different camera locations may be processed to corroborate measurements and/or increase the accuracy and reliability of measurements made using the images. For example, with reference again to FIG. 6, two different images of the scene 20A may be obtained using the camera 22 from two different locations, wherein each image includes an image of the reference target 120A. In one aspect of this embodiment, the processor 36 simultaneously may display both images of the scene on the display 38 (e.g. using a split screen), and calculates the exterior orientation of the camera for each image (e.g., according to the method outlined in FIGS. 25A and 25B as discussed in Section H of the Detailed Description). Subsequently, a user may identify points of interest in the scene via one of the displayed images (or points of interest may be automatically identified, for example, using stand-alone RFIDs placed at desired locations in the scene) and obtain position and/or size information associated with the points of interest based on the exterior orientation of the camera for the selected image. Thereafter, the user may identify the same points of interest in the scene via another of the displayed images and obtain position and/or size information based on the exterior orientation of the camera for this other image. If the measurements do not precisely corroborate each other, an average of the measurements may be taken.

I2. Scale-up Measurements

According to one aspect of the invention, various measurements in a scene may be accurately made using image metrology methods and apparatus according to at least one embodiment described herein by processing images in which a reference target is approximately one-tenth or greater of the area of the scene obtained in the image (e.g., with reference again to FIG. 6, the reference target 120A would be approximately at least one-tenth the area of the scene 20A obtained in the image 20B). In these cases, various camera calibration information is determined by observing the reference target in the image and knowing a priori the reference information associated with the reference target (e.g., as discussed above in Section H of the Detailed Description). The camera calibration information determined from the reference target is then extrapolated throughout the rest of the image and applied to other image contents of interest to determine measurements in the scene.

According to another embodiment, however, measurements may be accurately made in a scene having significantly larger dimensions than a reference target placed in the scene. In particular, according to one embodiment, a series of similar images of a scene that are obtained from a single camera location may be processed in a “scale-up” procedure, wherein the images have consecutively larger scales (i.e. the images contain consecutively larger portions of the scene). In one aspect of this embodiment; camera calibration information is interpolated from the smaller-scale images to the larger-scale images rather than extrapolated throughout a single image, so that relatively smaller reference objects (e.g., a reference target) placed in the scene may be used to make accurate measurements throughout scenes having significantly larger dimensions than the reference objects.

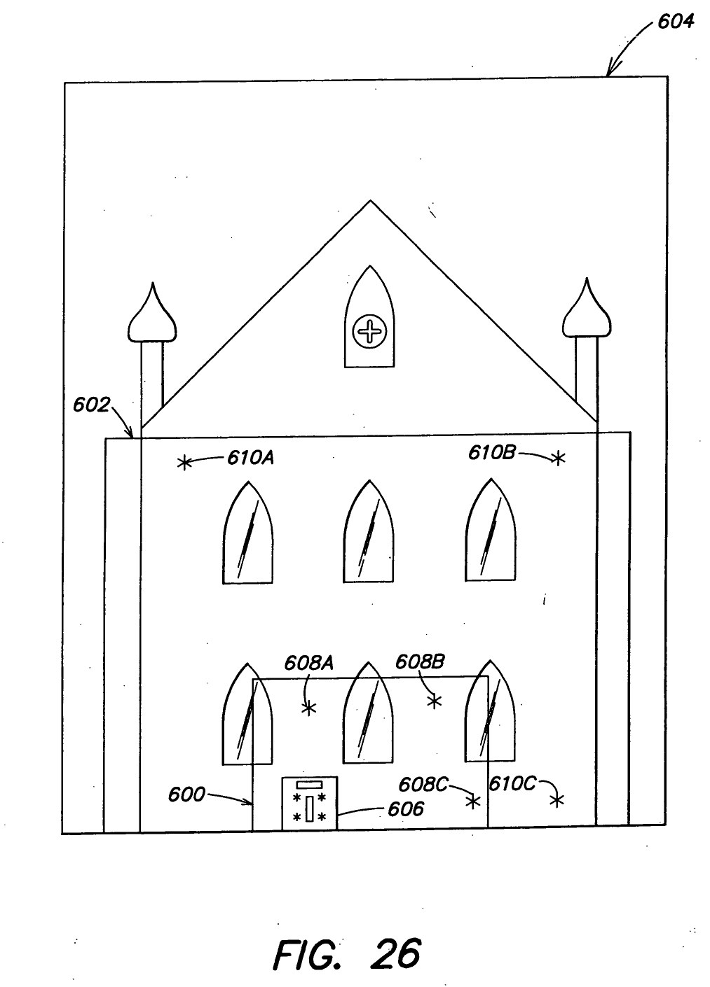

In one example of this implementation, the determination of camera calibration information using a reference target is essentially “bootstrapped” from images of smaller portions of the scene to images of larger portions of the scene, wherein the images include a common reference plane. For purposes of illustrating this example, with reference to the illustration of a scene including a cathedral as shown in FIG. 26, three images are considered; a first image 600 including a first portion of the cathedral, a second image 602 including a second portion of the cathedral, wherein the second portion is larger than the first portion and includes the first portion, and a third image 604 including a third portion of the cathedral, wherein the third portion is larger than the second portion and includes the second portion. In one aspect, a reference target 606 is disposed in the first portion of the scene against a front wall of the cathedral which serves as a reference plane. The reference target 606 covers an area that is approximately equal to or greater than one-tenth the area of the first portion of the scene. In one aspect, each of the first, second, and third images is obtained by a camera disposed at a single location (e.g., on a tripod), by using zoom or lens changes to capture the different portions of the scene.

In this example, at least the exterior orientation of the camera (and optionally other camera calibration information) is estimated for the first image 600 based on reference information associated with the reference target 606. Subsequently, a first set of at least three widely spaced control points 608A, 608B, and 608C not included in the area of the reference target is identified in the first image 600. The relative position in the scene (i.e., coordinates in the reference coordinate system) of these control points is determined based on the first estimate of exterior orientation from the first image (e.g., according to Eq. (11)). This first set of control points is subsequently identified in the second image 602, and the previously determined position in the scene of each of these control points serves as the reference information for a second estimation of the exterior orientation from the second image.

Next, a second set of at least three widely spaced control points 610A, 610B, and 610C is selected in the second image, covering an area of the second image greater than that covered by the first set of control points. The relative position in the scene of each control point of this second set of control points is determined based on the second estimate of exterior orientation from the second image. This second set of control points is subsequently identified in the third image 604, and the previously determined position in the scene of each of these control points serves as the reference information for a third estimation of the exterior orientation from the third image. This bootstrapping process may be repeated for any number of images, until an exterior orientation is obtained for an image covering the extent of the scene in which measurements are desired. According to yet another aspect of this embodiment, a number of stand-alone robust fiducial marks may be placed throughout the scene, in addition to the reference target, to serve as automatically detectable first and second sets of control points to facilitate an automated scale-up measurement as described above.

I3. Automatic Intersection or Bundle Adjustments Using Multiple Images

According to another embodiment of the invention involving multiple images of the same scene obtained at respectively different camera locations, camera calibration information may be determined automatically for each camera location and measurements may be automatically made using points of interest in the scene that appear in each of the images. This procedure is based in part on geometric and mathematical theory related to some conventional multi-image photogrammetry approaches, such as intersection (as discussed above in Section G of the Description of the Related Art) and bundle adjustments (as discussed above in Section H of the Description of the Related Art).

According to the present invention, conventional intersection and bundle adjustment techniques are improved upon in at least one respect by facilitating automation and thereby reducing potential errors typically caused by human “blunders,” as discussed above in Section H of the Description of the Related Art. For example, in one aspect of this embodiment, a number of individually (i.e., uniquely) identifiable robust fiducial marks (RFIDs) are disposed on a reference target that is placed in the scene and which appears in each of the multiple images obtained at different camera locations. Some examples of uniquely identifiable physical attributes of fiducial marks are discussed above in Section G3 of the Detailed Description. In particular, a mark similar to that shown in FIG. 16A may be uniquely formed such that one of the wedged-shaped regions of the mark has a detectably extended radius compared to other regions of the mark. Alternatively, a fiducial mark similar to that shown in FIG. 16A may be uniquely formed such that at least a portion of one of the wedged-shaped regions of the mark is differently colored than other regions of the mark. In this aspect, corresponding images of each unique fiducial mark of the target are automatically referenced to one another in the multiple images to facilitate the “referencing” process discussed above in Section H of the Description of the Related Art. By automating this referencing process using automatically detectable unique robust fiducial marks, errors due to user blunders may be virtually eliminated.

In another aspect of this embodiment, a number of individually (i.e., uniquely) identifiable stand-alone fiducial marks (e.g., RFIDs that have respective unique identifying attributes and that are printed, for example, on self-adhesive substrates) are disposed throughout a scene (e.g., affixed to various objects of interest and/or widely spaced throughout the scene), in a single plane or throughout three-dimensions of the scene, in a manner such that each of the marks appears in each of the images. As above, corresponding images of each uniquely identifiable stand-alone fiducial mark are automatically referenced to one another in the multiple images to facilitate the “referencing” process for purposes of a bundle adjustment.

It should be appreciated from the foregoing that either one or more reference targets and/or a number of stand-alone fiducial marks may be used alone or in combination with each other to facilitate automation of a multi-image intersection or bundle adjustment process. The total number of fiducial marks employed in such a process (i.e., including fiducial marks located on one or more reference targets as well as stand-alone marks) may be selected based on the constraint relationships given by Eqs. (15) or (16), depending on the number of parameters that are being solved for in the bundle adjustment. Additionally, according to one aspect of this embodiment, if the fiducial marks are all located in the scene to lie in a reference plane for the scene, the constraint relationship given by Eq. (16), for example, may be modified as

2jn≧Cj+2n, (19)

where C indicates the total number of initially assumed unknown camera calibration information parameters for each camera, n is the number of fiducial marks lying in the reference plane, and j is the number of different images. In Eq. (19), the number n of fiducial marks is multiplied by two instead of by three (as in Eqs. (15) and (16)), because it is assumed that the z-coordinate for each fiducial mark lying in the reference plane is by definition zero, and hence known.

I4. Site Surveys Using Automatically Linked Multiple Images

According to another embodiment, multiple different images containing at least some common features may be automatically linked together to form a “site survey” and processed to facilitate measurements throughout a scene or site that is too large and/or complex to obtain with a single image. In various aspects of this embodiment, the common features shared between consecutive pairs of images of such a survey may be established by a common reference target and/or by one or more stand-alone robust fiducial marks that appear in the images to facilitate automatic linking of the images.

For example, in one aspect of this embodiment, two or more reference targets are located in a scene, and at least one of the reference targets appears in two or more different images (i.e., of different portions of the scene). In particular, one may imagine a site survey of a number of rooms of a built space, in which two uniquely identifiable reference targets are used in a sequence of images covering all of the rooms (e.g., right-hand wall-following). Specifically, in this example, for each successive image, only one of the two reference targets is moved to establish a reference plane for that image (this target is essentially “leapfrogged” around the site from image to image), while the other of the two reference targets remains stationary for a pair of successive images to establish automatically identifiable link points between two consecutive images. At corners, an image could be obtained with a reference target on each wall. At least one uniquely identifying physical attribute of each of the reference targets may be provided, for example, by a uniquely identifiable fiducial mark on the target, some examples of which are discussed above in Sections I3 and G3 of the Detailed Description.

According to another embodiment, at least one reference target is moved throughout the scene or site as different images are obtained so as to provide for camera calibration from each image, and one or more stand-alone robust fiducial marks are used to link consecutive images by establishing link points between images. As discussed above in Section G3 of the Detailed Description, such stand-alone fiducial marks may be provided as uniquely identifiable marks each printed on a self-adhesive substrate; hence, such marks may be easily and conveniently placed throughout a site to establish automatically detectable link points between consecutive images.

In yet another embodiment related to the site survey embodiment discussed above, a virtual reality model of a built space may be developed. In this embodiment, a walk-through recording is made of a built space (e.g., a home or a commercial/industrial space) using a digital video camera. The walk-through recording is performed using a particular pattern (e.g., right-hand wall-following) through the space. In one aspect of this embodiment, the recorded digital video images are processed by either the image metrology processor 36 of FIG. 6 or the image metrology server 36A of FIG. 7 to develop a dimensioned model of the space, from which a computer-assisted drawing (CAD) model database may be constructed. From the CAD database and the image data, a virtual reality model of the space may be made, through which users may “walk through” using a personal computer to take a tour of the space. In the network-based system of FIG. 7, users may walk through the virtual reality model of the space from any client workstation coupled to the wide-area network.

### J: Orientation Dependent Radiation Analysis

J1. Introduction

Fourier analysis provides insight into the observed radiation pattern emanated by an exemplary orientation dependent radiation source (ODR), as discussed in section G2 of the detailed description. The two square-wave patterns of the respective front and back gratings of the exemplary ODR shown in FIG. 13A are multiplied in the spatial domain; accordingly, the Fourier transform of the product is given by the convolution of the transforms of each square-wave grating. The Fourier analysis that follows is based on the far-field approximation, which corresponds to viewing the ODR along parallel rays, as indicated in FIG. 12B.

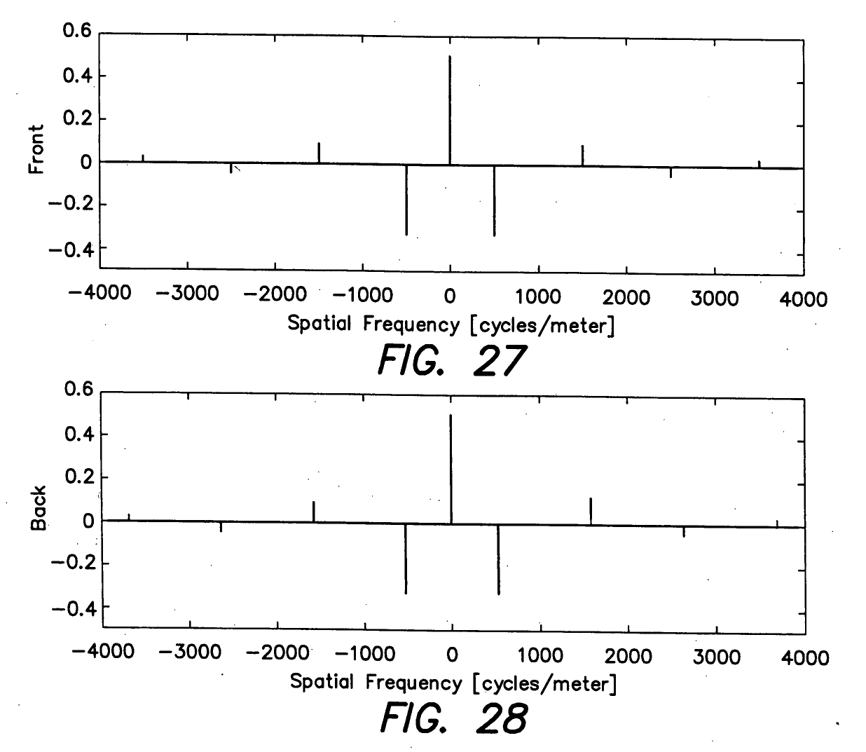

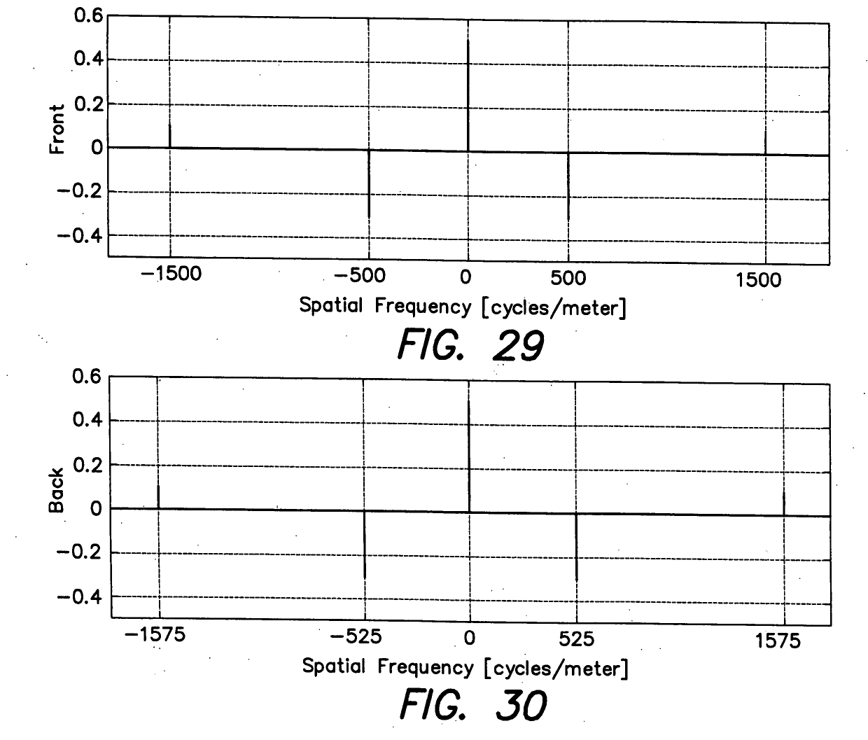

Fourier transforms of the front and back gratings are shown in FIGS. 27, 28, 29 and 30. In particular, FIG. 27 shows the transform of the front grating from −4000 to +4000 [cycles/meter], while FIG. 29 shows an expended view of the same transform from −1500 to +1500 [cycles/meter]. Similarly, FIG. 28 shows the transform of the back grating from −4000 to +4000 [cycles/meter], while FIG. 30 shows an expanded view of the same transform from −1575 to +1575 [cycles/meter]. For the square wave grating, power appears at the odd harmonics. For the front grating the Fourier coefficients are given by:

$$F ( k {f}_{f} ) = \{ \begin{matrix}{( - 1 )}^{( k - 1 ) / 2} \frac{1}{π} \frac{1}{k} & k odd \\ 0 & otherwise\end{matrix} \qquad ( 20 )$$

And for the back grating the Fourier coefficients are given by:

$$F ( k {f}_{b} ) = \{ \begin{matrix}{( - 1 )}^{( k - 1 ) / 2} \frac{1}{π} \frac{1}{k} {ⅇ}^{j ( Δ {x}_{b} k {f}_{b} 2 π )} & k odd \\ 0 & otherwise\end{matrix} \qquad ( 21 )$$

where:

f_{f} is the spatial frequency of the front grating [cycles/meter];

f_{b} is the spatial frequency of the back grating [cycles/meter];

F (f) is the complex Fourier coefficient at frequency f;

k is the harmonic number, f=k f_{f} or f=k f_{b};

Δx_{b} [meters] is the total shift of the back grating relative to the front grating, defined in Eqn (26) below.

The Fourier transform coefficients for the front grating are listed in Table 1. The coefficients shown correspond to a front grating centered at x=0 (i.e., as shown in FIG. 13A). For a back grating shifted with respect to the front grating by a distance Δx_{b}, the Fourier coefficients are phase shifted by e^{j(Δx}^{_{b}} ^{f 2π)}, as seen in Eqn (21).

TABLE 1
Fourier transform coefficients for the ODR front grating
square-wave pattern;
f_{f} = 500 [cycles/meter] is the spatial
frequency of the front grating.

| f = k f_{f} | | F (k f_{f}) |
|---|---|---|
| [cycles/meter] | k | [Amplitude] |
| . . . | . . . | . . . |
| −5f_{f} = −2500 | −5 | ${( - 1 )}^{3} \frac{1}{π} \frac{1}{5} = - 0.064$ |
| −3f_{f} = −1500 | −3 | ${( - 1 )}^{2} \frac{1}{π} \frac{1}{3} = 0.106$ |
| −1f_{f} = −500 | −1 | ${( - 1 )}^{1} \frac{1}{π} \frac{1}{1} = - 0.318$ |
| 0f_{f} = 0 | 0 | 0.5 |
| 1f_{f} = 500 | 1 | ${( - 1 )}^{1} \frac{1}{π} \frac{1}{1} = - 0.318$ |
| 3f_{f} = 1500 | 3 | ${( - 1 )}^{2} \frac{1}{π} \frac{1}{3} = 0.106$ |
| 5f_{f} = 2500 | 5 | ${( - 1 )}^{3} \frac{1}{π} \frac{1}{5} = - 0.064$ |
| . . . | . . . | . . . |

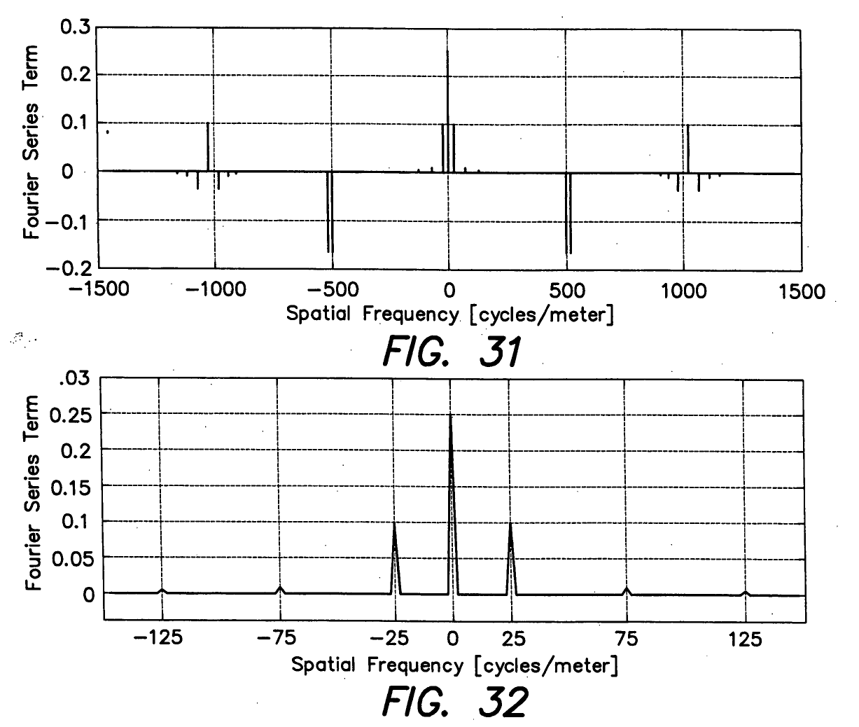

Convolution of the Fourier transforms of the ODR front and back gratings corresponds to multiplication of the gratings and gives the Fourier transform of the emanated orientation-dependent radiation, as shown in FIGS. 31 and 32. In particular, the graph of FIG. 32 shows a closeup of the low-frequency region of the Fourier transform of orientation-dependent radiation shown in FIG. 31.

Identifying the respective coefficients of the front and back grating Fourier transforms as:

Front:

. . . a₋₃, a₋₁, a₀, a₁, a₃, . . .

Back:

. . . e^{-j(Δx}^{_{b}} ^{3 f}^{_{b}}^{,2π)}α₋₃, e^{-j(Δx}^{_{b}} ^{1 f}^{_{b}}^{,2π)}α₋₁, α₀, e^{j(Δx}^{_{b}} ^{1 f}^{_{b}}^{,2π)}α₁, e^{j(Δx}^{_{b}} ^{3 f}^{_{b}}^{,2π)}α₃, . . .

then, for the case of f_{b}>f_{f}, the coefficients of the Fourier transform shown in FIG. 32 (i.e., the center-most peaks) of the orientation-dependent radiation emanated by the ODR are given in Table 2, where:

F=min(f_{f}, f_{b}) is the smaller of the grating spatial frequencies;

Frequencies lying in range between −F to +F are considered;

Δf=f_{f}−f_{b}, is the frequency difference between the front and back gratings, (Δf can be positive or negative).

TABLE 2
Coefficients of the central peaks in the Fourier transform of
the orientation-dependent radiation emanated by an ODR (f_{b} > f_{f}).

| f | Coefficient |
|---|---|
| . . . | . . . |
| −3Δf | ${α}_{- 3} {a}_{3} = {ⅇ}^{- j ( {Δx}_{b} 3 {f}_{b} 2 π )} \frac{1}{{π}^{2}} \frac{1}{{3}^{2}}$ |
| −1Δf | ${α}_{- 1} {a}_{1} = {ⅇ}^{- j ( {Δx}_{b} 1 {f}_{b} 2 π )} \frac{1}{{π}^{2}} \frac{1}{{1}^{2}}$ |
| 0 | ${α}_{0} {a}_{0} = {( \frac{1}{2} )}^{2}$ |
| 1Δf | ${α}_{1} {a}_{- 1} = {ⅇ}^{j ( {Δx}_{b} 1 {f}_{b} 2 π )} \frac{1}{{π}^{2}} \frac{1}{{1}^{2}}$ |
| 3Δf | ${α}_{3} {a}_{- 3} = {ⅇ}^{j ( {Δx}_{b} 3 {f}_{b} 2 π )} \frac{1}{{π}^{2}} \frac{1}{{3}^{2}}$ |
| . . . | . . . |

These peaks correspond essentially to a triangular waveform having a frequency f_{M}=|Δf| and a phase shift of

ν=360 Δx_{b} f_{b} [degrees] (22)

where ν is the phase shift of the triangle waveform at the reference point x=0. An example of such a triangle waveform is shown in FIG. 13D.

With respect to the graph of FIG. 31, the group of terms at the spatial frequency of the gratings (i.e., approximately 500 [cycles/meter]) corresponds to the fundamental frequencies convolved with the DC components. These coefficients are given in Table 3. The next group of terms correspond to sum frequencies. They are given in Table 4. Groups similar to that at (f_{f}+f_{b}) occur at intervals of increasing frequency and in increasingly complex patterns.

TABLE 3
Fourier coefficients at the fundamental frequencies
(500 and 525 [cycles/meter]).

| f | Coefficient |
|---|---|
| f_{f} | ${α}_{0} {a}_{1} = \frac{1}{2} \frac{1}{π} \frac{1}{1}$ |
| f_{b} | ${α}_{1} {a}_{0} = {ⅇ}^{j ( {Δx}_{b} 1 {f}_{b} 2 π )} \frac{1}{2} \frac{1}{π} \frac{1}{1}$ |
| −f_{f} | ${α}_{0} {a}_{- 1} = \frac{1}{2} \frac{1}{π} \frac{1}{1}$ |
| −f_{b} | ${α}_{- 1} {a}_{0} = {ⅇ}^{- j ( {Δx}_{b} 1 {f}_{b} 2 π )} \frac{1}{2} \frac{1}{π} \frac{1}{1}$ |

TABLE 4
Fourier coefficients at the sum frequencies.

| f | Coefficient |
|---|---|
| f_{f} + f_{b} | ${α}_{1} {a}_{1} = \frac{1}{{π}^{2}} \frac{1}{{1}^{2}}$ |
| (f_{f} + f_{b}) − 2Δf | ${α}_{- 3} {a}_{- 1} = {ⅇ}^{- j ( {Δx}_{b} 3 {f}_{b} 2 π )} \frac{1}{{π}^{2}} \frac{1}{3} \frac{1}{1}$ |
| (f_{f} + f_{b}) + 2Δf | ${α}_{+ 3} {a}_{+ 3} = {ⅇ}^{j ( {Δx}_{b} 1 {f}_{b} 2 π )} \frac{1}{{π}^{2}} \frac{1}{1} \frac{1}{3}$ |
| (f_{f} + f_{b}) − 4Δf | ${α}_{- 5} {a}_{- 3} = {ⅇ}^{- j ( {Δx}_{b} 5 {f}_{b} 2 π )} \frac{1}{{π}^{2}} \frac{1}{5} \frac{1}{3}$ |
| . . . | . . . |

As discussed above, the inverse Fourier transform of the central group of Fourier terms shown in FIG. 31 (i.e., the terms of Table 2, taken for the entire spectrum) exactly gives a triangle wave having a frequency f_{M}=|Δf|, phase shifted by ν=360 Δx_{b} f_{b} [degrees]. As shown in FIG. 13D, such a triangle wave is evident in the low-pass filtered waveform of orientation-dependent radiation. The waveform illustrated in FIG. 13D is not an ideal a triangle waveform, however, because: a) the filtering leaves the 500 and 525 [cycle/meter] components shown in FIG. 31 attenuated but nonetheless present, and b) high frequency components of the triangle wave are attenuated.

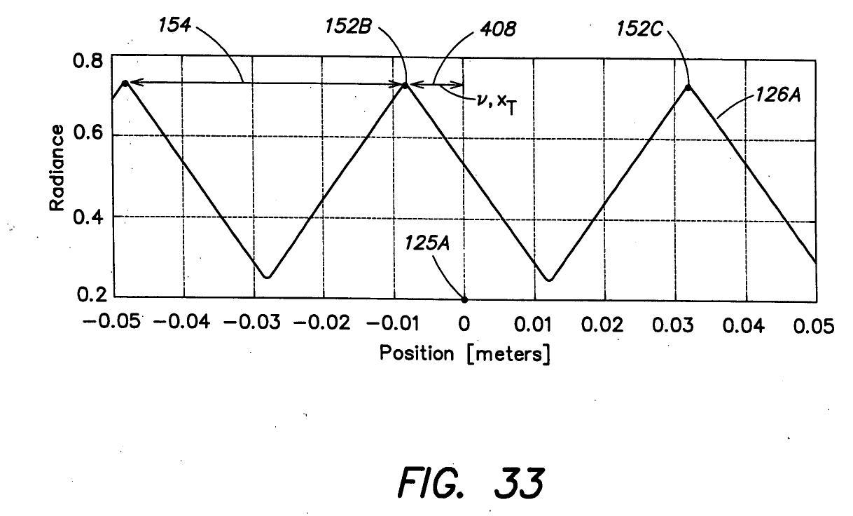

FIG. 33 shows yet another example of a triangular waveform that is obtained from an ODR similar to that discussed in Section G2, viewed at an oblique viewing angle (i.e., a rotation) of approximately 5 degrees off-normal, and using low-pass filtering with a 3 dB cutoff frequency of approximately 400 [cycles/meter]. The phase shift 408 of FIG. 33 due to the 5° rotation is −72°, which may be expressed as a lateral position, x_{T}, of the triangle wave peak relative to the reference point x=0:

$${x}_{T} = \frac{v / 360}{{f}_{M}} [ meters ] \qquad ( 23 )$$

where x_{T} is the lateral position of the triangle wave peak relative to the reference point x=0 and takes a value of −0.008 [meters] when f_{M}=25 [cycles/meter] in this example.

The coefficients of the central peaks of the Fourier transform of the orientation-dependent radiation emanated by the ODR (Table 2) were derived above for the case of a back grating frequency greater than the front grating frequency (f_{b}>f_{f}). When the back grating frequency is lower than that of the front, the combinations of Fourier terms which produce the low-frequency contribution are reversed, and the direction of the phase shift of the low-frequency triangle waveform is reversed (i.e., instead of moving to the left as shown in FIG. 33, the waveform moves to the right for the same direction of rotation. This effect is seen in Table 5; with (f_{f}>f_{b}), the indices of the coefficients are reversed, as are the signs of the complex exponentials and, hence, the phase shifts.

TABLE 5
Coefficients of the central peaks in the Fourier transform of the
orientation-dependent radiation emanated from an ODR (f_{f} > f_{b}).

| f | Coefficient |
|---|---|
| . . . | . . . |
| −3Δf | ${α}_{3} {a}_{- 3} = {ⅇ}^{j ( {Δx}_{b} 3 {f}_{b} 2 π )} \frac{1}{{π}^{2}} \frac{1}{{3}^{2}}$ |
| −1Δf | ${α}_{1} {a}_{- 1} = {ⅇ}^{j ( {Δx}_{b} 1 {f}_{b} 2 π )} \frac{1}{{π}^{2}} \frac{1}{{1}^{2}}$ |
| 0 | ${α}_{0} {a}_{0} = {( \frac{1}{2} )}^{2}$ |
| 1Δf | ${α}_{- 1} {a}_{1} = {ⅇ}^{- j ( {Δx}_{b} 1 {f}_{b} 2 π )} \frac{1}{{π}^{2}} \frac{1}{{1}^{2}}$ |
| 3Δf | ${α}_{- 3} {a}_{3} = {ⅇ}^{- j ( {Δx}_{b} 3 {f}_{b} 2 π )} \frac{1}{{π}^{2}} \frac{1}{{3}^{2}}$ |
| . . . | . . . |

J2. 2-D Analysis of Back Grating Shift with Rotation

From the point of view of an observer, the back grating of the ODR (shown at 144 in FIG. 12A) shifts relative to the front grating (142 in FIG. 12A) as the ODR rotates (i.e., is viewed obliquely). The two dimensional (2-D) case is considered in this subsection because it illuminates the properties of the ODR and because it is the applicable analysis when an ODR is arranged to measure rotation about a single axis. The process of back-grating shift is illustrated in FIG. 12A and discussed in Section G2.

J2.1. The Far-field Case, with Refraction

In the ODR embodiment of FIG. 11, the ODR has primary axis 130 and secondary axis 132. The X and Y axes of the ODR coordinate frame are defined such that unit vector ^{r}X_{D}∈R³ is parallel to primary axis 130, and unit vector ^{r}Y_{D}∈R³ is parallel to the secondary axis 132 (the ODR coordinate frame is further described in Section L2.4). The notation ^{r}X_{D}∈R³ indicates that ^{r}X_{D} is a vector of three elements which are real numbers, for example ^{r}X_{D}=[1 0 0]^{T}. This notation will be used to indicate the sizes of vectors and matrices below. A special case is a real scalar which is in R¹, for example Δx_{b}∈R¹.

As described below in connection with FIG. 11, δ^{b}x∈R³ [meters] is the shift of the back grating due to rotation. In the general three-dimensional (3-D) case, considered in section J3., below, and for the ODR embodiment described in connection with FIG. 11, the phase shift ν of the observed radiation pattern is determined in part by the component of δ^{b}x which is parallel to the primary axis, said component being given by:

δ^{Db}x=^{r}X_{D}^{T} δ^{b}x (24)

where δ^{Db}x [meters] is the component of δ^{b}x which contributes to determination of phase shift ν. In the special, two-dimensional (2-D) case described in this section we are always free to choose the reference coordinate frame such that the X axis of the reference coordinate frame is parallel to the primary axis of the ODR, with the result that ^{r}X_{D}^{T}=[1 0 0]^{T} and δ^{Db}x=δ^{b}x (1)

A detailed view of the ODR at approximately a 45° angle is seen in FIG. 34. The apparent shift in the back grating relative to the front grating due to an oblique view angle, δ^{Db}x, (e.g., as discussed in connection with FIG. 12B) is given by:

δ^{Db}x=z₁ tan θ′ [meters] (25)

The angle of propagation through the substrate, θ′, is given by Snell's law:

$${n}_{1} sin θ = {n}_{2} sin {θ}^{′}$$

$$or$$

$${θ}^{′} = {sin}^{- 1} ( \frac{{n}_{1}}{{n}_{2}} sin θ )$$

Where

θ is the rotation angle 136 (e.g., as seen in FIG. 12A) of the ODR [degrees],

θ′ is the angle of propagation in the substrate 146 [degrees],

z₁ is the thickness 147 of the substrate 146 [meters],

n₁, n₂ are the indices of refraction of air and of the substrate 146, respectively.

The total primary-axis shift, Δx_{b}, of the back grating relative to the front grating is the sum of the shift due to the rotation angle and a fabrication offset of the two gratings:

$$Δ {x}_{b} = {δ}^{D b} x + {x}_{0} = {z}_{l} tan ( {sin}^{- 1} ( \frac{{n}_{1}}{{n}_{2}} sin θ ) ) + {x}_{0} \qquad ( 26 )$$

Where

Δx_{b}∈R¹ is the total shift of the back grating [meters],

x₀∈R¹ is the fabrication offset of the two gratings [meters] (part of the reference information).

Accordingly, for x₀=0 and θ=0°, i.e., normal viewing, from Eqn (26) it can be seen that Δx_{b}=0 (and, hence, ν=0 from Eqn (22)).

Writing the derivative of Eqn (26) w.r.t. θ gives:

$$\frac{ⅆ {δ}^{D b} x}{ⅆ θ} = {z}_{l} \frac{{n}_{1}}{{n}_{2}} \frac{cos ( θ )}{{( 1 - {( \frac{{n}_{1}}{{n}_{2}} sin ( θ ) )}^{2} )}^{\frac{3}{2}}}$$

Writing the Taylor series expansion of the δ^{Db}x term of Eqn (26) gives:

$$\frac{{δ}^{D b} x}{{z}_{l}} = \frac{{n}_{1}}{{n}_{2}} θ + \frac{{n}_{1} ( - \frac{1}{6} + \frac{{n}_{1}^{2}}{2 {n}_{2}^{2}} )}{{n}_{2}} {θ}^{3} + \\ \frac{{n}_{1} ( \frac{1}{120} + \frac{\frac{3 {n}_{1}^{4}}{2 {n}_{2}^{4}} - \frac{2 {n}_{1}^{2}}{3 {n}_{2}^{2}}}{4} - \frac{{n}_{1}^{2}}{12 {n}_{2}^{2}} )}{{n}_{2}} {θ}^{5} + 𝔒 ( {θ}^{7} ) \qquad ( 27 )$$

Using the exemplary indices of refraction n₁=1.0 and n₂=1.5, the Taylor series expansion becomes

$$\frac{{δ}^{D b} x}{{z}_{l}} = \frac{2}{3} \frac{π}{180} θ + \frac{1}{27} {( \frac{π}{180} )}^{3} {θ}^{3} - \frac{31}{1620} {( \frac{π}{180} )}^{5} {θ}^{5} + 𝔒 ( {θ}^{7} ) \\ = 0.666667 \frac{π}{180} θ + 0.037037 {( \frac{π}{180} )}^{3} {θ}^{3} - \\ 0.0191358 {( \frac{π}{180} )}^{5} {θ}^{5} + 𝔒 ( {θ}^{7} ) \qquad ( 28 )$$

where θ is in [degrees].

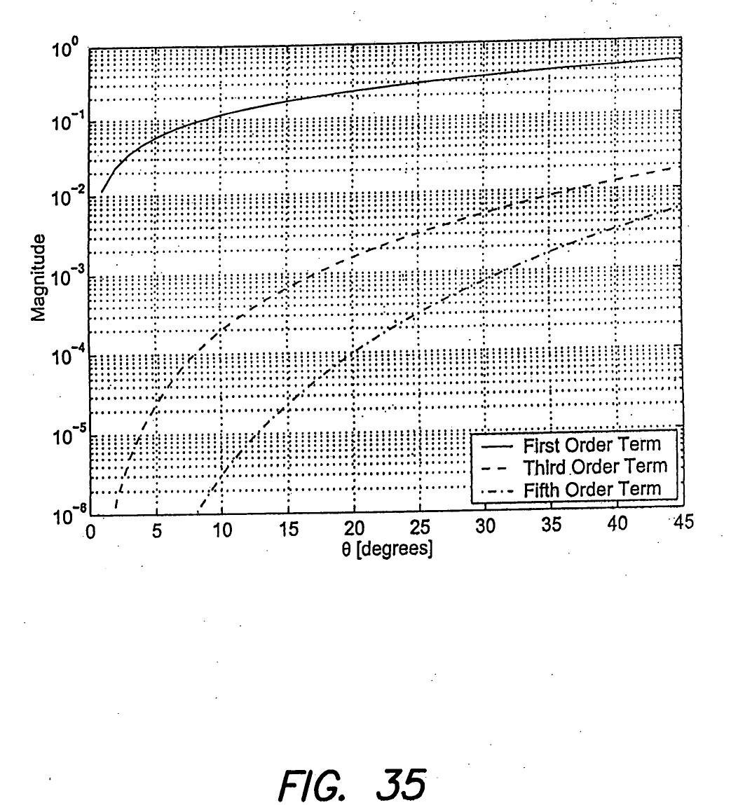

One sees from Eqn (28) that the cubic and quintic contributions to δ^{b}x are not necessarily insignificant. The first three terms of Eqn (28) are plotted as a function of angle in FIG. 35. From FIG. 35 it can be seen that the cubic term makes a part per thousand contribution to δ^{b}x at 10° and a 1% contribution at 25°.

Accordingly, in the far-field case, ν (or x_{T}) is observed from the ODR (see FIG. 33), divided by f_{b} to obtain Δx_{b} (from Eqn (22)), and finally Eqn (26) is evaluated to determine the ODR rotation angle θ (the angle 136 in FIG. 34).

J2.2. The Near-field Case, with Refraction

ODR observation geometry in the near-field is illustrated in FIG. 36. Whereas in FIG. 12B all rays are shown parallel (corresponding to the camera located far from the ODR) in FIG. 36, observation rays A and B are shown diverging by angle ψ.

From FIG. 36, it may be observed that the observation angle ψ is given by:

$$ψ = {tan}^{- 1} ( \frac{{}^{f} x ( 1 ) cos θ}{{z}_{cam} + {}^{f} x ( 1 ) sin θ} ) \qquad ( 29 )$$

where ^{f}x∈R³ [meters] is the observed location on the observation (front) surface 128A of the ODR; ^{f}x(1)∈R¹ [meters] is the X-axis component of ^{f}x; ^{f}x(1)=0 corresponds to the intersection of the camera bearing vector 78 and the reference point 125A (x=0) on the observation surface of the ODR; the camera bearing vector 78 extends from the reference point 125A of the ODR to the origin 66 of the camera coordinate system; z_{cam} is the length 410 of the camera bearing vector, (i.e., the distance between the ODR and the camera origin 66); and θ is the angle between the ODR normal vector and the camera bearing vector [degrees].

The model of FIG. 36 and Eqn (29) assumes that the optical axis of the camera intersects the center of the ODR region. From FIG. 36 it may be seen that in two dimensions the angle between the observation ray B and an observation surface normal at ^{f}x(1) is θ+ψ; accordingly, from Eqn (25) and Snell's law (see FIG. 34, for example)

$${δ}^{D b} x = {z}_{l} tan ( {sin}^{- 1} ( \frac{{n}_{1}}{{n}_{2}} sin ( θ + ψ ) ) ) . \qquad ( 30 )$$

Because ψ varies across the surface, δ^{Db}x is no longer constant, as it is for the far-field case. The rate of change of δ^{Db}x along the primary axis of the ODR is given by:

$$\frac{ⅆ {δ}^{D b} x}{ⅆ {}^{f} x ( 1 )} = \frac{ⅆ {δ}^{D b} x}{ⅆ ψ} \frac{ⅆ ψ}{ⅆ {}^{f} x ( 1 )} = \frac{ⅆ}{ⅆ ψ} {z}_{l} tan ( {sin}^{- 1} ( \frac{{n}_{1}}{{n}_{2}} sin ( θ + ψ ) ) ) \frac{ⅆ ψ}{ⅆ {}^{f} x ( 1 )} \qquad ( 31 )$$

The pieces of Eqn (31) are given by:

$$\begin{matrix}\frac{ⅆ {δ}^{D b} x}{ⅆ ψ} = {z}_{l} \frac{{n}_{1}}{{n}_{2}} \frac{cos ( θ + ψ )}{{( 1 - {( \frac{{n}_{1}}{{n}_{2}} sin ( θ + ψ ) )}^{2} )}^{\frac{3}{2}}} & ( 32 ) \\ {And }^{1} & \\ \frac{ⅆ ψ}{ⅆ {}^{f} x ( 1 )} = \frac{{z}_{cam} cos θ}{{z}_{cam}^{2} + 2 {z}_{cam} sin θ {}^{ f} x ( 1 ) + {{}^{f} x ( 1 )}^{2}} & ( 33 )\end{matrix}$$

The term

$$\frac{ⅆ {δ}^{D b} x}{ⅆ {}^{f} x ( 1 )}$$

is significant because it changes the apparent frequency of the back grating. The apparent back-grating frequency, f_{b}′, is given by:

$${f}_{b}^{′} = {f}_{b} \frac{{d}^{ b} x}{d {}^{ f} x ( 1 )} = {f}_{b} ( 1 + \frac{ⅆ {δ}^{D b} x}{ⅆ {}^{f} x ( 1 )} ) [ \frac{cycles}{meter} ] \qquad ( 34 )$$

From Eqns (31) and (33) it should be appreciated that the change in the apparent frequency f_{b}′ of the back grating is related to the distance z_{cam}. The near-field effect causes the swept-out length of the back grating to be greater than the swept-out length of the front grating, and so the apparent frequency of the back grating is always increased. This has several consequences:

An ODR comprising two gratings and a substrate can be reversed (rotated 180° about its secondary axis), so that the back grating becomes the front and vice versa. In the near-field case, the spatial periods are not the same for the Moire patterns seen from the two sides. When the near-field effect is considered, f_{M}′∈R¹, the apparent spatial frequency of the ODR triangle waveform (e.g. as seen at 126A in ¹Equations (32) and (33) have the intriguing property of canceling curvature when n₁=n₂. This numerical result has not yet been established algebraically. FIG. 33) will depend on the apparent back-grating frequency f_{b}′

$${f}_{M}^{′} = \vert {f}_{f} - {f}_{b}^{′} \vert [ \frac{cycles}{meter} ]$$

When sign (f_{f}−f_{b})=sign (f_{f}−f_{b}) we may right:

$${f}_{M}^{′} = \vert {f}_{f} - {f}_{b}^{′} \vert = ( {f}_{f} - {f}_{b} ) - {f}_{b} \frac{ⅆ {δ}^{D b} x}{ⅆ {}^{f} x ( 1 )} sign ( {f}_{f} - {f}_{b} ) \qquad ( 35 )$$

where the sign(·) function is introduced by bringing the differential term out from the absolute value. If the back grating has the lower spatial frequency, the effective increase in f_{b} due to the near-field effect reduces f_{f}−f_{b}′, and f_{M}′ is reduced. Correspondingly, if the back grating has the higher spatial frequency f_{M}′ is increased. This effect permits differential mode sensing of z_{cam}.

In contrast, when the ODR and camera are widely separated and the far-field approximation is valid, the spatial frequency of the Moire pattern (i.e., the triangle waveform of orientation-dependent radiation) is given simply by f_{M}=|f_{f}−f_{b}| and is independent of the sign of (f_{f}−f_{b}). Thus, in the far-field case, the spatial frequency (and similarly, the period 154 shown in FIGS. 33 and 13D) of the ODR transmitted radiation is independent of whether the higher or lower frequency grating is in front.

There is a configuration in which the Moiré pattern disappears in the near-field case: for example, given a particular combination of ODR parameters z₁, f_{f} and f_{b}, and pose parameters θ and z_{cam} in Eqn (31):

$${f}_{M}^{′} = \vert {f}_{f} - {f}_{b}^{′} \vert = \vert {f}_{f} - {f}_{b} - {f}_{b} \frac{ⅆ {δ}^{D b} x}{ⅆ {}^{f} x ( 1 )} \vert = 0.$$

Front and back gratings with identical spatial frequencies, f_{f}=f_{b}, produce a Moiré pattern when viewed in the near field. The near-field spatial frequency f_{M}′ of the Moiré pattern (as given by Eqn (35)) indicates the distance z_{cam} to the camera if the rotation angle θ is known (based on Eqns (31) and (33)).

J2.3. Summary

Several useful engineering equations can be deduced from the foregoing.

Detected phase angle ν is given in terms of δ^{Db}x (assuming the fabrication offset x₀=0, from Eqns (22) and (4)):

ν=δ^{Db}x f_{b} 360 [degrees]

δ^{Db}x as a function of ^{f}x(1), z_{cam} and θ:

$${δ}^{D b} x ( {}^{f} x ( 1 ) , {z}_{cam} , θ ) = {z}_{l} tan ( {sin}^{- 1} ( \frac{{n}_{1}}{{n}_{2}} sin ( θ + {tan}^{- 1} ( \frac{{}^{ f} x ( 1 ) cos θ}{{z}_{cam} - {}^{ f} x ( 1 ) sin θ} ) ) ) )$$

ODR sensitivity

The position x_{T} of a peak (e.g., the peak 152B shown in FIG. 33) of the triangle waveform of the orientation-dependent radiation emanated by an ODR, relative to the reference point 125A (x=0). Taking the fabrication offset x₀=0, the position x_{T} of the triangular waveform is given by

$${x}_{T} = \frac{1}{{f}_{M}^{′}} v = \frac{1}{{f}_{M}^{′}} {f}_{b} {z}_{l } tan ( {sin}^{- 1} ( \frac{{n}_{1}}{{n}_{2}} sin θ + ψ {\vert}_{{f}_{x ( 1 ) = {x}_{T}}} ) ) \approx \frac{{f}_{b}}{{f}_{M}^{′}} {z}_{l} \frac{{n}_{1}}{{n}_{2}} \frac{π}{180} θ \qquad ( 36 )$$

where θ is in degrees, and wherein the first term of the Taylor series expansion in Eqn (27) is used for the approximation in Eqn (36).

From Eqn (36) an ODR sensitivity may be defined as S_{ODR}=x_{T}/θ and may be approximated by:

$${S}_{ODR} = \frac{{f}_{b}}{{f}_{M}^{′}} {z}_{l} \frac{{n}_{1}}{{n}_{2}} \frac{π}{180} [ meters / degree ] \qquad ( 37 )$$

A threshold angle θ^{T} in degrees for the trigonometric functions in Eqn (36) to give less than a 1% effect (i.e., the approximation in Eqn (36) has an error of less than 1%) is given by:

$$( - \frac{1}{6} + \frac{{n}_{1}^{2}}{2 {n}_{2}^{2}} ) {( \frac{π}{180} )}^{3} {( {θ}^{T} )}^{3} < 1 \% \qquad ( 38 )$$

(From the cubic term of the Taylor series expansion, Eqn (27)). Using n₁=1.0, and n₂=1.5 gives:

θ<θ^{T}=14°

Threshold for the length of the camera bearing vector, z_{cam}^{T}, for the near-field effect to give a change in f_{M}′ of less than 1%:

$${f}_{b} \frac{ⅆ {δ}^{D b} x}{ⅆ {}^{f} x ( 1 )} < 1 \% {f}_{M}^{′} \qquad ( 39 )$$

Evaluating Eqn (35) with n₁=1.0, n₂=1.5 and θ=0° gives

$$\frac{ⅆ {δ}^{D b} x}{ⅆ {}^{f} x ( 1 )} \approx 0.65 \frac{{z}_{l}}{{z}_{cam}^{T}}$$

and substituting into Eqn (39) gives:

$$\frac{1}{0.01 \%} \frac{0.65 {f}_{b}}{{f}_{M}^{′}} {z}_{l} < {z}_{cam}^{T} \qquad ( 40 )$$

Accordingly, Eqn (40) provides one criterion for distinguishing near-field and far-field observation given particular parameters. In general, a figure of merit FOM may be defined as a design criterion for the ODR 122A based on a particular application as

$$FOM = \frac{{f}_{b} {z}_{l}}{{f}_{M}^{′} {z}_{cam}} , \qquad ( 41 )$$

where an FOM>0.01 generally indicates a reliably detectable near-field efface, and an FOM>0.1 generally indicates an accurately measurable distance z_{cam}. The FOM of Eqn (41) is valid if f_{M}′ z_{cam}>f_{b} zₗ; otherwise, the intensity of the near-field effect should be scaled relative to some other measure (e.g., a resolution of f_{M}′). For example, f_{M}′ can be chosen to be very small, thereby increasing sensitivity to z_{cam}.

In sum, an ODR similar to that described above in connection with various figures may be designed to facilitate the determination of a rotation or oblique viewing angle q of the ODR based on an observed position x_{T} of a radiation peak and a predetermined sensitivity S_{ODR}, from Eqns (36) and (37). Additionally, the distance z_{cam} between the ODR and the camera origin (i.e., the length 410 of the camera bearing vector 78) may be determined based on the angle θ and observing the spatial frequency f_{M}′ (or the period 154 shown in FIGS. 33 and 13D) of the Moire pattern produced by the ODR, from Eqns (31), (33), and (35).

J3. General 3-D Analysis of Back Grating Shift in the Near Field with Rotation

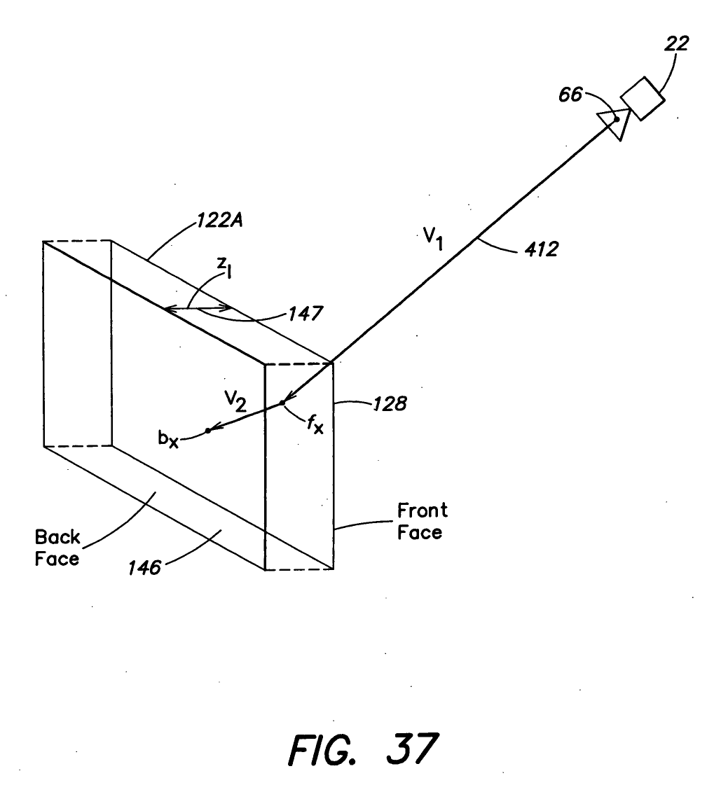

The apparent shift of the back grating as seen from the camera position determines the phase shift of the Moire pattern. This apparent shift can be determined in three dimensions by vector analysis of the line of sight. Key terms are defined with the aid of FIG. 37.

V₁∈R³ is the vector 412 from the camera origin 66 to a point ^{f}x of the front (i.e., observation) surface 128 of the ODR 122A;

V₂∈R³ is the continuation of the vector V₁ through the ODR substrate 146 to the back surface (V₂ is in general not collinear with V₁ because of refraction);

^{f}x∈R³ is the point where vector V₁ strikes the front surface (the coordinate frame of measurement is indicated by the left superscript, coordinate frames are discussed further in Section L2.4); ^{b}x∈R³ is the point where vector V₂ strikes the back surface.

J3.1. Determination of Phase Shift ν as a Function of ^{f}x, ν(^{f}x)

In n dimensions, Snell's law may be written:

(42)

n₂ \overline{V}₂^{⊥}=n₁ \overline{V}₁^{⊥}, (43)

where \overline{V}^{⊥} is the component of the unit direction vector of V₁ or V₂ which is orthogonal to the surface normal. Using Eqn (43) and the fact that the surface normal may be written as a unit vector (e.g., in reference coordinates) V^{∥}=[ 0 0 1]^{T}, V₂ can be computed by:

$$\begin{matrix}{V}_{1} = {}^{f} x - {}_{}^{r}{P}{}_{{O}_{c}}^{} & ( 44 ) \\ {\overline{V}}_{1}^{⊥} = {[ {V}_{1} ( 1 \text{:} 2 ) / \vert {V}_{1} \vert , 0 ]}^{T} ; {\overline{V}}_{2}^{⊥} = \frac{{n}_{1}}{{n}_{2}} {\overline{V}}_{1}^{⊥} & \\ {\overline{V}}_{2} = [ {\overline{V}}_{1}^{⊥} ( 1 \text{:} 2 ) , - \sqrt{( 1 - {( {\overline{V}}_{1}^{⊥} )}^{T} {\overline{V}}_{2}^{⊥} )} ] & \\ {δ}^{ b} x ( {}^{f} x ) = \frac{{z}_{l}}{{\overline{V}}_{2} ( 3 )} {\overline{V}}_{2} & ( 45 )\end{matrix}$$

Using δ^{b}x(^{f}x), ν(^{f}x), the Moiré pattern phase, ν, is given by:

δ^{Db}x=^{r}X_{D}^{T} δ^{b}x (46)

where ^{r}P_{O}^{_{c}} is the location of the origin of camera coordinate expressed in reference coordinates; δ^{Db}x∈R¹ [meters] is the component of δ^{b}x∈R³ that is parallel to the ODR primary axis and which determines ν:

ν(^{f}x)=ν₀+360(f_{b}−f_{f})^{Df}x+360f_{b}δ^{Db}x[deg] (47)

where

ν(^{f}x)∈R¹ is the phase of the Moiré pattern at position ^{f}x∈R³;

^{Df}x∈R¹, ^{Df}x=^{r}X_{D}^{T f}x;

^{r}X_{D}∈R³ is a unit vector parallel to the primary axis of the ODR.

The model of luminance used for camera calibration is given by the first harmonic of the triangle waveform:

\hat{L}(^{f}x)=a₀+a₁ cos(ν(^{f}x)) (48)

where a₀ is the average luminance across the ODR region, and a₁ is the amplitude of the Luminance variation.

Equations (47) and (48) introduce three model parameters per ODR region: ν₀, a₀ and a₁. Parameter ν₀ is a property of the ODR region, and relates to how the ODR was assembled. Parameters a₀ and a₁ relate to camera aperture, shutter speed, lighting conditions, etc. In the typical application, ν₀ is estimated once as part of a calibration procedure, possibly at the time that the ODR is manufactured, and a₀ and a₁ are estimated each time the orientation of the ODR is estimated.

### K: Landmark Detection Methods

Three methods are discussed below for detecting the presence (or absence) of a mark in an image: cumulative phase rotation analysis, regions analysis and-intersecting edges analysis. The methods differ in approach and thus require very different image characteristics to generate false positives. In various embodiments, any of the methods may be used for initial detection, and the methods may be employed in various combinations to refine the detection process.

K1. Cumulative Phase Rotation Analysis

In one embodiment, the image is scanned in a collection of closed paths, such as are seen at 300 in FIG. 19. The luminance is recorded at each scanned point to generate a scanned signal. An example luminance curve is seen before filtering in FIG. 22A. This scan corresponds to one of the circles in the left-center group 334 of FIG. 19, where there is no mark present. The signal shown in FIG. 22A is a consequence of whatever is in the image in that region, which in this example is white paper with an uneven surface.

The raw scanned signal of FIG. 22A is filtered in the spatial domain, according to one embodiment, with a two-pass, linear, digital, zero-phase filter. The filtered signal is seen as the luminance curve of FIG. 22B. Other examples of filtered luminance curves are shown in FIGS. 16B, 17B and 18B.

After filtering, the next step is determination of the instantaneous phase rotation of a given luminance curve. This can be done by Kalman filtering, by the short-time Fourier transform, or, as is described below, by estimating phase angle at each sample. This latter method comprises:

1. Extending the filtered, scanned signal representing the luminance curve at the beginning and end. to produce the signal that would be obtained by more than 360° of scanning. This may be done, for example, by adding the segment from 350° to 360° before the beginning of the signal (simulating scanning from −10° to 0°) and adding the segment from 0° to 10° after the end.

2. Constructing the quadrature signal according to:

a(i)=λ(i)+jλ(i−Δ) (49)

Where

a(i)∈C¹ is a complex number (indicated by α(i)∈C¹) representing the phase of the signal at point (i.e., pixel sample) i;

λ(i)∈R¹ is the filtered luminance at pixel i (e.g., i is an index on the pixels indicated. such as at 328, in FIG. 20);

Δ∈Z⁺ is a positive integer (indicated by Δ∈Z⁺) offset, given by:

$$Δ = round ( \frac{{360}^{∘}}{4 * N} / \frac{{360}^{∘}}{{N}_{s}} ) \qquad ( 50 )$$

Nₛ is the number of points in the scanned path, and N is the number of separately identifiable regions of the mark;

j is the complex number.

3. The phase rotation δηᵢ∈R¹ [degrees] between sample i−1 and sample i is given by:

$$\begin{matrix}{δη}_{i} = a tan 2 ( i m ( b ( i ) ) , r e ( b ( i ) ) ) & ( 51 ) \\ where & \\ b ( i ) = \frac{a ( i )}{a ( i - 1 )} & \end{matrix}$$

and where a tan 2(−, −) is the 2-argument arc-tangent function as provided, for example, in the C programming language math library.

4. And the cumulative phase rotation at scan index i, ηᵢ∈R¹, is given by:

ηᵢ=ηᵢ₋₁+δηᵢ (52)

Examples of cumulative phase rotation plots are seen in FIGS. 16C, 17C, 18C, and 22C. In particular, FIGS. 16C, 17C and 18C show cumulative phase rotation plots when a mark is present, whereas FIG. 22C shows a cumulative phase rotation plot when no mark is present. In each of these figures ηᵢ is plotted against φᵢ∈R¹, where φᵢ is the scan angle of the pixel scanned at scan index i, shown at 344 in FIG. 20. The robust fiducial mark (RFID) shown at 320 in FIG. 19 would give a cumulative phase rotation curve (ηᵢ) with a slope of N when plotted against φᵢ. In other words, for normal viewing angle and when the scanning curve is centered on the center of the RFID

ηᵢ=N φᵢ

In each of FIGS. 16C, 17C, 18C and 22C the ηᵢ curve is shown at 366 and the N φᵢ curve is shown at 349. Compared with FIGS. 16C, 17C and 18C, the deviation in FIG. 22C from of the curve 366, from the N φ reference line 349 is very large. This deviation is the basis for the cumulative phase rotation analysis. A performance measure for detection is:

$${J}_{1} = \frac{rms ( [ λ ] )}{ϵ ( [ η ] )} \qquad ( 53 )$$

Where

rms ([λ]) is the RMS value of the (possibly filtered) luminance signal [λ], and ε([η]) is the RMS deviation between the N φ reference line 349 and the cumulative phase rotation of the luminance curve:

ε([η])=rms([η]−N [φ]); (54)

and where [λ], [η], and [φ] indicates vectors of the corresponding variables over the Nₛ samples along the scan path.

The offset 362 shown in FIG. 18A indicates the position of the center of the mark with respect to the center of the scanning path. The offset and tilt of the mark are found by fitting to first and second harmonic terms the difference between the cumulative phase rotation, e.g. 346, 348, 350 or 366, reference line 349:

$$\begin{matrix}{Φ}_{c} = [ \begin{matrix}⋮ & ⋮ & ⋮ & ⋮ \\ cos ( [ φ ] ) & sin ( [ φ ] ) & cos ( 2 [ φ ] ) & sin ( 2 [ φ ] ) \\ ⋮ & ⋮ & ⋮ & ⋮\end{matrix} ] \\ {Π}_{c} = {( {Φ}_{c}^{T} {Φ}_{c} )}^{- 1} {Φ}_{c}^{T} ( [ η ] - N [ φ ] ) \end{matrix} \qquad ( 55 )$$

Where

Eqn (55) implements a least-squared error estimate of the cosine and sine parts of the first and second harmonic contributions to the cumulative phase curve;

and [φ] is the vector of sampling angles of the scan around the closed path (i.e., the X-axis of FIGS. 16B, 16C, 17B, 17C, 18B, 18C , 22B and 22C).

This gives:

η(φ)=N φ+Π_{c}(1)cos(φ)+Π_{c}(3)sin(φ)+Π_{c}(3)cos(2φ)+Π_{c}(4)sin(2φ) (56)

where the vector Π_{c}∈R⁴ comprises coefficients of cosine and sine parts for the first and second harmonic; these are converted to magnitude and phase by writing:

η(φ)=Nφ+A₁ cos(φ+β₁)+A₂ cos(2φ+β₂) (57)

Where

A₁=\sqrt{Π_{c}(1)²+Π_{c}(2)²}

β₁=−a tan 2(Π_{c}(2), Π_{c}(1)) [degrees]

A₂=\sqrt{Π_{c}(3)²+Π_{c}(4)²}

β₂=−a tan 2(Π_{c}(4), Π_{c}(3)) [degrees]

Offset and tilt of the fiducial mark make contributions to the first and second harmonics of the cumulative phase rotation curve according to:

| Effect | First Harmonic | Second Harmonic |
|---|---|---|
| Offset | X | X |
| Tilt | | X |

So offset and tilt can be determined by:

1. Determining the offset from the measured first harmonic;

2. Subtracting the influence of the offset from the measured second harmonic;

3. Determining the tilt from the adjusted measured second harmonic.

1. The offset is determined from the measured first harmonic by:

$${X}_{0} = [ \begin{matrix}{x}_{0} \\ {y}_{0}\end{matrix} ] = \frac{{A}_{1}}{N} \frac{2 π}{360} ∠ ( {90}^{∘} - {β}_{1} ) = \frac{{A}_{1}}{N} \frac{2 π}{360} [ \begin{matrix}sin ( {β}_{1} ) \\ cos ( {β}_{1} )\end{matrix} ] [ pixels ] \qquad ( 58 )$$

2. The contribution of offset to the cumulative phase rotation is given by:

ηₒ(φ)=A₁ cos(φ+β₁)+A₂ₐ cos(2φ+β₂ₐ)

Where ηₒ is the contribution to η due to offset, and with

$${A}_{2 a} = \frac{1}{2} {( \frac{{A}_{1}}{N} )}^{2} \frac{2 π}{360} ; {β}_{2 a} = 90 + 2 {β}_{1}$$

Subtracting the influence of the offset from the measured second harmonic gives the adjusted measured second harmonic:

Π′_{c}(3)=Π_{c}(3)−A₂ₐ cos(β₂ₐ)

Π′_{c}(4)=Π_{c}(4)−A₂ₐ sin(β₂ₐ)

3. And finally,

A_{2b}=\sqrt{Π′_{c}(3)²+Π′_{c}(4)²}

β_{2b}=−a tan 2(Π′_{c}(4), Π′_{c}(3)) (59)

Where the second harmonic contribution due to tilt is given by:

ν_{2b}(φ)=A_{2b} cos(2φ+β_{2b})

The tilt is then given by:

$$\begin{matrix}{r}_{t} = 1 - 2 {A}_{2 b} \frac{2 π}{360} [ rad ] & ( 60 ) \\ {ρ}_{t} = \frac{{β}_{2 b} - {90}^{∘}}{2} [ deg ] & \end{matrix}$$

where ρₜ is the rotation to the tilt axis, and θₜ=cos⁻¹(rₜ) is the tilt angle.

K1.1. Quadrature Color Method

With color imaging a fiducial mark can contain additional information that can be exploited to enhance the robustness of the detection algorithm. A quadrature color RFID is described here. Using two colors to establish quadrature on the color plane it is possible to directly generate phase rotation on the color plane, rather than synthesizing it with Eqn (51). The results—obtained at the cost of using a color camera—is reduced computational cost and enhanced robustness, which can be translated to a smaller image region required for detection or reduced sensitivity to lighting or other image effects.

An example is shown in FIG. 23A. The artwork is composed of two colors, blue and yellow, in a rotating pattern of black-blue-green-yellow-black . . . where green arises with the combination of blue and yellow.

If the color image is filtered to show only blue light, the image of FIG. 23B is obtained; a similar but rotated image is obtained by filtering to show only yellow light.

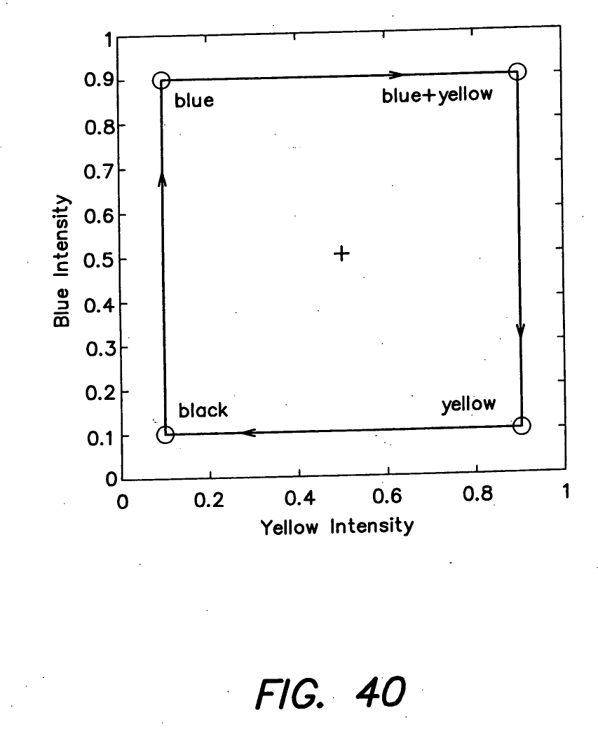

On an appropriately scaled 2-dimensional color plane with blue and yellow as axes, the four colors of FIG. 23A lie at four corners of a square centered on the average luminance over the RFID, as shown in FIG. 40. In an alternative embodiment, the color intensities could be made to vary continuously to produce a circle on the blue-yellow plane. For a RFID pattern with N spokes (cycles of black-blue-green-yellow) the detected luminosity will traverse the closed path of FIG. 40 N times. The quadrature signal at each point is directly determined by:

a(i)=(λ_{y}(i)−\overline{λ}_{y})+j(λ_{b}(i)−\overline{λ}_{b}) (61)

where λ_{y}(i) and λ_{b}(i) are respectively the yellow and blue luminosities at pixel i; and \overline{λ}_{y} and \overline{λ}_{b} are the mean yellow and blue luminosities; respectively. Term a(i) from Eqn (61) can be directly used in Eqn (49), et. seq. to implement the cumulative phase rotation algorithm, with the advantages of:

Greatly increased robustness to false positives due to both the additional constraint of the two color pattern and the fact that the quadrature signal, the jλ(i−Δ) term in Eqn (49), is drawn physically from the image rather than synthesized, as described with Eqn (49) above;

Reduced computational cost, particularly if regions analysis is rendered unnecessary by the increased robustness of the cumulative phase rotation algorithm with quadrature color, but also, for example, by doing initial screening based on the presence of all four colors along a scanning path.

Regions analysis and intersecting edges analysis could be performed on binary images, such as shown in FIG. 40. For very high robustness, either of these analyses could be applied to both the blue and yellow filtered images.

K2. Regions Analysis

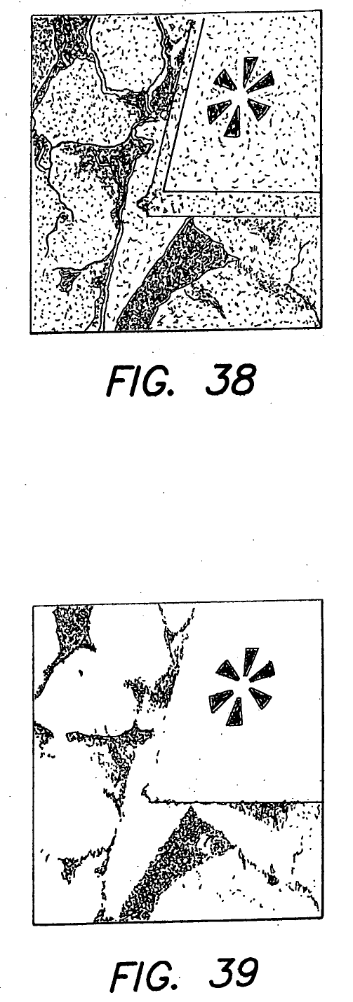

In this method, properties such as area, perimeter, major and minor axes, and orientation of arbitrary regions in an image are evaluated. For example. as shown in FIG. 38, a section of an image containing a mark can be thresholded, producing a black and white image with distinct connected regions as seen in FIG. 39. The binary image contains distinct regions of contiguous black pixels.

Contiguous groups of black pixels may be aggregated into labeled regions. The various properties of the labeled regions can then be measured and assigned numerical quantities. For example, 165 distinct black regions in the image of FIG. 39 are identified, and for each region a report is generated based on the measured properties, an example of which is seen in Table 6. In short, numerical quantities are computed for each of several properties for each contiguous region.

TABLE 6
Representative sample of properties of distinct black regions in FIG. 39.

| Region | | | Major Axis | Minor Axis | Orienta- |
|---|---|---|---|---|---|
| Index | Area | Centroid | Length | Length | tion |
| 1 | 1 | [1.00, 68.00] | 1.15 | 1.15 | 0 |
| 2 | 1102 | [32.87, 23.70] | 74.83 | 29.73 | 59.9 |
| . . . | | | | | |
| 165 | 33 | [241.27, 87.82] | 15.56 | 3.05 | 93.8 |

Scanning in a closed path, it is possible to identify each labeled region touched by the scan pixels. An algorithm to determine if the scan lies on a mark having N separately identifiable regions proceeds by:

1. Establishing the scan pixels encircling a center;

2. Determining the labeled regions touched by the scan pixels;

3. Throwing out any labeled regions with an area less than a minimum threshold number of pixels;

4. If there are not N regions, reject the candidate;

5. If there are N regions, compute a performance measure according to:

$$\overline{C} = \frac{\sum {C}_{i}}{N} \qquad ( 62 )$$

V_{C}_{ᵢ}=Cᵢ−\overline{C} (63)

\overline{ω}ᵢ=a tan 2(V_{C}_{ᵢ}(2), V_{C}_{ᵢ}(1)) (64)

\overline{\tilde{ω}}ᵢ=\overline{ω}ᵢ−\overline{\hat{ω}}ᵢ (65)

$$\begin{matrix}{J}_{2} = 1 / {\sum }_{i}^{N / 2} \{ {( {A}_{i} - {A}_{{i}^{*}} )}^{2} / {( ( {A}_{i} + {A}_{{i}^{*}} ) / 2 )}^{2} + \\ {( {M}_{i} - {M}_{{i}^{*}} )}^{2} / {( ( {M}_{i} + {M}_{{i}^{*}} ) / 2 )}^{2} + \\ {( {m}_{i} - {m}_{{i}^{*}} )}^{2} / {( ( {m}_{i} + {m}_{{i}^{*}} ) / 2 )}^{2} + \\ {( {\hat{ϖ}}_{i} - {\hat{ϖ}}_{{i}^{*}} )}^{2} / {( ( {\hat{ϖ}}_{i} + {\hat{ϖ}}_{{i}^{*}} ) / 2 )}^{2} + \\ {( {\tilde{ϖ}}_{i} - {\tilde{ϖ}}_{{i}^{*}} )}^{2} / {( ( {\tilde{ϖ}}_{i} + {\tilde{ϖ}}_{{i}^{*}} ) / 2 )}^{2} \}\end{matrix} \qquad ( 66 )$$

Where

Cᵢ is the centroid of the i^{th} region, i∈1 . . . N;

\overline{C} is the average of the centroids of the regions, an estimate of the center of the mark;

V_{C}_{ᵢ} is the vector from \overline{C} to Cᵢ;

\overline{ω}ᵢ is the angle of V_{C}_{ᵢ};

\overline{\hat{ω}}ᵢ is the orientation of the major axis of the i^{th} region;

\overline{\tilde{ω}}ᵢ is the difference between the i^{th} angle and the i^{th} orientation;

J₂ is the first performance measure of the regions analysis method;

Aᵢ is the area of the i^{th} region, i∈{1 . . . N/2};

i*=i+(N/2), it is the index of the region opposed to the i^{th} region;

Mᵢ is the major axis length of the i^{th} region; and

mᵢ is the minor axis length of the i^{th} region.

Equations (62)-(66) compute a performance measure based on the fact that symmetrically opposed regions of the mark 320 shown in FIG. 16A are equally distorted by translations and rotations when the artwork is far from the camera (i.e., in the far field), and comparably distorted when the artwork is in the near field. Additionally the fact that the regions are elongated with the major axis oriented toward the center is used. Equation (62) determines the centroid of the combined regions from the centroids of the several regions. In Eqn (65) the direction from the center to the center of each region is computed and compared with the direction of the major axis. The performance measure, J₂ is computed based on the differences between opposed spokes in relation to the mean of each property. Note that the algorithm of Eqns (62)-(66) operates without a single tuned parameter. The regions analysis method is also found to give the center of the mark to sub-pixel accuracy in the form of \overline{C}.

Thresholding A possible liability of the regions analysis method is that it requires determination of a luminosity threshold in order to produce a binary image, such as FIG. 38. With the need to determine a threshold, it might appear that background regions of the image would influence detection of a mark, even with the use of essentially closed-path scanning.

A unique threshold is determined for each scan. By gathering the luminosities, as for FIG. 16B, and setting the threshold to the mean of that data, the threshold corresponds only to the pixels under the closed path—which are guaranteed to fall on a detected mark—and is not influenced by uncontrolled regions in the image.

Performing region labeling and analysis across the image for each scan may be prohibitively expensive in some applications. But if the image is thresholded at several levels at the outset and labeling performed on each of these binary images, then thousands of scanning operations can be performed with only a few labelling operations. In one embodiment, thresholding may be done at 10 logarithmically spaced levels. Because of constraints between binary images produced at successive threholds, the cost of generating 10 labeled images is substantially less than 10 times the cost of generating a single labeled image.

K3. Intersecting Edges Analysis

It is further possible to detect or refine the detection of a mark like that shown at 320 in FIG. 16A by observing that lines connecting points on opposite edges of opposing regions of the mark must intersect in the center, as discussed in Section G3. The degree to which these lines intersect at a common point is a measure of the degree to which the candidate corresponds to a mark. In one embodiment several points are gathered on the 2N edges of each region of the mark by considering paths of several radii, these edge points are classified into N groups by pairing edges such as a and g, b and h, etc. in FIG. 16A. Within each group there are Nₚ(i) edge points {xⱼ, yⱼ}ᵢ where i∈{1 . . . N} is an index on the groups of edge points and j∈{1 . . . Nₚ(i)} is an index on the edge points within each group.

Each set of edge points defines a best-fit line, which may be given as:

[symbol]

(αᵢ)=\hat{Ω}ᵢ+αᵢ \hat{μ}ᵢ (67)

$${\hat{Ω}}_{i} = [ \begin{matrix}mean ( {x}_{j} ) \\ mean ( {y}_{j} )\end{matrix} ] \qquad ( 68 )$$

where αᵢ∈R¹ is a scalar parameter describing position along the line, \hat{ω}ᵢ∈R² is one point on the line given as the means of the xⱼ and yⱼ values of the edge points defining the line, \hat{μ}ᵢ∈R² is a vector describing the slope of the line. The values \hat{Ω}ᵢ and \hat{μ}ᵢ are obtained, for example, solving for each group:

$$\begin{matrix}{Φ}_{i} = [ \begin{matrix}1 & {x}_{1} \\ 1 & {x}_{2} \\ ⋮ & ⋮\end{matrix} ] \\ {Π}_{i} = {( {Φ}_{i}^{T} {Φ}_{i} )}^{- 1} {Φ}_{i}^{T} [ \begin{matrix}{y}_{1} \\ {y}_{2} \\ ⋮\end{matrix} ]\end{matrix} \qquad ( 69 )$$

\hat{ξ}ᵢ=90°−a tan(Πᵢ(2)) (70)

where the xⱼ and yⱼ are the X and Y coordinates of image points within a group of edge points, parameters Πᵢ∈R² give the offset and slope of the i^{th} line, and \hat{ξ}ᵢ∈R¹ [degrees] is the slope expressed as an angle. Equation (69) minimizes the error measured along the Y axis. For greatest precision it is desirable to minimize the error measured along an axis perpendicular to the line. This is accomplished by the refinement:

$$\begin{matrix}while δ {\hat{ξ}}_{i} > {ϵ}_{s} do \\ {}_{i}^{l}{R}{}_{i}^{} = [ \begin{matrix}cos ( {\hat{ξ}}_{i} ) & sin ( {\hat{ξ}}_{i} ) \\ - sin ( {\hat{ξ}}_{i} ) & cos ( {\hat{ξ}}_{i} )\end{matrix} ] & ( 71 ) \\ {}_{}^{l}{P}{}_{j}^{} = {}_{i}^{l}{R}{}_{i}^{} ( {[ \begin{matrix}{x}_{j} \\ {y}_{j}\end{matrix} ]}_{i} - {\hat{Ω}}_{i} ) j ∈ \{ 1 … {N}_{p} ( i ) \} & ( 72 ) \\ δ {\hat{ξ}}_{i} = \frac{{[ {}_{}^{l}{P}{}_{1}^{} ( 2 ) {}_{}^{l}{P}{}_{2}^{} ( 2 ) ⋯ ] [ {}_{}^{l}{P}{}_{1}^{} ( 1 ) {}_{}^{l}{P}{}_{2}^{} ( 1 ) ⋯ ]}^{T}}{{[ {}_{}^{l}{P}{}_{1}^{} ( 1 ) {}_{}^{l}{P}{}_{2}^{} ( 1 ) ⋯ ] [ {}_{}^{l}{P}{}_{1}^{} ( 1 ) {}_{}^{l}{P}{}_{2}^{} ( 1 ) ⋯ ]}^{T}} & ( 73 ) \\ {\hat{ξ}}_{i} = {\hat{ξ}}_{i} + δ {\hat{ξ}}_{i} & ( 74 )\end{matrix}$$

where ^{l}Pⱼ(1) and ^{l}Pⱼ(2) refer to the first and second elements of the ^{l}Pⱼ∈R² vector respectively; εₛ provides a stopping condition and is a small number, such as 10⁻¹²; and \hat{μ}ᵢ in Eqn (67) is given by: \hat{μ}ᵢ=[cos(\hat{ξ}ᵢ)sin(\hat{ξ}ᵢ)]^{T}.

The minimum distance dᵢ between a point Ĉ and the i^{th} best-fit line is given by:

αᵢ=\hat{μ}ᵢ^{T}(Ĉ−\hat{Ω}ᵢ)/|\hat{μ}ᵢ|²

dᵢ=|Ĉ−(\hat{Ω}ᵢ+αᵢ\hat{μ}ᵢ)| (75)

The best-fit intersection of a collection of lines, Ĉ, is the point which minimizes the sum of squared distances, Σᵢdᵢ², between Ĉ and each of the lines. The sum of squared distances is given by:

$${Q}_{d} = {\sum }_{i = 1}^{N} {d}_{i}^{2} = {Π}_{d}^{T} {A}_{d} {Π}_{d} + {B}_{d} {Π}_{d} \qquad ( 76 )$$

Π_{d}=[Ĉ(1) Ĉ(2) α₁ α₂ . . . ]^{T}

$$\begin{matrix}{A}_{d} = [ \begin{matrix}N & 0 & - {\hat{μ}}_{1} ( 1 ) & - {\hat{μ}}_{2} ( 1 ) & ⋯ \\ 0 & N & - {\hat{μ}}_{1} ( 2 ) & - {\hat{μ}}_{2} ( 2 ) & ⋯ \\ - {\hat{μ}}_{1} ( 1 ) & - {\hat{μ}}_{1} ( 2 ) & {{\hat{μ}}_{1} ( 1 )}^{2} + {{\hat{μ}}_{1} ( 2 )}^{2} & 0 & 0 \\ - {\hat{μ}}_{2} ( 1 ) & - {\hat{μ}}_{2} ( 2 ) & 0 & {{\hat{μ}}_{2} ( 1 )}^{2} + {{\hat{μ}}_{2} ( 2 )}^{2} & 0 \\ ⋮ & ⋮ & 0 & 0 & ⋰\end{matrix} ] & ( 77 ) \\ {B}_{d} = [ \begin{matrix}{\sum }_{i = 1}^{N} - 2 {\hat{Ω}}_{i} ( 1 ) \\ {\sum }_{i = 1}^{N} - 2 {\hat{Ω}}_{i} ( 2 ) \\ 2 {\hat{Ω}}_{1} ( 1 ) {\hat{μ}}_{1} ( 1 ) + 2 {\hat{Ω}}_{1} ( 2 ) {\hat{μ}}_{1} ( 2 ) \\ 2 {\hat{Ω}}_{2} ( 1 ) {\hat{μ}}_{2} ( 1 ) + 2 {\hat{Ω}}_{2} ( 2 ) {\hat{μ}}_{2} ( 2 ) \\ ⋮\end{matrix} ] & ( 78 )\end{matrix}$$

where Q_{d} is the sum of squared distances to be minimized, Ĉ(1), \hat{Ω}ᵢ(1) \hat{μ}ᵢ(1) refer to the X-axis element of these vectors, and Ĉ(2), \hat{Ω}ᵢ(2) \hat{μ}ᵢ(2) refer to the Y-axis element of these vectors; Π_{d}∈R^{N+2} is a vector of the parameters of the solution comprising the X- and Y-axis values of Ĉ and the parameters αᵢ for each of the N lines, and matrix A_{d}∈R^{(N+2)(N+2)} and row vector B_{d}∈R^{(N+2)} are composed of the parameters of the N best-fit lines.

Equation (76) may be derived by expanding Eqn (75) in the expression Q_{d}=Σᵢ₌₁^{N} dᵢ². Equation (76) may be solved for Ĉ by:

Π_{d}=−(2A_{d})⁻¹ B_{d}^{T} (79)

$$\hat{C} = [ \begin{matrix}{Π}_{d} ( 1 ) \\ {Π}_{d} ( 2 )\end{matrix} ] ; [ \begin{matrix}\begin{matrix}{α}_{1} \\ {α}_{1}\end{matrix} \\ ⋮\end{matrix} ] = [ \begin{matrix}\begin{matrix}{Π}_{d} ( 3 ) \\ {Π}_{d} ( 4 )\end{matrix} \\ ⋮\end{matrix} ] \qquad ( 80 )$$

The degree to which the lines defined by the groups of edge points intersect at a common point is defined in terms of two error measures

ε₁: the degree to which points on opposite edges of opposing regions fail to lie on a line, given by

$${ϵ}_{1} ( i ) = {\sum }_{j} {{}_{}^{l}{P}{}_{j}^{} ( 2 )}^{2} \qquad ( 81 )$$

with ^{l}Pⱼ as given in Eqns (71)-(72), evaluated for the i^{th} line.

ε₂: the degree to which the N lines connecting points on opposite edges of opposing regions fail to intersect at a common point, given by:

$${ϵ}_{2} ( i ) = {\sum }_{j} {d}_{i}^{2} \qquad ( 82 )$$

with dᵢ as given in Eqn (75).

In Summary, the Algorithm is:

1. Several points are gathered on the 2N edges of the regions of the mark by considering paths of several radii, points are classified into N groups by pairing edges a and g, etc.;

2. N best-fit lines are found for the N groups of points using Eqns (67)-(74), and the error by which these points fail to lie on the corresponding best-fit line is determined, giving ε₁(i) for the i^{th} group of points;

3. The centroid Ĉ which is most nearly at the intersection of the N best-fit lines is determined using Eqns (75)-(80);

4. The distance between each of the best-fit lines and the centroid Ĉ is determined, giving ε₂(i) for the i^{th} best-fit line;

5. The performance is computed according to:

$${J}_{3} = 1 / {\sum }_{i}^{N} \{ {ϵ}_{1} ( i ) + {ϵ}_{2} ( i ) \} \qquad ( 83 )$$

K4. Combining Detection Approaches

The detection methods discussed above can be arranged and combined in many ways. One example is given as follows, but it should be appreciated that the invention is not limited to this example.

Thresholding and labeling the image at 10 logarithmically spaced thresholds between the minimum and maximum luminosity.

Essentially closed-path scanning and region analysis, as described in section K2., giving performance measure J₂ of Eqn (66).

This reduces the number of mark candidates to a manageable number. Setting aside image defects. such as a sun light glint on the mark artwork, there are no false negatives because uncontrolled image content in no way influences the computation of J₂. The mnmber of false-positive detections is highly dependent upon the image. In some cases there are no false-positives at this point.

Refinement by fitting the edges of the regions of the mark, as described in section K3., giving J₃ of Eqn (83). This will eliminate false positives in images such as FIG. 38.

Further refinement by evaluating the phase rotation giving J₁ of Eqn (53).

Merging the performance measures

J_{T}=J₁ J₂ J₃ (84)

### : Position and Orientation Estimation

L1. Intrduction

Relative position and orientation in three dimensions (3D) between a scene reference coordinate system and a camera coordinate system (i.e., camera exterior orientation) comprises 6 parameters: 3 positions {X, Y and Z} and 3 orientations {pitch, roll and yaw}. Some conventional standard machine vision techniques can accurately measure 3 of these variables, X-position, Y-position and roll-angle.

The remaining three variables (the two out-of-plane tilt angles pitch and yaw, and the distance between camera and object, or z_{cam}) are difficult to estimate at all using conventional machine vision techniques and virtually impossible to estimate accurately. A seventh variable, camera principal distance, depends on the zoom and focus of the camera, and may be known if the camera is a calibrated metric camera, or more likely unknown if the camera is a conventional photographic camera. This variable is also difficult to estimate using conventional machine vision techniques.

L1.1. Near and Far Field

Using orientation dependent reflectors (ODRs), pitch and yaw can be measured. According to one embodiment, in the far-field (when the ODRs are far from the camera) the measurement of pitch and yaw is not coupled to estimation of Z-position or principal distance. According to another embodiment, in the near-field, estimates of pitch, yaw, Z-position and principle distance are coupled and can be made together. The coupling increases the complexity of the algorithm, but yields the benefit of full 6 degree-of-freedom (DOF) estimation of position and orientation, with estimation of principal distance as an added benefit.

L2. Coordinate Frames and Transformations

L2.1. Basics

The following material was introduced above in Sections B and C of the Description of the Related Art, and is treated in greater detail here.

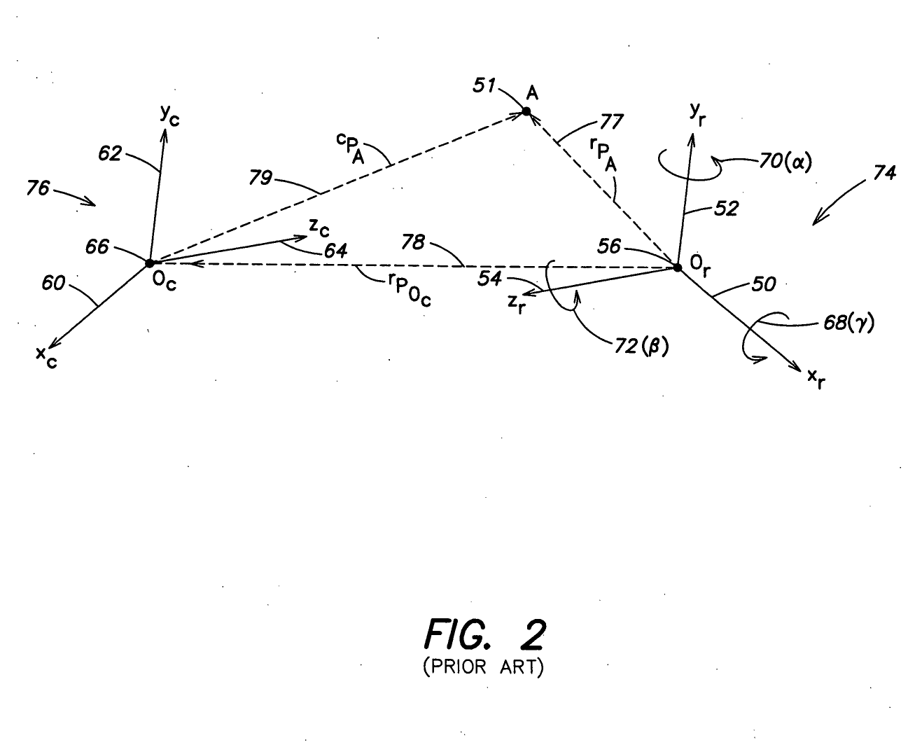

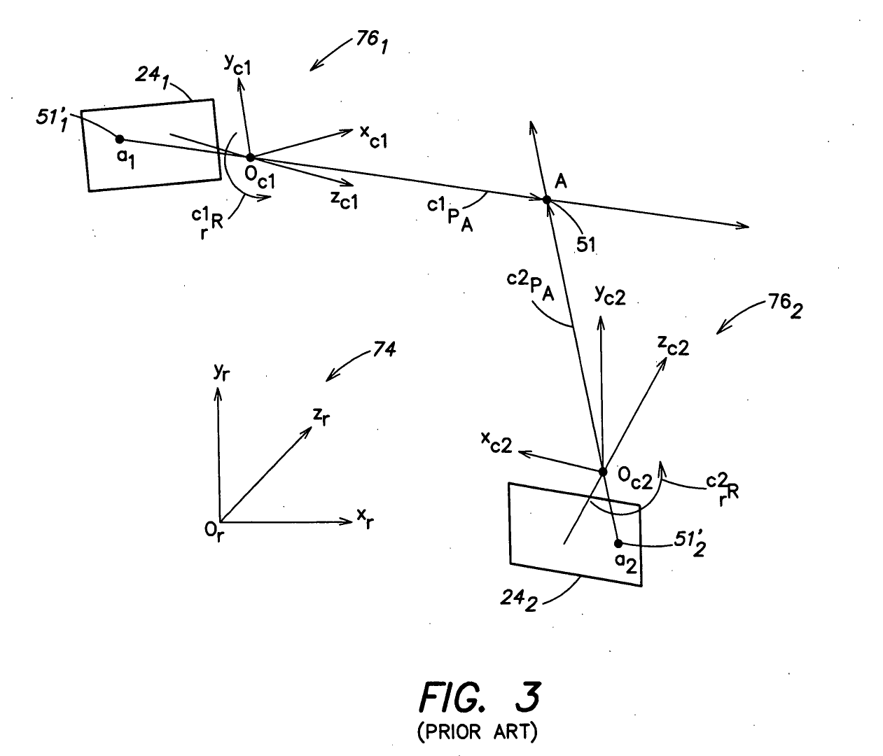

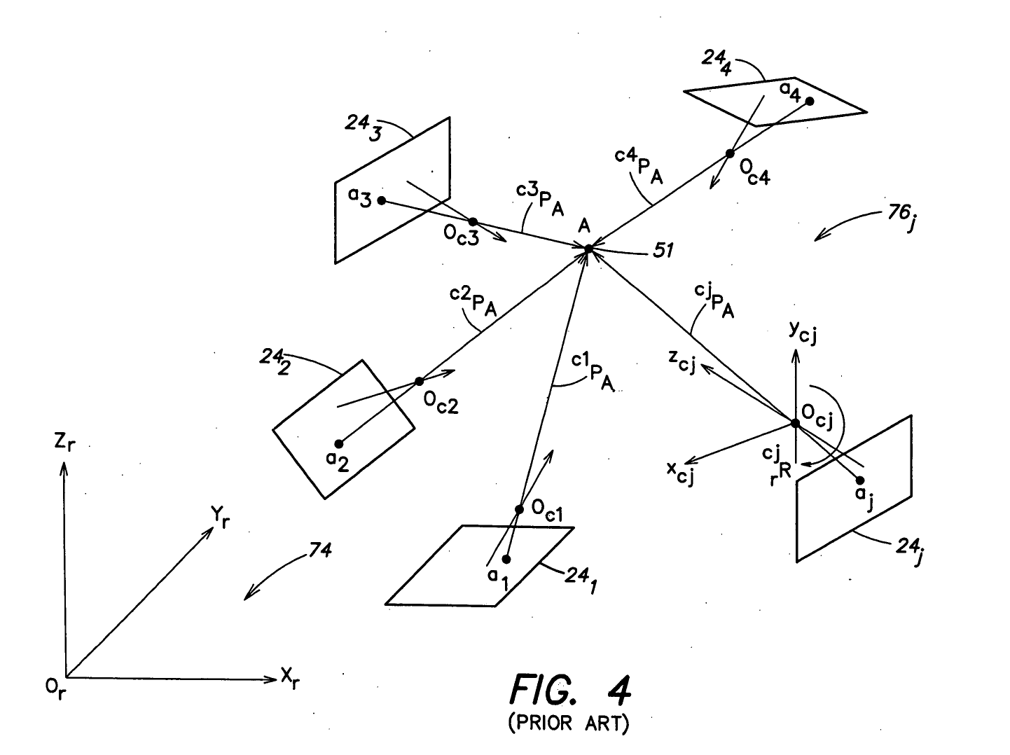

For image metrology analysis, it is helpful to describe points in space with respect to many coordinate systems or frames (such as reference or camera coordinates). As as discussed above in connection with FIGS. 1 and 2, a coordinate system or frame generally comprises three orthogonal axes {X, Y and Z}. In. general the location of a point B can be described with respect to frame S by specifying its position along each of three axes, for example ^{S}P_{B}=[3.0, 0.8, 1.2]^{T}. We may say that point B is described in “frame S,” in “the S frame,” or equivalently, “in S coordinates.” For example, describing the position of point B with respect to (w.r.t.) the reference frame, we may write “point B in the reference frame is . . . ” or equivalently “point B in reference coordinates is . . . ”.

As illustrated in FIG. 2, the point A is shown with respect to the camera frame c and is given the notation ^{c}P_{A}. The same point in the reference frame r is given the notation ^{r}P_{A}

The position of a frame (i.e., coordinate system) relative to another includes both rotation and translation, as illustrated in FIG. 2. Term ^{c}P_{O}_{ᵣ} refers to the location of the origin of frame r expressed in frame c. A point A might be determined in camera coordinates (frame c) from the same point expressed in the reference frame (frame r) using

^{c}P_{A}=ᵣ^{c}R ^{r}P_{A}+^{c}P_{O}_{ᵣ} (85)

Where ᵣ^{c}R∈R^{3×3} expresses the rotation from reference to camera coordinates, and ^{c}P_{O}_{ᵣ} is the position of the origin of the reference coordinate frame expressed in the camera frame. Eqn (85) can be simplified using the homogeneous coordinate transformation from frame c to frame r, which is given by:

$${}_{c}^{r} T = [ \begin{matrix}{}_{c}^{r} R & ⋮ & {}_{}^{r}{P}{}_{{O}_{c}}^{} \\ ⋯ & ⋯ & ⋯ \\ 0 & ⋮ & 1\end{matrix} ]$$

where

_{c}^{r}R∈R^{3×3} is the rotation matrix from the camera to reference frame,

^{r}P_{O}_{_{c}}∈R³ is the center of the camera frame in reference coordinates.

A homogeneous transformation from the reference frame to the camera frame is then given by:

$${}_{r}^{c} T = [ \begin{matrix}{}_{r}^{c} R & ⋮ & {}_{}^{c}{P}{}_{{O}_{r}}^{} \\ ⋯ & ⋯ & ⋯ \\ 0 & ⋮ & 1\end{matrix} ] \qquad ( 86 )$$

Where ᵣ^{c}R=_{c}^{r}R^{T} and ^{c}P_{O}_{ᵣ}=−ᵣ^{c}R ^{r}P_{O}_{_{c}}.

Using the homogeneous transformation, a point A might be determined in camera coordinates from the same point expressed in the reference frame using

^{c}P_{A}=ᵣ^{c}T ^{r}P_{A} (87)

To use the homogeneous transformation, the position vectors are augmented by one. For example, ^{c}P_{A}=[3.0 0.8 1.2]^{T} becomes ^{c}P_{A}=[3.0 0.8 1.2 1.0]^{T}, with 1.0 adjoined to the end. This corresponds to ᵣ^{c}R∈R^{3×3} while ᵣ^{c}T∈R^{4×4}. The notation ^{c}P_{A} is used in either case, as it is always clear by adjoining or removing the fourth element is required (or third element for a homogeneous transform in 2 dimensions). In general, if the operation involves a homogeneous transform, the additional element must be adjoined, otherwise it is removed.

L2.2. Rotations:

Two coordinate frames are related to each other by a rotation and translation, as illustrated in FIG. 2. Generally, the rotation matrix from a frame B to a frame A is given by:

$${}_{B}^{A} R = [ \begin{matrix}{}_{}^{A}{\hat{X}}{}_{B}^{} & {}_{}^{A}{\hat{Y}}{}_{B}^{} & {}_{}^{A}{\hat{Z}}{}_{B}^{}\end{matrix} ] \qquad ( 88 )$$

where ^{A}\hat{X}_{B} is the unit X vector of the B frame expressed in the A frame, and likewise for ^{A}Ŷ_{B} and ^{A}\hat{Z}_{B}. There are many ways to represent rotations in three dimensions, the most general being a 3×3 rotation matrix, such as _{B}^{A}R. A rotation may also be described by three angles, such as pitch (γ), roll (β) and yaw (α), which are also illustrated in FIG. 2.

To visualize pitch, roll and yaw rotations, two notions should be kept in mind: 1) what is rotating; and 2) in what order the rotations occur. For example, according to one embodiment, a reference target is considered as moving in the camera frame or coordinate system. Thus, if the reference target was at the origin of the reference frame 74 shown in FIG. 2, a +10° pitch rotation 68 (counter-clockwise) would move the Y-axis to the left and the Zaxis downward. Mathematically, rotation matrices do not commute, and so

Rᵣₒₗₗ R_{yaw} R_{pitch} ≠R_{yaw} R_{pitch} Rᵣₒₗₗ

Physically, if we pitch and then yaw, we come to a position different from that obtained from yawing and then pitching. An important feature of the pitch-yaw-roll sequence used here is that the roll is last, and so the roll angle is that directly measured in the image.

According to one embodiment, the angles γ, β and α give the rotation of the reference target in the camera frame (i.e., the three orientation parameters of the exterior orientation). The rotation matrix from reference frame to camera frame, ᵣ^{c}R, is given by:

$$\begin{matrix}{}_{r}^{c} R = {R}_{180} {R}_{roll} {R}_{yaw} {R}_{pitch} \\ = [ \begin{matrix}- 1 & 0 & 0 \\ 0 & 1 & 0 \\ 0 & 0 & - 1\end{matrix} ] [ \begin{matrix}{C}_{β} & - {S}_{β} & 0 \\ {S}_{β} & {C}_{β} & 0 \\ 0 & 0 & 1\end{matrix} ] \\ [ \begin{matrix}{C}_{α} & 0 & {S}_{α} \\ 0 & 1 & 0 \\ - {S}_{α} & 0 & {C}_{α}\end{matrix} ] [ \begin{matrix}1 & 0 & 0 \\ 0 & {C}_{γ} & - {S}_{γ} \\ 0 & {S}_{γ} & {C}_{γ}\end{matrix} ] \\ = [ \begin{matrix}- 1 & 0 & 0 \\ 0 & 1 & 0 \\ 0 & 0 & - 1\end{matrix} ] [ \begin{matrix}{C}_{β} {C}_{α} & {C}_{β} {S}_{α} {S}_{γ} - {S}_{β} {C}_{γ} & {C}_{β} {S}_{α} {C}_{γ} + {S}_{β} {S}_{γ} \\ {S}_{β} {C}_{α} & {S}_{β} {S}_{α} {S}_{γ} + {C}_{β} {C}_{γ} & {S}_{β} {S}_{α} {C}_{γ} - {C}_{β} {S}_{γ} \\ - {S}_{α} & {C}_{α} {S}_{γ} & {C}_{α} {C}_{γ}\end{matrix} ] \\ = [ \begin{matrix}- {C}_{β} {C}_{α} & - {C}_{β} {S}_{α} {S}_{γ} + {S}_{β} {C}_{γ} & - {C}_{β} {S}_{α} {C}_{γ} - {S}_{β} {S}_{γ} \\ {S}_{β} {C}_{α} & {S}_{β} {S}_{α} {S}_{γ} + {C}_{β} {C}_{γ} & {S}_{β} {S}_{α} {C}_{γ} - {C}_{β} {S}_{γ} \\ {S}_{α} & - {C}_{α} {S}_{γ} & - {C}_{α} {C}_{γ}\end{matrix} ]\end{matrix} \qquad ( 89 )$$

where C_{β} indicates a cosine function of the angle β, S_{β} indicates a sine function of the angle θ, and the diagonal array reflects a 180° rotation of the camera frame about its Y-axis, so that the Z-axis of the camera is pointed toward the reference target (in the sense opposite the Z-axis of the reference frame, see Rotated normalized image frame below).

The rotation from the camera frame to the reference frame is given by:

$$\begin{matrix}{}_{c}^{r} R = {}_{r}^{c}{R}{}_{}^{T} = {R}_{pitch}^{T} {R}_{yaw}^{T} {R}_{roll}^{T} {R}_{180}^{T} & ( 90 ) \\ = [ \begin{matrix}1 & 0 & 0 \\ 0 & {C}_{γ} & {S}_{γ} \\ 0 & - {S}_{γ} & {C}_{γ}\end{matrix} ] [ \begin{matrix}{C}_{α} & 0 & - {S}_{α} \\ 0 & 1 & 0 \\ {S}_{α} & 0 & {C}_{α}\end{matrix} ] [ \begin{matrix}{C}_{β} & {S}_{β} & 0 \\ - {S}_{β} & {C}_{β} & 0 \\ 0 & 0 & 1\end{matrix} ] [ \begin{matrix}- 1 & 0 & 0 \\ 0 & 1 & 0 \\ 0 & 0 & - 1\end{matrix} ] & \\ = [ \begin{matrix}{C}_{β} {C}_{α} & {S}_{β} {C}_{α} & - {S}_{α} \\ {C}_{β} {S}_{α} {S}_{γ} - {C}_{γ} {S}_{β} & {S}_{β} {S}_{α} {S}_{γ} + {C}_{β} {C}_{γ} & {C}_{α} {S}_{γ} \\ {S}_{γ} {S}_{β} + {C}_{γ} {C}_{β} {S}_{α} & - {C}_{β} {S}_{γ} + {C}_{γ} {S}_{α} {S}_{β} & {C}_{α} {C}_{γ}\end{matrix} ] [ \begin{matrix}- 1 & 0 & 0 \\ 0 & 1 & 0 \\ 0 & 0 & - 1\end{matrix} ] & \\ = [ \begin{matrix}- {C}_{β} {C}_{α} & {S}_{β} {C}_{α} & {S}_{α} \\ - {C}_{β} {S}_{α} {S}_{γ} + {C}_{γ} {S}_{β} & {S}_{β} {S}_{α} {S}_{γ} + {C}_{β} {C}_{γ} & - {C}_{α} {S}_{γ} \\ - {S}_{γ} {S}_{β} - {C}_{γ} {C}_{β} {S}_{α} & - {C}_{β} {S}_{γ} + {C}_{γ} {S}_{α} {S}_{β} & - {C}_{α} {C}_{γ}\end{matrix} ] & \end{matrix}$$

Orientation is specified as the pitch, then yaw, then roll of the reference target.

L2.3. Connection to Photogrammetric Notation

An alternative notation sometimes found in the photogrammetric literature is:

Roll κ(rather than β)

Yaw φ(rather than α)

Pitch ω(rather than γ)

The order of the rotations is commonly like that for ᵣ^{c}R.

L2.4. Frames

For image metrology analysis according to one embodiment there are several coordinate frames (e.g., having two or three dimensions) that are considered.

1. Reference Frame ^{r}P_{A}

The reference frame is aligned with the scene, centered in the reference target. For purposes of the present discussion measurements are considered in the reference frame or a measurement frame having a known spatial relationship to the reference frame. If the reference target is flat on the scene there may be a roll rotation between the scene and reference frames.

2. Measurement Frame ^{m}P_{A}

Points of interest in a scene not lying in the reference plane may lie in a measurement plane having a known spatial relationship to the reference frame. A transformation ᵣ^{m}T from the reference frame to the measurement frame may be given by:

$$\begin{matrix}{}_{r}^{m} T = [ \begin{matrix}{}_{r}^{m} R & ⋮ & {}_{}^{m}{P}{}_{{O}_{r}}^{} \\ ⋯ & ⋯ & ⋯ \\ 0 & ⋮ & 1\end{matrix} ] & ( 91 ) \\ where & \\ {}_{r}^{m} R = [ \begin{matrix}{C}_{{β}_{5}} {C}_{{α}_{5}} & {C}_{{β}_{5}} {S}_{{α}_{5}} {S}_{{γ}_{5}} - {S}_{{β}_{5}} {C}_{{γ}_{5}} & {C}_{{β}_{5}} {S}_{{α}_{5}} {C}_{{γ}_{5}} + {S}_{{β}_{5}} {S}_{{γ}_{5}} \\ {S}_{{β}_{5}} {C}_{{α}_{5}} & {S}_{{β}_{5}} {S}_{{α}_{5}} {S}_{{γ}_{5}} + {C}_{{β}_{5}} {C}_{{γ}_{5}} & {S}_{{β}_{5}} {S}_{{α}_{5}} {C}_{{γ}_{5}} - {C}_{{β}_{5}} {S}_{{γ}_{5}} \\ - {S}_{{α}_{5}} & {C}_{{α}_{5}} {S}_{{γ}_{5}} & {C}_{{α}_{5}} {C}_{{γ}_{5}}\end{matrix} ] & ( 92 )\end{matrix}$$

where α₅, β₅, and γ₅ are arbitrary known yaw, roll and pitch rotations between the reference and measurement frames, and ^{m}P_{O}_{ᵣ} is the position of the origin of the reference frame in measurement coordinates. As shown in FIG. 5, for example, the vector ^{m}P_{O}_{ᵣ} could be established by selecting a point at which measurement plane 23 meets the reference plane 21.

In the particular example of FIG. 5, the measurement plane 23 is related to reference plane 21 by a −90° yaw rotation. The information that the yaw rotation is 90° is available for built spaces with surfaces at 90° angles, and specialized information may be available in other circumstances. The sign of the rotation must be consistent with the ‘right-hand rule,’ and can be determined from the image.

When there is a −90° yaw rotation, equation (91) gives

$${}_{r}^{m} T = [ \begin{matrix}0 & 0 & - 1 & \\ 0 & 1 & 0 & {}_{}^{m}{P}{}_{{O}_{r}}^{} \\ 1 & 0 & 0 & \\ 0 & 0 & 0 & 1\end{matrix} ] \qquad ( 93 )$$

3. ODR Frame ^{Dj}P_{A}

Coordinate frame of the j^{th} ODR. It may be rotated with respect to the reference frame, so that

$${}_{r}^{{D}_{j}} R = [ \begin{matrix}{C}_{{ρ}_{j}} & {S}_{{ρ}_{j}} & 0 \\ - {S}_{{ρ}_{j}} & {C}_{{ρ}_{j}} & 0 \\ 0 & 0 & 1\end{matrix} ] \qquad ( 94 )$$

where ρⱼ is the roll rotation angle of the j^{th} ODR in the reference frame. The direction vector of the longitudinal (i.e., primary) axis of the ODR region is given by:

^{r}X_{Dj}=_{Dj}^{r}R[1 0 0]^{T} (95)

In the examples of FIGS. 8 and 10B, the roll angles ρⱼ of the ODRs is 0 or 90 degrees w.r.t the reference frame. However, it should be appreciated that ρⱼ may be an arbitrary roll angle.

4. Camera Frame ^{c}P_{A}

Attached to the camera origin (i.e., nodal point of the lens), the Z-axis is out of the camera, toward the scene. There is a 180 yaw rotation between the reference and camera frames, so that the Z-axis of the reference frame is pointing generally toward the camera, and the Z-axis of the camera frame is pointing generally toward the reference target.

5. Image Plane (Pixel) Coordinates ⁱPₐ

Location of a point a (i.e., a projection of an object point A) in the image plane of the camera, ⁱPₐ∈R².

6. Normalized Image Coordinates ⁿPₐ

Described in section L3., below.

7. Link Frame ^{L}P_{A}

The Z-axis of the link frame is aligned with the camera bearing vector 78 (FIG. 9), which connects the reference and camera frames. It is used in interpretation reference target reference objects to determine the exterior orientation of the camera.

The origin of the link frame is coincident with the origin of the reference frame:

^{r}P_{O}_{_{L}}=[0 0 0]^{T}

The camera origin lies along the Z-axis of the link frame:

^{r}P_{O}_{_{c}}=_{L}^{r}R [0 0 z_{cam}]^{T}

where z_{cam} is the distance from the reference frame origin to the camera origin.

8. Scene Frame ^{s}P_{A}

The reference target is presumed to be lying flat in the plane of the scene, but there may be a rotation (−y axis on the reference target may not be vertically down in the scene). This roll angle (about the z axis in reference target coordinates) is given by roll angle β₄:

$${}_{r}^{s} R = [ \begin{matrix}{C}_{{β}_{4}} & - {S}_{{β}_{4}} & 0 \\ {S}_{{β}_{4}} & {C}_{{β}_{4}} & 0 \\ 0 & 0 & 1\end{matrix} ] \qquad ( 96 )$$

L2.5. Angle Sets

From the foregoing, it should be appreciated that according to one embodiment, an image processing method may be described in terms of five sets of orientation angles:

1. Orientation of the reference target in the camera frame: _{c}^{r}R(γ, β, α), (i.e., the three orientation parameters of exterior orientation);

2. Orientation of the link frame in the reference frame: _{L}^{r}R(γ₂, α₂), (i.e., camera bearing angels);

3. Orientation of the camera in the link frame: _{L}^{c}R(γ₃, β₃, α₃);

4. Roll of the reference target (i.e., the reference frame) in the scene (arising with a reference target, the Y-axis of which is not precisely vertical); ᵣ^{s}R(β₄); and

5. Orientation of the measurement frame in the reference frame, ᵣ^{m}R(γ₅, β₅, α₅) (typically a 90 degree yaw rotation for built spaces.)

L3. Camera Model

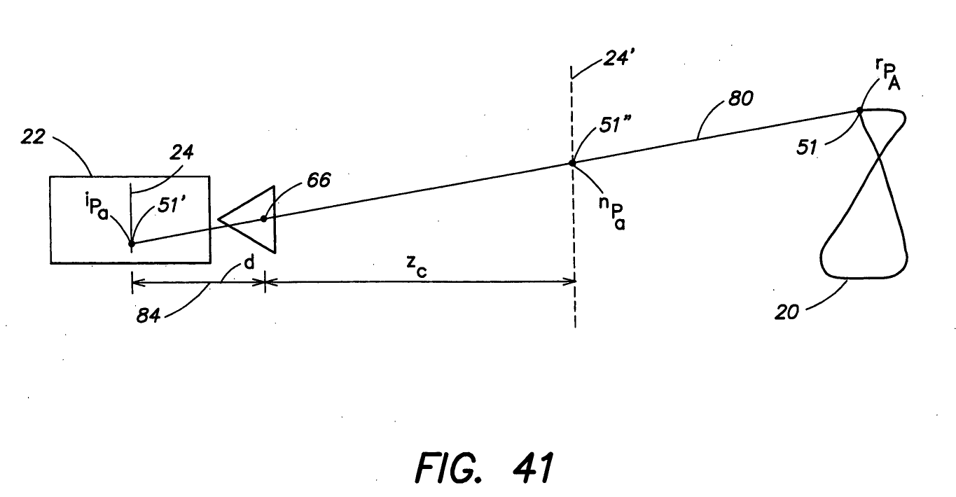

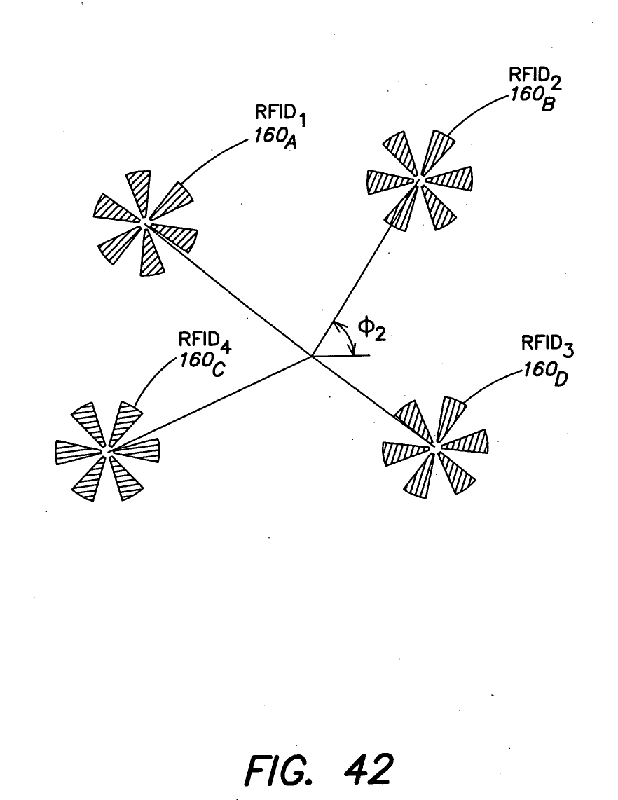

By introducing normalized image coordinates, camera model properties (interior orientation) are separated from camera and reference target geometry (exterior orientation). Normalized image coordinates is illustrated in FIG. 41. A point ^{r}P_{A} 51 in the scene 20 is imaged where a ray 80 from the point passing through camera origin 66 intersects the imaging plane 24 of the camera 22, which is at point ⁱPₐ 51′.

Introducing the normalized image plane 24′ at Z_{c}=1 [meter] in camera coordinates, the ray 80 from ^{r}P_{A} intersects the normalized image plane at the point ⁿPₐ 51″. To determine ⁿPₐ from knowledge of the camera and scene, ^{r}P_{A} is expressed in camera coordinates:

^{c}P_{A}=ᵣ^{c}T ^{r}P_{A}

where ^{c}P_{A}=[^{c}X_{A} ^{c}Y_{A} ^{c}Z_{A}]^{T}.

Normalizing so that the Z-component of the ray 80 in camera coordinates is equal to 1 meter,

$${}_{}^{n}{P}{}_{a}^{} = \frac{{}_{}^{c}{P}{}_{A}^{}}{{}_{}^{c}{Z}{}_{A}^{}} = [ \begin{matrix}{}_{}^{c}{X}{}_{A}^{} / {}_{}^{c}{Z}{}_{A}^{} \\ {}_{}^{c}{Y}{}_{A}^{} / {}_{}^{c}{Z}{}_{A}^{} \\ 1\end{matrix} ] \qquad ( 97 )$$

Eqn (97) is a vector form of the collinearity equations discussed in Section C of the Description of the Related Art.

Locations on the image plane 24, such as the image coordinates ⁿPₐ, are determined by image processing. The normalized image coordinates ⁿPₐ are derived from ⁱPₐ by:

$$\begin{matrix}step 1 \text{:} {P}_{a} = {}_{i}^{n} T {}_{}^{i}{P}{}_{a}^{} & ( 98 ) \\ step 2 \text{:} {}_{}^{n}{P}{}_{a}^{} = \frac{{P}_{a}}{{P}_{a} ( 3 )} & \end{matrix}$$

where Pₐ∈R³ is an intermediate variable, and ₙⁱT is given by:

$${}_{n}^{i} T = [ \begin{matrix}- d {k}_{x} & 0 & {x}_{0} \\ 0 & - d {k}_{y} & {y}_{0} \\ 0 & 0 & 1\end{matrix} ] \qquad ( 99 )$$

Where

ₙⁱT∈R^{3×3} is a homogeneous transform for the mapping from the two-dimensional (2-D) normalized image coordinates to the 2-D image coordinates.

d is the principle distance 84 of the camera, [meters];

kₓ is a scale factor along the X axis of the image plane 24, [pixels/meter] for a digital camera;

k_{y} is a scale factor along the Y axis of the image plane 24, [pixels/meter] for a digital camera;

x₀ and y₀ are the X and Y coordinates in the image coordinate system of the principle point where the optical axis actually intersects the image plane, [pixels] for a digital camera.

For digital cameras, kₓ and k_{y} are typically accurately known from the manufacturers specifications. Principle point values x₀ and y₀ vary between cameras and over time, and so must be calibrated for each camera. The principal distance, d depends on zoom, if present, and focus adjustment, and may need to be estimated for each image. The parameters of ₙⁱT are commonly referred to as the “interior orientation” parameters of the camera.

L3.1. Image Distortion and Camera Calibration

The central projection model of FIG. 1 is an idealization. Practical lens systems will introduce radial lens distortion, or other types of distortion, such as tangential (i.e, centering) distortion or film deformation for analog cameras (see, for example, the Atkinson text, Ch 2.2 or Ch 6).

As opposed to the transformations between coordinate frames, for example ᵣ^{c}T, described in connection with FIG. 1, image distortion is treated by mapping within one coordinate frame. Locations of points of interest in image coordinates are measured by image processing, for example by detecting a fiducial mark, as described in Section K. These measured locations are then mapped (i.e., translated) to locations where the points of interest would be located in a distortion-free image.

A general form for correction for image distortion may be written:

ⁱP*ₐ=f_{c}(U, ⁱPₐ) (100)

where f_{c} is an inverse model of the image distortion process, U is a vector of distortion model parameters, and, for the purposes of this section, ⁱP*ₐ is the distortion-free location of a point of interest in the image. The mathematical form for f_{c}(U, ·) depends on the distortion being modeled, and the values of the parameters depend on the details of the camera and lens. Determining values for parameters U is part of the process of camera calibration, and must generally be done empirically. A model for radial lens distortion may, for example, be written:

$$\begin{matrix}{r}_{a} = \sqrt{{( {x}_{a} - {x}_{0} )}^{2} + {( {y}_{a} - {y}_{0} )}^{2}} & ( 101 ) \\ δ {r}_{a} = {K}_{1} {r}_{a}^{3} + {K}_{2} {r}_{a}^{5} + {K}_{3} {r}_{a}^{7} & ( 102 ) \\ δ {x}_{a} = δ {r}_{a} \frac{{x}_{a}}{{r}_{a}} ; δ {y}_{a} = δ {r}_{a} \frac{{y}_{a}}{{r}_{a}} & ( 103 ) \\ {}_{}^{i}{P}{}_{a}^{*} = {}_{}^{i}{P}{}_{a}^{} + δ {}_{}^{i}{P}{}_{a}^{} = [ \begin{matrix}{x}_{a} \\ {y}_{a}\end{matrix} ] + [ \begin{matrix}δ {x}_{a} \\ δ {y}_{a}\end{matrix} ] & ( 104 )\end{matrix}$$

where mapping f_{c}(U, ·) is given by Eqns (101)-(104), ⁱPₐ=[xₐ yₐ]^{T} is the measured location of point of interest a, for example at 51′ in FIG. 1, U=[K₁ K₂ K₃]T is the vector of parameters, determined as a part of camera calibration, and JδⁱPa is the offset in image location of point of interest a introduced by radial lens distortion. Other distortion models can be characterized in a similar manner, with appropriate functions replacing Eqns (101)-(104) and appropriate model parameters in parameter vector U.

Radial lens distortion, in particular, may be significant for commercial digital cameras. In many cases a single distortion model parameter, K₁, will be sufficient. The parameter may be determined by analyzing a calibration image in which there are sufficient control points (i.e., points with known spatial relation) spanning a sufficient region of the image. Distortion model parameters are most often estimated by a least-squares fitting process (see, for example, Atkinson, Ch 2 and 6).

The distortion model of Eqn (100) is distinct from the mathematical forms most commonly used in the field of Photogrammetry (e.g., Atkinson, Ch 2 and Ch 6), but has the advantage that the process of mapping from actual-image to normalized image coordinates can be written in a compact form:

$${}_{}^{n}{P}{}_{a}^{} = {}_{i}^{n} T [ \begin{matrix}{f}_{c} ( U , {}_{}^{i}{P}{}_{a}^{} ) \\ 1\end{matrix} ] \qquad ( 105 )$$

where ⁿPₐ is the distortion-corrected location of point of interest a in normalized image coordinates, ᵢⁿT=ₙⁱR⁻¹∈T^{3×3} is a homogeneous transform matrix, [f_{c}(U, ⁱ\hat{P}ₐ)1]^{T} is the augmented vector needed for the homogeneous transform representation, and function f_{c}(U, ·) includes the non-linearities introduced by distortion. Alternatively, Eqn (105) can be written

ⁿPₐ=ᵢⁿT(ⁱPₐ) (106)

where the parentheses indicate that ᵢⁿT(·) is a possibly non-linear mapping combining the nonlinear mapping of f_{c}(U, ·) and homogeneous transform ᵢⁿT.

Using the notation of Eqn (100), the general mapping of Eqn (9) of Section A may be written:

$${}_{}^{i}{P}{}_{a}^{} = {f}_{c}^{- 1} ( U , {}_{n}^{i} T \frac{1}{{}_{}^{c}{P}{}_{A}^{} ( 3 )} {}_{}^{c}{P}{}_{A}^{} ) \qquad ( 107 )$$

and the general mapping of Eqn (10) of Section A may be written:

$${}_{}^{i}{P}{}_{a}^{} = {f}_{c}^{- 1} ( U , {}_{n}^{i} T \frac{1}{{}_{}^{c}{P}{}_{A}^{} ( 3 )} {}_{r}^{c} T {}_{}^{r}{P}{}_{A}^{} ) \qquad ( 108 )$$

where ⁱPₐ is the location of the point of interest measured in the image (e.g., at 51′ in image 24 in FIG. 1), f_{c}⁻¹(U, ⁱPₐ) is the forward model of the image distortion process (e.g., the inverse of Eqns, (101)-(104)) and ₙⁱT and ᵣ^{c}T are homogeneous transformation matrices.

L4. The Image Metrology Problem, Finding ^{r}P_{A} given ⁱPₐ

Position ^{r}P_{A} can be found from a position in the image ⁱPₐ. This is not simply a transformation, since the image is 2 dimensional and ^{r}P_{A} expresses a point in 3-dimensional space. According to one embodiment, an additional constraint comes from assuming that ^{r}P_{A} lies in the plane of the reference target. Inverting Eqn (98)

ⁿPₐ=ᵢⁿT ⁱP*ₐ

To discover where the vector ⁿPₐ intersects the reference plane, the vector is rotated into reference coordinates and scaled so that the Z-coordinate is equal to ^{r}P_{O}_{_{c}} (3)

^{r}Jₐ=_{c}^{r}R ⁿPₐ (109)

$${}_{}^{r}{P}{}_{A}^{} = - \frac{{}_{}^{r}{P}{}_{{O}_{c}}^{} ( 3 )}{{}_{}^{r}{J}{}_{a}^{} ( 3 )} {}_{}^{r}{J}{}_{a}^{} + {}_{}^{r}{P}{}_{{O}_{c}}^{} \qquad ( 110 )$$

where ^{r}Jₐ is an intermediate result expressing the vector from the camera center to ⁿPₐ in reference coordinates, and ^{r}P_{O}_{_{c}} (3) and ^{r}P (3) refer to the third (or Z-axis) elements of each vector, respectively; and where _{c}^{r}R includes the three orientation parameters of the exterior orientation, and ^{r}P_{O}_{_{c}} includes the three position parameters of the exterior orientation.

The method of Eqns (109)-(110) is essentially unchanged for measurement in any coordinate frame with known spatial relationship to the reference frame. For example, if there is a measurement frame m (e.g., shown at 57 in FIG. 5) and ᵣ^{m}R and ^{m}P_{O}_{ᵣ} described in connection with Eqn (91) are known, then Eqns (109)-(110) become:

^{m}Jₐ=_{c}^{m}R ⁿPₐ (111)

$${}_{}^{m}{P}{}_{A}^{} = - \frac{{}_{}^{m}{P}{}_{{O}_{c}}^{} ( 3 )}{{}_{}^{m}{J}{}_{a}^{} ( 3 )} {}_{}^{m}{J}{}_{a}^{} + {}_{}^{m}{P}{}_{{O}_{c}}^{} \qquad ( 112 )$$

where ^{m}P_{O}_{_{c}}=^{m}P_{O}_{ᵣ}+ᵣ^{m}R ^{r}P_{O}_{_{c}}.

The foregoing material in this Section is essentially a more detailed treatment of the discussion in Section G of the Description of the Related Art, in connection with Eqn (11). Eqns (111) and (112) provide a “total” solution that may also involve a transformation from a reference plane to a measurement plane, as discussed above in connection with FIG. 5.

L5. Detailed Discussion of Exemplary Image Processing Methods

According to one embodiment, an image metrology method first determines an initial estimate of at least some camera calibration information. For example, the method may determine an initial estimate of camera exterior orientation based on assumed, estimated, or known interior orientation parameters (e.g., from camera manufacturer). Based on these initial estimates of camera calibration information, least-squares iterative algorithms subsequently may be employed to refine the estimates.

L5.1. An Ezemplary Initial Estimation Method

One example of an initial estimation method is described below in connection with the reference target artwork shown in FIGS. 8 or 10B. In general, this initial estimation method assumes reasonable estimation or knowledge of camera interior orientation parameters, detailed knowledge of the reference target artwork (i.e., reference information), and involves automatically detecting the reference target in the image, fittingg the image of the reference target to the artwork model, detecting orientation dependent radiation from the ODRs of the reference target, calculating camera bearing angles from the ODR radiation, calculating a camera position and orientation in the link frame based on the camera bearing angles and the target reference information, and finally calculating the camera exterior orientation in the reference frame.

L5.1.1. An Exemplary Reference Target Artwork Model (i.e., Exemplary Reference Information)

1. Fiducial marks are described by their respective centers in the reference frame.

2. ODRs are described by:

(a) Center in the reference frame ^{r}P_{O}_{_{Dj}}

(b) ODR half length and half width, (length2 , width2)

(c) Roll rotation from the reference frame to the ODR frame,

$${}_{r}^{{D}_{j}} R = [ \begin{matrix}Cos {ρ}_{j} & Sin {ρ}_{j} \\ - Sin {ρ}_{j} & Cos {ρ}_{j}\end{matrix} ]$$

where ρⱼ is the roll rotation angle of the iₜₕ ODR.

L5.1.2. Solving for the Reference Target Geometry

Determining the reference target geometry in the image with fiducial marks (RFIDs) requires matching reference target RFIDs to image RFIDs. This is done by

1. Finding RFIDs in the image (e.g., see Section K);

2. Determining a matching order of the image RFIDs to the reference target RFIDs;

3. Determining a center of the pattern of RFIDs;

4. Least squares solution of an approximate coordinate transformation from the reference frame to the camera frame.

L5.1.3. Finding RFID Order

The N_{FIDs} robust fiducial marks (RFIDs) contained in the reference target artwork are detected and located in the image by image processing. From the reference information, the N_{FIDs} fiducial locations in the artwork are known. There is no order in the detection process, so before the artwork can be matched to the image, it is necessary to match the RFIDs so that ^{r}O_{Fj} corresponds to ⁱO_{Fj}, where ^{r}O_{Fj}∈R² is the location of the center of the of the j^{th} RFID in the reference frame, ⁱO_{Fj}∈R² is the location of the center of the j^{th} RFID detected in the image, where j∈{1 . . . N_{FIDs}}. To facilitate matching the RFIDs, the artwork should be designed so that the RFIDs form a convex pattern. If robustness to large roll rotations is desired (see step 3, below) the pattern of RFIDs should be substantially asymmetric, or a unique RFID should be identifiable in some other way, such as by size or number of regions, color, etc.

An RFID pattern that contains 4 RFIDs is shown in FIG. 40. The RFID order is determined in a process of three steps.

Step 1: Find a point in the interior of the RFID pattern and sort the angles φⱼ to each of the N_{FIDs} RFIDs. An interior point of the RFID pattern in each of the reference and image frames is found by averaging the N_{FIDs} locations in the respective frames:

^{r}O_{F}=mean(^{r}O_{Fj})

ⁱO_{F}=mean(ⁱO_{Fj})

The means of the RFID locations, ^{r}O_{F} and ⁱO_{F} provide points on the interior of the fiducial patterns in the respective frames.

Step 2: In each of the reference and image frames, the RFIDs are uniquely ordered by measuring the angle φⱼ between the X-axis of the corresponding coordinate frame. and a line between the interior point and each RFID, such as φ₂ in FIG. 40, and sorting, these angles from greatest to least. This will produce an ordered list of the RFIDs in each of the reference and image frames, in correspondence except for a possible permutation that may be introduced by roll rotation. If the is little or no roll rotation between the reference and image frames, sequential matching of the uniquely ordered RFIDs in the two frames provides the needed correspondence.

Step 3. Significant roll rotations between the reference and image frames, arising with either a rotation of the camera relative to the scene, β in Eqn (92), or a rotation of the artwork in the scene, β₄ in Eqn (96), can be accommodate by exploiting either a unique attribute of at least one of the RFIDs or by exploiting substantial asymmetry in the pattern of RFIDs. The ordered list of RFIDs in the image (or reference) frame can be permuted and the two lists can be tested for the goodness of the correspondence.

L5.1.4. Finding the ODRs in the Image

Three or more RFIDs are sufficient to determine an approximate 2-D transformation from reference coordinates to image coordinates.

ⁱO_{Fj}≈ᵣⁱT₂ ^{r}O_{Fj}

where ⁱO_{Fj}∈R³ is the center of an RFID in image coordinates augmented for use with a homogeneous transformation, ᵣⁱT²∈R^{3×3} is the apprpximate 2-D transformation between essentially 2-D artwork and the 2-D image; and ^{r}O_{Fj}∈R³ is the X and Y coordinates of the center of the RFID in reference coordinates corresponding to ⁱO_{Fj}, augmented for use with a homogeneous transformation.

The approximate 2-D transformation is used to locate the ODRs in the image so that the orientation dependent radiation can be analyzed. The 2-D transformation is so identified because it contains no information about depth. It is an exact geometric model for flat artwork and in the limit z_{cam}→∞. When the reference artwork is flat, and the distance between camera and reference artwork, z_{cam}, is sufficiently large. Writing

$${}_{}^{i}{O}{}_{{F}_{j}}^{} = [ \begin{matrix}{}_{}^{i}{x}{}_{{F}_{j}}^{} \\ {}_{}^{i}{y}{}_{{F}_{j}}^{} \\ 1\end{matrix} ] = {}_{r}^{i}{T}{}_{2}^{} {}_{}^{r}{O}{}_{{F}_{j}}^{} = [ \begin{matrix}a & b & c \\ d & e & f \\ 0 & 0 & 1\end{matrix} ] [ \begin{matrix}{}_{}^{r}{x}{}_{{F}_{j}}^{} \\ {}_{}^{r}{y}{}_{{F}_{j}}^{} \\ 1\end{matrix} ] \qquad ( 113 )$$

the parameters a, b, c, d, e, and f of transformation matrix ᵣⁱT₂ can be found by least squares fitting of:

$$[ \begin{matrix}{}_{}^{i}{x}{}_{{F}_{1}}^{} \\ {}_{}^{i}{y}{}_{{F}_{1}}^{} \\ \begin{matrix}\begin{matrix}⋮ \\ {}_{}^{i}{x}{}_{{F}_{{N}_{FIDs}}}^{}\end{matrix} \\ {}_{}^{i}{y}{}_{{F}_{{N}_{FIDs}}}^{}\end{matrix}\end{matrix} ] = [ \begin{matrix}{}_{}^{r}{x}{}_{{F}_{1}}^{} & {}_{}^{r}{y}{}_{{F}_{1}}^{} & 1 & 0 & 0 & 0 \\ 0 & 0 & 0 & {}_{}^{r}{x}{}_{{F}_{1}}^{} & {}_{}^{r}{y}{}_{{F}_{1}}^{} & 1 \\ & & ⋯ & ⋯ & & \\ {}_{}^{r}{x}{}_{{F}_{{N}_{FIDs}}}^{} & {}_{}^{r}{y}{}_{{F}_{{N}_{FIDs}}}^{} & 1 & 0 & 0 & 0 \\ 0 & 0 & 0 & {}_{}^{r}{x}{}_{{F}_{{N}_{FIDs}}}^{} & {}_{}^{r}{y}{}_{{F}_{{N}_{FIDs}}}^{} & 1\end{matrix} ] [ \begin{matrix}a \\ b \\ c \\ d \\ e \\ f\end{matrix} ]$$

Once ᵣⁱT₂ is determined, the image region corresponding to each of the ODRs may be determined by applying ᵣⁱT₂ to reference information specifying the location of each ODR in the reference target artwork. In particular, the corners of each ODR in the image may be identified by knowing ᵣⁱT₂ and the reference information.

L5.1.5. Detecting ODR Radiation

Based on the fiducial marks, two-dimensional image regions are determined for each ODR (i.e., ODR radiation pattern), and the luminosity in the two-dimensional image region is projected onto the primary axis of the ODR region and accumulated. The accumulation challenge is to map the two-dimensional region of pixels onto the primary axis of the ODR in a way that preserves detection of the phase of the radiation pattern. This mapping is sensitive because aliasing effects may translate to phase error. Accumulation of luminosity is accomplished for each ODR by:

1. Defining a number N_{bins}(j) of bins along the primary axis of the j^{th} ODR;

2. For each pixel within the image region of the jₜₕ ODR, determining k, the index of the bin into which the center of the pixel falls,

3. For each bin the sum and weighted sum of pixels falling into the bin are accumulated so that the mean and first moment can be computed:

(a) The mean luminosity in bin k of the j^{th} ODR is given:

$${L}_{j} ( k ) = {\sum }_{i = 1}^{{N}_{j} ( k )} λ ( i ) / {N}_{j} ( k ) \qquad ( 114 )$$

where Nⱼ(k) is the number of pixels falling into bin k; λ(i) is the measured luminosity of the i^{th} image pixel, and L is the mean luminosity;

(b) The of the center of luminosity (the first moment) is given:

$${}_{}^{i}{\hat{P}}{}_{j}^{} ( k ) = {\sum }_{i = 1}^{{N}_{j} ( k )} λ ( i ) {}^{i} P ( i ) / {L}_{j} ( k ) \qquad ( 115 )$$

where ⁱ\hat{P}ⱼ(k)∈R² is the first moment of luminosity in bin k, ODR j, and ⁱP(i)∈R² is the image location of the center of pixel i.

L5.1.6. Determining Camera Bearing Angles α₂ and γ₂ from ODR Rotation Angles θⱼ

The Z-axis of the link frame connects the origin of the reference frame center with the origin of the camera frame, as shown at 78 in FIG. 9. The pitch and yaw of the link frame, referred to as camera bearing angles (as described in connection with FIG. 9), are derived from the respective ODR rotation angles. The camera bearing angles are α₂ (yaw or azimuth) and γ₂ (pitch or elevation). There is no roll angle, because the camera bearing connects two points, independent of roll.

Rotation from the link frame to the reference frame is given by:

$${}_{L}^{r} R = [ \begin{matrix}{C}_{α2} & 0 & {S}_{α2} \\ 0 & 1 & 0 \\ - {S}_{α2} & 0 & {C}_{α2}\end{matrix} ] [ \begin{matrix}1 & 0 & 0 \\ 0 & {C}_{γ2} & - {S}_{γ2} \\ 0 & {S}_{γ2} & {C}_{γ2}\end{matrix} ] = [ \begin{matrix}{C}_{α2} & {S}_{α2} {S}_{γ2} & {S}_{α2} {C}_{γ2} \\ 0 & {C}_{γ2} & - {S}_{γ2} \\ - {S}_{α2} & {C}_{α2} {S}_{γ2} & {C}_{α2} {C}_{γ2}\end{matrix} ]$$

The link frame azimuth and elevation angles α₂ and γ₂ are determined from the ODRs of the reference target. Given ᵣ^{Dj}R, θⱼ the rotation angle measured by the j^{th} ODR, is given by the first element of the rotated bearing angles:

$${θ}_{j} = {}_{r}^{{D}_{j}} R ( 1 , \text{:} ) [ \begin{matrix}{γ}_{2} \\ {α}_{2}\end{matrix} ]$$

Where the notation ᵣ^{Dj}R (1,:) refers to the first row of the matrix. Accordingly, pitch and yaw are determined from θⱼ by:

$$[ \begin{matrix}{γ}_{2} \\ {α}_{2}\end{matrix} ] = {[ \begin{matrix}{}_{r}^{{D}_{1}} R ( 1 , \text{:} ) \\ {}_{r}^{{D}_{2}} R ( 1 , \text{:} )\end{matrix} ]}^{- 1} [ \begin{matrix}{θ}_{1} \\ {θ}_{2}\end{matrix} ]$$

(the matrix pseudo-inverse would be use if more than two ODR regions were measured).

The camera bearing vector is given by:

$${}_{}^{r}{P}{}_{{O}_{c}}^{} = {}_{L}^{r} R [ \begin{matrix}0 \\ 0 \\ {z}_{cam}\end{matrix} ] = [ \begin{matrix}{C}_{{γ}_{2}} {S}_{{α}_{2}} \\ - {S}_{{γ}_{2}} \\ {C}_{{α}_{2}} {C}_{{γ}_{2}}\end{matrix} ] {z}_{cam}$$

Expressing the bearing vector in the ODR frame gives:

$${}_{}^{{D}_{j}}{P}{}_{{O}_{c}}^{} = {}_{r}^{{D}_{j}} R {}_{}^{ r}{P}{}_{{O}_{c}}^{} + {}_{}^{{D}_{j}}{P}{}_{{O}_{r}}^{} = [ \begin{matrix}{C}_{{γ}_{2}} {C}_{{ρ}_{j}} {S}_{{α}_{2}} - {S}_{{γ}_{2}} {S}_{{ρ}_{j}} \\ - {C}_{{ρ}_{j}} {S}_{{γ}_{2}} - {C}_{{γ}_{2}} {S}_{{α}_{2}} {S}_{{ρ}_{j}} \\ {C}_{{α}_{2}} {C}_{{γ}_{2}}\end{matrix} ] {z}_{cam} + {}_{}^{{D}_{j}}{P}{}_{{O}_{r}}^{} \qquad ( 116 )$$

The measured rotation angle, θⱼ is related to the bearing vector by:

$${θ}_{j} = arctan ( \frac{{}_{}^{{D}_{J}}{P}{}_{{O}_{c}}^{} ( 1 )}{{}_{}^{{D}_{j}}{P}{}_{{O}_{c}}^{} ( 3 )} ) \qquad ( 117 )$$

When the center of the reference frame is on the Y-axis of the ODR frame it follows that ^{Dj}P_{O}_{ᵣ}(1)=0, and ^{Dj}P_{O}_{ᵣ}(3)=0. Accordingly, Eqns (116) and (117) can be combined to give:

$$\frac{{C}_{{γ}_{2}} {C}_{{ρ}_{j}} {S}_{{α}_{2}} - {S}_{{γ}_{2}} {S}_{{ρ}_{j}}}{{C}_{{α}_{2}} {C}_{{γ}_{2}}} = tan ( {θ}_{j} ) \qquad ( 118 )$$

With the ODR angles, θⱼ, measured and the reference information known, there are two unknowns in Eqn (118): γ₂ and α₂. Bringing these terms out, we can write:

$$[ \begin{matrix}\begin{matrix}{C}_{{ρ}_{1}} & - {S}_{{ρ}_{1}} \\ {C}_{{ρ}_{2}} & - {S}_{{ρ}_{2}}\end{matrix} \\ ⋮\end{matrix} ] [ \begin{matrix}{h}_{1} \\ {h}_{2}\end{matrix} ] = [ \begin{matrix}tan ( {θ}_{1} ) \\ tan ( {θ}_{2} ) \\ ⋮\end{matrix} ] \qquad ( 119 )$$

$$\text{where}$$

$${h}_{1} = \frac{{C}_{{γ}_{2}} {S}_{{α}_{2}}}{{C}_{{α}_{2}} {C}_{{γ}_{2}}} = \frac{{S}_{{α}_{2}}}{{C}_{{α}_{2}}} \text{and} {h}_{2} = \frac{{S}_{{γ}_{2}}}{{C}_{{α}_{2}} {C}_{{γ}_{2}}}$$

Solving Eqn (119) for h₁ and h₂ allows finding α₂ and γ₂. If there are many ODRs, Eqn (119) lends itself to a least squares solution. The restriction used with Eqn (118), that ^{Dj}P_{O}_{ᵣ}(1)=0, and ^{Dj}P_{O}_{ᵣ}(3)=0, can be relaxed. If z_{cam}>>|[^{Dj}P_{O}_{ᵣ}(1) ^{Dj}P_{O}_{ᵣ}(3)]| Eqn (118) will be a valid approximation and the values determined for α₂ and γ₂ close to the true values.

L5.1.7. Calculating Camera Position and Orientation in the Link Frame; Derivation of _{L}^{c}R and ^{c}P_{O}_{ᵣ}

Using projective coordinates, one may write:

^{c}P_{A}(3) ⁿPₐ=^{c}P_{A} (120)

Where

^{c}P_{A} is the 3-D coordinates of a fiducial mark in the camera coordinate system (unknown);

ⁿPₐ is the normalized image coordinates of the image point ⁱPₐ of a fiducial mark (known from the image);

^{c}P_{A}(3) is the Z-axis coordinate of the fiducial mark P_{A} in the camera frame (unknown).

Using Eqn (120) and the transformation of reference to camera coordinates, one may find:

^{L}P_{A}=^{c}P_{A}(3) ⁿPₐ=[_{L}^{c}R ᵣ^{T}R ^{r}P_{A}+^{c}P_{O}_{ᵣ}] (121)

Where ^{c}P_{O}_{ᵣ} is the reference frame origin in the camera frame (unknown), and also represents the camera bearing vector (FIG. 9).

Rotation ^{r}_{L}R is known from the ODRs, and point ^{r}P_{A} is known from the reference information, and so ^{L}P_{A} (and likewise ^{L}P_{B}) can be computed from:

^{L}P_{A}=ᵣ^{L}R ^{r}P_{A}+^{L}P_{O}_{ᵣ} (note: ^{L}P_{O}_{ᵣ}=0 by definition)

Using at least 2 fiducial marks appearing in the image of the reference target at reference-frame locations ^{r}P_{A} and ^{r}P_{B} known from the reference information, one may write:

d_{A} ⁿPₐ=_{L}^{c}R ^{L}P_{A}+^{c}P_{O}_{ᵣ}

d_{B} ⁿP_{b}=_{L}^{c}R ^{L}P_{B}+^{c}P_{O}_{ᵣ}

where d_{A}=^{c}P_{A}(3) and d_{B}=^{c}P_{B}(3) [meters]. These two equations may be viewed as “modified” collinearity equations.

Subtracting these two equations gives:

d_{A} ⁿPₐ−d_{B} ⁿP_{b}=_{L}^{c}R(^{L}P_{A}−^{L}P_{B}) (122)

The image point corresponding origin (center) of the reference frame, ⁱP_{O}_{ᵣ}, is determined, for example using a fiducial mark at ^{r}P_{O}_{ᵣ}, an intersection of lines connecting fiducial marks, or transformation ᵣⁱT₂. Point ⁿP_{O}_{ᵣ}, the normalized image point corresponding to ⁱP_{O}_{ᵣ}, establishes the ray going from the camera center to the reference target center, along which ^{c}\hat{Z}_{L} lies:

^{c}\hat{Z}_{L}=−ⁿP_{O}_{ᵣ}/∥ⁿP_{O}_{ᵣ}∥

Rotation _{L}^{c}R may be written

_{L}^{c}R=[^{c}\hat{X}_{L} ^{c}Ŷ_{L} ^{c}\hat{Z}_{L}]

where \hat{X}_{L} etc. are the unit vectors of the link frame axes. The rotation matrix is given as:

$${}_{L}^{c} R = [ \begin{matrix}{C}_{{β}_{3}} {C}_{{α}_{3}} & - {S}_{{β}_{3}} {C}_{{α}_{3}} & {S}_{{α}_{3}} \\ {C}_{{β}_{3}} {S}_{{α}_{3}} {S}_{{γ}_{3}} + {C}_{{γ}_{3}} {S}_{{β}_{3}} & - {S}_{{β}_{3}} {S}_{{α}_{3}} {S}_{{γ}_{3}} + {C}_{{β}_{3}} {C}_{{γ}_{3}} & - {C}_{{α}_{3}} {S}_{{γ}_{3}} \\ {S}_{{γ}_{3}} {S}_{{β}_{3}} - {C}_{{γ}_{3}} {C}_{{β}_{3}} {S}_{{α}_{3}} & {C}_{{β}_{3}} {S}_{{γ}_{3}} + {C}_{{γ}_{3}} {S}_{{α}_{3}} {S}_{{β}_{3}} & {C}_{{α}_{3}} {C}_{{γ}_{3}}\end{matrix} ]$$

And so α₃ and γ₃ may be found from:

α₃=180−sin⁻¹(^{c}\hat{Z}_{L}(1)) (123)

where 180° is added because of the 180° yaw between the camera frame and the link frame. The range of sin⁻¹ is −90° . . . 90°. The pitch rotation from camera frame to link is given by:

γ₃=a tan 2(−^{c}\hat{Z}_{L}(2)/C_{α3}, ^{c}\hat{Z}_{L}(3)/C_{α}₃) (124)

Writing

$$[ \begin{matrix}{b}_{x} \\ {b}_{y} \\ {b}_{z}\end{matrix} ] = {}_{}^{L}{P}{}_{A}^{} - {}_{}^{L}{P}{}_{B}^{}$$

Eqn (122) may be written:

d_{A} ⁿPₐ−d_{B} ⁿP_{b}=bₓ(C_{β3}d₁+S_{β3}d₂)+b_{y}(C_{β3}d₂−S_{β3}d₁)+b_{z} d₃ (125)

Where

$${d}_{1} = [ \begin{matrix}{C}_{α3} \\ {S}_{{α}_{3}} {S}_{{γ}_{3}} \\ - {C}_{{γ}_{3}} {S}_{{α}_{3}}\end{matrix} ] {d}_{2} = [ \begin{matrix}0 \\ {C}_{{γ}_{3}} \\ {S}_{{γ}_{3}}\end{matrix} ] {d}_{3} = [ \begin{matrix}{S}_{{α}_{3}} \\ - {C}_{{α}_{3}} {S}_{{γ}_{3}} \\ {C}_{{α}_{3}} {C}_{{γ}_{3}}\end{matrix} ]$$

d₁ and d₂ are seen to represent the first two columns of _{c}^{r}R with the β₃ terms factored out. Eqn (125) can be rearranged as:

d_{A}(ⁿPₐ−ⁿP_{b})+d_{AB} ⁿP_{b}=C_{β3}e₁+S_{⊖3}e₂+b_{z} d₃ (126)

with

d_{AB}=d_{A}−d_{B}; e₁=bₓd₁+b_{y}d₂ and e₂=bₓd₂−b_{y}d₁

System of equations (126) provides four equations in four unknowns, 3 equations from the three spatial dimensions, and the nonlinear constraint:

C_{β3}²+S_{β3}²=1 (127)

The unknowns are: {d_{A}, d_{AB}, C_{β3}, S_{β3}}.

This system of equations can be solved by:

1. Setting up the linear system of three equations in four unknowns:

Q=[(ⁿPₐ−ⁿP_{b}), ⁿP_{b}, −e1, −e2]

$$B = [ \begin{matrix}{d}_{A} {=}^{c} {P}_{A} ( 3 ) \\ {d}_{AB} \\ {C}_{{β}_{3}} \\ {S}_{{β}_{3}}\end{matrix} ]$$

b_{z}d₃=QB

2. The matrix Q∈R^{3×4}. The solution comprises a contribution from the row space of Q and a contribution from the null space of Q. The row space contribution is given by:

Bᵣ=Q^{-R} b_{z}d₃=Q^{T} inv(QQ^{T})b_{z}d₃ (128)

3. The contribution from the null space can be determined be satisfying constraint (127):

B=Bᵣ+ψN_{Q} (129)

Where N_{Q} is the null space of Q, and ψ∈R¹ is to be determined.

4. Solve for ψ:

B(3)=Bᵣ(3)+ψN_{Q} (3)

B(4)=Bᵣ(4)+ψN_{Q} (4)

B(3)²+B(4)²−1=0 (130)

Which gives:

_{q1}ψ²+_{q2}ψ+_{q3}=0

_{q1}=N_{Q}(3)²+N_{Q}(4)²

_{q2}=2(Bᵣ(3) N_{Q}(3)+Bᵣ(4) N_{Q}(4))

_{q3}=Bᵣ(3)²+Bᵣ(4)²−1

5. There are two solutions to the quadratic equation

$$ψ = \frac{- {q}_{2} \pm \sqrt{{q}_{2}^{2} - 4 {q}_{3} {q}_{1}}}{2 {q}_{1}}$$

The correct branch is the one which gives a positive value for d_{A}=B(1)=^{c}P_{A}(3).

With the solution of Eqn (129) values for {d_{A}, d_{AB}, C_{β3}, S_{β3}} are determined and _{L}^{c}R can be found. Vector ^{c}P_{O}_{_{L}} is approximately given (exactly given if ^{r}P_{A}=[0 0 0]^{T}) as:

$${}^{c} {P}_{{O}_{L}} {=}_{L}^{c} R [ \begin{matrix}0 \\ 0 \\ {d}_{A}\end{matrix} ] \qquad ( 131 )$$

Steps 1 through 5, combined with Eqns (123) and (124) provide a means to estimate the camera position and orientation in link coordinates. As described in Section L5.1.6., interpretation of the ODR information permit estimation of the orientation of the link frame in reference coordinates. Combined, the position and orientation of the camera in reference coordinates can be estimated.

L5.1.8. Completing the Initial Exterior Orientation Estimation (i.e., Resection)

The collinearity equations for resection are expressed in Eqn (10) as:

ⁱPₐ=_{c}ⁱT(ᵣ^{c}T(^{r}P_{A}))

where, from Eqn (91)

$${}_{c}^{r} T = [ \begin{matrix}{}_{c}^{t} R & ⋮ & {}^{r} {P}_{{O}_{c}} \\ … & … & … \\ 0 & ⋮ & 1\end{matrix} ]$$

Using the link frame as an intermediate frame as discussed above:

ᵣ^{c}R=_{L}^{c}Rᵣ^{L}R

where ᵣ^{L}R was determined in Section L5.1.6. using information from at least two ODRS, and _{L}^{c}R and ^{c}P_{O}_{ᵣ}=^{c}P_{O}_{_{L}} were determined in Section L5.1.7. using information from at least two fiducial marks. From ᵣ^{c}R the angles α, β, γ can be determined.

L5.1.9. Other Exemplary Initial Estimation Methods

Alternatively to the method outlined in Sections L5.1.6. and L5.1.7., estimates for the exterior orientation parameters may be obtained by:

1. Estimating the pitch and yaw from the cumulative phase rotation signal obtained from a robust fiducial mark, as described in Section K, Eqn (59);

2. Estimating the roll directly from the angle between a vector between two fiducial marks in the reference artwork and a vector in image coordinates between the corresponding images of the two fiducial marks;

3. Estimating the target distance (z_{cam}) using the near-field effect of the ODR discussed in Appendix A;

4. Estimating parameters ^{c}P_{O}_{ᵣ}(1)/^{c}P_{O}_{ᵣ}(3) and ^{c}P_{O}_{ᵣ}(2)/^{c}P_{O}_{ᵣ}(3) from the image coordinates of the origin of the reference frame (obtained using a fiducial mark at the origin, the intersection of lines connecting fiducial marks, or transform matrix ᵣⁱT₂);

5. Combining estimates of z_{cam}, ^{c}P_{O}_{ᵣ}(1)/^{c}P_{O}_{ᵣ}(3) and ^{c}P_{O}_{ᵣ}(2)/^{c}P_{O}_{ᵣ}(3) to estimate ^{c}P_{O}_{ᵣ}.

Other methods to obtain an initial estimate of exterior orientation may also be used; in one aspect, the only requirement is that the initial estimate be sufficiently close to the true solution so that a least-squares iteration converges.

L5.2. Estimation Refinements; Full Camera Calibration

A general model form is given by:

ν=F(u, c); ε*=ν−\hat{ν} (132)

where \hat{ν}∈R^{m} is a vector of m measured data (e.g., comprising the centers of the fiducial marks and the luminosity analysis of the ODR regions); ν∈R^{m} is a vector of m data predicted using the reference information and camera calibration data; F(·) is a function modeling the measured data based on the reference information and camera calibration data. The values for reference information and camera calibration parameters are partitioned between u∈Rⁿ, the vector of n parameters to be determined and c, a vector of constant parameters. The several parameters of u+c may be partitioned many different ways between u (to be estimated) and c (constant, taken to be known). For example, if parameters of the artwork are precisely known, the reference information would be represented in c. If the camera is well calibrated, interior orientation and image distortion parameters would be placed in c and only exterior orientation parameters would be placed in u. It is commonly the case with. non-metric cameras that principle distance, d, is not known and would be included in vector u. For camera calibration, additional interior orientation and image distortion parameters would be placed in u. In general, the greater the number of parameters in u, the more information must be present in the data vector v for an accurate estimation.

Vector u may be estimated by the Newton-Raphson iteration described below. This is one embodiment of the generalized functional model described in Section H and with Eqn (14), and is described with somewhat modified notation.

û₀: inital estimate of the scaled parameters

for i=0 . . . (Nᵢ−1)

$$\begin{matrix}{υ}_{i} = F ( {\hat{u}}_{i} , c ) \\ {ϵ}_{i} = {υ}_{i} - \hat{υ} \\ δ {\hat{u}}_{i} = - {S [ {{{S}^{T} ( \frac{ⅆ υ}{ⅆ u} )}^{T}}_{{u}_{i}} {W}^{T} {W ( \frac{ⅆ υ}{ⅆ u} )}_{{u}_{i}} S ]}^{- 1} {{{S}^{T} ( \frac{ⅆ υ}{ⅆ u} )}^{T}}_{{tu}_{i}} {W}^{T} W {ϵ}_{i} \\ {\hat{u}}_{i + 1} = {\hat{u}}_{i} + δ {\hat{u}}_{i}\end{matrix} \qquad ( 133 )$$

where

Nᵢ is the number of iterations of the Newton-Raphson method;

\hat{ν}∈R^{m} is the measured data;

εᵢ∈R^{m} is the estimation residual at the i^{th} step;

S∈R^{n×n} is a matrix scaling the parameters to improve the conditioning of the matrix inverse

$$S = [ \begin{matrix}{s}_{1} & & & 0 \\ & {s}_{2} & & \\ & & ⋰ & \\ 0 & & & {s}_{n}\end{matrix} ] ;$$

û₀=S⁻¹ u₀ are the scaled initial parameters;

W∈R^{m×m} is a matrix weighting the data;

The iteration of Eqn (133) is run until the size of the parameter update is less than a stop threshold, |δuᵢ|<StopThreshold. This determines Nᵢ;

The partition of model parameters between u and c may vary, it is not necessary to update all parameters all of the time.

Scaling is implemented according to u=Sû, where u is the vector of the parameters. The matrix inversion step in Eqn (133) may be poorly condition if the parameters span a large range of numerical values, scaling is used so that the elements of û are of approximately the same size. Often, the sᵢ are chosen to have magnitude comparable to a typical value for the corresponding uᵢ.

There are several possible coordinate frames in which εᵢ can be computed, including image coordinates, normalized-image coordinates and target coordinates. Image coordinates are used, because the data are directly expressed here without reference to any model parameter. Using image coordinates requires that the derivatives of equation (133) all be computed w.r.t. image coordinate variables.

To carry out the iteration of Eqn (133) the data predicted by the model, vᵢ, must be computed, as well as the derivatives of the data in the parameters, (dv/du)ᵤᵢ. Computation of these quantities, as well as determination of S and W is discussed in the next three sections.

L5.2.1. Computing νᵢ

The data predicted on the basis of reference information and camera calibration are given by

$${υ}_{i} = F ( {u}_{i - 1} , c ) = [ \begin{matrix}FID positions \\ in image \\ RGR Luminosity\end{matrix} ] = [ \begin{matrix}{}^{i} {O}_{{F}_{1}} ( 1 ) \\ {}^{i} {O}_{{F}_{1}} ( 2 ) \\ ⋮ \\ {}^{i} {O}_{{F}_{{N}_{{FID}_{s}}}} ( 1 ) \\ {}^{i} {O}_{{F}_{{N}_{{FID}_{s}}}} ( 2 ) \\ {\hat{L}}_{1} ( 1 ) \\ ⋮ \\ {\hat{L}}_{1} ( {N}_{bins} ( 1 ) ) \\ ⋮ \\ ⋮ \\ {\hat{L}}_{{N}_{D}} ( 1 ) \\ ⋮ \\ {\hat{L}}_{{N}_{D}} ( {N}_{bins} ( {N}_{D} ) )\end{matrix} ] \qquad ( 134 )$$

where ⁱO_{Fj}(1) is the predicted X-coordinate of the j^{th} fiducial mark, and likewise ⁱO_{Fj}(2) is the predicted Y-coordinate; N_{D} is the number of ODR regions, and where the predicted luminosity in the k^{th} bin of the j^{th} ODR region is written \hat{L}ⱼ(k), j∈{1 . . . N_{D}} and k∈{1 . . . N_{bins}(j)}, the range for k indicates that a distinct number of bins may be used for the accumulation of luminosity for each ODR region (see section L5.1.5.).

In the reference artwork examples of FIGS. 8 and 10B, there are 8 data corresponding to the measured X and Y positions of the 4 fiducial marks, and 344 data corresponding to luminosity as a function of position in a total of four ODR regions (in FIG. 8, the ODRs shown at 122A and 122B each comprise two regions, with the regions arranged by choice of grating frequencies to realize differential mode sensing, in FIG. 10B there are four ODRs, each with one region and arranged to realize differential mode sensing).

The predicted fiducial centers are computed using the equations (97) and (98). The luminosity values are predicted using Eqn (48):

$$\begin{matrix}{}^{n} {\hat{P}}_{j} ( k ) {=}_{i}^{n} T {(}^{i} {\hat{P}}_{j} ( k ) ) \\ {}^{D} {J}_{a} {{=}_{c}}^{{D}_{j}} {R}^{n} {\hat{P}}_{j} ( k ) \\ {}^{f} {\hat{P}}_{j} ( k ) = - {\frac{{}^{{D}_{j}} {P}_{{O}_{c}} ( 3 )}{{}^{D} {J}_{a} ( 3 )} }^{D} {J}_{a} {+}^{{D}_{j}} {P}_{{O}_{c}} \\ {\hat{L}}_{j} ( k ) = {a}_{0} ( j ) + {a}_{1} ( j ) cos ( v {(}^{f} {\hat{P}}_{j} ( k ) ) )\end{matrix}$$

where ⁱ\hat{P}ⱼ(k)∈R² is the first moment of illumination in the k^{th} bin of the j^{th} ODR; ^{f}\hat{P}ⱼ(k)∈R³ is the corresponding point projected to the front face of the ODR (using camera calibration parameters in u and c); \hat{L}ⱼ(k) is the value of luminance predicted by the model at front-face point ^{f}\hat{P}ⱼ(k) (using parameters a₀(j) and a₁(j)).

L5.2.2. Determining the Data Derivatives with Respect to the Model Parameters

For the purposes of discussion, estimation of the exterior orientation, principle distance and ODR parameters {v₀, a₀, a₁} is considered in this section, giving u∈R^{7+3N}^{_{D}}. For the artwork of FIGS. 8 and 10B, with two ODR regions per ODR, N_{D}=4, which gives 19 parameters, or u∈R¹⁹. The order of the model parameters in the u vector is:

u=[γ β α ^{c}P_{O}_{ᵣ}^{T} d ¹v₀ . . . ^{N}^{_{D}}v₀ ¹a₀ ¹a₁ . . . ^{N}^{_{D}}a₀ ^{N}^{_{D}}a₁]^{T} (135)

Where ^{c}P_{O}_{ᵣ}^{T}∈R³ represents the reference artwork position (reference frame origin) in camera coordinates. Alternative embodiments might additionally include the three additional interior orientation parameters and the parameters of an image distortion model.

Determining the Derivative of the Fiducial Mark Positions w.r.t. Model Parameters

The image-coordinate locations of the fiducial marks (RFIDs) are computed from their known locations in the artwork (i.e., reference information) using the coordinate transform given in Eqn (108) where f_{c}⁻¹(··) and ᵣ^{c}T and ₙⁱT depend upon the exterior and interior orientation end camera calibration parameters but do not depend on the ODR region parameters.

Computation of the derivative requires

$$\frac{ⅆ {}_{}^{c}{P}{}_{A}^{}}{ⅆ u} ,$$

which depends on ^{r}P_{A} and is given by:

$$\frac{{ⅆ}^{c} {P}_{A}}{ⅆ u} = [ {\frac{{ⅆ}_{r}^{c} R}{ⅆ γ} }^{r} {P}_{A} , {\frac{{ⅆ}_{r}^{c} R}{ⅆ β} }^{r} {P}_{A} , {\frac{{ⅆ}_{r}^{c} R}{ⅆ α} }^{r} {P}_{A} , [ \begin{matrix}1 \\ 0 \\ 0\end{matrix} ] , [ \begin{matrix}0 \\ 1 \\ 0\end{matrix} ] , [ \begin{matrix}0 \\ 0 \\ 1\end{matrix} ] , [ \begin{matrix}0 \\ 0 \\ 0\end{matrix} ] ] \qquad ( 136 )$$

and where

$$\frac{ⅆ {}_{r}^{c} R}{ⅆ γ} ∈ {R}^{3 \times 3}$$

is the element-wise derivative of the rotation matrix w.r.t. γ. From Eqn (92), one finds

$$\begin{matrix}\frac{ⅆ {}_{r}^{c} R}{ⅆ γ} = \begin{matrix}{R}_{180} & {R}_{roll} & {R}_{yaw} & \frac{ⅆ {R}_{pitch}}{ⅆ γ}\end{matrix} \\ = [ \begin{matrix}- 1 & 0 & 0 \\ 0 & 1 & 0 \\ 0 & 0 & - 1\end{matrix} ] [ \begin{matrix}{C}_{β} & - {S}_{β} & 0 \\ {S}_{β} & {C}_{β} & 0 \\ 0 & 0 & 1\end{matrix} ] [ \begin{matrix}{C}_{α} & 0 & {S}_{α} \\ 0 & 1 & 0 \\ - {S}_{α} & 0 & {C}_{a}\end{matrix} ] \\ [ \begin{matrix}1 & 0 & 0 \\ 0 & - {S}_{γ} & - {C}_{γ} \\ 0 & {C}_{γ} & - {S}_{γ}\end{matrix} ]\end{matrix} \qquad ( 137 )$$

and likewise for the other three rotation matrix derivatives.

Starting with Eqns (97) and (98) the derivatives in pixel coordinates are given by:

$$\frac{ⅆ {}_{}^{i}{P}{}_{a}^{}}{ⅆ u} ( 1 , \text{:} ) = - {dk}_{x} ( \frac{1}{{}_{}^{c}{P}{}_{A}^{} ( 3 )} \frac{ⅆ {}_{}^{c}{P}{}_{A}^{} ( 1 , \text{:} )}{ⅆ u} - \frac{{}_{}^{c}{P}{}_{A}^{} ( 1 )}{{{}_{}^{c}{P}{}_{A}^{} ( 3 )}^{2}} \frac{ⅆ {}_{}^{c}{P}{}_{A}^{} ( 3 , \text{:} )}{ⅆ u} ) \\ \frac{ⅆ {}_{}^{i}{P}{}_{a}^{}}{ⅆ u} ( 2 , \text{:} ) = - {dk}_{y} ( \frac{1}{{}_{}^{c}{P}{}_{A}^{} ( 3 )} \frac{ⅆ {}_{}^{c}{P}{}_{A}^{} ( 2 , \text{:} )}{ⅆ u} - \frac{{}_{}^{c}{P}{}_{A}^{} ( 2 )}{{{}_{}^{c}{P}{}_{A}^{} ( 3 )}^{2}} \frac{ⅆ {}_{}^{c}{P}{}_{A}^{} ( 3 , \text{:} )}{ⅆ u} ) \\ \frac{ⅆ {}_{}^{i}{P}{}_{a}^{}}{ⅆ u} ( \text{:} , 7 ) = - [ \begin{matrix}{k}_{x} & 0 \\ 0 & {k}_{y}\end{matrix} ] \frac{{}_{}^{c}{P}{}_{A}^{} ( 1 \text{:} 2 )}{{}_{}^{c}{P}{}_{A}^{} ( 3 )} \qquad ( 138 )$$

where subarrays are identified using MATLAB notation: A(1,:) refers to the 1^{st} row of A, B (:, 7) refers to the 7^{th} column of B; and if C is a 3-vector, C (1:2) refers to elements 1 through 2 of vector C. When ^{r}P_{A} in Eqn (136) is the position in reference coordinates corresponding to ^{r}O_{Fj}, the position of the j^{th} RFID, then dⁱPₐ/du is the derivative of the position in image coordinates of the j^{th} RFID w.r.t. parameters u.

L5.2.3. Determining the Derivative of Orientation Dependent Radiation, \hat{L}ⱼ(k) w.r.t. Model Parameters

The computation of the derivatives of \hat{L}ⱼ(k) proceeds by:

1. The known pixel coordinates of the center of luminosity of each bin are transformed to a point on the ODR, ⁱ\hat{P}ⱼ(k)→^{f}\hat{P}ⱼ(k)

2. The derivative of the transformation, d^{f}\hat{P}ⱼ(k)/d ⁱ\hat{P}ⱼ(k), is computed:

$$\begin{matrix}\frac{ⅆ {}_{}^{r}{P}{}_{{O}_{c}}^{}}{ⅆ u} = - [ \begin{matrix}\frac{ⅆ {}_{c}^{r} R}{ⅆ γ} {}_{}^{c}{P}{}_{{O}_{r}}^{} , & \frac{ⅆ {}_{c}^{r} R}{ⅆ β} {}_{}^{c}{P}{}_{{O}_{r}}^{} , & \frac{ⅆ {}_{c}^{r} R}{ⅆ α} {}_{}^{c}{P}{}_{{O}_{r}}^{} , & {}_{c}^{r} R , & [ \begin{matrix}0 \\ 0 \\ 0\end{matrix} ]\end{matrix} ] \\ \frac{ⅆ {}_{}^{r}{P}{}_{{O}_{c}}^{}}{ⅆ u} ∈ {R}^{3 \times 7} ; & ( 139 ) \\ \begin{matrix}\frac{ⅆ {}_{}^{D}{J}{}_{a}^{}}{ⅆ u} = [ \begin{matrix}\frac{ⅆ {}_{c}^{r} R}{ⅆ γ} {}_{i}^{n} T {}_{}^{i}{P}{}_{a}^{} , & \frac{ⅆ {}_{c}^{r} R}{ⅆ β} {}_{i}^{n} T {}_{}^{i}{P}{}_{a}^{} , & \frac{ⅆ {}_{c}^{r} R}{ⅆ α} {}_{i}^{n} T {}_{}^{i}{P}{}_{a}^{} ,\end{matrix} \\ \begin{matrix}[ \begin{matrix}0 & 0 & 0 \\ 0 & 0 & 0 \\ 0 & 0 & 0\end{matrix} ] , & {}_{c}^{r} R \frac{ⅆ {}_{i}^{n} T}{ⅆ d} {}_{}^{i}{P}{}_{a}^{}\end{matrix} ]\end{matrix} \\ \frac{ⅆ {}_{}^{D}{J}{}_{a}^{}}{ⅆ u} ∈ {R}^{3 \times 7} ; & ( 140 ) \\ \begin{matrix}\frac{ⅆ {}_{}^{f}{\hat{P}}{}_{j}^{} ( k ) ( l , \text{:} )}{ⅆ u} = {}_{}^{D}{J}{}_{a}^{} ( l ) [ - \frac{1}{{}_{}^{D}{J}{}_{a}^{} ( 3 )} \frac{ⅆ {}_{}^{r}{P}{}_{{O}_{c}}^{} ( 3 , \text{:} )}{ⅆ u} + \\ \frac{{}_{}^{r}{P}{}_{{O}_{c}}^{} ( 3 )}{{{}_{}^{D}{J}{}_{a}^{} ( 3 )}^{2}} \frac{ⅆ {}_{}^{D}{J}{}_{a}^{} ( 3 , \text{:} )}{ⅆ u} ] - \\ \frac{{}_{}^{r}{P}{}_{{O}_{c}}^{} ( 3 )}{{}_{}^{D}{J}{}_{a}^{} ( 3 )} \frac{ⅆ {}_{}^{D}{J}{}_{a}^{}}{ⅆ u} + \frac{ⅆ {}_{}^{r}{P}{}_{{O}_{c}}^{}}{ⅆ u}\end{matrix} & ( 141 ) \\ l ∈ \{ 1 , 2 \} & ( 142 )\end{matrix}$$

3. The point ^{f}\hat{P}ⱼ(k) is projected onto the ODR region longitudinal axis

^{f}\hat{P}ⱼ(k)^{∥}=^{r}X_{Dj}(^{r}X_{Dj}^{T}(^{f}\hat{P}ⱼ(k)−^{r}P_{O}_{_{c}}))+^{r}P_{O}_{_{c}}

where ^{r}X_{Dj} is the unit vector along the longitudinal axis of the ODR region in reference coordinates, and ^{r}P_{O}_{_{c}} is the reference coordinates center of the ODR region.

4. The derivative dδ^{b}x/d^{f}\hat{P}ⱼ(k) is calculated at ^{f}\hat{P}ⱼ(k)^{∥}. The derivative follows from Eqns (J21) and (J22).

5. The derivative of the back grating shift w.r.t. the parameters is computed:

$$\frac{ⅆ δ {}^{b} x}{ⅆ u} = \frac{ⅆ δ {}^{b} x}{ⅆ {}_{}^{f}{\hat{P}}{}_{j}^{} ( k )} ( \begin{matrix}{}_{}^{r}{X}{}_{{D}_{j}}^{} & {}_{}^{r}{X}{}_{{D}_{j}}^{T} & \frac{ⅆ {}_{}^{f}{\hat{P}}{}_{j}^{} ( k )}{ⅆ u} - \frac{ⅆ {}_{}^{r}{P}{}_{{O}_{c}}^{}}{ⅆ u}\end{matrix} ) \qquad ( 143 )$$

6. The component of

$$\frac{ⅆ {δ}^{b} x}{ⅆ u}$$

lying along the ODR longitudinal axis is considered

$$\frac{ⅆ δ {}^{Db} x}{ⅆ u} ∈ {R}^{1 \times 7} \frac{ⅆ δ {}^{Db} x}{ⅆ u} = {}_{}^{r}{X}{}_{D}^{T} \frac{ⅆ δ {}^{b} x}{ⅆ u} \qquad ( 144 )$$

7. The derivative of the Moire pattern (i.e., triangle waveform) phase at a point in the image w.r.t. the parameters is given by:

$$\frac{ⅆ v}{ⅆ u} ∈ {R}^{1 \times ( 7 + {N}_{D} )} ; \\ \frac{ⅆ v}{ⅆ u} = [ [ 360 ( {f}_{f} - {f}_{b} ) {}_{}^{r}{X}{}_{{D}_{j}}^{T} \frac{ⅆ {}_{}^{f}{\hat{P}}{}_{j}^{} ( k )}{ⅆ u} + 360 {f}_{b} \frac{ⅆ δ {}^{Db} x}{ⅆ u} ] \\ [ \begin{matrix}0 & ⋯ & 1 & ⋯ & 0\end{matrix} ] ] \qquad ( 145 )$$

where the vector [0 . . . 1 . . . 0]∈R^{1×N}ᵣ reflects the contributions of the v₀ parameters to the derivative.

8. Finally, the derivative the Moiré pattern luminance at a point in the image w.r.t. the parameters is given by:

$$\frac{ⅆ {\hat{L}}_{j} ( k )}{ⅆ u} ∈ {R}^{1 \times ( 7 + 3 {N}_{D} )} ; \\ \frac{ⅆ {\hat{L}}_{j} ( k )}{ⅆ u} = [ [ - {a}_{1} sin ( v ) \frac{ⅆ v}{ⅆ u} ] [ \begin{matrix}0 & ⋯ & 1 , & cos ( v ) & ⋯ & 0\end{matrix} ] ] \qquad ( 146 )$$

where the first term has dimension 1×(7+N_{D}) and includes derivatives due to the extended exterior orientation parameters and the v₀, and the second term has dimension 1×2N_{D} and includes derivatives w.r.t. the parameters a₀ and a₁ (see Eqn (J25)).

9. The derivative of the data w.r.t. the parameters is given by:

$$\frac{ⅆ v}{ⅆ u} = [ \begin{matrix}\begin{matrix}\frac{ⅆ {}_{}^{i}{P}{}_{a}^{}}{ⅆ u} & [ 0 ]\end{matrix} \\ [ \frac{ⅆ {\hat{L}}_{j} ( k )}{ⅆ u} ]\end{matrix} ] ∈ {R}^{( 2 {N}_{FID} + {N}_{l} ) \times ( 7 + 3 {N}_{D} )} \qquad ( 147 )$$

Where N_{FID} is the number of fiducial marks, Nₗ is the total number of luminosity readings from the N_{D} ODR regions, and the zero terms, [0]∈R^{2N}^{_{FID}}^{×3N}^{_{D}} reflects the fact that the fiducial locations do not depend upon the ODR region parameters.

L5.3. Determining the Weighting and Scaling Matrices

The weighting matrix W and the scaling matrix S play an important role in determining the accuracy of the estimates, the behavior of the iteration and the conditioning of the matrix inversion. The matrices W∈R^{(2N}^{_{FID}}^{+N}^{ₗ}^{)×(2N}^{_{FID}}^{+N}^{ₗ}⁾ and S∈R^{(7+3N}^{_{D}}^{)×(7+3N}^{_{D}}⁾ are typically diagonal, which can be used to improve the efficiency of the evaluation of Eqn (133). The elements of W provide a weight on each of the data points. These weights are used to:

Shut off consideration of the ODR data during the first phase of fitting, while the fiducial marks are being fit;

Control the relative weight placed on the fiducial marks;

Weight the ODR luminosity data, (see Eqn (114)), according to the number of pixels landing in the bin;

Window the ODR luminosity data.

The elements of S are set according to the anticipated range of variation of each variable. For example, ^{c}P_{O}_{ᵣ}(3) may be several meters, while d will usually be a fraction of a meter; therefore S(6, 6) takes a larger value than S(7, 7). S(6, 6) corresponds to ^{c}P_{O}_{ᵣ}(3), and S(7, 7) corresponds to d (see Eqn (135)). The diagonal elements of W and S are non-negative.

### M Summary of Exemplary Implementations

It should be appreciated that a variety of image metrology methods and apparatus according to the present invention, including those particularly described in detail above, can be implemented in numerous ways, as the invention is not limited to any particular manner of implementation. For example, image metrology methods and apparatus according to various embodiments of the invention may be implemented using dedicated hardware designed to perform any one or more of a variety of functions described herein, and/or using one or more computers or processors (e.g., the processor 36 shown in FIG. 6, the client workstation processors 44 and/or the image metrology server 36A shown in FIG. 7, etc.) that are programmed using microcode (i.e., software) to perform any one or more of the variety of finctions described herein.

In particular, it should be appreciated that the various image metrology methods outlined herein, including the detailed mathematical analyses outlined in Sections J, K and L of the Detailed Description, for example, may be coded as software that is executable on a processor that employs any one of a variety of operating systems. Additionally, such software may be written using any of a number of suitable programming languages and/or tools, including, but not limited to, the C-programming language, MATLAB™, MathCAD™, and the like, and also may be compiled as executable machine language code.

In this respect, it should be appreciated that one embodiment of the invention is directed to a computer readable medium (or multiple computer readable media) (e.g., a computer memory, one or more floppy discs, compact discs, optical discs, magnetic tapes, etc.) encoded with one or more computer programs that, when executed on one or more computers or other processors, perform methods that implement the various embodiments of the invention discussed above. The computer readable medium or media can be transportable, such that the program or programs stored thereon can be loaded onto one or more different computer systems to implement various aspects of the present invention as discussed above. It should be understood that the term “computer program” is used herein in a generic sense to refer to any type of computer code that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Having thus described several illustrative embodiments of the present invention, various alterations, modifications, and improvements will readily occur to those skilled in the art. Such alterations, modifications, and improvements are intended to be within the spirit and scope of the invention. Accordingly, the foregoing description is by way of example only and is not intended as limiting.

What is claimed is:

1. An image metrology reference target, comprising:
at least one fiducial mark; and
at least one orientation dependent radiation source disposed in a predetermined spatial relationship with respect to the at least one fiducial mark, the at least one orientation dependent radiation source emanating from an observation surface orientation dependent radiation having at least one detectable property in an image of the reference target that varies as a function of at least one of a rotation angle of the orientation dependent radiation source and a distance between the orientation dependent radiation source and a camera obtaining the image of the reference target.

2. The reference target of claim 1, wherein:
the at least one fiducial mark includes automatic detection means for facilitating an automatic detection of the reference target in the image; and
the at least one orientation dependent radiation source includes bearing determination means for facilitating a determination of at least one of a position and at least one orientation angle of the reference target with respect to the camera.

3. The reference target of claim 1, wherein the at least one fiducial mark includes at least one robust fiducial mark.

4. The reference target of claim 1, wherein the at least one fiducial mark includes at least four fiducial marks disposed in a predetermined relationship with respect to one another.

5. The reference target of claim 4, wherein the at least one orientation dependent radiation source includes at least two orientation dependent radiation sources disposed non-parallel with respect to each other.

6. The reference target of claim 1, wherein the at least one orientation dependent radiation source includes at least two parallel orientation dependent radiation sources.

7. The reference target of claim 6, wherein the at least one detectable property of a first orientation dependent radiation source of the at least two parallel orientation dependent radiation sources varies differently than the at least one detectable property of a second orientation dependent radiation source of the at least two parallel orientation dependent radiation sources as a fimction of a common rotation angle of the at least two parallel orientation dependent radiation sources.

8. The reference target of claim 1, wherein the reference target includes at least one identifiable physical attribute that uniquely distinguishes the reference target.

9. The reference target of claim 8, wherein the reference target includes at least two different fiducial marks.

10. The reference target of claim 1, further including at least one reflector coupled to the at least one orientation dependent radiation source to reflect radiation that is incident to the reference target and that passes through the at least one orientation dependent radiation source.

11. The reference target of claim 1, wherein:
the reference target has an essentially planar surface; and
the observation surface of the at least one orientation dependent radiation source is essentially parallel with the planar surface of the reference target.

12. The reference target of claim 1, wherein the at least one detectable property of the at least one orientation dependent radiation source includes a spatial distribution of the orientation dependent radiation on the observation surface that varies as a function of at least one of the rotation angle of the orientation dependent radiation source and the distance between the orientation dependent radiation source and the camera.

13. The reference target of claim 12, wherein the spatial distribution of the orientation dependent radiation on the observation surface includes at least one Moire pattern.

14. The reference target of claim 12, wherein the spatial distribution of the orientation dependent radiation on the observation surface includes an essentially triangular waveform.

15. The reference target of claim 1, wherein the at least one detectable property of the at least one orientation dependent radiation source includes at least one of a position of the orientation dependent radiation on the observation surface, a spatial period of the orientation dependent radiation, a polarization of the orientation dependent radiation, and a wavelength of the orientation dependent radiation.

16. The reference target of claim 1, wherein the at least one orientation dependent radiation source includes:
a first grating having a first spatial frequency; and
a second grating, coupled to the first grating, having a second spatial frequency.

17. The reference target of claim 16, wherein the at least one orientation dependent radiation source further includes an essentially transparent substrate disposed between the first grating and the second grating.

18. The reference target of claim 16, wherein the first spatial frequency and the second spatial frequency are different.

19. The reference target of claim 16, wherein the first spatial frequency and the second spatial frequency are the same.

20. The reference target of claim 1, wherein:
the at least one orientation dependent radiation source includes a first orientation dependent radiation source and a second orientation dependent radiation source;
the observation surface of each orientation dependent radiation source has a primary axis along which the at least one first detectable property varies and a secondary axis orthogonal to the primary axis; and
the first and second orientation dependent radiation sources are oriented such that the secondary aces of the first and second orientation dependent radiation sources are orthogonal to each other.

21. The reference target of claim 20, wherein:
the reference target has a center; and
the first and second orientation dependent radiation sources are oriented such that the secondary axes of the first and second orientation dependent radiation sources each passes through the center of the reference target.

22. The reference target of claim 1, wherein:
the at least one orientation dependent radiation source includes a first orientation dependent radiation source and a second orientation dependent radiation source disposed parallel with respect to each other;
the first orientation dependent radiation source includes:
a first front grating having a first spatial frequency; and
a first back grating, coupled to the first front grating, having a second spatial frequency that is greater than the first spatial frequency; and the second orientation dependent radiation source includes:
a second front grating having a third spatial frequency; and
a second back grating, coupled to the second front grating, having a fourth spatial frequency that is less than the third spatial frequency.

23. The reference target of claim 1, further including at least one automatically readable coded pattern coupled to the reference target, the automatically readable coded pattern including coded information relating to at least one physical property of the reference target.

24. The reference target of claim 0, wherein the at least one physical property of the reference target includes at least one of relative spatial positions of the at least one fiducial mark and the at least one orientation dependent radiation source, a size of the reference target, a size of the at least one orientation dependent radiation source, and a unique identifying attribute of the reference target.

25. The reference target of claim 0, wherein the at least one automatically readable coded pattern includes a bar code affixed to the reference target.

26. An apparatus, comprising:
at least one orientation dependent radiation source to emanate from an observation surface orientation dependent radiation having at least one detectable property that varies as a function of at least one of a rotation angle of the orientation dependent radiation source and a distance between the orientation dependent radiation source and a radiation detection device receiving the orientation dependent radiation.

27. The apparatus of claim 26, wherein the at least one detectable property of the at least one orientation dependent radiation source includes a spatial distribution of the orientation dependent radiation on the observation surface that varies as a function of at least one of the rotation angle of the orientation dependent radiation source and the distance between the orientation dependent radiation source and the radiation detection device.

28. The apparatus of claim 27, wherein the spatial distribution of the orientation dependent radiation on the observation surface includes at least one Moire pattern.

29. The apparatus of claim 27, wherein the spatial distribution of the orientation dependent radiation on the observation surface includes an essentially triangular waveform.

30. The apparatus of claim 26, wherein the at least one detectable property of the at least one orientation dependent radiation source includes at least one of a position of the orientation dependent radiation on the observation surface, a spatial period of the orientation dependent radiation, a polarization of the orientation dependent radiation, and a wavelength of the orientation dependent radiation.

31. The apparatus of claim 26, wherein the at least one orientation dependent radiation source includes:
a first grating having a first spatial frequency; and
a second grating, coupled to the first grating, having a second spatial frequency.

32. The apparatus of claim 31, wherein the at least one orientation dependent radiation source further includes an essentially transparent substrate disposed between the first grating and the second grating.

33. The apparatus of claim 31, wherein the first spatial frequency and the second spatial frequency are different.

34. The apparatus of claim 31, wherein the first spatial frequency and the second spatial frequency are the same.

35. A method for processing an image including at least one orientation dependent radiation source that emanates from an observation surface orientation dependent radiation having at least a first detectable property in the image and a second detectable property in the image that each varies as a function of at least one of a rotation angle of the orientation dependent radiation source and a distance between the orientation dependent radiation source and a camera obtaining the image of the at least one orientation dependent radiation source, the method comprising acts of:
determining the rotation angle of the orientation dependent radiation source from the first detectable property; and
determining the distance between the orientation dependent radiation source and the camera from at least the second detectable property.

36. The method of claim 35, wherein the at least one orientation dependent radiation source includes at least two parallel orientation dependent radiation sources, wherein each of the at least first and second properties of one of the at least two parallel orientation dependent radiation sources varies differently than the respective at least first and second properties of another of the at least two parallel orientation dependent radiation sources, and wherein the act of determining the rotation angle of the orientation dependent radiation source from the first detectable property includes an act of:
determining a common rotation angle of the at least two parallel orientation dependent radiation sources based on a comparison of the respective first detectable properties of the at least two parallel orientation dependent radiation sources,
and wherein the act of determining the distance between the orientation dependent radiation source and the camera from at least the second detectable property includes an act of:
determining a common distance between the at least two parallel orientation dependent radiation sources and the camera based at least on a comparison of the respective second detectable properties of the at least two parallel orientation dependent radiation sources.

37. The method of claim 35, wherein the first detectable property includes a detectable phase of the orientation dependent radiation, wherein the second detectable property includes a detectable spatial frequency of the orientation dependent radiation, and wherein:
the act of determining the rotation angle of the orientation dependent radiation source from the first detectable property includes an act of determining the rotation angle from the detectable phase; and
the act of determining the distance between the orientation dependent radiation source and the camera from at least the second detectable property includes an act of determining the distance from the detectable spatial frequency and the rotation angle.

38. The method of claim 37, wherein the first detectable property includes a detectable position of the orientation dependent radiation on the observation surface, and wherein the act of determining the rotation angle of the orientation dependent radiation source from the first detectable property includes an act of determining the rotation angle from the detectable position.

39. A computer readable medium encoded with a program for execution on at least one processor, the program, when executed on the at least one processor, performing a method for processing an image including at least one orientation dependent radiation source that emanates from an observation surface orientation dependent radiation having at least a first detectable property in the image and a second detectable property in the image that each varies as a fuinction of at least one of a rotation angle of the orientation dependent radiation source and a distance between the orientation dependent radiation source and a camera obtaining an image of the at least one orientation dependent radiation source, the method comprising acts of:
determining the rotation angle of the orientation dependent radiation source from the first detectable property; and
determining the distance between the orientation dependent radiation source and the camera from at least the second detectable property.

40. The computer readable medium of claim 39, wherein the at least one orientation dependent radiation source includes at least two parallel orientation dependent radiation sources, wherein each of the at least first and second properties of one of the at least two parallel orientation dependent radiation sources varies differently than the respective at least first and second properties of another of the at least two parallel orientation dependent radiation sources, and wherein the act of determining the rotation angle of the orientation dependent radiation source from the first detectable property includes an act of:
determining a common angle of the at least two parallel orientation dependent radiation sources based on a comparison of the respective first detectable properties of the at least two parallel orientation dependent radiation sources,
and wherein the act of determining the distance between the orientation dependent radiation source and the camera from at least the second detectable property includes an act of:
determining a common distance between the at least two parallel orientation dependent radiation sources and the camera based at least on a comparison of the respective second detectable properties of the at least two parallel orientation dependent radiation sources.

41. The computer readable medium of claim 39, wherein the first detectable property includes a detectable phase of the orientation dependent radiation, wherein the second detectable property includes a detectable spatial frequency of the orientation dependent radiation, and wherein:
the act of determining the rotation angle of the orientation dependent radiation source from the first detectable property includes an act of determining the rotation angle from the detectable phase; and
the act of determining the distance between the orientation dependent radiation source and the camera from at least the second detectable property includes an act of determining the distance from the detectable spatial frequency and the rotation angle.

42. The computer readable medium of claim 41, wherein the first detectable property includes a detectable position of the orientation dependent radiation on the observation surface, and wherein the act of determining the rotation angle of the orientation dependent radiation source from the first detectable property includes an act of determining the rotation angle from the detectable position.

43. In a system including at least one orientation dependent radiation source that emanates from an observation surface orientation dependent radiation having at least a first detectable property and a second detectable property that each varies as a function of at least one of a rotation angle of the orientation dependent radiation source and a distance between the orientation dependent radiation source and a radiation detection device receiving the orientation dependent radiation, a method comprising acts of:
determining the rotation angle of the orientation dependent radiation source from the first detectable property; and
determining the distance between the orientation dependent radiation source and the radiation detection device from at least the second detectable property.

44. The method of claim 43, wherein the at least one orientation dependent radiation source includes at least two parallel orientation dependent radiation sources, wherein each of the at least first and second properties of one of the at least two parallel orientation dependent radiation sources varies differently than the respective at least first and second properties of another of the at least twc parallel orientation dependent radiation sources, and wherein the act of determining the rotation angle of the orientation dependent radiation source from the first detectable property includes an act of:
determining a common rotation angle of the at least two parallel orientation dependent radiation sources based on a comparison of the respective first detectable properties of the at least two parallel orientation dependent radiation sources,
and wherein the act of determining the distance between the orientation dependent radiation source and the radiation detection device from at least the second detectable property includes an act of:
determining a common distance between the at least two parallel orientation dependent radiation sources and the radiation detection device based at least on a comparison of the respective second detectable properties of the at least two parallel orientation dependent radiation sources.

45. The method of claim 43, wherein the first detectable property includes a detectable phase of the orientation dependent radiation, wherein the second detectable property includes a detectable spatial frequency of the orientation dependent radiation, and wherein:
the act of determining the rotation angle of the orientation dependent radiation source from the first detectable property includes an act of determining the rotation angle from the detectable phase; and
the act of determining the distance between the orientation dependent radiation source and the radiation detection device from at least the second detectable property includes an act of determining the distance from the detectable spatial frequency and the rotation angle.

46. The method of claim 45, wherein the first detectable property includes a detectable position of the orientation dependent radiation on the observation surface, and wherein the act of determining the rotation angle of the orientation dependent radiation source from the first detectable property includes an act of determining the rotation angle from the detectable position.

47. A computer readable medium encoded with a program for execution on at least one processor, the program, when executed on the at least one processor, performing a method in a system including at least one orientation dependent radiation source that emanates from an observation surface orientation dependent radiation having at least a first detectable property and a second detectable property that each varies as a function of at least one of a rotation angle of the orientation dependent radiation source and a distance between the orientation dependent radiation source and a radiation detection device receiving the orientation dependent radiation, the method comprising acts of:
determining the rotation angle of the orientation dependent radiation source from the first detectable property; and
determining the distance between the orientation dependent radiation source and the radiation detection device from at least the second detectable property.

48. The computer readable medium of claim 47, wherein the at least one orientation dependent radiation source includes at least two parallel orientation dependent radiation sources, wherein each of the at least first and second properties of one of the at least two parallel orientation dependent radiation sources varies differently than the respective at least first and second properties of another of the at least two parallel orientation dependent radiation sources, and wherein the act of determining the rotation angle of the orientation dependent radiation source from the first detectable property includes an act of:
determining a common rotation angle of the at least two parallel orientation dependent radiation sources based on a comparison of the respective first detectable properties of the at least two parallel orientation dependent radiation sources,
and wherein the act of determining the distance between the orientation dependent radiation source and the radiation detection device from at least the second detectable property includes an act of:
determining a common distance between the at least two parallel orientation dependent radiation sources and the radiation detection device based at least on a comparison of the respective second detectable properties of the at least two parallel orientation dependent radiation sources.

49. The computer readable medium of claim 47, wherein the first detectable property includes a detectable phase of the orientation dependent radiation, wherein the second detectable property includes a detectable spatial frequency of the orientation dependent radiation, and wherein:
the act of determining the rotation angle of the orientation dependent radiation source from the first detectable property includes an act of determining the rotation angle from the detectable phase; and
the act of determining the distance between the orientation dependent radiation source and the radiation detection device from at least the second detectable property includes an act of determining the distance from the detectable spatial frequency and the rotation angle.

50. The computer readable medium of claim 50, wherein the first detectable property includes a detectable position of the orientation dependent radiation on the observation surface, and wherein the act of determining the rotation angle of the orientation dependent radiation source from the first detectable property includes an act of determining the rotation angle from the detectable position.

51. An image metrology reference target, comprising:
automatic detection means for facilitating an automatic detection of the reference target in an image of the reference target obtained by a camera; and
bearing determination means for facilitating a determination of at least one of a position and at least one orientation angle of the reference target with respect to the camera.

52. The reference target of claim 0, wherein:
the automatic detection means includes at least one robust fiducial mark; and
the bearing determination means includes at least one orientation dependent radiation source disposed in a predetermined spatial relationship with respect to the at least one fiducial mark, the at least one orientation dependent radiation source emanating from an observation surface orientation dependent radiation having at least one detectable property in the image of the reference target that varies as a function of at least one of a viewing angle of the orientation dependent radiation source and a distance between the orientation dependent radiation source and the camera obtaining the image of the reference target.

53. The reference target of claim 52, wherein:
the at least one fiducial mark includes at least four fiducial marks; and
the at least one orientation dependent radiation source includes at least two orientation dependent radiation sources.
